(19) United States
(12) Patent Application Publication
(10) Pub. No.: US 2018/0136979 A1
(43) Pub. Date: May 17, 2018

(54) OFFER-BASED COMPUTING ENVIROMENTS

(71) Applicant: Robert Paul Morris, Raleigh, NC (US)

(72) Inventor: Robert Paul Morris, Raleigh, NC (US)

(73) Assignee: SITTING MAN, LLC, Raleigh, NC (US)

(21) Appl. No.: 15/615,538

(22) Filed: Jun. 6, 2017

Related U.S. Application Data
(60) Provisional application No. 62/346,429, filed on Jun. 6, 2016.

(51) Int. Cl. G06F 9/50; G06F 9/48

(52) U.S. Cl. CPC G06F 9/5055; H04L 67/02; G06F 9/4881

(57) ABSTRACT

Methods and systems are described comprising: providing circuitry operable for use with a system including a node; receiving, via the circuitry, a request to perform a task; detecting, via the circuitry, a resource that is identified by the request and that is not utilized in performing the task; and identifying, via the circuitry, a plurality of task host circuitry instances that are each capable of performing the task, wherein a first instance of task host circuitry in the plurality does not have access to the resource; and assigning, via the circuitry, the task to the first instance of task host circuitry to perform the task.

The present application claims priority to U.S. Provisional Application No. 62/346,429, titled “Offer-Based Computing Environments,” filed on Jun. 6, 2016; which is incorporated herein by reference in its entirety for all purposes.

### FIELD OF THE INVENTION

The present invention relates to operating environments that make efficient use of resources by assigning a task, included in work to be performed as tasks, to an environment capable of performing the task. The assigning is based on a resource utilized in performing tasks.

### BACKGROUND

Cloud computing environments arose, at least in part, from a need or desire to lower the cost of Internet accessed computing service providers. Cloud computing platforms such as APACHE MESOS and Google's BORG (among others) accomplish this by dividing work into units, referred to as tasks, and by matching the tasks with computing environments based on resources offered by the computing environments and resources utilized in performing the respective tasks. The resources considered in matching are limited and typically include processor time, available processor memory, and available persistent storage. The applications that may operate on these platforms are limited by the resources accessible within the servers, data centers, or other grouping of devices that host these platforms. Application providers may write custom logic to overcome some of the limits of these platforms, but other limitations cannot be presently overcome. Significantly, the limited management of resources in present day cloud environment limits the physical environments in which cloud platforms can presently operate. The present disclosure addresses these limitations allowing cloud platforms as well as other cloud technologies to operate in new physical environments which as describe below provides benefits other than or in addition to resource utilization benefits realized by present day cloud platforms and also allowing a much wider set of tasks to be performed in these new environments as well as in environments similar to present day data centers of cloud computing environment providers. As the Figures and descriptions of the present disclosure make apparent, the benefits of the present disclosure extend into networking, usability, security, and privacy—to identify a few of areas addressed by the subject matter of the present disclosure.

The present disclosure addresses the above needs as well as other related needs.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described comprising: providing circuitry operable for use with a system including a node; receiving, via the circuitry, a request to perform a task; detecting, via the circuitry, a resource that is identified by the request and that is not utilized in performing the task; and identifying, via the circuitry, a plurality of task host circuitry instances that are each capable of performing the task, wherein a first instance of task host circuitry in the plurality does not have access to the resource; and assigning, via the circuitry, the task to the first instance of task host circuitry to perform the task.

### BRIEF DESCRIPTION OF THE DRAWINGS

Objects and advantages of the present invention will become apparent to those skilled in the art upon reading this description in conjunction with the accompanying drawings, and in which for the subject matter described herein:

FIG. 1 illustrates an arrangement of components included in an embodiment of the subject matter described herein.

FIG. 2 illustrates a flow chart in accordance with an embodiment the subject matter described herein.

FIG. 3 illustrates a system in accordance with an embodiment of the subject matter described herein.

FIG. 4 illustrates a message or data flow diagram in accordance with an embodiment of the subject matter described herein.

FIG. 5A and FIG. 5B illustrate an arrangement of components included in an embodiment of the subject matter described herein.

FIG. 6A and FIG. 6B illustrate an arrangement of components included in an embodiment of the subject matter described herein.

FIG. 7 illustrates a flow chart in accordance with an embodiment the subject matter described herein.

FIG. 8 illustrates a flow chart in accordance with an embodiment the subject matter described herein.

FIG. 9 illustrates a system in accordance with an embodiment of the subject matter described herein.

FIG. 10 illustrates an arrangement of components included in an embodiment of the subject matter described herein.

FIG. 11 illustrates a flow chart in accordance with an embodiment the subject matter described herein.

FIG. 12 illustrates a flow chart in accordance with an embodiment the subject matter described herein.

FIG. 13 illustrates a system in accordance with an embodiment of the subject matter described herein.

FIG. 14 illustrates an arrangement of components included in an embodiment of the subject matter described herein.

FIG. 15 illustrates an arrangement of components included in an embodiment of the subject matter described herein.

FIG. 16 illustrates a flow chart in accordance with an embodiment the subject matter described herein.

FIG. 17 illustrates a flow chart in accordance with an embodiment the subject matter described herein.

FIG. 18 illustrates a flow chart in accordance with an embodiment the subject matter described herein.

FIG. 19 illustrates a flow chart in accordance with an embodiment the subject matter described herein.

FIG. 20 illustrates a system in accordance with an embodiment of the subject matter described herein.

FIG. 21 illustrates a flow chart in accordance with an embodiment the subject matter described herein.

FIG. 22 illustrates a system in accordance with an embodiment of the subject matter described herein.

FIG. 23 illustrates a flow chart in accordance with an embodiment the subject matter described herein.

FIG. 24 illustrates a flow chart in accordance with an embodiment the subject matter described herein.

FIG. 25 illustrates a system in accordance with an embodiment of the subject matter described herein.

FIG. 26 illustrates a flow chart in accordance with an embodiment the subject matter described herein.

FIG. 27 illustrates a system in accordance with an embodiment of the subject matter described herein.

FIG. 28 illustrates a message or data flow diagram in accordance with an embodiment of the subject matter described herein.

FIG. 29A and FIG. 29B illustrate an arrangement of components included in an embodiment of the subject matter described herein.

FIG. 30A and FIG. 30B illustrate an arrangement of components included in an embodiment of the subject matter described herein.

FIG. 31 illustrates a flow chart in accordance with an embodiment the subject matter described herein.

FIG. 32 illustrates a flow chart in accordance with an embodiment the subject matter described herein.

FIG. 33 illustrates a system in accordance with an embodiment of the subject matter described herein.

FIG. 34 illustrates a flow chart in accordance with an embodiment the subject matter described herein.

FIG. 35 illustrates a system in accordance with an embodiment of the subject matter described herein.

FIG. 36 illustrates a message or data flow diagram in accordance with an embodiment of the subject matter described herein.

FIG. 37 illustrates a system in accordance with an embodiment of the subject matter described herein.

FIG. 38 illustrates a system in accordance with an embodiment of the subject matter described herein.

FIG. 39 illustrates a message or data flow diagram in accordance with an embodiment of the subject matter described herein.

FIG. 40 illustrates a flow chart in accordance with an embodiment the subject matter described herein.

FIG. 41 illustrates a flow chart in accordance with an embodiment the subject matter described herein.

FIG. 42 illustrates a flow chart in accordance with an embodiment the subject matter described herein.

FIG. 43 illustrates a flow chart in accordance with an embodiment the subject matter described herein.

FIG. 44 illustrates a system in accordance with an embodiment of the subject matter described herein.

FIG. 45 illustrates a message or data flow diagram in accordance with an embodiment of the subject matter described herein.

FIG. 46 illustrates a flow chart in accordance with an embodiment the subject matter described herein.

FIG. 47 illustrates a flow chart in accordance with an embodiment the subject matter described herein.

FIG. 48 illustrates user interface elements in accordance with an embodiment of the subject matter described herein.

FIG. 49 illustrates user interface elements in accordance with an embodiment of the subject matter described herein.

FIG. 50 illustrates user interface elements in accordance with an embodiment of the subject matter described herein.

FIG. 51 illustrates user interface elements in accordance with an embodiment of the subject matter described herein.

FIG. 52 illustrates a system in accordance with an embodiment of the subject matter described herein.

FIG. 53 illustrates a flow chart in accordance with an embodiment the subject matter described herein.

FIG. 54 illustrates a system in accordance with an embodiment of the subject matter described herein.

FIG. 55 illustrates a system in accordance with an embodiment of the subject matter described herein.

FIG. 56 illustrates a system in accordance with an embodiment of the subject matter described herein.

FIG. 57 illustrates a system in accordance with an embodiment of the subject matter described herein.

FIG. 58 illustrates a flow chart in accordance with an embodiment the subject matter described herein.

FIG. 59 illustrates a flow chart in accordance with an embodiment the subject matter described herein.

FIG. 60 illustrates a flow chart in accordance with an embodiment the subject matter described herein.

FIG. 61 illustrates a flow chart in accordance with an embodiment the subject matter described herein.

FIG. 62 illustrates a flow chart in accordance with an embodiment the subject matter described herein.

FIG. 63 illustrates a flow chart in accordance with an embodiment the subject matter described herein.

FIG. 64 illustrates a system in accordance with an embodiment of the subject matter described herein.

FIG. 65 illustrates a flow chart in accordance with an embodiment the subject matter described herein.

FIG. 66 illustrates a system in accordance with an embodiment of the subject matter described herein.

FIG. 67 illustrates a flow chart in accordance with an embodiment the subject matter described herein.

FIG. 68 illustrates a flow chart in accordance with an embodiment the subject matter described herein.

FIG. 69 illustrates a flow chart in accordance with an embodiment the subject matter described herein.

FIG. 70 illustrates a flow chart in accordance with an embodiment the subject matter described herein.

FIG. 71 illustrates a system in accordance with an embodiment of the subject matter described herein.

FIG. 72 illustrates a system in accordance with an embodiment of the subject matter described herein.

FIG. 73 illustrates a system in accordance with an embodiment of the subject matter described herein.

FIG. 74 illustrates a flow chart in accordance with an embodiment the subject matter described herein.

FIG. 75 illustrates an arrangement of components included in an embodiment of the subject matter described herein.

FIG. 76 illustrates an arrangement of components included in an embodiment of the subject matter described herein.

FIG. 77 illustrates a system in accordance with an embodiment of the subject matter described herein.

FIG. 78 illustrates a system in accordance with an embodiment of the subject matter described herein.

FIG. 79 illustrates a flow chart in accordance with an embodiment the subject matter described herein.

FIG. 80 illustrates a flow chart in accordance with an embodiment the subject matter described herein.

FIG. 81 illustrates an arrangement of components included in an embodiment of the subject matter described herein.

FIG. 82 illustrates a flow chart in accordance with an embodiment the subject matter described herein.

FIG. 83 illustrates a flow chart in accordance with an embodiment the subject matter described herein.

FIG. 84 illustrates a flow chart in accordance with an embodiment the subject matter described herein.

FIG. 85 illustrates a flow chart in accordance with an embodiment the subject matter described herein.

FIG. 86 illustrates a system in accordance with an embodiment of the subject matter described herein.

FIG. 87 illustrates an exemplary operating environment in which one or more aspects of the subject matter may be embodied.

Some addressable entities (AEs) or other types of parts, illustrated in the drawings are identified by numbers with an alphanumeric suffix. An addressable entity or part may be referred to generically in the singular or in the plural by dropping a suffix of the addressable entity's or part's identifier or a portion thereof.

### DETAILED DESCRIPTION

All publications, patent applications, patents, and other references mentioned herein are incorporated by reference in their entirety, unless explicitly stated otherwise. In case of conflict, the present disclosure, including definitions, will control.

One or more aspects of the disclosure are described with reference to the drawings, wherein the various structures are not necessarily drawn to scale. In addition, the materials, Figures, and examples are illustrative only and not intended to be limiting. As an option, each of the flow charts, data flow diagrams, system diagrams, operating environment diagrams, network diagrams, user interface diagrams, or Figures that depict other types of diagrams may be implemented in the context and details of any of the other diagrams in the foregoing Figures unless clearly indicated by the diagrams themselves or in the description below. For purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure. It is to be understood that other embodiments or aspects may be utilized and structural and functional modifications may be made without departing from the scope of the subject matter disclosed herein.

Although flow charts, pseudo-code, hardware, devices, or systems similar or equivalent to those described herein can be used in the practice or testing of the subject matter described herein, suitable flow charts, pseudo-code, hardware, devices, or systems are described below. Each embodiment, option, or aspect of the subject matter disclosed herein (including any applications incorporated by reference) may or may not incorporate any desired feature from any other embodiment, option, or aspect described herein (including any applications incorporated by reference).

Of course, the various embodiments set forth herein may be implemented utilizing hardware, software, or any desired combination thereof. For that matter, any type of logic may be utilized which is capable of implementing the various functionality set forth herein. It should be noted that, one or more aspects of the various embodiments of the present invention may be included in an article of manufacture (e.g. One or more computer program products) having, for instance, computer usable media. The media has embodied therein, for instance, computer readable program code for providing and facilitating the capabilities of the various embodiments. The article of manufacture can be included as a part of a computer system or sold separately.

References in this specification or references in specifications incorporated by reference to an “embodiment”; may mean that particular aspects, architectures, functions, features, structures, characteristics, etc. Of an embodiment that may be described in connection with the embodiment may be included in at least one implementation. Thus, references to an “embodiment” may not necessarily refer to the same embodiment. The particular aspects etc. may be included in forms other than the particular embodiment described or illustrated and all such forms may be encompassed within the scope and claims of the present application.

References, in this specification or references in specifications incorporated by reference to “for example”, may mean that particular aspects, architectures, functions, features, structures, characteristics, etc. described in connection with the embodiment or example may be included in at least one implementation. Thus references to an “example” may not necessarily refer to the same embodiment, example, etc. The particular aspects etc. may be included in forms other than the particular embodiment or example described or illustrated and all such forms may be encompassed within the scope and claims of the present application.

Further, the various examples provided herein relating to improvements to apparatuses and processes (e.g. as shown in the contexts of the Figures included in this specification, for example) may be used in various applications, contexts, environments, etc. The applications, uses, etc. Of these improvements etc. may not be limited to those described above, but may be used, for example, in combination. For example, one or more applications etc. used in the contexts, for example, in one or more Figures may be used in combination with one or more applications etc. used in the contexts of, for example, one or more other Figures or one or more applications etc. described in any specifications incorporated by reference.

Still yet, the diagrams depicted herein are just examples. There may be many variations to these diagrams or the steps (or operations) described therein without departing from the spirit of the various embodiments of the invention. For instance, the steps may be performed in a differing order, or steps may be added, deleted or modified. All of these variations are considered a part of the claimed invention.

While various embodiments are described below, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Terminology

Unless otherwise defined herein or alternatively in a definition included by reference, all technical and scientific terms used herein have the same meaning as commonly understood by one of ordinary skill in the art to which the present disclosure belongs.

Use of the terms “a” and “an” and “the” and similar referents in the context of describing the subject matter (particularly in the context of the following claims) are to be construed to cover both the singular and the plural, unless otherwise indicated herein or clearly contradicted by context.

The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The use of “including”, “comprising”, “having”, and variations thereof are meant to encompass the items listed thereafter and equivalents thereof as well as additional items and equivalents thereof.

The term “or” in the context of describing the subject matter (particularly in the context of the following claims) is to be construed to be, as used herein, inclusive. That is, the term “or” is equivalent to “and/or” unless otherwise indicated herein or clearly contradicted by context.

Terms used to describe interoperation or coupling between or among parts are intended to include both direct and indirect interoperation or coupling, unless otherwise indicated. Exemplary terms used in describing interoperation or coupling include “mounted,” “connected,” “attached,” “coupled”, “communicatively coupled,” “operatively coupled,” “invoked”, “called”, “provided to”, “received from”, “identified to”, “interoperated” and similar terms and their variants.

In various implementations of the subject matter of the present disclosure, circuitry for “sending” an entity is referenced. As used herein “sending” refers to providing via a network or making accessible via a shared data area, stack, a queue, a pointer to a memory location, an interprocess communication mechanism, and the like. Similarly, in various implementations of the subject matter of the present disclosure, circuitry for “receiving” an entity as use herein may include receiving or otherwise accessing via a network, gaining access via a network or making accessible via a shared data area, stack, a queue, a pointer to a memory location, an interprocess communication mechanism, and the like. Circuitry for “exchanging” may include circuitry for sending or for receiving. In various implementations of the subject matter of the present disclosure, circuitry for “identifying” as use herein may include, without being exhaustive, circuitry for accessing, sending, receiving, exchanging, detecting, creating, modifying, translating, or transforming. In various implementations of the subject matter of the present disclosure, circuitry for “detecting” as use herein may include e, without being exhaustive, circuitry for accessing, sending, receiving, exchanging, identifying, creating, modifying, translating, or transforming.

As used herein, any reference to an entity “in” an association is equivalent to describing the entity as “included in or identified by” the association, unless explicitly indicated otherwise.

A system, an apparatus, or other hardware that accesses a resource to process or otherwise utilize in performing an operation, a task, or an instruction is referred to herein as a “resource accessor”. The term “resource” as used herein with respect to a “task” (defined below) refers to any entity accessed by a resource accessor to process or utilize in performing the task. As such a resource may include data, a system, an apparatus, hardware (e.g. mechanical, electrical, etc.), or a user accessed by a resource accessor to process or otherwise utilize in performing a task. A resource may, at least in part, be a physical entity or may, at least in part, be a virtual entity or logical entity realized by one or more physical entities. As such, a resource accessor that accesses a resource to process or otherwise utilize in performing a task may, at least in part, be a physical entity or may at least in part be in part a virtual entity or logical entity realized by one or more physical entities. A physical entity may be alive or not. An entity that allows a resource accessor to access a resource is referred to herein as a “resource provider”. A resource provider may also be a resource with respect to a resource accessor. In an automobile, a gasoline engine may, as a resource accessor, access gas, as a resource, from a gas tank, as a resource provider, via a fuel line, also in the role of a resource provider. In a computing environment, physical processor memory, virtual processor memory, a persistent storage device, network hardware, a processor, a computing process, virtual circuitry realized when a processor accesses and executes machine code stored in a processor memory, and the like is each an example of a resource when accessed via a resource accessor; a resource provider when providing access to a resource utilized by a resource accessor in performing a task; and a resource accessor when accessing a resource in performing an operation. For example, a signal propagated by a communications medium may be a resource or data stored on a hard drive may be a resource, but in and of themselves are not resource accessors. Each may be processed as a resource by a suitable resource accessor. Exemplary resources with respect to various tasks performed by a computing environment (see below) or a portion thereof include a cache memory, a system bus, a switching fabric, an input device, an output device, a network protocol, an interrupt, a semaphore, a pipe, a queue, a stack, a data segment, a memory address space, a file system, a network address space, a URI, an image capture device, an audio output device, a user, a database, a persistent data store, a semaphore, a pipe, a socket, and so on. A resource may be identified based on an attribute or constraint such as a state, a condition, an amount, a duration, a time, a date, a rate, an average, a measure of dispersion, a maximum, a minimum, a temperature, a velocity, an acceleration, a weight, a mass, a count, an order, or an ordering—too name a few examples. In an operating system of a computing environment, a thread scheduler may access a thread or data associated with a thread in performing a task, a memory manager may access a memory page or data about a memory page in managing memory for a computing process, and so forth.

An “operating environment” (OE), as used herein, is an arrangement of physical entities and/or virtual entities that include or that may be configured to include an embodiment of the subject matter of the present disclosure. An operating environment may, as indicated, include one or more logical entities represented or otherwise realized in one or more physical entities. For example, physical electronic circuitry is a physical entity that includes one or more electronic circuits each designed and built to perform a particular operation, task, or instruction. An example of a logical entity, is virtual circuitry or logic that is realized in one or more physical electronic circuits, such as the physical circuitry included in a memory device, in a wired or wireless network adapter, or in special purpose or general purpose instruction execution circuitry as described in more detail below. All embodiments of the subject matter of the present disclosure include one or more physical entities that access or utilize one or more physical resources. Embodiments of the subject matter of the present disclosure that provide, transmit, or receive electrical power include electronic circuitry which is either not programmable or otherwise reconfigurable, or that is programmable but that does not embody a Turing machine. Some embodiments may include programmable circuitry that embodies a Turing machine for realizing virtual circuitry. Virtual circuitry may be represented in a memory device or in a data transmission medium. Virtual circuitry is emulated or realized by physical circuitry. For example, virtual circuitry may be specified in data accessible to physical circuitry that emulates the virtual circuitry by processing the data. Such data may be stored or otherwise represented, for example, in a memory device or in a data transmission medium coupled to the physical circuitry to allow the physical circuitry access to a data representation of the virtual circuitry to emulate the operation of the virtual circuitry. A computing process is an example of a virtual resource (also referred to as a logical resource) that represents virtual circuitry that in operation may be emulated or realized by programmable physical circuitry according to a data representation of the virtual circuitry.

An operating environment may be emulated by another operating environment. That is an operating environment may be a virtual operating environment (VOE) realized in a physical operating environment. An operating environment may include or may be provided by one or more devices. The operating environment is said, herein, to be the operating environment “of” the device or devices. A device may be a virtual device realized in one or more physical devices. At least some of the virtual circuitry may be represented by data that is a translation of source code written in a programming language. An operating environment, as used herein, may include software accessible to a processor as logic (i.e. virtual circuitry). An operating environment may include or may be provided by one or more devices that include one or more processors to execute instruction(s) to emulate virtual circuitry. An operating environment that includes a processor is referred to herein as a “computing environment”. In an aspect, a computing environment may include an operating system, such as WINDOWS, LINUX, OSX, OS360, and the like. In an aspect, an operating environment, which may be or may include a computing environment, may include one or more operating systems.

As used herein a “processor” is an instruction execution machine, apparatus, or device. A processor may include one or more electrical, optical, or mechanical parts that when executed operate in interpreting and executing data that specifies virtual circuitry (i.e. logic), typically generated from code written in a programming language. Exemplary processors include one or more microprocessors, digital signal processors (DSPs), graphics processing units (GPUs), application-specific integrated circuits (ASICs), optical or photonic processors, or field programmable gate arrays (FPGAs). A processor in an operating environment may be a virtual processor emulated by one or more physical processors. A processor may be included in an integrated circuit (IC), sometimes called a chip or microchip. An IC is a semiconductor wafer on which thousands or millions of resistors, capacitors, and transistors are fabricated. An IC can function as an amplifier, oscillator, timer, counter, computer memory, or processor. A particular IC may be categorized as linear (analog) or digital, depending on its intended application.

As used herein the term “operating environment resource” (OER) is a resource defined with respect to a particular operating environment. An OER is a physical or virtual entity that is accessed, directly or indirectly, by the operating environment and utilized in performing an operation or a “task” (defined below). For example, first circuitry (physical or virtual) that provides a data exchange interface or that otherwise enables communicating directly or indirectly with second circuitry may be an OER with respect to third circuitry that access the second circuitry via the first circuitry. For example, the first circuitry may include or otherwise embody a programming interface (also referred to as an API). Further the first circuitry may have one or more OERs within a particular operating environment with respect to itself. Exemplary OERs for computing environments include a processor, a memory manager, a scheduler, a process, a thread, an executable maintained in a library, a data store, a data storage medium, a file, a directory, a file system, user data, authorization data, authentication data, a stack, a heap, a queue, an interprocess communication mechanism (e.g. a stream, a pipe, an interrupt, etc.), a synchronization mechanism (e.g. a lock, a semaphore, an ordered list, etc.), an output device, an input device, a networking device, a device driver, a network protocol, a link or reference, a linker, a loader, a compiler, an interpreter, a sensor, an address space, an addressable space, an invocation mechanism, a memory mapper, a security model or a security manager, a GPS client or server, a web server, a browser, a container (such as a LINUX container), a virtual machine, a framework (such as a MESOS framework or an OMEGA framework), a scheduler, a timer, a clock, a code segment, a data segment, boot logic, shutdown logic, a cache, a buffer, a processor register, a log, a tracing mechanism, a registry, a network adapter, a line card, a kernel, a security ring, a policy, a policy manager, encryption hardware or software, a routing/forwarding/relaying mechanism, a data base, a user communications agent (e.g. Email, instant messaging, voice, etc.), a distributed file system, a distributed memory mechanism, a shared memory mechanism, a broadcast mechanism, a display, graphics hardware, a signal (e.g. a UNIX signal), a pipe, a stream, a socket, a physical memory, a virtual memory, a virtual file system, a command line interface, and loadable logic code or data (e.g. a dynamic link library). OERs in computing environments may be accessed for process management, thread management, memory management, input/output device management, virtual machines, kernels, storage management, security management, network management, user interface management, data storage, data exchange via a network, presenting output, detecting input, operatively coupling to a peripheral device or a peer device, providing power, generating heat, dissipating heat, and the like.

The term “operating environment resource set” (OER Set) for a task performed by an operating environment, as used herein, refers to the set of OERs that are accessed by an operating environment in a performing of task. Note that a set may be empty, include one member, or may include multiple members. The term “operating environment resource container” (OER Container) for the set, as used herein, refers to the OERs identified or otherwise referenced by at least a portion of the operating environment that operates in performing the task. An OER Container, is thus, included in an OER Set. For example, for a computing environment, an OER set for one or more instructions that are executed by a processor in performing a task refers to the OERs that are directly accessed in an executing of the one or more instructions. For the computing environment, the OER container for the one or more instructions refers to the OERs utilized or otherwise accessed indirectly by the operating environment in the executing of the one or more instructions by the processor in performing the task. A measure of a resource utilized in performing a task may be based on one or more resources in an OER set or in an OER container. According to the subject matter of the present disclosure a resource accessor that utilizes a set of resources to perform a task has an OER Container and an OER Set. One or more measures may be determined or identified to determine if the OER Set or the OER Container is accessible, sufficient, or in a condition compatible for performing the task via the resource accessor.

Whether an OER is included in an OER Container or an OER Set for a performing of a task may depend on the particular portion or portions of the operating environment that operate or that are otherwise accessed in performing the task. For example, in a computing environment, whether an instruction is executed in a particular performing of a task may be determined or otherwise configured during the performing, prior to loading an instruction executed in the performing into a processor address space for the executing, during a translating of source code or a translating of a translation of the source code of that includes a translation of an instruction executed in the performing of the task.

A “virtual operating environment” (VOE) operates in another operating environment, referred to as a “host operating environment” with respect to the virtual operating environment. With respect to computing environments, Linux and Windows virtual machines are examples of virtual operating environments. The term “virtual machine” (VM) as used herein refers to an implementation that emulates a physical machine (e.g., a computer). A VM that includes an emulation of a processor is a virtual operating environment provided by a host operating environment where the host operating environment includes a processor realized in hardware. VMs provide hardware virtualization. Another category of virtual operating environment is referred to, herein, as a “process virtual environment” (PVE). A PVE includes a single computing process. A JAVA VM is an example of a process virtual environment. PVEs are typically tied to particular programming languages. Still another exemplary type of virtual operating environment is a “container operating environment” (COE). As used herein, a COE refers to a partition of a host operating environment that isolates an executing of particular logic, such as in a computer program, from other partitions. For example, a single physical server may be partitioned into multiple small partitions that each execute logic for respective web servers. To particular logic, such as logic implementing a web server, operating in a partition (COE); the partition appears to be an operating environment. COE's are referred to in other contexts outside the present disclosure as virtual environments (VE), virtual private servers (VPS), guests, zones, containers (e.g. Linux containers), etc. At least one of a resource utilized by a resource accessor (e.g. task circuitry) and a resource provider that allows the resource accessor to access the resource (e.g. a task operating environment or task host circuitry) may be included in a virtual operating environment.

The term “minimally-complete operating environment” (MOE), as used herein, refers to, in the context of performing a task, an operating environment in a group of operating environments that are each a) capable of performing the task based on one or more OERs accessed by the operating environment in the performing and b) has a minimum measure associated with the performing with respect to the group of operating environments. Each of the measures associated with a respective operating environment in the group is determined according to a metric based on one or more of the OERs. A measure of a resource utilized in performing a task may be included in defining or otherwise configuring an MOE. In an aspect of the subject matter of the present disclosure, a measure of accessible resources in an operating environment may determine whether the operating environment is an MOE for a task in a group of operating environments each capable of operating to perform the task

For a computing environment, an MOE, may be an operating environment that in a group of operating environments and in the context of a task at least partially specified in source code written in a programming languages that is a) capable of performing the task by executing an executable translation of the source code based on one or more OERs accessed by the operating environment in the performing and b) has a minimum measure associated with the performing in the group. An operation may be performed by one operating environment by executing a translation including one or more instructions translated from the source code. The same operation may be performed by another operating environment by executing a different translation including one or more instructions translated from the source code. For example, one operating environment may perform the operation by executing instructions translated from the source code for an INTEL processor and the other operating environment may perform the operation by executing instructions translated from the source code for an ARM processor.

In an aspect, an operation or a task may be performed only in a MOE in a group of operating environments as a matter of policy or configuration. The operation or task may be scheduled so that the operating environment that is the MOE exists or is otherwise available. For a particular operation or task, an MOE in a group of OEs may be determined, for example, based on a metric for measuring power accessed (e.g. an OER) in performing the operation by each of the OEs. One or more of the OEs may be COEs or VOEs operating in a host operating environment. The MOE may be selected based on the least power accessed according to a specified metric, in an embodiment. In another aspect, an MOE may be determined based on a metric measuring time. The metric may be based on time to perform the task by respective operating environments in a group of two or more. The MOE may be determined based on a least time or a preferred duration for performing the operation or task. Metrics for determining MOEs may be based on OERs in OER Sets, may be based on OERs in OER Containers, or may be based on some other grouping of OERs.

An “offer-based computing environment” (OCE), as used herein, refers to an operating environment that organizes work (e.g. applications, services, and the like) into units of work referred to herein as “tasks” where a task is associated with one or more resources accessed by task circuitry (see below) or otherwise utilized in performing the task. Data that identifies a task and identifies one or more resources accessed or otherwise utilized to perform the task is referred to herein as “task data”. Resources are shared or allocated by matching identified tasks to be performed with instances of task host circuitry (defined below) that provide access to resource(s) utilized in executing task circuitry or accessed by the task circuitry that operates to perform an identified task. As defined “task circuitry” is a resource accessor and task host circuitry provides an operating environment, referred to herein as a “task operating environment” (TOE) in which the task circuitry operates. The resources accessed by the task circuitry or otherwise utilized by a TOE in performing a task are OERs with respect to the TOE. Also as defined, the resource(s) accessed by the task circuitry when operating in a task operating environment identify an OER Set and also identify an OER Container with respect to the task operating environment as the terms “OER Set” and “OER Container” are defined above or otherwise exemplified in the specification and Figures of the present disclosure. Still further, an MOE, based on a specified criterion, is included in a plurality of task operating environments in which a particular task may be performed. Task circuitry may include virtual circuitry realized by a processor. Task circuitry may identified by or in a shell script or command line operation. Task circuitry may include circuitry of an application. A task may include a number of sub-tasks some or all of which may be related by their inputs or outputs or may be related by when they are to be performed with respect to other sub-tasks. “Task coordination circuitry” (TCC), as the term is used herein, refers to circuitry that may operate to coordinate or schedule a number of tasks or their sub-tasks. Task coordination circuitry may provide or otherwise may be associated with an API to monitor the state of the tasks allowing a monitoring application or system to perform one or more actions based on the state or other metadata accessible via the API. A task may be performed by hardware which may include task circuitry. When a task is performed, one or more resources are utilized or otherwise accessed in performing the task. Task coordination circuitry may include or otherwise may interoperate with one or more instances of circuitry, referred to herein as “task match circuitry” (TMC), that may operate to match a task to task host circuitry to perform the task. The matching may be based on data that identifies one or resources offered by task host circuitry, as a resource provider, as accessible resources to task circuitry, as a resource accessor, or resources otherwise utilized in executing the task circuitry such a processor or other hardware included in executing the task circuitry. Data that identifies one or more resources offered by task host circuitry is referred to herein as an “offer”. Task host circuitry may provide, manage, maintain, or coordinate one or more task operating environments (TOEs) in which task circuitry may operate to perform a task. In order to match a task with an offer, task match circuitry receives, accesses, or otherwise identifies one or more resources that may be utilized in performing the task by task circuitry operating in a task operating environment of task host circuitry. Task match circuitry may match one or more resources identified by task data with one or more resources identified by an offer. As described below in the specification and illustrated in the Figures, task data may be matched by task match circuitry with an offer based on a resource identified by the task data or the offer data as not accessed, utilized, accessible, or utilizable in performing the task. A resource may be identified as not accessed, not utilized, not accessible, or utilizable may be explicitly identified as such in task data or offer data or may be identified implicitly in some embodiments. For example, in an embodiment, a resource that is not identified in task data or that is not identified in offer data may be defined in the embodiment as not accessed, not utilized, not accessible, or utilizable.

Task host circuitry further may include or interoperate with circuitry that advertises one or more resources accessible to task circuitry operating in a task operating environment of the task host circuitry. The one or more resources are advertised to allow a task, that utilizes or otherwise accesses one or more of the advertised resources to be assigned to the task host circuitry, to be performed by corresponding task circuitry operating in a task operating environment of the task host circuitry. The term “task-offer routing circuitry” (TORC), as used herein, sometimes refers to circuitry included in or otherwise hosted by one or more nodes that may operate to provide offers from instances of task host circuitry to one or more instance of task match circuitry that matches one or more tasks to be performed to one or more of the offers. Alternatively or additionally, the term “task-offer routing circuitry”, as used herein; sometimes refers to circuitry included in or otherwise hosted by one or more nodes that operate to provide task data to task host circuitry associated with an offer matched to a task identified by the task data by task match circuitry to perform the task. Task-offer routing circuitry may be separate from task host circuitry, task match circuitry, or task coordination circuitry in some embodiments. In some embodiments task-offer routing circuitry may be included in one or more of task host circuitry, task match circuitry, or task coordination circuitry.

The term “service site”, as user herein, refers to one or more nodes that operates circuitry that provides a service via a network to a client node. The client node may be a user node or may operate as server. A service site may or may not include or may or may not be hosted by a cloud computing environment.

The terms “network node” and “node” herein both refer to a device having network interface hardware capable of operatively coupling the device to a network. Further, the terms “device” and “node” in the context of providing or otherwise being included in an operating environment refer respectively, unless clearly indicated otherwise, to one or more devices and nodes. A “server node” may, as used herein, refer to one or more nodes in a service site, in a data center, included in or otherwise hosting a cloud computing environment, or included in or otherwise hosting an offer-based computing environment.

As used herein, the term “addressable entity” (addressable entity) refers to any data representation that may be translated into virtual circuitry or may be circuitry or data that may be stored in a memory and accessed by a processor, in an operating environment, to execute an instruction in emulating the virtual circuitry or to process at least some of the data as an operand of an instruction executed by the processor. An addressable entity is or specifies circuitry. An addressable entity may include a circuit or may be specified in machine code, object code, byte code, and source code—to name some examples. Object code includes a set of instructions or data elements that either are prepared to link prior to loading or are loaded into an operating environment. When in an operating environment, object code may include references resolved by a linker or may include one or more unresolved references. The context in which this term is used will make clear the state of the object code when it is relevant. An addressable entity may include one or more addressable entities. As used herein, the terms “application”, “service”, “subsystem”, and “library” include one or more addressable entities accessible to a processor via a data storage medium or may be realized in one or more hardware parts. An addressable entity may be defined, referenced, or otherwise identified by source code specifiable in a programming language. An addressable entity is addressable by a processor when translated from the source code and loaded into a processor memory of the processor in an operating environment. Examples of addressable entities include variables, constants, functions, subroutines, procedures, modules, methods, classes, objects, code blocks, and labeled instructions. A “code block” includes one or more instructions in a given scope specified in a programming language. An addressable entity may include a value. addressable entities may be written in or translated to a number of different programming languages or representation languages. An addressable entity may be specified in or translated into source code, object code, machine code, byte code, or any intermediate language for processing by an interpreter, compiler, linker, loader, or analogous tool. Some addressable entities include instructions executed by a processor. The instructions may be executed in a computing context referred to as a “computing process” or simply a “process” or in a task context. A process may include one or more “threads”. A “thread” includes a one or more instructions executed by a processor in a computing sub-context of a process. The terms “thread” and “process” may be used interchangeably herein when a process includes only one thread. Task circuitry may be executed in a thread or process. Alternatively or additionally, task circuitry when executed may create or otherwise include a thread or a process. In various contexts, an addressable entity may be included in a resource utilized in performing a task, may be included in a resource accessor that utilizes a resource in performing a task, or may be included in a resource provider that allows a resource accessor to access a resource utilized by the resource accessor in performing a task. An addressable entity may be accessed as a resource, may operate or may be executed in allowing access to a resource as a resource provider, or may be resource accessor that utilizes a resource in performing a task.

A “programming language” is defined for expressing data or operations (in one or more addressable entities) in source code written by a programmer or generated automatically from an identified design pattern or from a design language, which may be a visual language specified via a drawing. The source code may be translated into instructions or into data that are valid for processing by an operating environment to emulate a virtual circuit or virtual circuitry. For example, a compiler, linker, or loader may be included in translating source code into machine code that is valid for a type of processor in an operating environment. A programming language is defined or otherwise specified by an explicit or implicit schema that identifies one or more rules that specify whether source code is valid in terms of its form (e.g. syntax) or its content (e.g. vocabulary such as valid tokens, words, or symbols). A programming language defines the semantics or meaning of source code written in the programming language with respect to an operating environment in which a translation of the source code is executed. Source code written in a programming language may be translated into a “representation language”. As used herein, a “representation language” is defined or otherwise specified by an explicit or implicit schema that identifies at least one of a syntax and a vocabulary for a scheduled translation of source code that maintains the functional semantics expressed in the source code. Note that some programming languages may serve as representation languages. Exemplary types of programming languages for writing or otherwise expressing source code include array languages, object-oriented languages, aspect-oriented languages, assembler languages, command line interface languages, functional languages, list-based languages, procedural languages, reflective languages, scripting languages, and stack-based languages. Exemplary programming languages include C, C#, C++, FORTRAN, COBOL, LISP, FP, JAVA®, APL, PL/I, ADA, Smalltalk, Prolog, BASIC, ALGOL, ECMAScript, BASH, and various assembler languages. Exemplary types of representation languages include object code languages, byte code languages, machine code languages, programming languages, and various other translations of source code.

A “user interface element” (user interface element), as used herein refers to a user-detectable output of an output device of an operating environment. More specifically, visual outputs of a user interface are referred to herein as “visual interface elements”. A visual interface element may be a visual output in a graphical user interface (GUI) presented via a display device. Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application user interface may include one or more of the user interface elements listed. Those skilled in the art will understand that this list is not exhaustive. The terms “visual representation”, “visual output”, and “visual interface element” are used interchangeably herein. Other types of user interface elements include audio outputs referred to as “audio interface elements”, tactile outputs referred to as “tactile interface elements”, and the like. As such, the term “output” as used herein refers any type of output.

A visual output may be presented in a two-dimensional presentation where a location may be defined in a two-dimensional space. For example, one dimension may be a vertical dimension and the other a horizontal dimension. A location in a first dimension, such as the horizontal dimension, may be referenced according to an X-axis and a location in the second dimension (e.g. The vertical dimension) may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie or underlie some or all of another visual output.

A user interface element may be stored or otherwise represented in an output space. As used herein, the term “output space” refers to memory or other medium allocated or otherwise provided to store or otherwise represent output information, which may include audio, visual, tactile, or other sensory data for presentation via an output device. For example, a memory buffer to store an image or text string may be an output space as sensory information for a user. An output space may be physically or logically contiguous or non-contiguous. An output space may have a virtual as well as a physical representation. An output space may include a storage location in a processor memory, in a secondary storage, in a memory of an output adapter device, or in a storage medium of an output device. A screen of a display, for example, is an output space. In various embodiments, a display may be included in a mobile device (e.g., phone, tablet, mobile entertainment device, etc.), a fixed display device (e.g., within a vehicle, computer monitor, a non-portable television, etc.), or any other display element, screen, or projection device which may present a visual output to a user.

An order of visual outputs in a particular dimension is herein referred to as an order in that dimension. For example, an order with respect to a Z-axis is referred to as a “Z-order”. The term “Z-value” as used herein refers to a location in a Z-order. A Z-order specifies the front-to-back or back-to-front ordering of visual outputs in an output space with respect to a Z-axis. In one aspect, a visual output with a higher Z-value than another visual output may be defined to be on top of or closer to the front than the other visual output. In another aspect, a visual output with a lower Z-value than another visual output may be defined to be on top of or closer to the front than the other visual output. For ease of description the present disclosure defines a higher Z-value to be on top of or closer to the front than a lower Z-value.

A “user interface element handler” (user interface element handler), as the term is used herein, refers to an addressable entity that includes circuitry (virtual or physical) to send information to present an output via an output device, such as a display. A user interface element handler, additionally or alternatively, may also include circuitry to process input information that corresponds to a user interface element. The input information may be received by the user interface element handler in response to a user input detected via an input device of an operating environment. Information that is transformed, translated, or otherwise processed by logic in presenting a user interface element by an output device is referred to herein as “output information” with respect to the logic. Output information may include or may otherwise identify data that is valid according to one or more schemas (defined below). Exemplary schemas for output information are defined data such as raw pixel data, JPEG for image data, video formats such as MP4, markup language data such as defined by a schema for a hypertext markup language (HTML) and other XML-based markup, a bit map, or instructions (such as those defined by various script languages, byte code, or machine code)—to name some examples. For example, a web page received by a browser may include HTML, ECMAScript, or byte code processed by logic in a user interface element handler to present one or more user interface elements.

An “interaction”, as the term is used herein, refers to any activity including a user and an object where the object is a source of sensory data detected by the user or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input of the portable electronic device exemplifies the device, as an input target, receiving input from the user. Note that the user in providing input is receiving sensory information from the portable electronic. An interaction may include an input from the user that is detected or otherwise sensed by the device. An interaction may include sensory information that is received by a user included in the interaction that is presented by an output device included in the interaction.

A metric defines a unit of measure. For example, an “inch” is a unit of measure for measuring length. A “kilowatt-hour” (kWh) is a unit of measurement in a metric for measuring an amount of energy. Instead of or in addition to measuring an amount a metric may measure a rate. “Kilowatts per hour” (kWh/h) is energy or power metric for measuring a rate of energy used. Alternatively or additionally, a metric may determine a state such as whether a component is receiving power or not, whether an output is detectable by a user or not, and the like. A “measure” is a result of a particular measuring or measurement process. For example, 3 inches is a measure according to the length metric for inches, 100 kWh is a measure of an energy metric identifying an amount of energy, and TRUE and FALSE may each be measures for a two-state metric. As used herein, a “measure of a cost” refers to a result of a measuring process for determining the cost according to a specified metric. Measuring may include estimating a measurement. As used herein, a “performance cost”, is a cost for performing an instruction or operation in an operating environment. The instruction or operation is specified in source code and performed by executing a translation of the source by the operating environment. A cost may be expressed as a measure which is a result of a measuring or estimating process, based on a metric.

As used herein, the term “network protocol” refers to a set of rules, conventions, or schemas that govern how nodes exchange information over a network. The set may define, for example, a convention or a data structure. Those skilled in the art will understand upon reading the descriptions herein that the subject matter disclosed herein is not restricted to the network protocols described or their corresponding OSI layers or other architectures (such as a software defined network (SDN) architecture). The term “network path” as used herein refers to a sequence of nodes in a network that are communicatively coupled to transmit data in one or more data units of a network protocol between a pair of nodes in the network. The terms “network node” and “node” herein both refer to a device having a network interface hardware capable of operatively coupling the device to a network. Further, the terms “device” and “node” in the context of providing or otherwise being included in an operating environment refer respectively, unless clearly indicated otherwise, to one or more devices and nodes.

As used herein, the term “user communication” refers to data exchanged via a network along with an identifier that identifies a user, group, or legal entity as a sender of the data or as a receiver of the data. The identifier is included in a data unit of a network protocol or in a message of an application protocol transported by a network protocol. The application protocol is referred to herein as a “user communications protocol”. The sender is referred to herein as a “contactor”. The receiver is referred to herein as a “contactee”. The terms “contactor” and “contactee” identify roles of “communicants” in a user communication. The contactor and the contactee is each a “communicant” in the user communication. An identifier that identifies a communicant in a user communication is referred herein as a “communicant identifier”. The terms “communicant identifier” and “communicant address” are used interchangeably herein. A communicant identifier that identifies a communicant in a user communication exchanged via a user communications protocol is said to be in an identifier space or an address space of the user communications protocol. The data in a user communication may include text data, audio data, image data, or instruction data. A user communications protocol defines one or more rules, conventions, or vocabularies for constructing, transmitting, receiving or otherwise processing a data unit of or a message transported by the user communications protocol. Exemplary user communications protocols include a simple mail transfer protocol (SMTP), a post office protocol (POP), an instant message (IM) protocol, a short message service (SMS) protocol, a multimedia message service (MMS) protocol, a Voice over IP (VOIP) protocol, internet mail access protocol (IMAP), and hypertext transfer protocol (HTTP). Any network protocol that specifies a data unit or transports a message addressed with a communicant identifier is or may operate as a user communications protocol. In a user communication, data may be exchanged via one or more user communications protocols. Exemplary communicant identifiers include email addresses, phone numbers, multi-media communicant identifiers such as SKYPE® IDs, instant messaging identifiers, MMS identifiers, and SMS identifiers. Those skilled in the art will see from the preceding descriptions that a URL may serve as a communicant identifier.

The term “user communications agent” refers to logic which may be included in an application that may operate in an operating environment to receive, on behalf of a contactee, a communicant message addressed to the contactee by a communicant identifier in the user communication. The user communications agent interacts with the contactee communicant in presenting or otherwise delivering the communicant message. Alternative or additionally, a user communications agent operates in an operating environment to send, on behalf of a contactor, a communicant message in a user communication addressed to a contactee by a communicant identifier in the user communication. A user communications agent may operate on behalf of a communicant in the role of a contactor or a contactee as described above is said, herein, to “represent” the communicant. A user in the role of a communicant interacts with a user communications agent to receive data addressed to the user in a user communication. Alternatively or additionally, a user in the role of a communicant interacts with a user communications agent to send data addressed to another communicant in a user communication.

The term “schema”, as used herein refers one or more rules that define or otherwise identify a type of resource. The one or more rules may be applied to determine whether a resource is a valid resource of the type defined by the schema. Schemas may be defined in various languages, grammars, or formal notations. For example, an XML schema is a type of XML document. The XML schema identifies documents of that conform to the one or more rules of the XML schema. For instance, a schema for HTML defines or otherwise identifies whether a given document is a valid HTML document. A rule may be expressed in terms of constraints on the structure (i.e. The format) and content (i.e. The vocabulary) of resources of the type defined by the schema. Exemplary languages for specifying schemas include the World Wide Web Consortium (W3C) XML Schema language, Data Type Definitions (DTDs), RELAX NG, Schematron, the Namespace Routing Language (NRL), MIME types, and the like. XML schema languages define transformations to apply to a class of resources. XML schemas may be thought of as transformations. These transformations take a resource as input and produce a validation report, which includes at least a return code reporting whether the resource (e.g. a document) is valid and an optional Post Schema Validation Infoset (PSVI), updating the original resource's infoset (e.g. The information obtained from the XML document by the parser) with additional information (default values, data types, etc.). A general purpose transformation language is thus a schema language. Thus, languages for building programming language compilers are schema languages and a programming language specifies a schema. A grammar includes a set of rules for transforming strings. As such, a grammar specifies a schema. Grammars include context-free grammars, regular grammars, recursive grammars, and the like. For context-free grammars, Backus Normal Form (BNF) is a schema language. With respect to data and a schema for validating the data, a “data element” as the terms is used herein refers at least a portion of the data that is identifiable by a parser processing the data according to the schema. A document or resource conforming to a particular schema is said to be “valid”, and the process of checking that conformance is called validation. Markup elements are data elements according to a schema for a markup language.

The term “criterion” as used herein refers to any information accessible to logic in an operating environment for determining, identifying, or selecting one option over another via the execution of the logic. A criterion may be information stored in a location in a memory or may be a detectable event. A criterion may identify a measure or may be included in determining a measure such a measure of performance.

### DESCRIPTION OF FIGURES

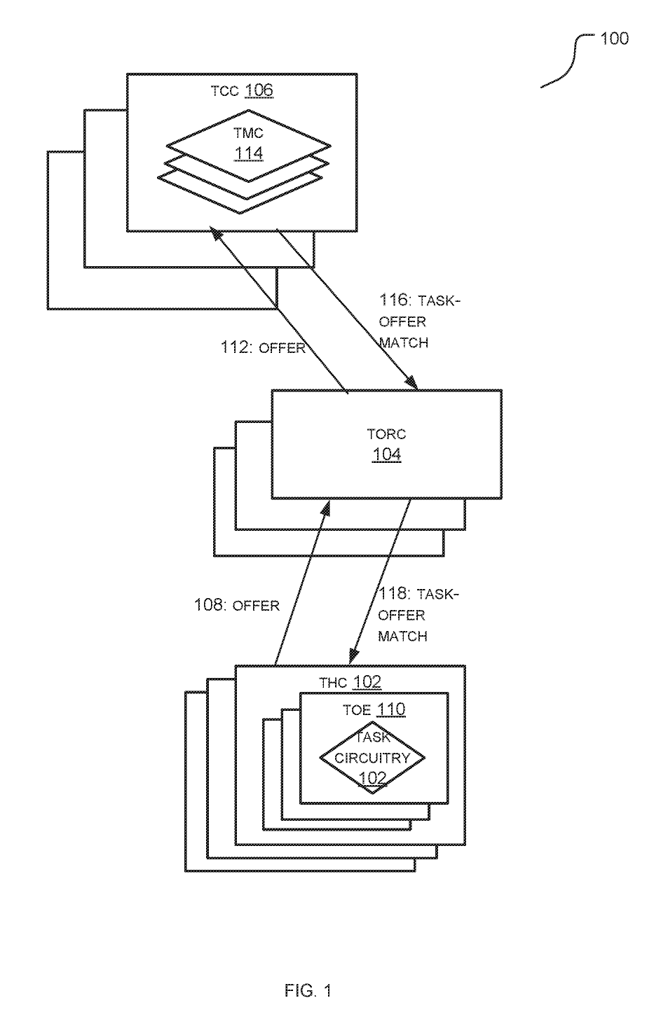

FIG. 1 illustrates an arrangement of components for efficiently sharing processing resources that may be included in an embodiment of an offer-based computing environment. Work performed by the arrangement is divided into or otherwise identified as a number of tasks. FIG. 1 illustrates that an embodiment of the arrangement may include one or more instances of task host circuitry 102, one or more instances of task-offer routing circuitry 104, and one or more instances of task coordination circuitry 106. A task host circuitry 102 may operate to an interoperate with task-offer routing circuitry 104 to identify an offer, as illustrate by exchange 108. For example, task host circuitry 102 may report to an instance of task-offer routing circuitry 104 that is able to provide access to 4 CPUs and 4 GB of processor memory via a task operating environment 110 included in, managed, maintained, or otherwise accessible to the task host circuitry 102. The task-offer routing circuitry 104 may operate based on an allocation policy, in an embodiment, to identify task coordination circuitry 106 that is to receive the offer. The task-offer routing circuitry 104 interoperates with the identified task coordination circuitry 106 to identify the offer. See exchange 112. The task coordination circuitry 106 may identify task match circuitry 114 to match the offer with a task identified by task data received or otherwise accessed by the task coordination circuitry 106. The task coordination circuitry 106 and the task match circuitry 114 schedule or otherwise determine when the task is to be performed. When the task is scheduled may be identified by a time, a duration, or relative to the occurrence of condition such a performing of another task. In response to task match circuitry 114 matching the offer with a task identified by the task data, the task coordination circuitry 106 interoperates with the task-offer routing circuitry instance 110 (see exchange 116) to assign the task (and optionally another task if the offered resources are sufficient) to the task host circuitry 102 that sent or is otherwise associated with the offer. The task-offer routing circuitry 104 interoperates (shown by exchange 118) with the task host circuitry 102 to identify the task(s). The task host circuitry 102, allocates or has pre-allocated the resources so that the resources are accessible via a task operating environment(s) and initiates operation of task circuitry (one or more instances based on the tasks and the number of tasks assigned). The task circuitry operates to perform the task utilizing the allocated resources. The task host circuitry 102 may identify offer any unused resources in another offer. Further, when the task circuitry 102 completes, the task host circuitry 106 may offer the now free resources in a new offer or may modify an outstanding offer.

Present day embodiments that include at least some functional similarities to the arrangement illustrated in FIG. 1 include MESOS (APACHE), BORG (GOOGLE), KUBERNETES (GOOGLE), OMEGA (GOOGLE), YARN, TUPPERWARE (FACEBOOK), AURORA (TWITTER), AUTOPILOT (MICROSOFT), QUINCY, COSMOS, APOLLO (MICROSOFT), FUXI (ALIBABA), and the like. For example, APACHE MESOS has an architecture that is composed of a master daemon that performs the role of task-offer routing circuitry, frameworks that operate as task coordination circuitries, “task slaves” operate as instances of task host circuitry that provide an environment in which task circuitry may operate to perform a particular task scheduled by the framework. Examples of MESOS frameworks include MARATHON, CHRONOS, and HADOOP. Examples of frameworks that have been built on top of BORG include MAPREDUCE, FLUMEJAVA, MILLWHEEL, and PREGEL. As described below and illustrated in the Figures, the arrangement of FIG. 1 or analogs may operate in many types of devices or groups of devices other than the present data centers in which the present day embodiments operate and may perform tasks present day embodiments are not able to perform.

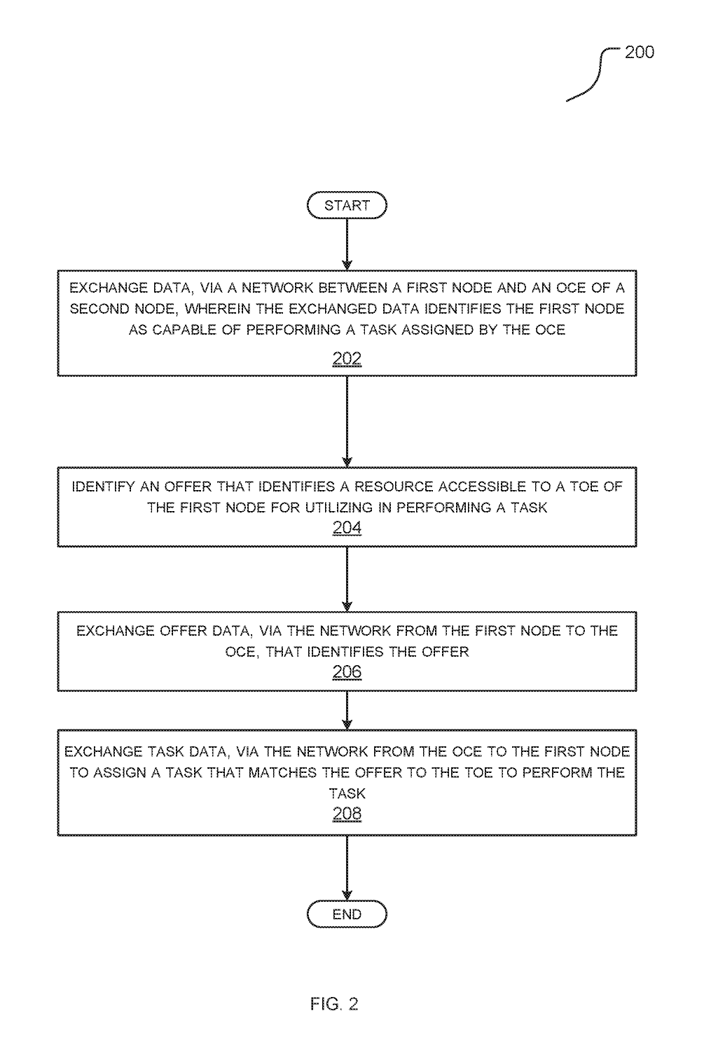

FIG. 2 shows a flow chart 200 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that is operable for performing the method. At block 202, data is exchanged between a first node and second node. The second node may be the node of an offer-based computing environment. The data is exchanged to identify the first node as capable of including or otherwise providing task host circuitry for performing tasks of offer-based computing environment. At block 204, an offer of the task host circuitry is identified. The offer may identify one or more resources accessible to a task operating environment of the task host circuitry for performing a task. The offer may be identified, preconfigured, or created dynamically by circuitry of the task host circuitry operating in or with the node. At block 206, the offer may be sent, via the node to the second node of the offer-based computing environment. The offer may be sent in the data exchanged in block 202 or may be transmitted separately. The offer may be received by circuitry of the offer-based computing environment (e.g. task-offer routing circuitry) that may operate to route the offer to task match circuitry. The task match circuitry may operate to match a task identified by task data with an offer. At block 208, task data is transmitted from the offer-based-operating environment and received by the first node via the network. The task data may be provided to circuitry of the task host circuitry that may operate to assign the task to a task operating environment that matches the offer. The task operating environment includes or otherwise accesses task circuitry that performs the task utilizing one or more resources identified by the offer.

In an embodiment, circuitry may be operable for performing the method of FIG. 2 in a system that may include a cloud computing environment provided by at least one data center that includes the second node. The system may also include the first node which is included in no data center of the cloud computing environment. In the system, the first node and the data center of the cloud computing environment may be communicatively coupled via a network.

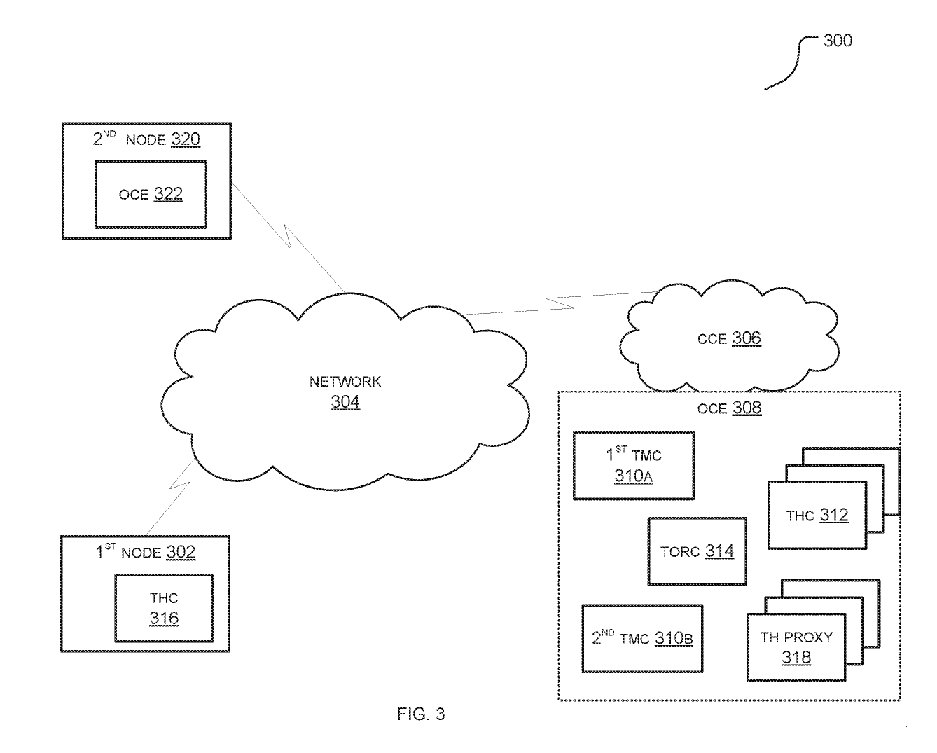

FIG. 3 shows a system 300 that may operate to perform one or more methods of the subject matter of the present disclosure. FIG. 3 shows that system 300 includes a first node 302 having a network interface for exchanging data via a network 304 with one or more other nodes that are included in or that otherwise host an offer-based computing environment. FIG. 3 illustrates an embodiment in which a cloud computing environment 306 is or includes an offer-based computing environment 308. Cloud computing environment 306, as illustrated may include one or more data centers that host one or more offer-based computing environments. Data centers of a cloud computing environment may be located in different geospatial locations and may exchange data via network 304 or via a separate network, such as a private network for performance, security, or reliability requirements or goals of the cloud computing environment 306 provider or clients of the cloud computing environment. Each data center, as described above, may include or otherwise some or all of an offer-based computing environment, as illustrated by offer-based computing environment 308. Offer-based computing environment 308 may include task match circuitry 310 that matches respective tasks to be performed with offers received or accessed from task host circuitry 312. An instance of task match circuitry 310 may exchange data with task host circuitry 312 directly or via a proxy, such as task-offer routing circuitry 314 as illustrated in system 300. FIG. 3 illustrates task host circuitry 316 operating outside the data center(s) of cloud computing environment 306 in an operating environment (not shown) of the first node 302. The operating environment of the first node 302 may include circuitry, such as in a network stack or in a network adapter, to exchange data via network 304 with one more nodes in a data center(s) of cloud computing environment 306 to identify task host circuitry 316 to offer-based computing environment 308 to perform one or more tasks. In an embodiment, the offer-based computing environment 308 of cloud computing environment 306 may include circuitry that represents task host circuitry 316 or other task host circuitry external (or within) data center(s) of cloud computing environment 306, such as shown by a task host proxy 318. A task host proxy may include circuitry to provide an offer that may identify one more resources accessible via external task host circuitry, such as task host circuitry 316, for performing a task in a task operating environment (not shown) of the external task host circuitry. In an aspect, task host proxy 318 may receive an offer from task host circuitry 316 via network 304 and operate to relay the offer to an instance of suitable task-offer routing circuitry 314. The task-offer routing circuitry 314 may be associated with or selected by the task host proxy 318. In an aspect, task host proxy 318 may access resource information from the first node 302 or from another node that monitors and represents the first node 302 to the task host proxy 318. The task host proxy 318 may transform the resource information into an offer suitably formatted for processing by task-offer routing circuitry 314.

A task host proxy and task-offer routing circuitry may exchange offer data or task data via a suitable data exchange medium or protocol (e.g. remote procedure calls, pipes, sockets, shared memory, a software defined network, a virtual network, a bus, a switch fabric, and so on). A node such as first node 302 or second node 320, may include an electrical appliance or device (e.g. a stove, a car, a phone, etc.), an energy source (e.g. a battery, a heat generator, an electricity generator, . . . ), a smartphone, a desktop PC, and the like. FIG. 3 illustrates an offer-based computing environment 322 operating in or otherwise hosted by the second node 320. The offer-based computing environment 322 may include a more than one instance of task host circuitry, task match circuitry, task coordination circuitry, task-offer routing circuitry, or task operating environments. In an embodiment, an operating environment, such as an operating environment of the second node 320, may be an offer-based computing environment. That is, services provided by an operating environment, such as operating system services, may be realized in task circuitry that operate in task host circuitry assigned to perform tasks included in providing the service based on offers provided by or otherwise associated with the task host circuitry.

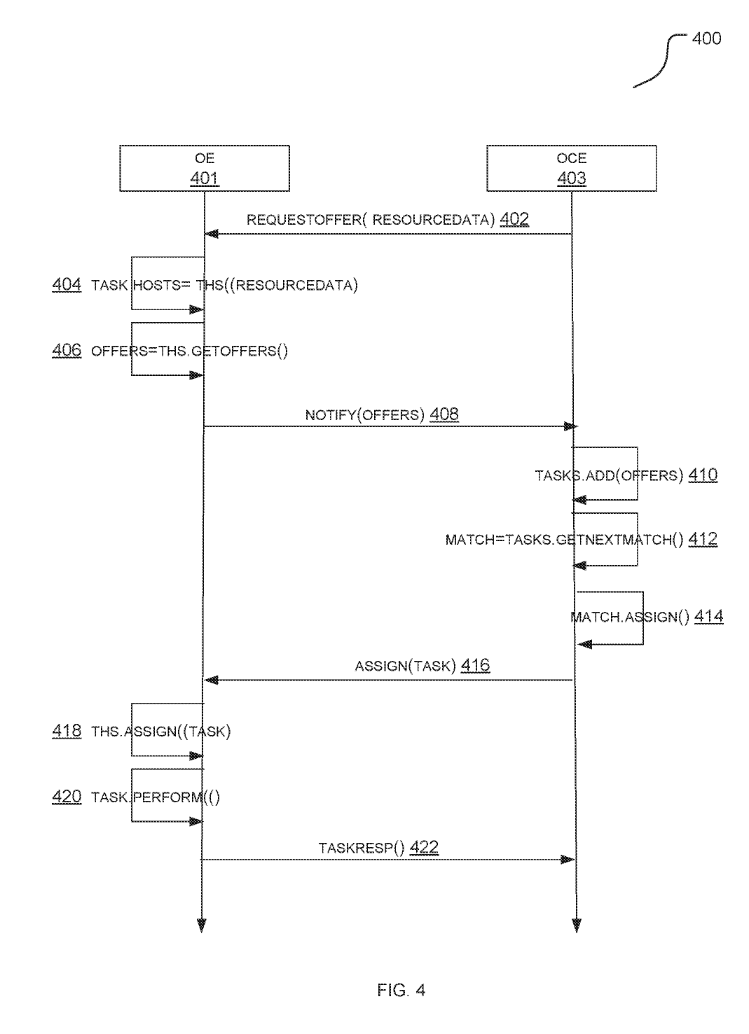

FIG. 4 illustrates a data flow diagram 400 of data exchanged between or among addressable entities or other parts of a first operating environment 401 and an offer-based computing environment 403, which may or may not be included in a cloud computing environment. The offer-based computing environment 403 may assign one or more tasks to one or more operating environments, such as the first operating environment 401, to perform. In an embodiment, illustrated by data flow diagram 400, offer-based computing environment 403 may transmit a message, such a request for an offer. See flow 402. The request may or may not specify one or resources or attributes of resources that are accessed in performing a task. A particular resource may be identified, a resource may be identified by any suitable attribute of the resource, such as its size, speed, time of availability, and so on. A flow 404, illustrates data that may be exchanged in operating environment 401 to identify one or more instances of task host circuitry operating in or otherwise accessible to operating environment 401. The data exchange may include resource data received from operating environment 401 to select, match, or otherwise identify one or more instances of task host circuitry from a number of instances of task host circuitry. Alternatively or additionally, task host circuitry may be identified with matching, filtering, or selecting based on resource data from the offer-based computing environment 403. Offer(s) associated with the one or more instances of task host circuitry may be identified. See flow 406, which illustrates an exchange with circuitry representing one more instances of task host circuitry and that may operate to identify one or more offers. For example, task host circuitry may be specified in an object oriented language. A class method may maintain a list or records of instances of task host circuitry that exist or that can be created. An offer may be identified based on metadata associated with each instance of task host circuitry or based on data included in each task host circuitry object instance. The object oriented language may be translated to byte code or assembler. Virtual circuitry may be realized when a processor accesses and executes an executable translation of the source code, such as machine code translated from the byte code or the assembler code. Offer data identifying one or more of the offers may be transmitted to offer-based computing environment 403. See flow 408. Referring to FIG. 3, task host proxy 318 may receive an offer from the operating environment 401 (which may be an operating environment of the first node 302. The data may be transmitted as a response to a request from offer-based computing environment 403 via flow 402. In an embodiment, flow 402 may include subscription data and flow 408 may represent a notification sent to offer-based computing environment 403 as a subscriber. Notification messages identifying offers, modifying offers, or cancelling offers may be sent by operating environment 401 to synchronize its state as a task host circuitry provider with offer-based computing environment 403. A flow 410 represents an exchange of offer data identifying the one or more offers to one or more instances of task match circuitry, which may operate in task coordination circuitry, such as a MESOS framework adapted according to the present disclosure. In flow 412, data is exchanged to identify a match between a task and an offer. In an embodiment, one offer may be matched with each task. In another aspect, a task may be matched with more than one offer. Referring to flow 414, assigning a task to task host circuitry may include selecting an offer from multiple offers based on a criterion other than a matching a resource identified in the offer. The criterion may be based on another resource, such a geospatial location of the operating environment 401 or an owner of the operating environment not identified in the offer, but known to the task coordination circuitry or the task match circuitry via another node or via a user. The selected task host circuitry may be sent task data identifying the task to perform. Input data or metadata utilized in performing, monitoring, or otherwise managing the performing of the task may be sent with the task data or may be provided separately. See flow 416. Referring to flow 418, data is exchanged in operating environment 401 to assign the task to a task operating environment in the identified task host circuitry. The task operating environment provides access to the resources identified by the offer. Flow 420 illustrates data exchanged in or by the task operating environment or otherwise in or by operating environment 401 in performing the task. Flow 422 illustrates data exchanged between operating environment 401 and offer-based computing environment 403 in response to completing the task or in response to failing to complete the task. In some embodiments, such an exchange may not occur, may be sent best effort, or otherwise may be optional. In an embodiment, each instance of task host circuitry with a matching offer may be notified of the match. The first task host circuitry to claim or accept assignment of the offer may perform the task while other instances of task host circuitry do not perform the particular task (and may not be aware of the task). In an embodiment, multiple instances of task host circuitry may perform the task. An outcome of the performed task may be determined based on a first task host circuitry to complete the task, a last task host circuitry to complete the task, a voting process, a merging of the results, a determination of a result via a statistical process, and so on.

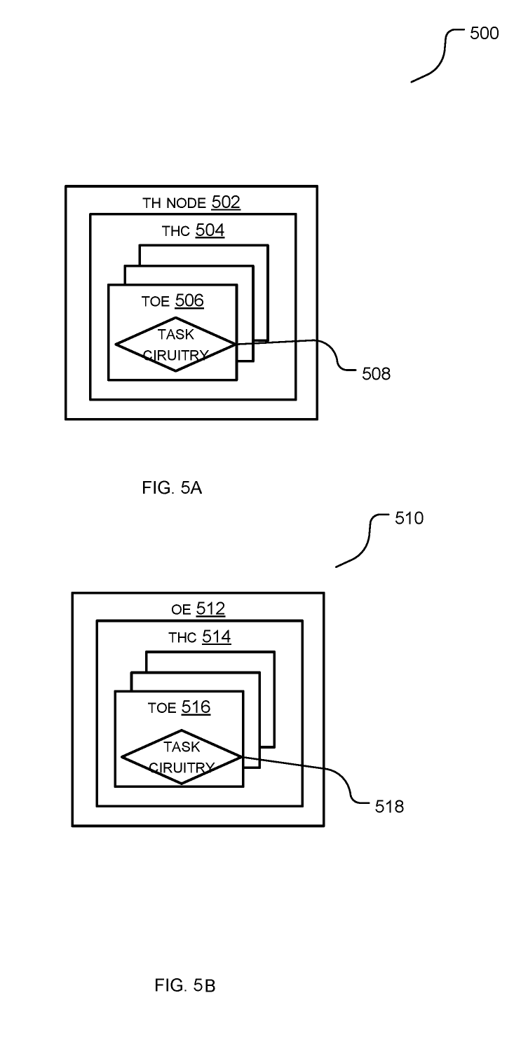

FIG. 5A illustrates an arrangement 500 that may operate to perform one or more methods of the present disclosure according to a particular embodiment. The arrangement 500 includes a node shown as task host node 502 that hosts circuitry of task host 504. Task host node 502, in an embodiment may not be included in an offer-based computing environment operating in another node, service site, data center, or cloud computing environment The task host circuitry 504 may be a host operating environment of the node 502 as shown arrangement 500. The host operating environment of the node may be or may include some or all of an offer-based computing environment. The task host circuitry 504 may monitor, manage, allocate, or otherwise allow a task operating environment 506 to access to one or more resources of the task host node 502. Circuitry of the task host 504 may instantiate, monitor, manage, or allow access to one or more task operating environments 506 each, of which, provides an operating environment in which task circuitry 508 included in performing an assigned task may be performed. The task may be assigned by an offer-based computing environment or a portion thereof operating in another node, service site, data center, of cloud computing environment. Task circuitry 508, in operation, accesses one or more resources via or of a task operating environment 506 in which the task circuitry 508 operates. The one or more resources may be allocated to or otherwise accessible to the task operating environment 506 via operation of circuitry of the task host 504.

FIG. 5B illustrates an arrangement 510 that differs from arrangement 500 at least in that circuitry of task host 514 operates in an operating environment 512, whereas in arrangement 500 the circuitry of the task 504 operates as a host operating environment 504 of a node 502. In arrangement 510, the circuitry of the task host 514 may operate as an offering based operating environment or a portion thereof, an application, a subsystem, or as a virtual operating environment in the operating environment 512. The operating environment 512 may include or may otherwise be hosted by a node (not shown). The node may not be included in an offer-based computing environment of another node, a service site, a data center, or of a cloud computing environment, in an embodiment. In another embodiment the node may be included in a data center, service site, or cloud computing environment and may be in an offer-based computing environment. As in arrangement 500, circuitry of the task host 514 may monitor, manage, allocate, or otherwise allow a task operating environment 516 access to one or more resources of the operating environment 512. Circuitry of the task host 514 may instantiate, monitor, manage, or allow access to one or more task operating environments 516 each of which provides an operating environment in which task circuitry 518 operates in performing an assigned task. The task may be assigned by an offer-based computing environment or a portion thereof operating in another node, service site, data center, of cloud computing environment. The task circuitry 518 in operation accesses one or more resources via the task operating environment 516 that are allocated to or otherwise accessible to the task operating environment 516 via operation of the circuitry of the task host 514. Operating environment 512 may include some or all of an offer-based computing environment that may assign one or more tasks to task host circuitry 514 that match an offer from task host circuitry 514.

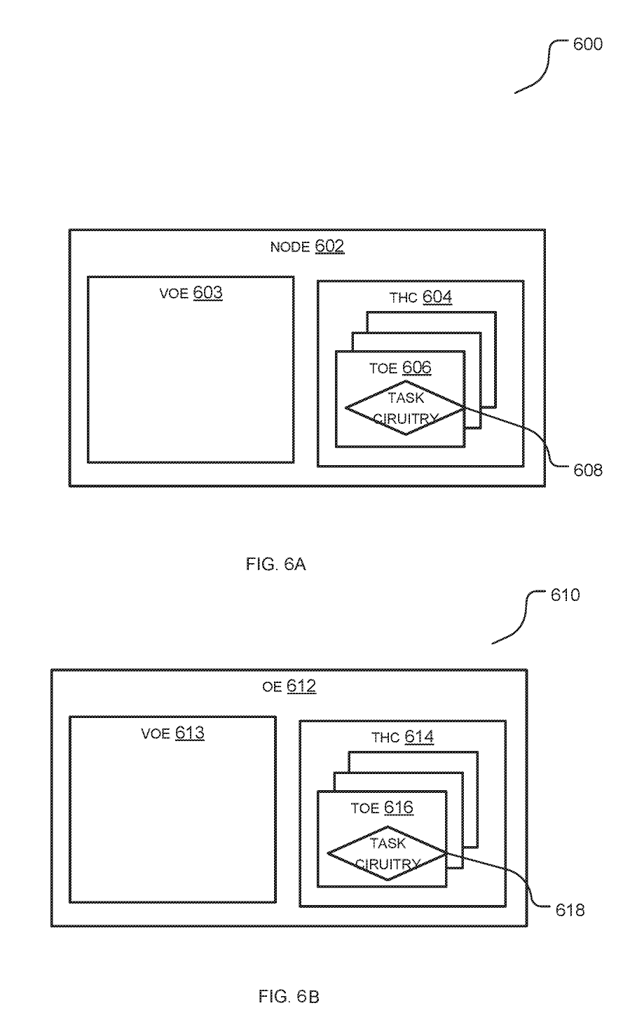

FIG. 6A illustrates an arrangement 600 similar to arrangement 500 in FIG. 5A. In arrangement 600, node 602 hosts another operating environment, shown as VOE 603, in addition to the operating environment provided by the circuitry of the task host 604. The other operating environment 603 may be a client operating environment or may be server operating environment. Node 602 may host both operating environments, virtual operating environment 603 and task host 604, simultaneously in an embodiment. Alternatively or additionally, node 602 may host one of the operating environments at one time and host the other at another time. While one operating environment is operating, the other may be off or in an inactive mode such as a sleep mode, a hibernate mode, or otherwise may be constrained in its operation. When operated at a same time, resources of the node may be allocated to each operating environment. One of the operating environments may control resource allocation, the two operating environments may negotiate for resource access according to configured negotiation polices, or resource allocation may be managed by circuitry not included in either operating environment (e.g. such circuitry may operate in another operating environment or on hardware of the node 602 reserved for such purposes). As described with respect to arrangement 500, task host circuitry 604 may monitor, manage, allocate, or otherwise allow access to resource(s) by one or more task operating environments 606 each of which may host task circuitry 608. Virtual operating environment 603 may include some or all of an offer-based computing environment that may assign one or more tasks to task host circuitry 604 that match an offer from task host circuitry 604.

FIG. 6B illustrates an arrangement 610 similar to arrangement 510 in FIG. 5B. A host operating environment 612, as shown, may host another operating environment, shown by virtual operating environment 613, in addition to the operating environment provided by the task host circuitry 614. The other virtual operating environment 613 may be a client operating environment or may be a server operating environment. Operating environment 612 may host both operating environments simultaneously in an embodiment. Alternatively or additionally, operating environment 612 may host one of the operating environment at one time and host the other at another time. While one operating environment is operating, the other may be off or in an inactive mode such as sleep mode, a hibernate mode, and the like. When operated at a same time, resources of the node may be allocated to each operating environment. As described with respect to arrangement 510, task host circuitry 614 may monitor, manage, allocate, or otherwise allow access to resource(s) by one or more task operating environments 616 each of which may host task circuitry 618. One or both of virtual operating environment 613 and operating environment 612 may include some or all of an offer-based computing environment that may assign one or more tasks to task host circuitry 614 that match an offer from task host circuitry 614.

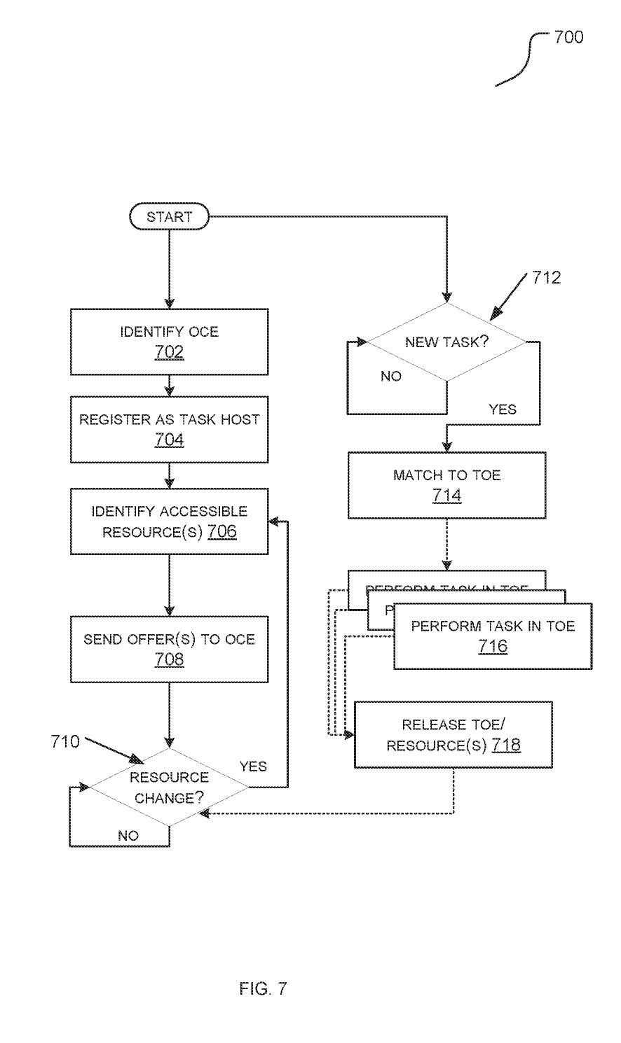

FIG. 7 shows a flow chart 700 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that is operable for use in a first node or first operating environment of the first node. The first node may not be included in an offer-based computing environment of a second node, data center, service site, or cloud computing environment. Further, in an embodiment, the first node is not a node owned or controlled by the provider of second node, service site, data center, or cloud computing environment. The first node or a system that includes the first node may include a processor that realizes some or all of the circuitry as virtual circuitry or hardware. At block 702, the offer-based computing environment is identified. Alternatively or additionally, the first node or first operating environment may be identified. In an embodiment, circuitry in the first node or first operating environment may access information that may identify the offer-based computing environment from a persistent data store, such as a file system or a database. The first node or first operating environment may be owned by a client or customer of the offer-based computing environment or an owner or user of the first node may have an account with the offer-based computing environment provider. Block 704 illustrates an embodiment where circuitry of a first node or first operating environment of the first node may operate to register task host circuitry of the first operating environment with the offer-based computing environment. At block 706, one or more resources that are or that may be configured to be accessible for performing a task may be identified. At block 708, one or more offers are identified to the offer-based computing environment. At block 710, when a change in a resource is detected, accessible resources are at least partially re-determined or re-identified as shown in flow chart 700 by a return of control from decision block 710 to block 706. Task activity may add resources, delete resources, or may modify an attribute of a resource. Each such event may trigger circuitry associated with decision block 710 to invoke circuitry that may operate to identify one or more resources or attributes that affect their accessibility. At block 712, task data may be received that matches an offer sent to the offer-based environment via operation of block 708. When a new task is detected as decision block 712, circuitry that realizes block 714 may be invoked to assign a performing of the task to a task operating environment (e.g. via assigning the task to task host circuitry). In an embodiment, the matching offer may be utilized to select an existing task operating environment that provides access to the resource(s) offered. In another embodiment, a task operating environment may be created, based on the matched offer, by task host circuitry. At block 716, task circuitry for the task is executed in the assigned, selected, or matched task operating environment. At block 718, resources utilized in performing the ask may be released to create a new offer or to make the matched offer available again. The task operating environment, in an embodiment, may be reused. In another aspect, the task operating environment may be destroyed so that a new task operating environment offering a different set of resources may be pre-configured for another task or created dynamically as required by a matched offer. Dotted lines in FIG. 7 illustrate flows that may occur between threads, processes, containers, or other types of virtual operating environments. Any suitable mechanism may be utilizing such a shared memory, semaphores, pipes, queues, interrupts, signals, sockets, and the like.

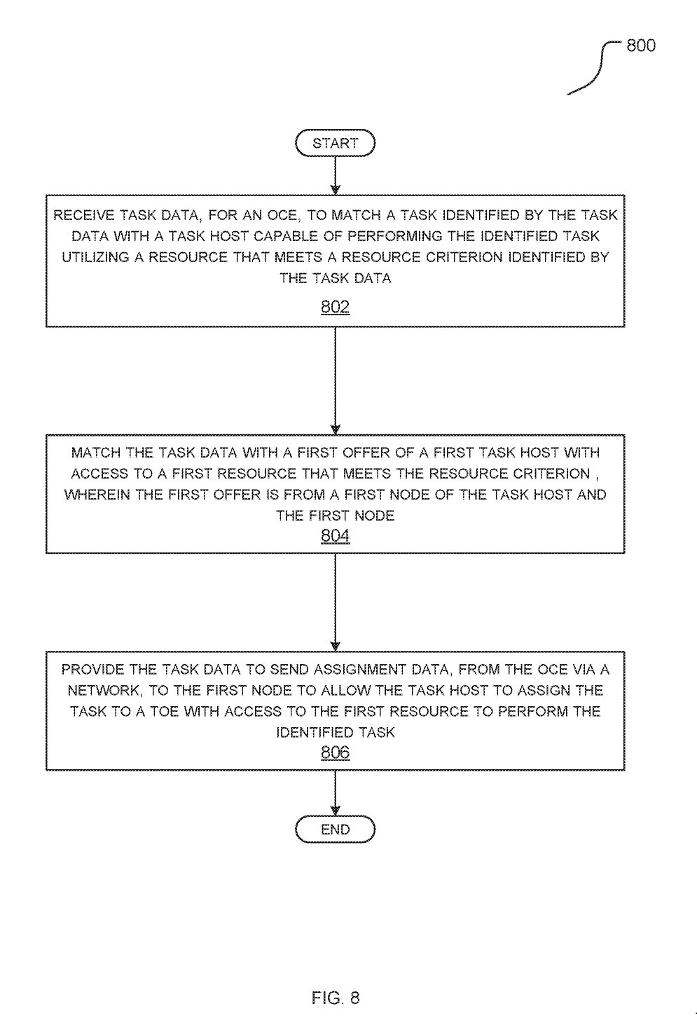

FIG. 8 shows a flow chart 800 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that is operable for use with a system. The system may include an offer-based computing environment provided by a second node, a service site, a data center, or a cloud computing environment. The system may also include a first node not included in the service site, data center, or cloud computing environment. The first node and the offer-based computing environment may be communicatively coupled via a network. At block 802, task data is identified by task match circuitry that operates for the offer-based computing environment to match a task with task host circuitry. The task is identified by the task data. The task data may also identify one or more resource criteria to identify one or more respective resources utilized to perform the task. Task host circuitry may be matched with a task based on an offer that may identify one or more resources accessible via a task operating environment of the task host circuitry and that meets the one or more criteria for performing the task. The offer may be identified by or otherwise associated with the task host circuitry. At block 804, the task data is matched by operation of the task match circuitry with a first offer from first task host circuitry with access to the identified resource. The resource identified by the task data is matched with a resource identified by the offer. The first offer may be received by the task match circuitry from the first node of the task host circuitry. At block 806, the task data may be provided to circuitry that may operate to send assignment data, from the offer-based computing environment via a network, to the first node. The first node may include, host, or otherwise have access to the task host circuitry. The task host circuitry may include circuitry that processes the assignment data and, as result, assigns the task to a task operating environment that provides or allows access to the resource to perform the identified task. The task host circuitry may operate to create or otherwise allocate the task operating environment. The task host circuitry may interoperate with the task operating environment to initiate, monitor, manage, or complete the performing of the identified task.

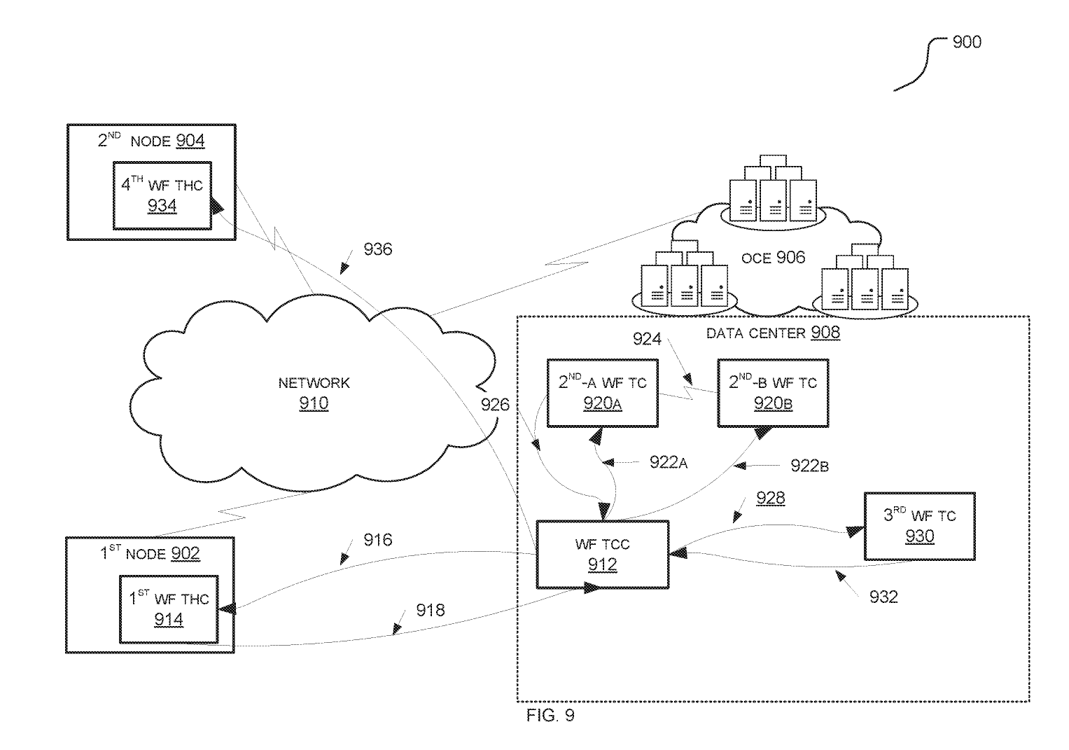

FIG. 9 shows a system 900 that may operate to perform one or more methods of the subject matter of the present disclosure. FIG. 9 shows that system 900 includes a first node 902, a second node 904, an offer-based computing environment 906, shown as a cloud computing environment that includes or is host by one or more data centers 908. Each of first node 902, second node 904, and offer-based computing environment 906 may be coupled to a network 910. Offer-based computing environment 906 may include task match circuitry (not shown) in or otherwise accessible to task coordination circuitry 912 (e.g. a MESOS framework adapted according to the present disclosure). The task coordination circuitry 912 may include one or more instances of task match circuitry based on the tasks, the resources utilized in performing the respective tasks, or based on one or more instances of task host circuitry. In an embodiment, first task data may be received by task coordination circuitry 912 to initiate a workflow. The first task data may be included in workflow data that may identify more than one task and may identify all tasks in the workflow for scheduling or otherwise coordinating by the task coordination circuitry 912. In another embodiment, workflow data that may identify any other tasks in the workflow may be received or not received along with the task data. Task coordination circuitry 912 may provide the first task data to task match circuitry (not shown) that matches the first task with an offer from or associated with task host circuitry. The offer may be received directly from the task host circuitry or indirectly, such as via an instance of task-offer routing circuitry (not shown). The first task may be assigned, based on the matched offer, to execute first task circuitry (not shown) in a task operating environment (not shown) of first task host circuitry 914. FIG. 9 illustrates that the first task may utilize a resource provided by a client node, such as first node 902. For example, the first task may utilize an input device to receive or identify data in response to user input detected via the input device. FIG. 9 illustrates an exchange 916 that provides data from the task coordination circuitry 912, directly or indirectly, to the first task host circuitry 914 to perform the first task. An exchange 918 illustrates, in one embodiment, data transmitted to the task coordination circuitry 912 to be processed in a task of the workflow. In an embodiment, the data of exchange 918 may include second task data for performing a second task in the work flow. In an embodiment, data of the exchange 918 may include or otherwise identify second task data that may identify a second task in the work flow to be matched with an offer from task host circuitry of the task coordination circuitry 912. Alternatively of additionally, the second task may be previously identified in workflow data received or otherwise identified by the task coordination circuitry 912 as described above.

FIG. 9 illustrate that a workflow may include tasks that are performed in parallel and tasks that may be performed in a sequence. Task data may identify multiple sub-tasks that may be performed in parallel. Each may be matched with an offer from task host circuitry (not shown). Task coordination circuitry 912 may provide the sub-task data for each sub-task to task match circuitry (which may the same or different task match circuitry according to the embodiment). Each sub-task may be matched with a respective offer from the same task host (not shown) or different instances of task host circuitry. The offers may be received directly from task host circuitry or indirectly, such as via an instance of task-offer routing circuitry (not shown), which may the same or different instance of task-offer routing circuitry for each sub-task according to the embodiment. The second sub-task-A may be assigned (see exchange 922a), based on a matched offer, to execute second sub-task-A circuitry 920a in a task operating environment (not shown) of task host circuitry (not shown). The second sub-task-A may utilize a resource accessible via the task operating environment hosting the second sub-task-A circuitry, and may operate in a node of the data center 908 as illustrated. In another embodiment, the second sub-task-A may be performed in a client node or other node not included in a data center 908 of the offer-based computing environment 906. A second sub-task-B may be assigned (see exchange 922b), based on a matched offer, to execute second sub-task-B circuitry 920b in a task operating environment (not shown) of task host circuitry (not shown). The second sub-task-B circuitry 920b may utilize a resource accessible via the task operating environment, and may operate in a node of the data center 908 as illustrated. In another embodiment, the second sub-task-B may be performed in a client node or other node not included in a data center 908 of the offer-based computing environment 906. Depending on the task performed by the sub-task or on a particular embodiment of the workflow, the sub-tasks may operate without communicating or may interoperate, as illustrated by a link 924. Two tasks may interoperate via any suitable means including, for example, a physical or virtual network link, a signal, a semaphore, a shared memory, a pipe, a stream, and the like. One or both tasks may provide data that may identify or may be utilized in performing another task in the work flow. FIG. 9 illustrates an exchange 926 in which, in one embodiment, data may be transmitted or otherwise made accessible to the task coordination circuitry 912 as a result of executing task circuitry 920a. The data may be transmitted to the task coordination circuitry 912 to be processed in a task of the workflow, such as a third task described in the following paragraph.

Task coordination circuitry 912 may access third task data that may identify a third task to be initiated after the second task. The third task may be preconfigured or may be identified based on a performing of a previous task (e.g. one or both of the first task and the second task). The third task data may be matched with an offer from task host circuitry (not shown). Task coordination circuitry 912 may provide the third task data to task match circuitry to match with an offer from task host circuitry (not shown) which may be a same or different task host circuitry included in performing one or more previous tasks of the workflow. Offers may be received directly from instances of task host circuitry or indirectly, such as via an instance of task-offer routing circuitry (not shown), which may the same or different instance of task-offer routing circuitry included in processing one or more previous tasks of the workflow. The third task may be assigned (see exchange 928), based on a matched offer, to execute third task circuitry 930 in a task operating environment (not shown) of task host circuitry (not shown). The third task circuitry may utilize or otherwise access a resource via the task operating environment, and may operate in a node of the data center 908 as illustrated. In another embodiment, the third task may be performed in a client node or other node not included in a data center of the offer-based computing environment 906. As with other tasks, the performing of the third task may provide data that may identify or may be utilized in performing another task in the work flow. FIG. 9 illustrates an exchange 932 that illustrates data transmitted or otherwise made accessible to the task coordination circuitry 912 to be processed in a task of the workflow.

Task coordination circuitry 912 may access fourth task data that may identify a fourth task to be initiated or completed after the third task. The fourth task may be preconfigured or may be identified based on a performing of a previous task (e.g. one or both of the first task, the second task, and the third task). The fourth task data, in an embodiment, may identify a particular user, a user having a particular role, an output device, a device with access to a particular location or type of location, or other resource not accessible ever or at a particular time via task host circuitry operating in a data center 908 of the offer-based computing environment 906. The task data may be matched with an offer from task host circuitry that has access to the resource identified by the task data. FIG. 9, illustrates fourth task host circuitry 936 operating based on the second node 904, operating in an operating environment of the second node, or otherwise accessible via the second node 904. Task match circuitry in the task coordination circuitry 912 may receive an offer from the fourth task host circuitry 934, directly or indirectly, as described elsewhere herein. The task match circuitry may match the third task data to task match circuitry to match with the offer from the fourth task host circuitry 934. The fourth task may be assigned (see exchange 936), based on a matched offer, to execute task circuitry in a task operating environment of the fourth task host circuitry 934. The fourth task may utilize a resource accessed via the task operating environment. For example, the fourth task may present an output of the workflow to a user of the fourth node 904 via an output device in or operatively coupled to the task circuitry operating in the task operating environment of the fourth task host circuitry 934. As with other tasks, the performing of the fourth task may provide data that may identify or may be utilized in performing another task in the work flow. FIG. 9 illustrates a workflow that ends with the performing of the fourth task. In an embodiment, status data, result data, or no data may be returned to the offer-based computing environment 906.

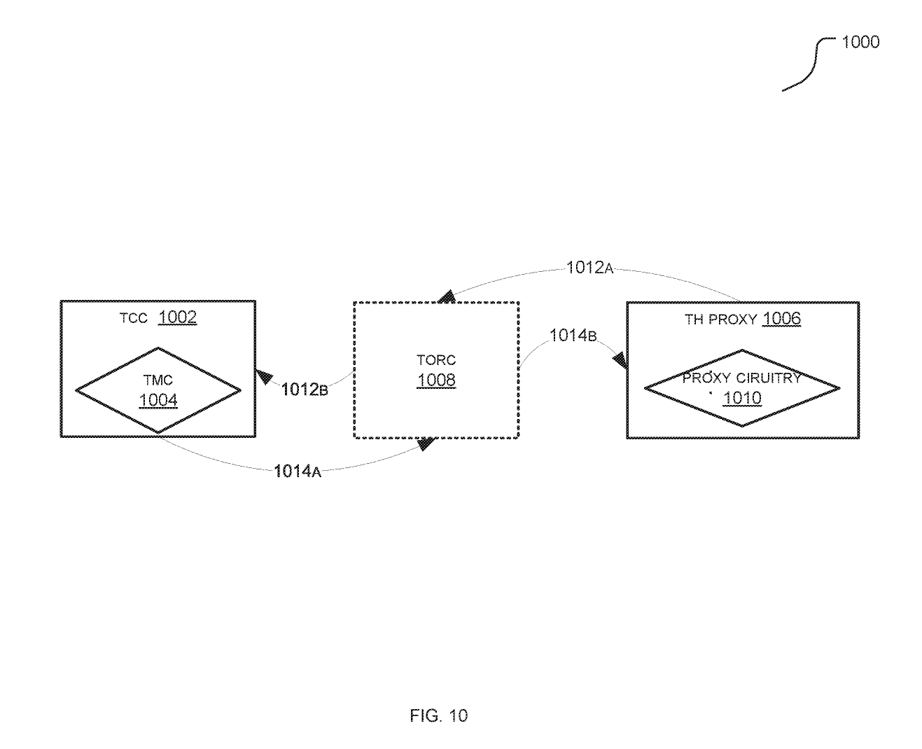

FIG. 10 illustrates an arrangement 1000 that when included in one or more suitable operating environments, may operate to perform a method of the subject matter of the present disclosure. The arrangement 1000 includes task coordination circuitry 1002, such as a MESOS framework adapted according to the teachings of the present disclosure, that includes task match circuitry 1004 to match or otherwise select an offer from one or more instances of task host circuitry with task data that may identify a task to be performed. In an embodiment, one or more offers may be received from task hosts (not shown) operating in a same server as the task coordination circuitry 1002, a same data center, or a same cloud computing environment. In an embodiment, one or more offers may be received from task hosts operating in one more nodes (e.g. PCs, notebook computers, appliances, automotive vehicles, roadways, railways, wearable devices, heating or cooling systems, delivery systems, and the like) that are not included in the server, data center, or offer-based computing environment of the task coordination circuitry. Such offers may be received by task host proxy 1006 which may operate in the server, data center, cloud computing of the task coordination circuitry 1002 or of task-offer routing circuitry 1008, if present. A task host proxy 1006 may include proxy circuitry 1010 that may be communicatively coupled via a network with such remote task host circuitry (not shown). A task host proxy 1006, in an embodiment may include proxy circuitry 1010 for particular task host circuitry (one or more instances), a particular type of task host circuitry, instances of task host circuitry in a specified location, or may be associated with one or more instances of task host circuitry based on some other suitable attribute of task host circuitry, a node of the task host circuitry, or of an operating environment that the task host circuitry operates in or may be otherwise accessible to, a user of the node of the task host circuitry, and the like. Task coordination circuitry 1002 may communicate with one or more instances of task host circuitry or task host circuitry proxies 1006 directly, or may communicate indirectly as shown in FIG. 10 via task-offer routing circuitry 1008 or an analog. In FIG. 10, task host proxy 1006 may send an offer via task-offer routing circuitry 1008 as illustrated by data exchange 1012a and data exchange 1012b. A task host proxy 1006 may receive an assignment to perform a task, based on a match with an offer from the task host proxy 1006. Task match circuitry 1004 may send data assigning a task to task host circuitry represented by proxy circuitry 1010 of the task host proxy 1006 via circuitry of task-offer routing circuitry 1008 as illustrated by data exchange 1014a and data exchange 1014b.

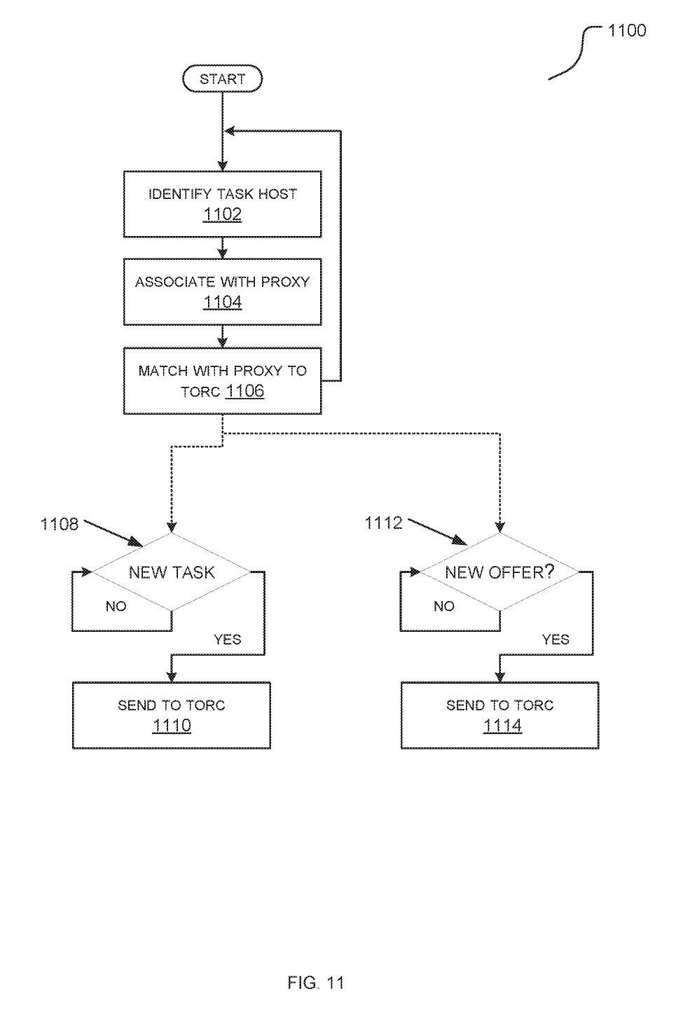

FIG. 11 shows a flow chart 1100 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use in a first node or a first operating environment of the first node. The first node may not be included in an offer-based computing environment of portion thereof that includes or is hosted by a second node, a data center, service site, or a cloud computing environment. Further, in an embodiment, the first node may be not a node owned or controlled by a provider of the second node, service site, data center, cloud computing environment, or the offer-based computing environment. The first node or a system that includes the first node may include a processor that realizes some or all of the circuitry as virtual circuitry or some or all of the circuitry may be included in the node as physical circuitry. At block 1102, task host circuitry of the first node or the operating environment may be identified. Alternatively or additionally, the first node or the first operating environment may be identified as capable of performing tasks assigned by the offer-based computing environment or the portion thereof based on one or more resources accessible via the first node or the first operating environment. At block 1104, the first node or the first operating environment may be associated with a proxy or an agent including circuitry for exchanging data about tasks or about offers from and to the offer-based computing environment via a network with the first node or the first operating environment identified via performing the operation of block 1102. At block 1106, the proxy may be associated with task-offer routing circuitry to communicate with task match circuitry. In an embodiment, task-offer routing circuitry may be selected or matched with the proxy based on an attribute of the first node of the first operating environment, an attribute of the task host circuitry, of a task operating environment of task host circuitry, or of a resource accessible for performing a task. In an embodiment, a match, selection, or association between a proxy and task-offer routing circuitry may be preconfigured. Operation of block 1108 or block 1110 may occur in a separate or a same sequence of instructions as may any of the previously described blocks. Block 1108 illustrates a decision block at which a match may be detected (or not) between a task to be performed and an offer sent from the first node or first operating environment identified in block 1102. When a match is detected, the proxy may be invoked to send task data identifying the matched task to the first node or the first operating environment to perform the task in a task operating environment of task host circuitry of the first node or the first operating environment. See block 1110. As with blocks 1108 and 1110, the operations of blocks 1112 and 1114 may occur in a separate or a same sequence of instructions. At block 1112, an offer received from the first node or from the first operating environment identified via operation of block 1102 may be detected or identified (or not). When an offer is received or otherwise detected, the offer may be provided to or otherwise identified to task match circuitry to match with a task to be performed. In an embodiment, illustrated in flow chart 1100, at block 1114, the offer may be delivered to task match circuitry by the operation of circuitry of an instance of task-offer routing circuitry associated with the proxy.

In an embodiment, an offer may identify a user. The offer may an identify one or more attributes of the user such as an identity of the user (alias, login, SSN, etc.), a role of the user, a group that a user may be a member of, a legal entity associated with the group, a constraint associated with the user, a permission or authorization, an age, a skill or capability, a location, a citizenship, a gender, a personal preference, a transaction associated with the user, a work flow associated with the user, and the like. For example, task data may identify a task requiring interaction with a user of an automotive vehicle, interaction with a user of a personal communications device (e.g. smartphone), interaction with a user of equipment that operates in manufacturing a good, interaction with a user of a type of appliance or brand of an appliance, or a user who may be a police officer, an EMT, a teacher, or a mechanic—to name a few examples.

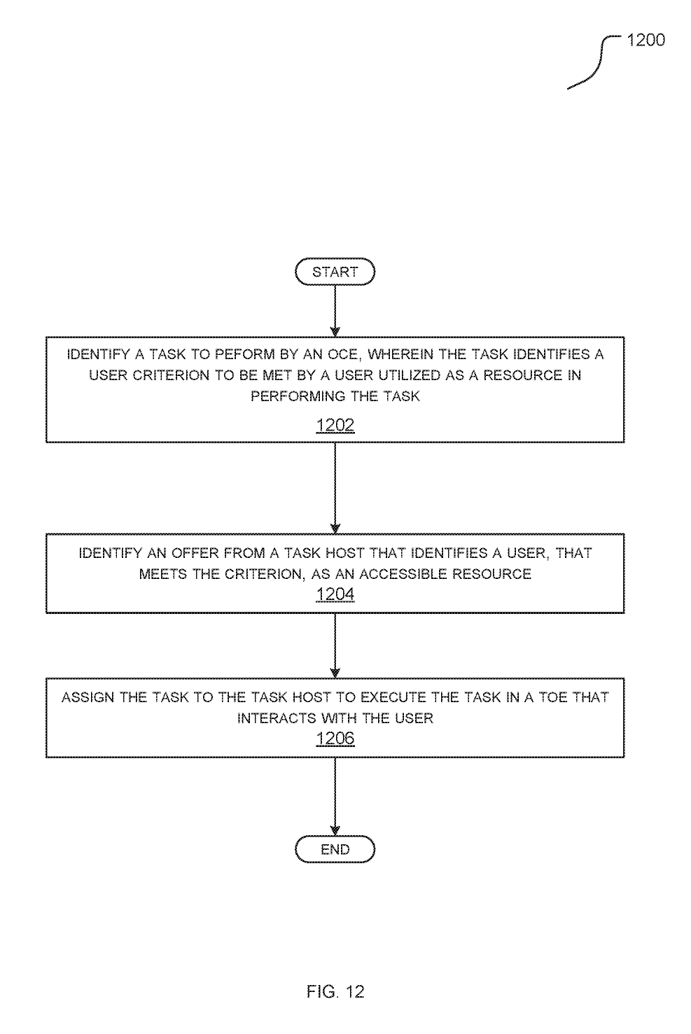

FIG. 12 shows a flow chart 1200 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment provided by a second node, a server site, a data center, or a cloud computing environment. The system may also include a first node not included in the service site, data center, or cloud computing environment of the offer-based computing environment. The first node and the offer-based computing environment may be communicatively coupled via a network. At block 1202, a task to perform via the offer-based computing environment may be identified. The task or metadata associated with the task may identify a criterion to be met by a user accessed as a resource in performing the task. At block 1204, an offer may be received or otherwise identified that indicates that a user may be an accessible resource of task host circuitry associated with the offer. The user identified by the offer meets the criterion according to data about the user identified in or based on the offer. At block 1206, the task may be assigned to the task host circuitry to performed the task by executing task circuitry in a task operating environment of the task host circuitry. The task circuitry in operation interacts with or otherwise accesses the user. The task host circuitry may operate in the first node or the first operating environment, in an embodiment.

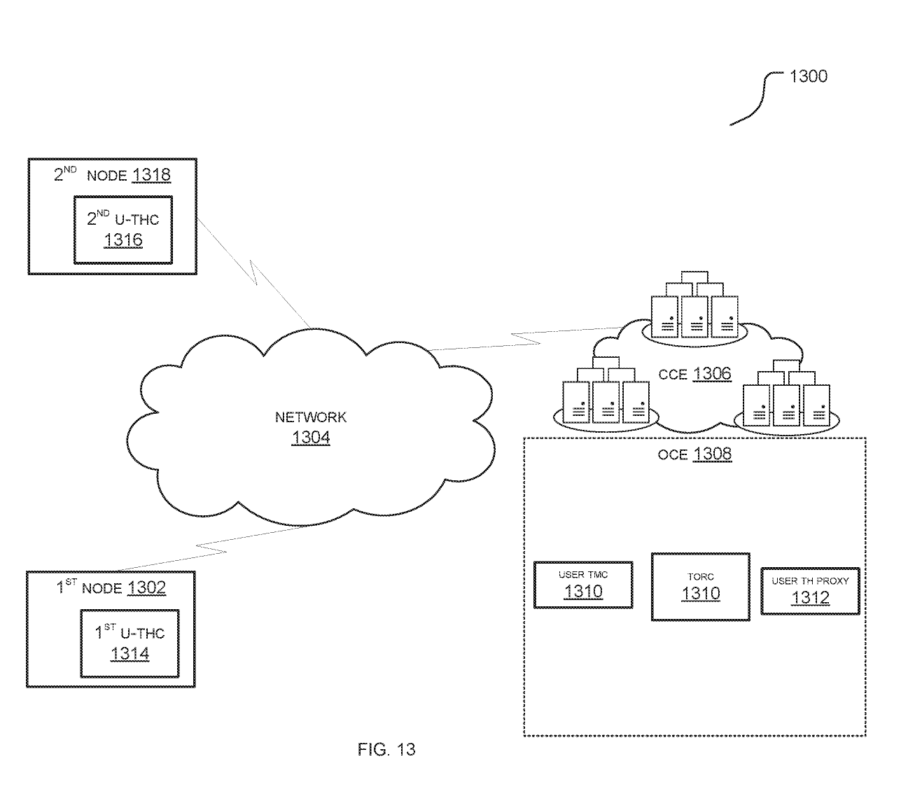

FIG. 13 shows a system 1300 that may operate to perform one or more methods of the subject matter of the present disclosure. FIG. 13 shows that system 1300 includes a first node 1302. A network 1304 may be included in the system 1300 that allows the first node 1302 to be included in a communicative coupling with one or more other nodes, such as a node of cloud computing environment 1306 which may be included in or may be hosted, at least in part, by one or more data centers. FIG. 13 illustrates an offer-based computing environment (or a portion of an offer-based computing environment) 1308 is included in the cloud computing environment 1306. FIG. 13 illustrates user task match circuitry 1310 that may operate to match a task that when performed utilizes a device that interacts with a user or that utilizes a user as a resource in performing the task. More than one instance of task match circuitry may be included that may be based on the same or on different circuitry. For example, task match circuitry may be provided for a first type of task and different task match circuitry may be provided for a second type of task. A task may be assigned a type based on one or more resources utilized in performing the task, another task associated with the task such a parent task of the task, a source of a request to perform the task, or any other attribute of the task deemed suitable by a developer, administrator, user, or owner of system 1300 or a similar system, such as other systems described in the present disclosure, their equivalents, or analogs. User task match circuitry 1310 may match or select task host circuitry based on one more offers received via circuitry of a user task host proxy 1312 that represents one or more user instances of task host circuitry. FIG. 13 illustrates a first user task host circuitry 1314 operating in or otherwise accessible to the first node 1302 and a second user task host circuitry 1316 operating in or otherwise accessible to a second node 1304. User task match circuitry may receive an offer via a user task host proxy 1312 directly or may receive an offer indirectly, for example via an instance of task-offer routing circuitry 1320 as illustrated in FIG. 13.

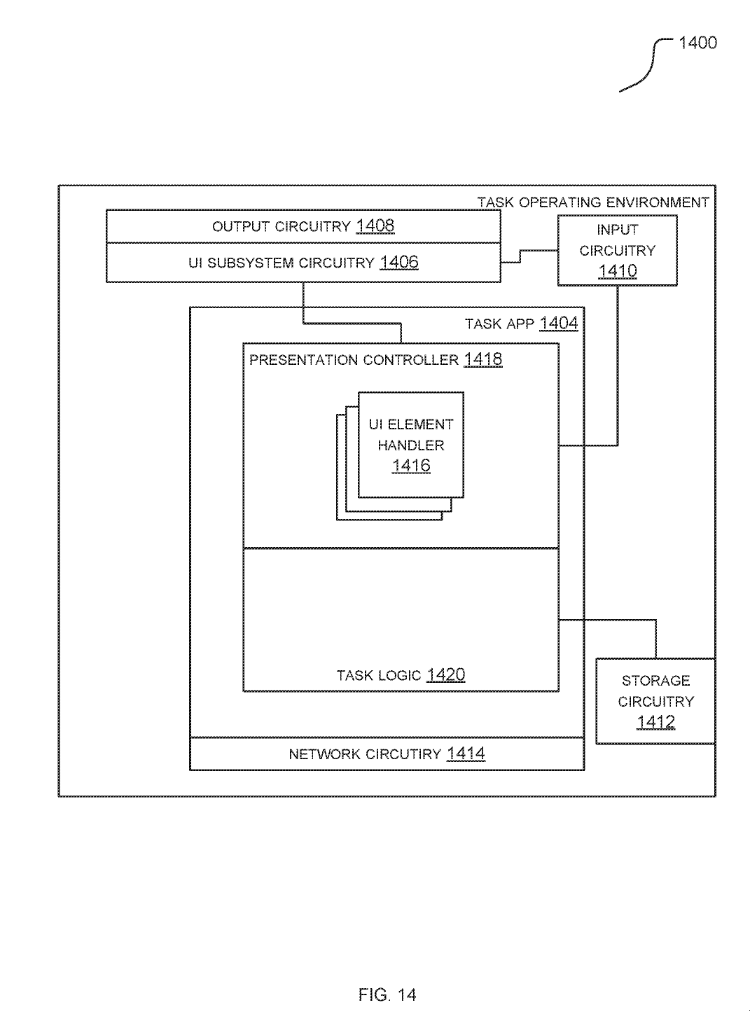

FIG. 14 illustrates a task operating environment 1400 hosting circuitry that enables a device of the task operating environment 1400 to interact with a user. In an embodiment, task operating environment 1400 may be a host operating environment of a node. In another embodiment task operating environment 1400 may be a virtual operating environment operating in a host operating environment of a node. A task operating environment, in various embodiments, may be or may operate in a container, such as Linux container, a computing process, a thread, or may include or be hosted by specialized hardware. A task may be performed in a task operating environment 1400 by virtual circuitry, such as that of an application generated from source code written in a programming language. Some of all of a task operating environment may include physical circuitry, may include mechanical parts, may be powered by electricity, heat, or another type of energy. A task operating environment 1400 may include or may otherwise utilize an arrangement of hardware, code, or data that may host task circuitry. Some task operating environments may provide operating environments in which many types of tasks may be performed. Some task operating environments may provide operating environments that are constrained in the type of task that may be performed, a size of task, a duration that task circuitry may operate, and the like. As stated, in various embodiments a task operating environment may include or may be included in a virtual operating environment, such as a virtual machine, that provides an operating environment for circuitry compatible with the virtual operating environment. FIG. 14 illustrates that a task operating environment 1400 may provide access to resources which may include hardware, code, or data that may be utilized by task circuitry. Task application 1404 illustrates an embodiment of task circuitry that may operate in task operating environment 1400 in performing a task. FIG. 14 illustrates exemplary accessible resources may include user interface circuitry, which may be structured as a user interface subsystem 1406 as shown in FIG. 14. Examples of user interface subsystems include user interface element libraries, windowing systems (e.g. X Windows), and graphics library or hardware such as included in current operating systems such as APPLE's IOS, ANDROID, MICROSOFT WINDOWS, LINUX, other forms of UNIX, and so on. Output circuitry 1408 may also be included or otherwise accessible to task circuitry via task operating environment 1400 as illustrated. Output circuitry 1408 may interoperate with the user interface subsystem circuitry 1406 to present output via an output device. Output circuitry 1408 may include a display adapter, a graphics processor, a display, an audio adapter, speakers, or device drivers suitable for interoperating with one or more accessible output devices. Task application 1404 circuitry may directly or indirectly access input data via one or more input devices via interoperating with input circuitry 1410 which, as illustrated, may be included in task operating environment 1400 or may otherwise be accessible to task circuitry 1404 via task operating environment 1400. Input circuitry a0310 may include or may otherwise enable interoperation with a keyboard, a keyboard adapter, a touch surface, a touch input adapter, a camera, image capture and processing circuitry, a microphone, audio input processing circuitry, and the like. Task operating environment 1400, as illustrated, may also provide access to memory as illustrated by storage circuitry 1412. Storage circuitry 1412 may operate in providing access to persistent storage such as a flash drive or hard-disk, or may operate in providing access to volatile storage such a physical or virtual processor memory. Storage circuitry 1412, in some embodiments, may perform file system or database operations.

Task operating environment 1400 illustrates network circuitry 1414. A task operating environment 1400 may include or otherwise may allow task circuitry 1404 to access a network, as a resource, via network circuitry 1414. Task circuitry may utilize, as illustrated by task application 1404, task logic 1420 to access a network circuitry 1414, as a resource, to access one or more other resources via a network. Network circuitry 1414 may include or otherwise may allow access to a network interface (hardware or virtual), as a resource, and circuitry supporting one or more network protocols, as resource(s), such as in a network stack. A network stack may include hardware or logic that transmits or that receives data over a network via network interface hardware or logic. Network stacks in different nodes may support the same protocol suite, such as TCP/IP, or may communicate via a network gateway or other protocol translation device or service.

A task operating environment 1400 may include or may otherwise provide access, as resource(s) to one or more application layer protocols supported via an application protocol circuitry, which may be included in network circuitry 1414 or may be provided separately, at least in part. Task application 1404 may communicate with other applications in client nodes or server nodes via various application protocols. Exemplary application protocols include hypertext transfer protocol (HTTP) and instant messaging and presence (XMPP-IM) protocol.

Task circuitry, such as task application 1404 may include or a task operating environment 1400 may provide access to circuitry that recognizes, parses, encodes, decodes, encrypts, decrypts, translates, or transforms data in various identifiable formats. Such circuitry may include or may emulate hardware, code, or data that during operation or when processed transforms or otherwise processes received data according to its data type. For example, some data may be identified by a MIME-type identifier. The received data may be transformed and provided to circuitry of one or more user interface element handlers 1416.

User interface element handler 1416 addressable entity(s) are illustrated included in circuitry of a presentation controller 1418. Alternatively of additionally circuitry of a user interface element handler 1416 may be separate from and accessible to circuitry of a presentation controller addressable entity 1418. A presentation controller 1418 may include or emulate hardware, code, or data that during operation or during processing manages the visual, audio, or other types of output of its including or accessing application as well as receive and route detected user and other inputs to task app 1404 and any extensions that task app 1404 may have in various embodiments.

Task circuitry may present data to a user via one or more output spaces associated with one or more output devices, such as a display or a speaker. In some aspects, a user interface element may provide one or more output spaces for presenting a user interface of multiple tasks interoperating or for presenting user interfaces of respective tasks included in performing a common task, sub-tasks of common tasks, or distinct unrelated tasks.

Circuitry included in task application 1404 may, in various embodiments, be provided as one or more resources accessible to task circuitry as the one or more resources rather than being included the task circuitry. Similarly, in various embodiments, one or more resources may be included in task circuitry allowing task host circuitry that does not provide access to the one or more included resources to operate the task circuitry in a task operating environment of the task host circuitry.

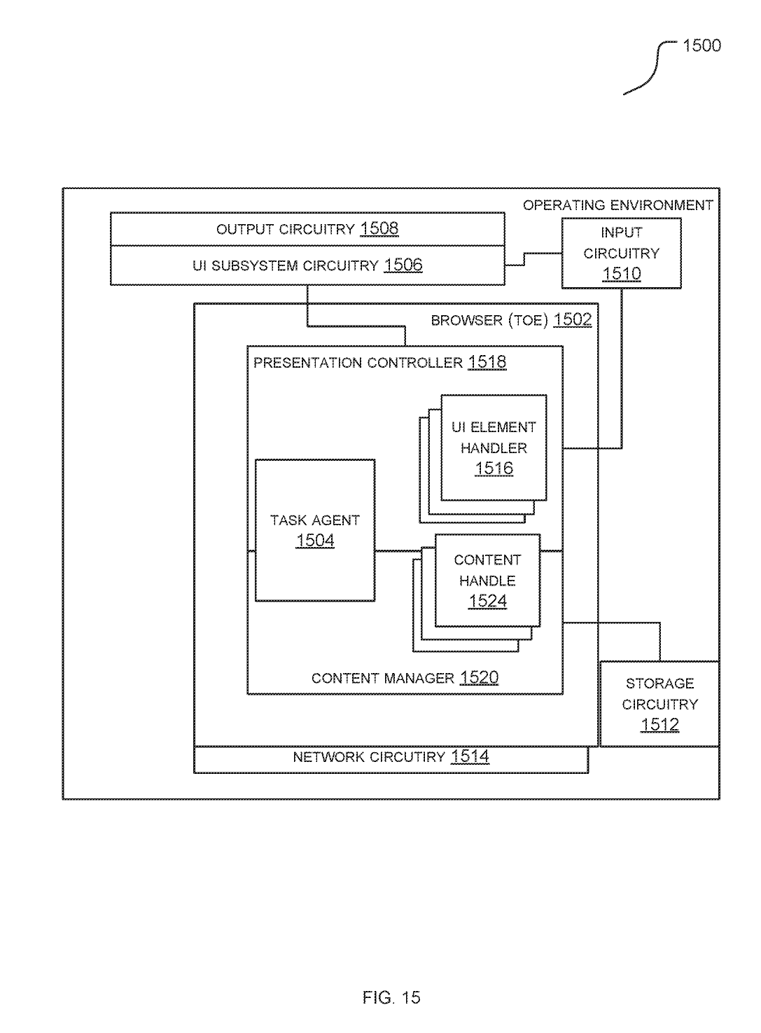

FIG. 15 illustrates an operating environment 1500 hosting circuitry that enables task circuitry operating in a task operating environment provided at least partially by a browser 1502 to interact with a user in performing a task that when performed accesses a resource of the browser 1502 or otherwise accessible via the browser 1502. For example, task circuitry may be invoked (i.e. access as a resource) browser circuitry, such as a script interpreter, to perform a browsing operation included in the task. FIG. 15 illustrates task circuitry including a task agent 1504 loaded into the environment of the browser 1502. The task agent 1504 may be located and loaded via a uniform resource locator (URL) identified via interaction with a user or identified via a hyperlink in the same or another task agent (which may include some of the task circuitry or task circuitry of a related task). In various aspects, browser circuitry 1502 may be included in task circuitry, may be a resource accessible to task circuitry in a task operating environment, or may provide some or all of a task operating environment in which task circuitry may be executed. A resource utilized by task circuitry in task agent 1504 may be accessible via a task operating environment provided by browser 1502. Browser 1502 may include an “app”, “widget”, “plugin”, or an extension which may be included in task circuitry or accessible as a resource to task circuitry such as task agent 1504. Circuitry that performs an assigned task may operate at least partially in one or more of the “app”, “widget”, “plugin”, extension, or task agent 1504. A task agent 1504 may be accessed from a local data store of the operating environment 1500 or may be received from a service site via a network, such as a web site. A task agent 1504 may provide a user interface via a browser 1502 for an application of a server, service site, data center, cloud computing environment, or offer-based computing environment. Web browser 1502 may include a task agent 1504 or otherwise may provide at least part of an operating environment for a task agent 1504. A task agent 1504 may be received via a network from a server, service site, data center, cloud computing environment, or offer-based computing environment including hardware, code, or data processed in a remote operating environment of the server, service site, data center, cloud computing environment, or offer-based computing environment.

Those skilled in the art will see based on the description and drawings of the present disclosure that arrangements of hardware, code, or data for performing an assigned task may be distributed across more than one task operating environment as subtasks. For example, such an arrangement may operate at least partially in a browser 1502 providing a task operating environment or may operate in another task operating environment in the same or different task host circuitry. The other task operating environment may be in or accessible to task host circuitry of a server node. Such an arrangement may operate at least partially in a computing environment of a server, a data center, a cloud computing environment, or an offer-based computing environment.

Browser 1502 as illustrated may include or may otherwise allow access to network circuitry 1514 as a resource in performing a task. A task operating environment may include its own network stack or other network circuitry. Network circuitry may transmit or receive data over a network via network interface hardware or code. Network circuitry may include a network stack such as TCP/IP stack. Network circuitry in or otherwise accessible to different task operating environments may support the same protocol suite, such as TCP/IP, or may communicate via a network gateway or other protocol translation device or service. For example, a task agent 1504 in FIG. 15 and a network application platform operating in a server or data center may interoperate via their network stacks respectively accessible to each.

A task operating environment, as described above, may include or otherwise may provide access to one or more application layer protocols supported via an application protocol service included in or separate from network circuitry 1514. Task circuitry, such as a task agent 1504, in a task operating environment of browser 1502 of a user node may communicate with other user nodes or server nodes (e.g. such as those in an offer-based computing environment) via various application protocols. Exemplary application protocols include hypertext transfer protocol (HTTP versions 1.0, 1.1, and 2.0), Web Sockets, RTC, SPDY, XMPP, and so on. QUIC may be utilized as an alternative to the TCP.

In FIG. 15, a task operating environment of a browser 1502 may receive some or all of a task agent 1504 in one or more messages exchanged via a network with a service application such as web server or via interoperation with an offer-based computing environment in performing one or more tasks. In FIG. 15, browser 1502 includes a content manager 1520 as a resource that operates in performing a task performed by a task agent 1504. A content manager 1520 includes or emulates hardware, code, or data that may interoperate with one or more of application protocol(s) or a network stack included in network circuitry 1514 to receive the message or messages including some or all of a task agent 1504.

A task agent 1504 may include a web page for presenting a user interface for a service application which may include interoperating with a task of the service application assigned by an offer-based computing environment to task host circuitry operating in or interoperating with the service application. The web page may include or reference data represented in one or more formats including HTML or other markup language, ECMAScript or other scripting language, byte code, image data, audio data, or machine code.

In an example, in response to a request received from browser 1502 in FIG. 15, task match circuitry may be invoked in an offer-based computing environment to assign a task, to be performed in response the request, to a task operating environment in the browser (e.g. The browser may operate as task host circuitry) or to a task operating environment of the service provider. A task performed in a task operating environment of an offer-based computing environment may operate to return data for generating a response message, such as an HTTP response. The same or an additional task may transform the data into a format suitable for processing by a content handler 1524 of the requesting browser 1502. Still another task of the offer-based computing environment may include the transformed data in the HTTP response or other suitable protocol and transmit the response via a network protocol, such as TCP or QUIC for delivery to a network interface of a node included in hosting the operating environment 1500.

While the examples above describe sending some or all of a task agent 1504 in response to a request, a service application, which may operate at least partially in an offer-based computing environment, additionally or alternatively may transmit some or all of a task agent 1504 to a browser 1502 via one or more asynchronous messages. In an aspect, an asynchronous message may be sent in response to a change detected by a service application (e.g. via a task of the service application performed in a task operating environment of an offer-based computing environment).

The one or more messages including information representing some or all of a task agent 1504 in FIG. 15 may be received by circuitry of a content manager 1520 via one or more of protocols of the network circuitry 1514. The content manager circuitry 1520, as shown, may include one or more content handler 1524 addressable entities or equivalents that include or emulate hardware, code, or data that during operation or when processed transforms or otherwise processes received data according to its data type, typically identified by a MIME-type identifier. Exemplary content handlers 1524 include a text/html content handler for processing HTML documents; an application/xmpp-xml content handler for processing XMPP streams including presence tuples, instant messages, and publish-subscribe data as defined by various XMPP specifications; one or more video content handlers for processing video streams of various types; and still image data content handlers for processing various images types. A content handler 1524 processes received data and may provide a representation of the processed data to one or more user interface element handlers user interface element handler 1516 addressable entities.

User interface element handler 1516 addressable entity(s) are illustrated in a presentation controller 1518 addressable entity. As described above, a presentation controller 1518 may include or emulate hardware, code, or data that during operation or during processing manages the visual, audio, or other types of output of its including or accessing application as well as receive and route detected user and other inputs to a task agent 1504, its including browser 1502, or extensions of the browser 1502 if any. A user interface element handler 1516 in a browser 1501 or in a user agent 1504 may include or access circuitry that operates at least partially in a content handler 1524 addressable entity or an equivalent. A user interface element handler received as a script or as byte code may operate as an extension in a browser 1502 or external to and interoperating with task circuitry in a task agent 1504 or in the browser 1502.

Task circuitry, such as circuitry of browser 1502 or circuitry of task agent 1504 (depending on the embodiment), may present data to a user via one or more output spaces associated with one or more output devices, such as a display or a speaker. In some aspects, a user interface element may provide one or more output spaces for presenting a user interface of multiple tasks interoperating or for presenting user interfaces of respective tasks. For example, a user interface element may be presented via interoperation of a browser 1502, a task agent 1504, and application circuitry hosted by a remote server, service site, data center, cloud computing environment, or offer-based computing environment. The browser 1502 may operate in a client node. The task agent 1504 may be provided to the client node or otherwise generated from source code (e.g. ECMAScript) and a translation of source code (e.g. Java bytecode) by the server, service site, data center, cloud computing environment, or offer-based computing environment via the network.

Various user interface elements presented via the operation of task circuitry may be presented via one or more user interface element handler(s) 1516. In FIG. 15, user interface element handler(s) 1516 of one or more tasks may include or emulate hardware, code, or data that in operation or as a result of processing send output information representing a visual interface element to a user interface subsystem 1506. A user interface subsystem 1506 may include or emulate hardware, code, or data that in operation or as a result of processing may instruct a corresponding graphics subsystem which may be included in output circuitry 1508 to draw the visual interface element in a region of output space of a display device, based on output information received from a corresponding user interface element handler addressable entity. Input may be received corresponding to a user interface element via input circuitry 1510 in a manner analogous to that described with respect to FIG. 14.

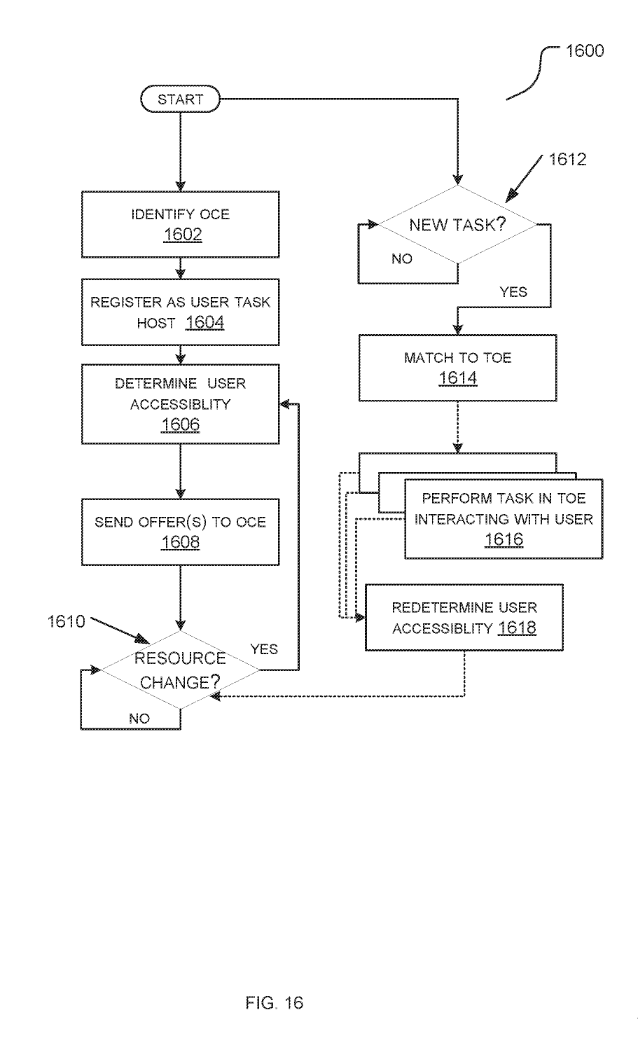

FIG. 16 shows a flow chart 1600 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use in a first node or a first operating environment of the first node that may be not included in an offer-based computing environment or a portion thereof of a second node, a data center, a service site, or a cloud computing environment. The system may include a processor that realizes some or all of the circuitry as virtual circuitry or the system may include hardware that includes some or all of the circuitry that operates in performing the method. At block 1602, the offer-based computing environment may be identified. At block 1604, the first node or the first operating environment may be bound or associated with the offer-based computing environment of the second node, data center, service site, or cloud computing environment. In an embodiment, circuitry of first node or the first operating environment may operate to register task host circuitry or to register to include or host task host circuitry. At block 1606, one or more resources that are or may be configured to be accessible for performing a task may be identified. In particular, access to a user or to a resource that utilizes user interaction may be determined. For example, a resource may include a user having a measure of attention directed to an output device, a user in a geospatial location, a user with a particular presence status, a user capable of interacting with a type of input device, a user with a particular identity, a user assigned a specified role, a user with access to another device such as a thermostat, light switch, car, etc. At block 1608, one or more offers are identified to the offer-based computing environment of the second node, data center, service site, or cloud computing environment. At block 1610, when a change in a resource is detected, accessible resources are at least partially re-determined or re-identified as shown in flow chart 1600 by a return of control from decision block 1610 to block 1606. In particular, when a change in a user or a change in accessibility to a resource via a user is detected, accessible resources are at least partially re-determined or re-identified as shown in flow chart 1600 by a return of control from decision block 1610 to block 1606. Task activity may change a user attribute utilized as a resource or utilized in accessing a resource in performing a task. As such, a change may add resources, delete resources, or may modify an attribute of a resource. Each such event may trigger operation of circuitry associated with decision block 1610 to invoke circuitry that may operate to identify one or more resources or attributes that affect their accessibility. At block 1612, task data may be received that matches an offer sent to the offer-based computing environment of the second node, data center, service site, or cloud computing environment via operation of block 1608. When a new task is detected at decision block 1612, circuitry that realizes block 1614 may be invoked to assign performing the task to a task operating environment. In an embodiment, the matching offer may be utilized to select an existing task operating environment that provides access to the resource(s) offered. In another embodiment, a task operating environment may be created, based on the matched offer, by task host circuitry. At block 1616, task circuitry for the task may be executed in the assigned, selected, or matched task operating environment. Performing the task includes accessing a user or accessing a resource via a user. At block 1618, resources utilized in performing the task may be released or re-determined to create a new offer or to make the matched offer available again. Dotted lines in FIG. 16 illustrate flows that may occur between threads, processes, containers, or other types of virtual operating environments. Any suitable mechanism may be utilized in enabling such flows such as shared memory, semaphores, pipes, queues, interrupts, signals, sockets, and the like.

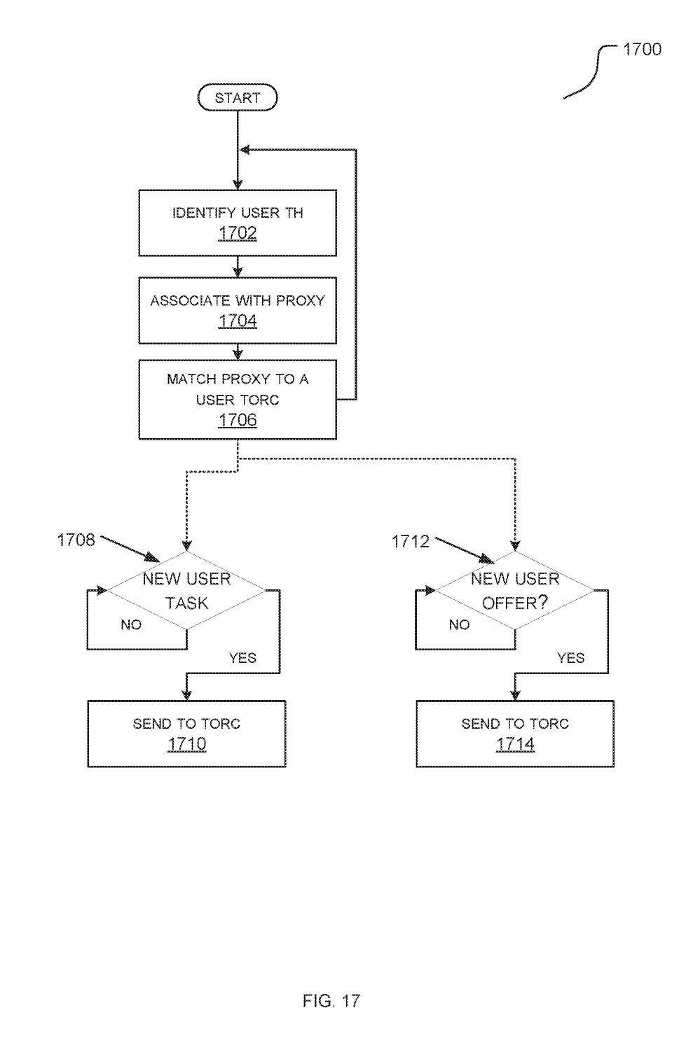

FIG. 17 shows a flow chart 1700 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use in a first node or a first operating environment of the first node that may be not included in an offer-based computing environment or a portion thereof included in or otherwise hosted by a second node, a data center, a service site, or a cloud computing environment. The first node, further, may not be node of a provider of the second node, data center, service site, computing environment, or offer-based computing environment. The system may include a processor that realizes some or all of the circuitry as virtual circuitry or the system may include hardware that includes some or all of the circuitry that operates in performing the method. At block 1702, user task host circuitry of the first node or the first operating environment may be identified. Alternatively or additionally, the first node or the first operating environment may be identified as capable of performing a task that includes interaction with a user or that accesses a resource via a user. The task may be assigned by the offer-based computing environment of the second node, data center, service site, or cloud computing environment based on one or more resources accessible via the first node or the first operating environment. Circuitry included in performing one or more of the methods of the present disclosure may be may be programmable in some embodiments, may be virtual circuitry generated from source code written in a programming language, or may be hard-wired. At block 1704, the first node or the first operating environment may be associated with a proxy or an agent including circuitry for exchanging data about tasks or about offers from and to offer-based computing environment of the second node, the data center, the service site, or the cloud computing environment via a network with the first node or the first operating environment identified via performing the operation of block 1702. In an embodiment, an existing connection with the first node or first operating environment may be provided to circuitry of the proxy. Alternatively or an additionally, an identifier of the first node or the first operating environment may be provided to the proxy. Still further, data that may identify the proxy to the first node or the first operating environment may be transmitted via a network to the first node or the first operating environment. Data exchanged between the first node or the first operating environment and the proxy may be included in associating the proxy and the first node, the first operating environment of the node, task-offer routing circuitry, or a task operating environment of the first node or the first operating environment. At block 1706, the proxy may be associated with task-offer routing circuitry to communicate with task match circuitry. The proxy, in one embodiment, may receive updates from the first node or first operating environment concerning accessibility of a user or a resource accessed via a user. The updates may be sent in response to requests for updates or may be sent asynchronously via the first node. Receiving asynchronous updates may require establishing a subscription with the first node or first operating environment for updates. In another embodiment updates may be sent and received without a subscription. In an embodiment, task-offer routing circuitry may be selected or matched with the proxy based on an attribute of the first node, the first operating environment, task host circuitry of the first node, a task operating environment of the first node, or a resource accessible from or via the first node or first operating environment for performing a task. In an embodiment, a match, selection, or association between a proxy and task-offer routing circuitry may be preconfigured. Operation of block 1708 or block 1710 may occur in a separate or a same sequence of instructions as any of the previously described blocks. Block 1708 illustrates a decision block at which a match may be detected (or not) between a task to be performed and an offer. The matched offer may identify, as a resource, one or more of a user, an attribute of a user, or a resource accessible via a user that may be utilized in performing the task. The offer may be received from the node identified in block 1702. When the match is detected, the proxy may be invoked to send task data identifying the matched task to the first node or the first operating environment to perform, in a task operating environment of task host circuitry of the first node or the first operating environment, the task that accesses the user or that accesses a resource via a user. See block 1710. As with blocks 1708 and 1710, the operation of blocks 1712 and 1714 may occur in a separate or a same sequence of instructions as any of the previously described blocks. At block 1712, an offer received from the first node or the first operating environment identified via operation of block 1702 may be detected (or not). When an offer is received or otherwise detected, the offer may be provided to or otherwise identified to task match circuitry to match with a task to be performed. In an embodiment, the offer may be delivered to task match circuitry by the operation of task-offer routing circuitry associated with the proxy.

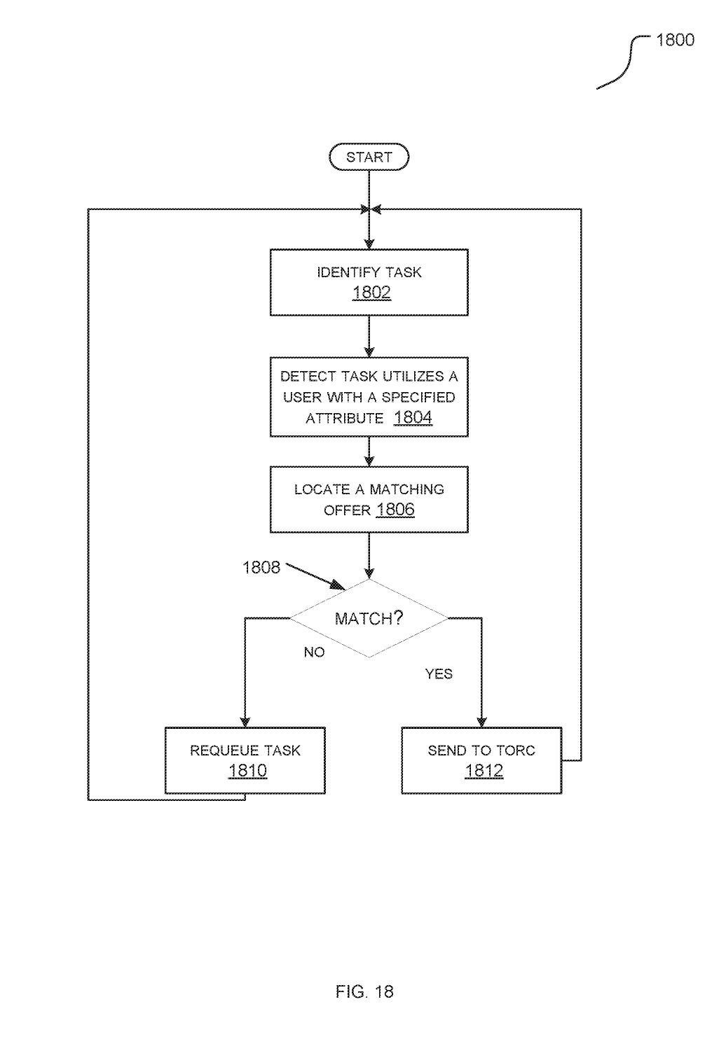

FIG. 18 shows a flow chart 1800 in accordance with an embodiment of a method. As an option, the method may, in various embodiments, be implemented in the context of one or more of the Figures set forth herein. Of course, however, the method may be carried out in any desired environment. Task match circuitry may be included in an embodiment or the method may include providing task match circuitry that may be operable for use with a system. At block 1802, a task may be identified. The task may be performed utilizing one or more identified resources. At block 1804, a detecting, determining, or identifying may be performed that the task must be or may be performed utilizing or otherwise having access to a user or a resource accessible to a user. The required, preferred, or optional attribute of the user may be determined, detected, or otherwise identified. At block 1806, an offer may be located, received, accessed, or otherwise identified that may identify a user as an accessible resource. At block 1808, a determination may be made as to whether the offer matches. The determining includes determining whether the user identified as a resource has an attribute that matches the attribute identified by the task data. If the determining indicates no match, control may be returned (not shown) to block 1806 to locate another offer to test for a match. If it may be determined that there are no matching offers, control may be passed to block 1810. The task may be queued or re-queued to wait for a matching offer before performing the operation of block 1802 again for the particular task. If a match may be detected at decision block 1808, control may be passed to block 1812, where task data identifying the task to be performed may be sent to task host circuitry associated with the offer. Flow chart 1800 illustrates an embodiment where the task data may be routed to the task host circuitry via task-offer routing circuitry that coordinates communications between one or more instances of task match circuitry and one or more instances of task host circuitry.

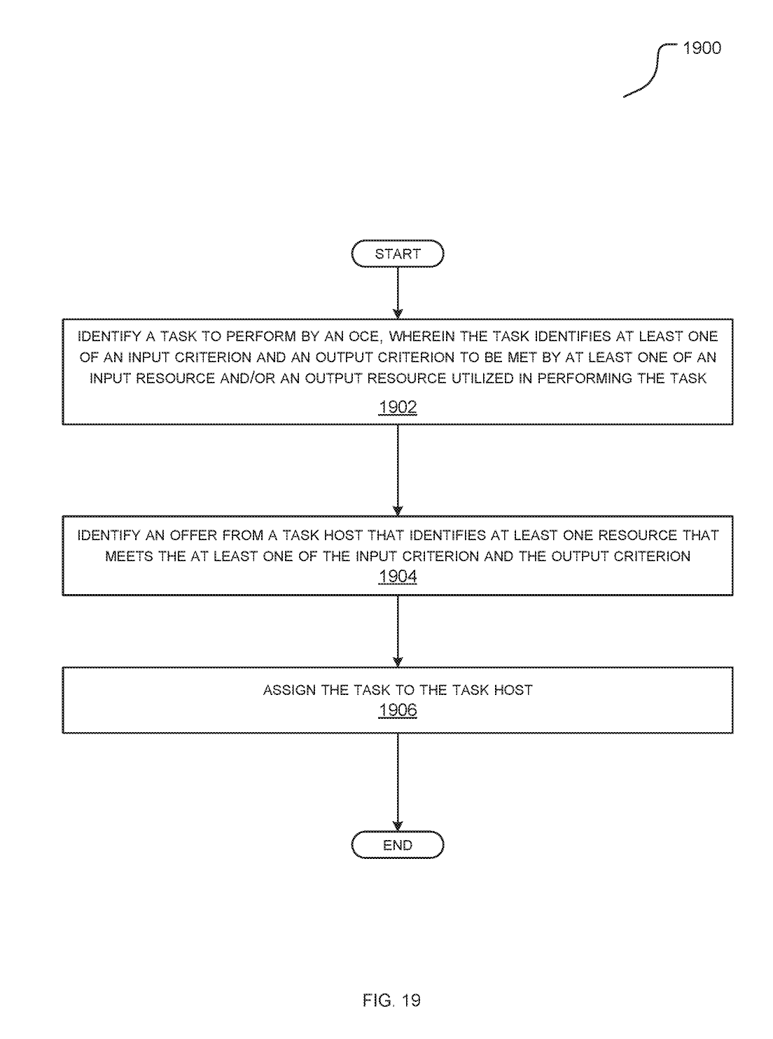

FIG. 19 shows a flow chart 1900 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 1902, a task to perform by an offer-based computing environment may be identified. The task or data associated with the task (e.g. metadata for the task) may identify one or more criteria to be met by one or more input resources or one or more output resources utilized or otherwise accessed in performing the task. An input resource may be or may include an input device or input circuitry having a capability or other attribute identified, directly or indirectly, by a criterion identified by the task or the task metadata. Similarly, an output resource may be or may include an output device or output circuitry having a capability or other attribute identified, directly or indirectly, by a criterion identified by the task or the data associated with the task. At block 1904, an offer from task host circuitry may be received or otherwise identified. The offer may identify one or more resources that meet the one or more respective criteria for a resource or resources utilized to perform the task. At block 1906, the task may be assigned to the task host circuitry.

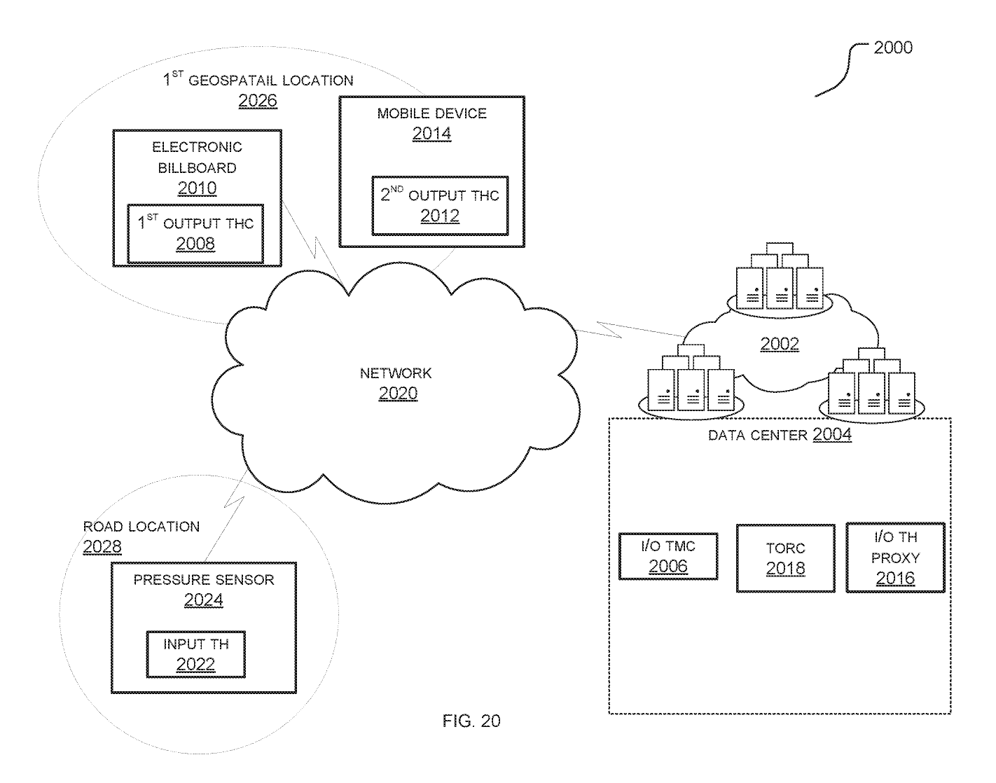

FIG. 20 shows a system 2000 that may operate to perform one or more methods of the subject matter of the present disclosure. The system 2000 includes an offer-based computing environment. The offer-based computing environment is illustrated by a cloud computing environment 2002 in FIG. 20, but may in other embodiments the offer-based computing environment may be in or hosted by node or service site. The cloud computing environment 2002 may include or may be otherwise hosted by one or more data centers 2004 or servers. The data center 2004 includes one or more devices that include or that host circuitry that may operate to match tasks to be performed with instances of task host circuitry that provide access to one or more resources utilized or otherwise accessed in a performing of the respective tasks via operation of task circuitry for the particular tasks. Data center 2004, as illustrated includes I/O task match circuitry 2006 to match tasks that when performed access an input or an output device directly or indirectly. I/O task match circuitry 2004 may be included in or otherwise accessed by task coordination circuitry (not shown), which may include other instances of or types of task match circuitry for matching other some tasks. In an embodiment, task host circuitry associated a matching offer for a task may operate in the offer-based computing environment including or otherwise hosted data center 2004. Alternatively or additionally, task host circuitry associated with a matching offer may operate, in whole or in part, in a node or operating environment not included in the offer-based operating environment or portion thereof hosted by one or more data centers 2004 of cloud computing environment 2002. FIG. 20 illustrates a first output task host circuitry 2008 operating in or otherwise interoperating with an electronic billboard 2010 or other type of input or output device. Second task host circuitry 2012 may be shown included in or capable of interoperating with a movable or mobile device 2014, such as a smartphone, a wearable device, a handheld audio player, a transportation vehicle (e.g. a car, a bicycle, a truck, a taxi, an airplane, etc.). The mobile device may provide access to one or more output devices for task circuitry operating in the second output task host circuitry 2012. The output device may be accessible via a user in an embodiment. For example, task circuitry operating in a task operating environment of the second task host circuitry 2012 may access an output device of the mobile device 2014, such as a smart phone, to instruct a user of the mobile device 2014 to attach or communicatively couple the mobile device 2014 to another device, such as a car or a home appliance. The task circuitry may access a resource of the other device via the communicative coupling to perform the task assigned to the second output task host circuitry 2012. In other embodiments, a task may be assigned to one or more instances of task host circuitry in automotive vehicles to present weather, traffic conditions, “amber alerts”, fuel prices from nearby sellers, and so on. In still another embodiment, the second output task host circuitry 2012 may also provide task circuitry with access to an input device when the task circuitry may be operating to perform a task. One or more input devices included in or accessible to the mobile device 2014 or a user of the mobile device 2014 may be identified via an offer from task host circuitry of the mobile device 2014. The same or different task match circuitry may match a task with an offer from the respective instances of task host circuitry or different task match circuitry may receive and match offers with tasks based on a resource accessed in performing a task, a type of task, an owner of task host circuitry or an I/O device, a location of the device, or based on any suitable attribute from a given implementation. Offers may be received from remote task host circuitry via a task host proxy. Tasks may be assigned to the remote task host circuitry via the same or different task host proxy. FIG. 20 illustrates I/O task host proxy 2016. A task host proxy 2016 may communicate directly with task match circuitry. Alternatively or additionally, task host proxy 2016 may communicate indirectly with task match circuitry. In FIG. 20, task host proxy communicates with task match circuitry 2006 via task-offer routing circuitry 2018. Some or all of task host proxy circuitry may be included in task-offer routing circuitry, in an embodiment, or vice versa. FIG. 20 illustrates a network 2020 for communicatively coupling remote instances of task host circuitry, such as first task host circuitry 2008, with the data center 2004 (e.g. I/O task host proxy 2016). FIG. 20 also illustrates an input task host circuitry 2022 that provides access to an input device, shown as a pressure sensor 2024. The input task host circuitry 2022 may be included in or capable of interoperating with the pressure sensor device 2024. Input task host circuitry 2022, in an embodiment, may also provide access to one or more output devices or may be associated with or interoperating with task host circuitry providing access to an output resource. FIG. 20 also illustrates that a location may be a resource or may be an attribute of a resource accessible via task host circuitry. The electronic billboard 2010 and the movable or mobile device 2014 may send respective offers that identify an output resource in a specified location. FIG. 20 illustrates the electronic billboard 2010 and the mobile device 2014 in a first geospatial location 2026. The electronic billboard 2010, in an embodiment, may be in a fixed position or may be movable within the first geospatial location 2026 given a specified constraint. The mobile device 2014 may be in motion. An offer from the second output task host circuitry 2012 may project a path of movement, a rate of movement, or may identify a duration in which the mobile device 2014 may be in the first geospatial location 2026. The pressure sensor 2024 may be identified as located in a road location 2028. The pressure sensor may be in or near a road in a fixed position. The pressure sensor, in another embodiment, may be in a vehicle moving along the roadway and identified as in the road location 2028 at a specified time or duration.

In an embodiment, a task to present an amber alert or an advertisement may be assigned to first output task host circuitry 2008 based on an offer that identifies the first geospatial location as a resource or an attribute of a resource accessible to the first task host circuitry 2008. Alternatively or additionally, an offer from first task host circuitry may identify a user in the first geospatial location that may view the output of the billboard. The first task host circuitry may receive location information of the mobile device 2014 to identify a location of the user of the mobile device. Other resources that may be identified by first output task host circuitry 2008 or second output task host circuitry include structures of building that include users. Attributes of such structures or building that may also be identified in an offer include a location with the first geospatial location 2026, an orientation of direction, an indication of movement or no movement, a direction of movement, a speed, a time of day (e.g. working hours), a day of the week, a date, and so on.

In an embodiment, input task host circuitry 2022 may identify one or attributes of the pressure sensor in an offer such as a capability to detect a maximum pressure, a minimum pressure, a precision of the pressure sensor, a counter that counts changes in pressure, whether the counter is resettable, is a rolling counter, whether the pressure sensor may identify a speed of an object moving over the sensor, whether the pressure sensor may identify a weight of an object or moving over the sensor, and so on.

In an embodiment, circuitry may be provided that may be operable for use with an offer-based computing environment. The circuitry may operate to receive an offer, via the network from a first node. The first node may identify at least one of an input device and an output device as a resource of the first node. The first node may communicate with the offer-based computing environment via a network. The circuitry may also operate to determine that no offer identifies the resource from task host circuitry in a second node, service site, data center, or cloud computing environment that is included in or that otherwise hosts the offer-based computing environment or a portion thereof. The circuitry may further operate to select the offer from the first node in response to the determining. Alternatively or additionally, the circuitry may operate to identify a task that matches the offer. In an embodiment, no offer from task host circuitry in the offer-based computing environment of the second node, data center, service site, or cloud computing environment has access to at least one of an input device and an output device that matches the needs or preferences of the particular task. The circuitry may, still further, operate to transmit data, via the network, that assigns the task to the first node.

In an embodiment, circuitry, may be provided that may be operable for use with a first operating environment of a first node that may communicate via a network with an offer-based computing environment or a portion thereof hosted by a second node, a data center, a service site, or a cloud computing environment. The circuitry may operate to receive first data that may identify the offer-based computing environment or the portion. The circuitry may, additionally, operate to exchange data, via a network between the first node and the offer-based computing environment of the second node, data center, service site, or cloud computing environment to associate, bind, or register the first node with the offer-based computing environment. Also, the circuitry may operate to create an offer that may identify at least one of an input device and an output device as a resource of the node. Further, the circuitry may operate to transmit, the offer via the network to the offer-based computing environment of the second node, data center, service site, or cloud computing environment to include the first as a task host circuitry node accessible for performing a task when assigned by the offer-based computing environment.

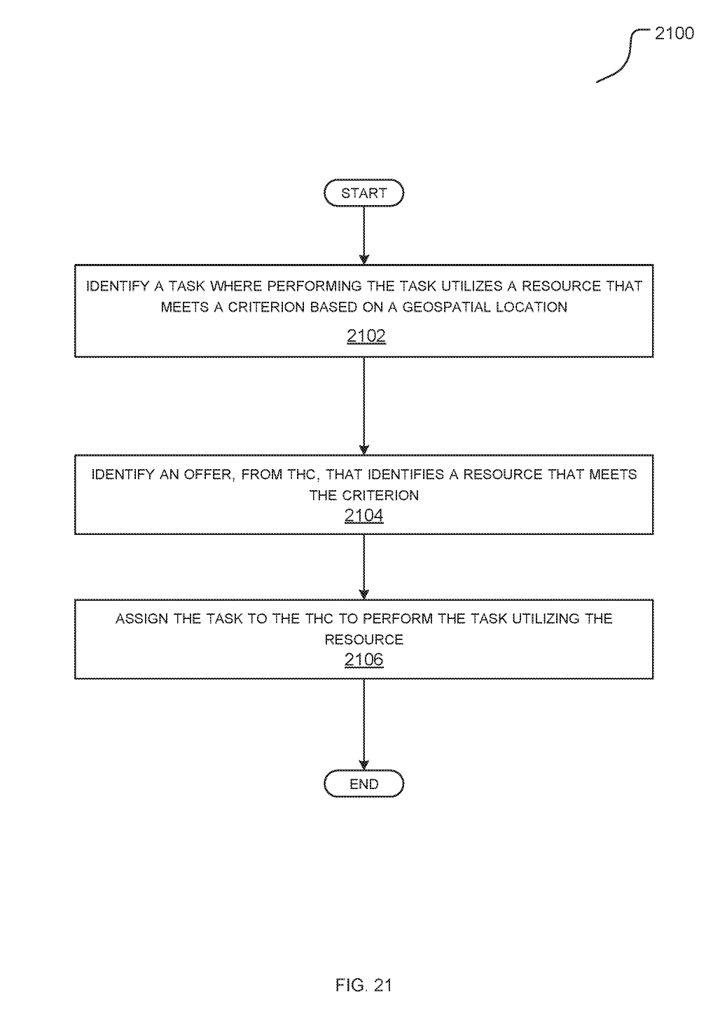

FIG. 21 shows a flow chart 2100 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 2102, a task may be identified where performing the task utilizes a resource that meets a criterion based on a geospatial location. At block 2104, an offer, from task host circuitry, may be identified. The offer may identify or otherwise provides metadata about a resource that meets the criterion. The criterion may be evaluated based on data in or identified by the offer. At block 2106, the task may be assigned to the task host circuitry to perform the task utilizing the resource.

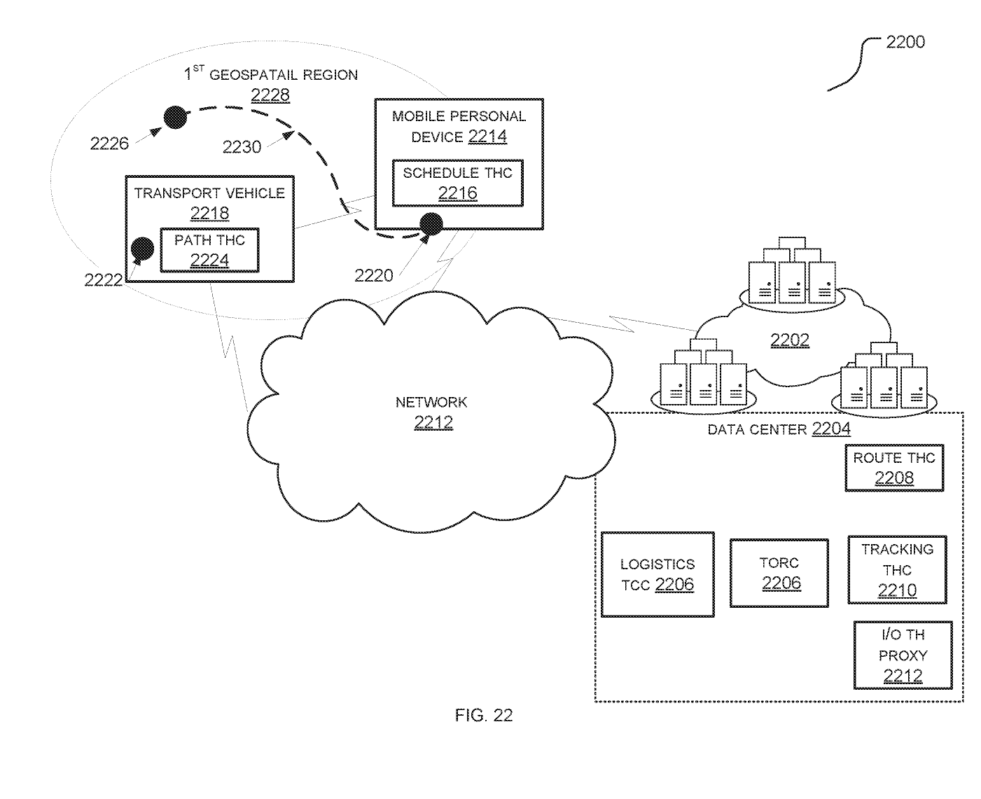

FIG. 22 shows a system 2200 that may operate to perform one or more methods of the subject matter of the present disclosure. In FIG. 22, system 2200 includes an offer-based computing environment 2202 included in a cloud computing environment that includes or is otherwise hosted by one or more data centers 2004 or servers. In other embodiments, the offer-based computing environment may include or otherwise be hosted by a node (e.g. a server node) or a cluster of nodes. A data center 2204 includes one or more servers that include or host circuitry that may operate to match tasks to be performed with instances of task host circuitry that provide access to one or more resources utilized or otherwise accessed in a performing of the task via operation of task circuitry for the particular task. Data center 2204, as illustrated includes logistics task coordination circuitry 2206 that may operate to schedule or otherwise coordinate tasks included in moving or delivering an object from one location to another. The logistics task coordination circuitry 2206 may include one or more instances of task match circuitry (not shown) to match one or more types of tasks, included in moving an object from one location to another, to one or more respective types of instances of task host circuitry providing access to resource(s) utilized in performing the respective types of tasks. FIG. 22 illustrates route task host circuitry 2208 that may provide resource(s) for task circuitry that operates in determining a route or routes for moving an object from a first location to a second location. In an embodiment, data center 2204 may include a task host proxy (not shown) for interoperating with route task host circuitry (not shown) located outside the data center 2204. Tracking task host circuitry 2210 is also illustrated that may provide an operating environment that includes one or more resources utilized by task circuitry that operates in the environment to maintain and update location data (e.g. current location, past location(s), or projected location(s)) associated with one or more objects, such as packages, transport vehicles, or customers. In an embodiment, data center 2204 may include a task host proxy (not shown) for interoperating with tracking task host circuitry (not shown) located outside the data center 2204. FIG. 22 also illustrates an I/O task host proxy 2212 that interoperates with task host circuitry that provides an operating environment for task circuitry that when executed interoperates with a user or accesses a resource via a user. FIG. 22 also includes a mobile personal device 2214 such as smartphone, wearable device, or a tablet computer. The mobile personal device 2214 may include an application, that in an embodiment, provides a user interface that interoperates with a user to identify a package for pick-up from a location, such as a location of the user who may be remain in a fixed location or may move. In operation, the application may identify one or more tasks to be performed to identify the package for pick-up. The device 2214 may include one or more instances of task match circuitry (not shown) that may operate as part of logistics framework 2206 or otherwise may interoperate with offer-based computing environment 2202 in coordinating an object (e.g. a package or a user) pick-up for moving or delivery. Schedule task host circuitry 2216 may be shown in mobile personal device. Task circuitry may operate in schedule task host circuitry 2216 that interacts with a user of mobile device 2214 may operate to provide scheduling information via an output device of mobile personal device 2216 or to receive scheduling information via an input device of mobile personal device 2214. Schedule task host circuitry 2216 may provide an offer to logistics task coordination circuitry 2206 via I/O task host proxy 2212, in an embodiment. FIG. 22 also illustrates a transport vehicle 2218 which may be utilized as a resource in a delivery task coordinated by logistics task coordination circuitry 2206. In a scenario, a task to deliver an object associated with a user from a pick-up location to a destination location may be received or otherwise identified by logistics task coordination circuitry 2206. The object may be with the user (such as in the user's home, carried by the user, in a vehicle of the user, etc.). In an aspect, the object to be delivered may include the user or may include the mobile device 2214. Logistics task coordination circuitry 2206 may assign a task to tracking task host circuitry 2210 to locate the object to be picked up or may assign one or more additional tasks to track the object prior to pick up in the event that it changes location. Based on a pick-up location 2220 of the object, logistics task coordination circuitry 2206 may assign one or more tasks to one or more instances of tracking task host circuitry 2210 to locate at least one transport vehicle to pick up the object from pick-up location 2220. FIG. 22 illustrates a transport vehicle 2218 at location 2222. Logistics task coordination circuitry 2206 may assign one or more tasks to one or more instances of route task host circuitry 2208 in which one or more task circuitry instances may operate to determine a route from location 2222 to pick-up location 2220 to pick up the object. The transport vehicle 2218 may be selected based on one more routes identified associated with one or more transport vehicles available for pick-up. Tasks that update, create, and maintain route schedules may also operate in a route task host circuitry 2208 or may assigned to another type of task host circuitry (not shown). In an embodiment, in response to identifying transport vehicle 2218 for the object pick-up, logistics task coordination circuitry 2206 may match a task to direct the transport vehicle to the pick-up location 2220 to path task host circuitry 2224 in the transport vehicle 2218. Path task host circuitry 2224 may perform a task of directing the transport vehicle to the pick-up location 2220. The transport vehicle 2218 may be autonomous or may have an operator. Task circuitry operating in a task operating environment of the path task host circuitry 2224 may interoperate with the operator of the transport vehicle 2218. For example, such task circuitry may provide visual or audio instructions to the operator. In an aspect, the pick-up location 2220 of the object may change. Task circuitry assigned to tracking task host circuitry 2210 may detect the change and create a task for rerouting the transport vehicle (or assigning another transport vehicle). The rerouting task may be assigned by logistics task coordination circuitry 2206 to the path task host circuitry 2224 which may update the currently operating task circuitry directing the transport vehicle 2218 to the pick-up location 2220 to update the current route or may replace or override the currently operating task with a new task that may determine a new route. Task circuitry operating in tracking task host circuitry 2210 may detect that the transportation vehicle 2218 and the object are within a specified distance or time from each other. The tracking task may interoperate with one or both the mobile device 2214 and the transport vehicle 2218 to indicate the detected state. Interoperation may be via logistics task coordination circuitry 2206 assigning a task via I/O task host proxy to task host circuitry in the transport vehicle 2218 or to task host circuitry in the mobile personal device 2214. An output may be presented by task circuitry operating in one the one or both of the transportation vehicle 2218 and the mobile device 2214 to identify one to the other or to identify when they are in a same location defined by a time or distance constraint. In an embodiment, one or both the transportation vehicle 2218 and the mobile personal device 2214 may send a signal via a network or via a link that may identify one to the other. An output may be presented to an operator or passenger in the transportation vehicle 2218 or to the user of the mobile device 2214 that provides information allowing one to identify the other to facilitate pick-up of the object. A task assigned to a tracking track host may detect the pick-up, which may be reported to a task assigned to a route task host circuitry 2208 that may identify one or more routes, which may include one or more transportation vehicles, for delivering the object, which may be the user of the mobile device 2214 to a destination location 2226 in a geospatial region 2228 that includes the pick-up location 2220 and the destination location 2226. In an aspect, a high-level route may be determined by a task operating in a route task host circuitry 2208 which may identify one or more locations between the pick-up location 2220 and the delivery location 2226. A detailed route between pairs of the one or more locations, may be determined by a path task host circuitry 2224 in transportation vehicle 2218 or with a human carrier between successive pairs in the route. The route 2230 is shown in FIG. 22 to represent one such route. Note that in an embodiment, the destination may be identified by a location of a movable object, such as a person or a transportation vehicle. Circuitry may be included in the transport vehicle or in the mobile device 2215 to interoperate with an operator of the transport vehicle 2218 or a user of the mobile device 2214 to confirm the correct object may be picked up by the closest carrier. If other objects are identified in route to the pick-up location 2220 or in route to the destination location 2226, patch task host circuitry 2224 may change route 2230 to allow the other objects to be pick-up during the deliver from the pick-up location 2220 to the destination location 2230. Path task host circuitry 2224 may receive location information for the other object(s) to pick-up form tracking task host circuitry 2210.

In an embodiment, circuitry may be provided that may be operable for use with an offer-based computing environment or a portion thereof including or otherwise hosted by a second node, a data center, a service site, or a cloud computing environment. The circuitry may operate to receive an offer, via the network from a first node. The offer may identify a resource at a specified location. The first node may be not included in the data center, the service site, or the cloud computing environment. The circuitry may additionally operate to determine that no offer from task host circuitry the offer-based computing environment or the portion including or hosted by the second node, the service site, the data center, or the cloud computing environment identifies a resource at the specified location. The circuitry may operate, in response to the determining, to select or match the offer from the first node. In an aspect, no offer from task host circuitry in the offer-based computing environment or the portion including or hosted by the second node, the service site, the data center, or the cloud computing environment has access to a resource at the specified location. The circuitry may further operate to transmit data, via the network, that assigns the task to the first node.

In an embodiment, circuitry may be provided that may be operable for use with use with a first operating environment of a first node not included in an offer-based computing environment or a portion thereof including or otherwise hosted by a second node, a data center, a service site, or a cloud computing environment. The circuitry may operate to receive data that may identify the offer-based computing environment or the portion. The circuitry may also operate to exchange data, via a network between the first node and the offer-based computing environment or the portion to associate task host circuitry of the first node with the offer-based computing environment. The circuitry may additionally operate to create an offer that may identify a resource at a specified location as a resource of the first node. The circuitry may further operate to transmit the offer via the network to the offer-based computing environment or the portion to include the first node as a task host circuitry node for performing tasks as assigned by the offer-based computing environment.

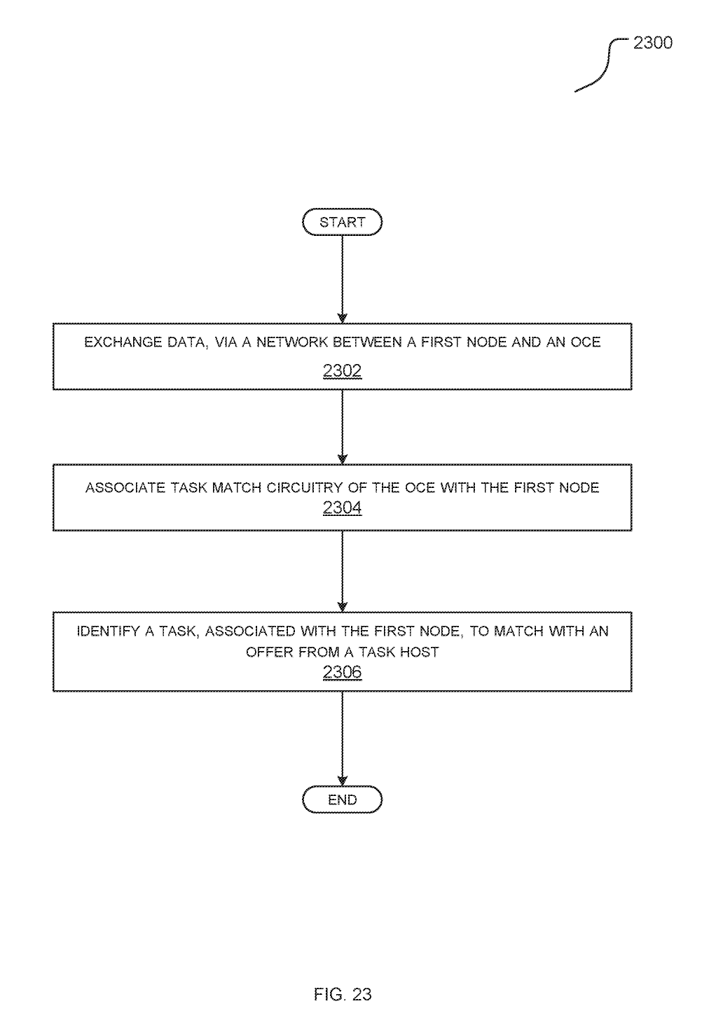

FIG. 23 shows a flow chart 2300 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment or a portion there of including or otherwise hosted by a second node, a service site, a data center, or a cloud computing environment. The system may include a first node not included in the data center, service site, or cloud computing environment. The first node and the offer-based computing environment or the portion may be communicatively coupled via a network. At block 2302, data may be exchanged, via a network between the first node and the offer-based computing environment or the portion of the second node, data center, service site, or cloud computing environment. The first node may be a user node or may otherwise be a node not provided, owned, or managed by a respective provider, owner, or manager of the second node, service site, data center, or cloud computing environment. At block 2304, task match circuitry of the offer-based computing environment center may be associated with the first node. The task match circuitry may operate in the second node, service site, data center, or cloud computing environment of the offer-based computing environment. In an aspect, task match circuitry of an offer-based computing environment may be included in a task coordination circuitry that operates on behalf of a particular type of user device, a particular user or type of user, a user or device in a particular location, and the like. The association may be based on the first node, the first operating environment node, a user of the first node, a location of the first node, or any other suitable attribute of the first node or first operating environment as determined or otherwise identified by the offer-based computing environment. At block 2306, a task, associated with the first node of the first operating environment may be identified, to match with an offer from task host circuitry. The task may be identified in data received from the first node or may be identified by the offer-based computing environment based on an attribute of the first node or the first operating environment. For example, a task may be identified or otherwise based on an I/O capability of the first node or first operating environment, a user interface model of the first operating environment, or sensory capabilities of a user of the first node—to name a few examples.

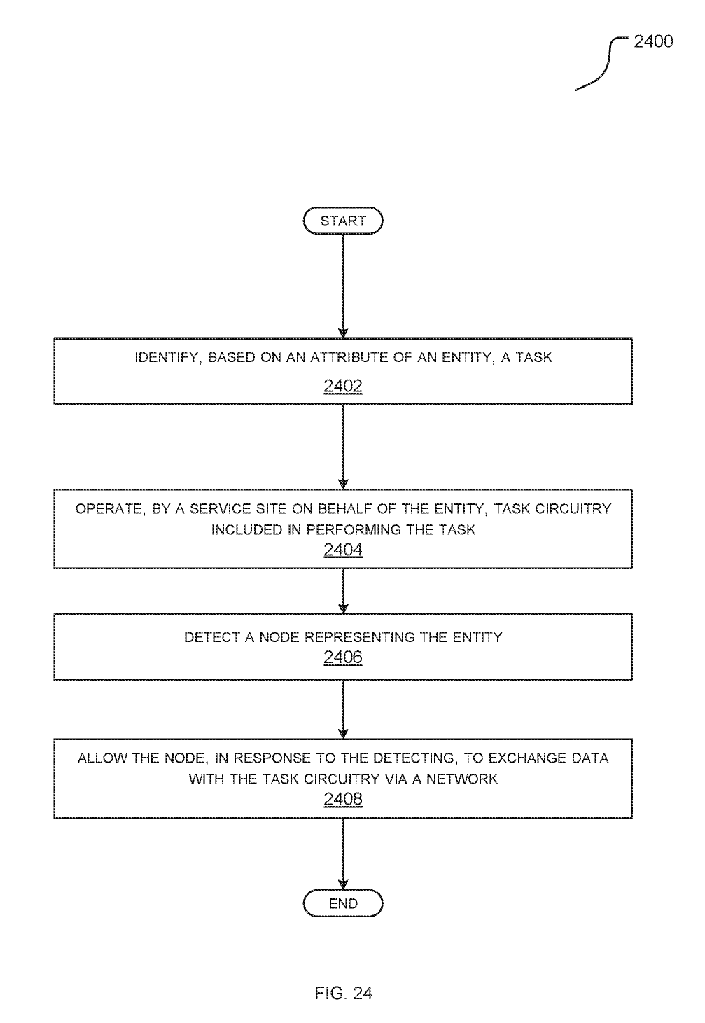

FIG. 24 shows a flow chart 2400 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include a service site and the system may include node not included in the service site. In an embodiment, the node may be a user node or a server node. In an embodiment, the service site may be included in or may otherwise be hosted, at least in part, an offer-based computing environment. The node and the service site may be communicatively coupled via a network. At block 2402, a task may be identified based on an attribute of an entity. Exemplary attributes and entities include a network address of a node, an operating system or an operating environment type of a node, a user of a node, a location of a node, a capability of a node (e.g. includes a web browser, email client), a file type, or an owner of the node—to name a few examples. At block 2404, task circuitry included in performing the task may be operated for or on behalf of the entity. In an embodiment, a task may operate to maintain and report a status of a user interacting with or otherwise represented by the node. In another embodiment, the task may operate to perform a service for an operating system in the operating environment of the node, such operating as a DHCP client for the node. In still another embodiment, the task may operate in caching data in a data stream in storage accessible to the service site for subsequently streaming to the node representing the user or for streaming to another node representing the user. At block 2406, a node representing the entity may be detected. The node itself may be the entity and the attribute may be the node's operational state or a type of application operating in the operating environment. The service site may detect the node by requesting information about the node via the network form the node or from another node. The service site may detect the node via data received from the node via a network. The node may be a source of the data or may operate as a relay for transmitting the data. At block 2408, the service site allows, in response to detecting the node representing the entity, a data exchange with the task circuitry. In an aspect, a task operating to provide presence information may detect a level or interaction between a user and an operating environment of the node, detect a type of interaction, and the like and determine a status of the user. The status, in an embodiment, may be reported based on subscription(s) to a tuple for the user. A task operating to provide a DHCP client for the node may provide, via the network, a network address for a network interface of the node. The network address may be for a virtual network interface in a virtual network. A task operating as a data stream cache, may detect a data stream that may be not currently playing or not being viewed by a user. A cache, if one exists, that utilizes storage of the node may be full or may otherwise meet a specified condition. Rather than pause the data stream, data may be cached at the service site via operation of the task.

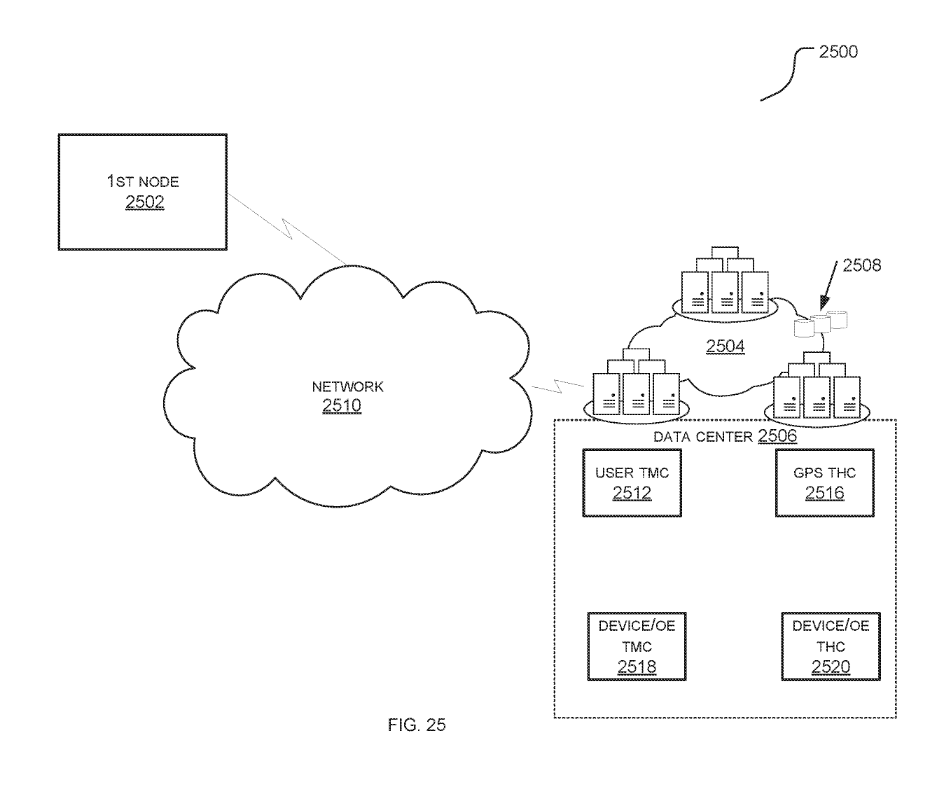

FIG. 25 shows a system 2500 that may operate to perform one or more methods of the subject matter of the present disclosure. FIG. 25 shows that system 2500 includes a first node 2502 that represents an entity such as a user with a specified attribute (e.g. a location, an identity, etc.), a device that has a specified capability such as a capability of producing heat (e.g. an oven, a heating system, etc.), or an entity capable of moving or being moved such as a car or an envelope. FIG. 25 illustrates a service site 2504 provided by one or more data centers 2506. The service site 2504 may be hosted, at least in part, by an offer-based computing environment. The service site 2504 may include or otherwise may access a persistent data store 2508 that stores data that associates a task with an entity having a specified attribute or attributes. Each of the node 2502 and the service site 2504 may be communicatively coupled to a network 2510. The data center 2506 of the service site 2504 or of a cloud computing environment hosting the service site 2504 may include task match circuitry that matches the task with an offer of task host circuitry. A service site 2504 may include one more instances of task match circuitry and may include one or more instances of instances of task host circuitry. In an embodiment, a task may be identified, in the data store 2508, in an association that may identify a user as an entity that may be an employee of a specified company. The task may operate to track the location of the user during a specified time period of a specified portion of a week. User task match circuitry 2512 may receive task data that may identify the association. The task match circuitry 2512 may match the tracking task with GPS task host circuitry 2514 that operates in the data center 2506. The GPS task host circuitry 2516 may receive GPS data that may identify a location of a device carried by, worn on, or that includes the user (e.g. a car). The GPS task host circuitry 2516 may report location changes to one or more subscribed clients. The user's location may be tracked via a device on, near, or that includes the user. The tracking device provides location data and may be enabled to identify the user (e.g. a smartphone, a smartwatch, a car, etc.). In another embodiment, a task may be identified, in the data store 2508, in an association that may identify a device, as an entity, that has a specified attribute, such as a location (absolute or relative to one or more other devices), and that has a specified capability. For example, the device may operate as a washing machine, a printer, a car, an audio recorder, and so on. Device task match circuitry 2518 may match the task with an offer from task host circuitry 2520. The task host circuitry 2520 may operate task circuitry to include the device in a virtual network with one or more other devices in a same location allowing the one or more other devices to access the device.

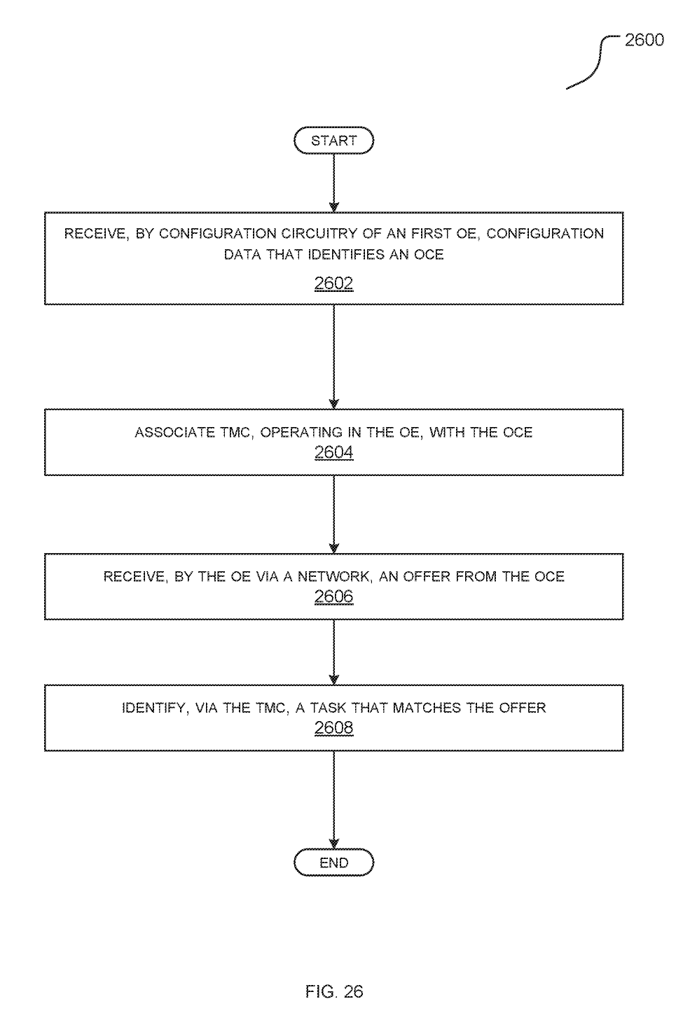

FIG. 26 shows a flow chart 2600 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment or a portion there of including or otherwise hosted by a second node, a service site, a data center, or a cloud computing environment. The system may also include a first operating environment of a first node. In an aspect, the first is not include in the service site, data center, or cloud computing environment. The first operating environment of the first node and the offer-based computing environment or portion may be communicatively coupled via a network. At block 2602, configuration data may be received by configuration circuitry of the first node or the first operating environment. The configuration data may identify the offer-based computing environment or the portion. At block 2604, task match circuitry or task coordination circuitry, that operates in the first node or the first operating environment, may be associated with the offer-based computing environment. The task match circuitry or task coordination circuitry may be associated with one or more instances of task-offer routing circuitry of the offer-based computing environment or may be associated with one or more instances of task host circuitry of the offer-based computing environment. The task match circuitry or task coordination circuitry may be communicatively coupled to proxy task match circuitry or a proxy task coordination circuitry operating in a data center of the offer-based computing environment. The proxy represents and may be included in a communicative coupling between the first node and one or more of second node, data center, the service site, and the cloud computing environment of the offer-based computing environment of the portion. The proxy may communicatively couple the task match circuitry or task coordination circuitry with one or more instances of task-offer routing circuitry or task host circuitry in the offer-based computing environment. At block 2606, an offer may be received by the task match circuitry or task coordination circuitry from the offer-based computing environment. The offer may be exchanged via the network. The offer may be received from, directly or indirectly, task host circuitry of the offer-based computing environment. The offer may be routed to the task match circuitry or task coordination circuitry by task-offer routing circuitry of the offer-based computing environment. In an aspect, the offer may be received by the task match circuitry or task coordination circuitry via a proxy described with respect to block 2604. At block 2608, a task that matches the offer may be identified. The task match circuitry or task coordination circuitry operates to determine or identify the match. The match may be subsequently identified to task host circuitry of the offer-based computing environment to perform the task. The match may be identified via a proxy or task-offer routing circuitry. The task host circuitry may identify a task operating environment associated with the offer. The task operating environment may be preexisting or may be created to perform the task. The task operating environment may be instantiated or otherwise configured so that task circuitry operating in the task operating environment has access to resources identified for the task. The resources are accessed or otherwise utilized to perform the task by the task circuitry.

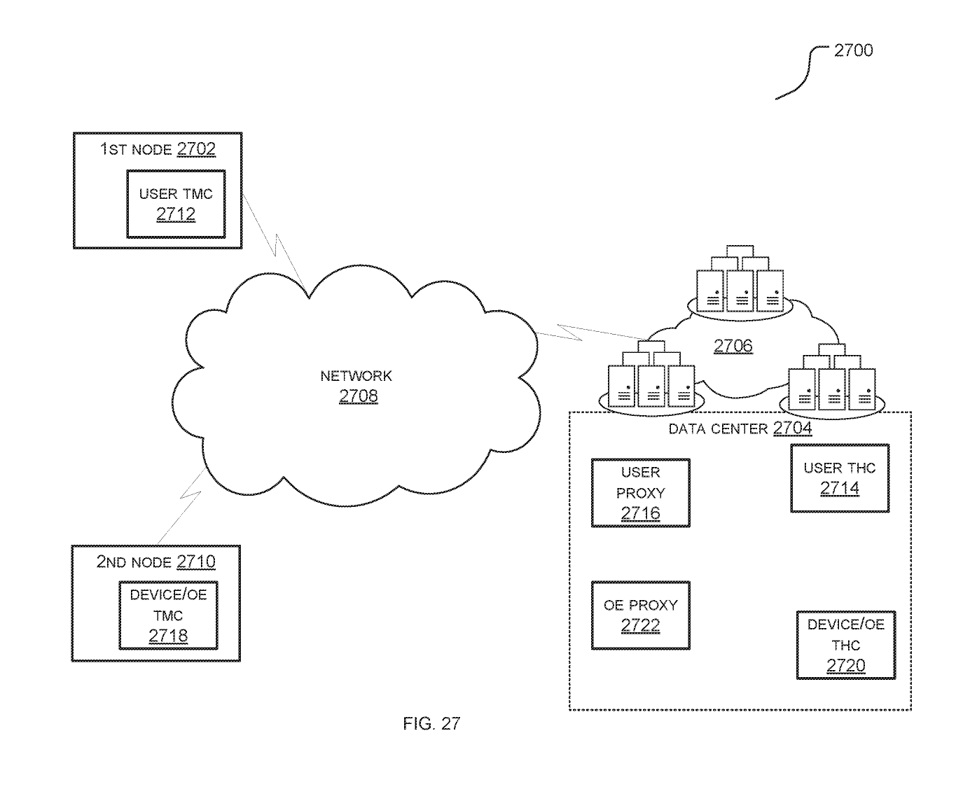

FIG. 27 shows a system 2700 that may operate to perform one or more methods of the subject matter of the present disclosure. FIG. 27 shows that system 2700 includes a first node 2702 may be communicatively coupled to an offer-based computing environment 2706 via a network 2708. FIG. 27 also illustrates a second node 2710 that may be communicatively coupled to the offer-based computing environment. FIG. 27 illustrates an embodiment where the offer-based computing environment 2706 includes or is otherwise hosted by a data center 2704. The offer-based computing environment, in an embodiment, may be included in a cloud computing environment. The first node 2702, as FIG. 27 illustrates, includes user task match circuitry 2712, which may operate to match tasks for a particular user, group, account, legal entity, or other user(s) having a specified attribute with an offer from task host circuitry of the offer-based computing environment 2706, such as a user task host circuitry 2714. The offer and a subsequent task assignment communicated between user task match circuitry 2712 and user task host circuitry 2714 may be direct or routed via a proxy, illustrated by user proxy 2716 (which may operate in task coordination circuitry). FIG. 27, also illustrates operating environment task match circuitry 2718 that may operate to match a task performed for or on behalf of an operating environment or a portion thereof of the second node 2710 with an offer from suitable task host circuitry, such as operating environment task host circuitry 2720, which may communicate via proxy circuitry as shown by operating environment proxy 2722. A device or an operating environment may include task coordination circuitry that may include or may otherwise access one or more instances of task match circuitry. A device or an operating environment of a device may include task match circuitry for a task of an application, a computing process, hardware that performs an operation (e.g. a toaster), a storage system, networking circuitry, structural electrical wiring, and so forth. The task match circuitry 2712 and the task match circuitry 2718 may interoperate with a same or a different proxy, task-offer routing circuitry (not shown), or task host circuitry.

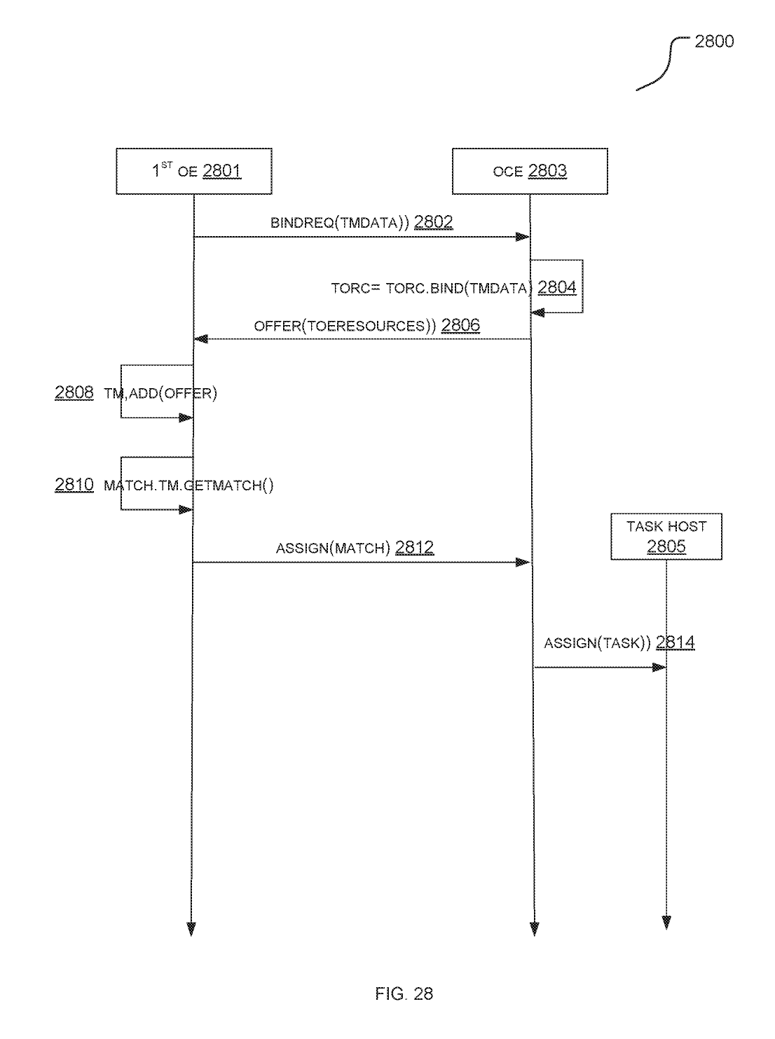

FIG. 28 illustrates a data flow diagram 2800 of data exchanged between or among addressable entities or other parts of a first operating environment 2801 and an offer-based computing environment 2803. Offer-based computing environment 2803, as illustrated, may receive assignments to perform one more tasks from one or more operating environments, such as the first operating environment 2801. In an embodiment, illustrated by data flow diagram 2800, offer-based computing environment 2803 and a node of the first operating environment 2801 may exchange one more messages that registers or otherwise identifies task match circuitry operating in the first operating environment 2801 as a source of task assignments for offer-based computing environment 2803 (see flow 2802). Task match circuitry in the first operating environment 2801 may be included in task coordination circuitry in the first operating environment 2801 or may interoperate with task coordination circuitry operating in offer-based computing environment 2803. The exchange may or may not specify one or more tasks or attributes of tasks that may be matched by task match circuitry in the first operating environment 2801. A particular task may be identified, a type of task may be identified, or resources utilized by one or more tasks assignable by task match circuitry in the first operating environment 2801 may be identified in the exchange 2802. A flow 2804, illustrates data that may be exchanged in offer-based computing environment 2803 to associate task match circuitry in the first operating environment 2801 with circuitry in the offer-based computing environment, such as task-offer routing circuitry, that may operate to send an offer from task host circuitry for receiving by the first operating environment 2801. The data exchange 2802 may include task data received by offer-based computing environment 2803 to select, match, or otherwise identify one or more instances of task-offer routing circuitry. Offer(s) associated with the one or more identified instances of task host circuitry may be identified to the first operating environment 2801 (see flow 2806). Flow 2808 illustrates that data identifying the offer may be queued or otherwise provided to task match circuitry. Flow 2810, illustrates a flow included in matching a task with the offer. A flow 2812 represents an exchange of task data in response to detecting a match between an offer and a task or that otherwise may identify task host circuitry to perform the task. Flow 2814, illustrates a data exchange between task match proxy circuitry or task-offer routing circuitry with task host circuitry 2805 to assigned the task to a task operating environment.

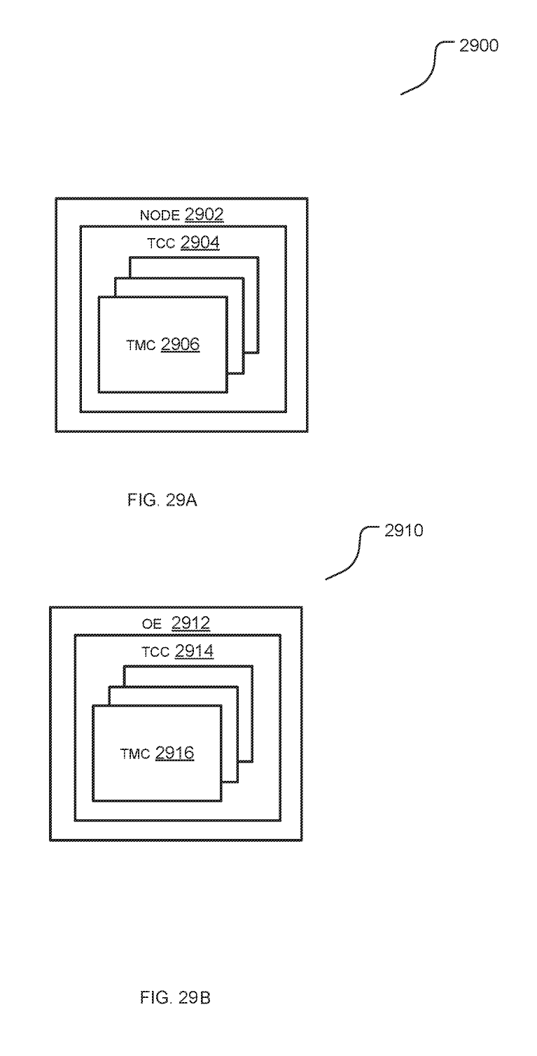

FIG. 29A illustrates an arrangement 2900 that may operate to perform a method of the present disclosure. The arrangement 2900 includes a node 2902 that, in an aspect, is separate from another node, data center, service site, or cloud computing environment included in or that otherwise hosts an offer-based computing environment or a portion thereof. the node 2902 as illustrated includes task coordination circuitry 2904. The task coordination circuitry 2904 may be or may otherwise provide a host operating environment of the node 2902. The task coordination circuitry 2904 may monitor, manage, allocate, or otherwise allow access to task match circuitry 2906. The task match circuitry 2906 in operation matches an offer from task host circuitry with a task of the node 2902.

FIG. 29B illustrates an arrangement 2910 that differs from arrangement 2900 at least in that task coordination circuitry 2914 operates in a host operating environment 2912, whereas in arrangement 2900 the task coordination circuitry 2904 operates as or otherwise provided a host operating environment 2904 of the node 2902. In arrangement 2910, the task coordination circuitry 2914 may operate as an application, a subsystem, or as a virtual operating environment in the operating environment 2912. In an embodiment, the operating environment 2912 may include or may otherwise be hosted by one or more nodes (not shown) that are not nodes of a data center, service site, or cloud computing environment of an offer-based computing environment or a portion thereof. As in arrangement 2900, the task coordination circuitry 2914 may monitor, manage, allocate, or otherwise allow accesses to resource of the operating environment 2912. The task coordination circuitry 2914 may instantiate, monitor, manage, or allow access to task match circuitry 2916. Operating environment 2912 may include some or all of an offer-based computing environment that may assign one or more tasks to task host circuitry 2914 that match an offer from task host circuitry 2914.

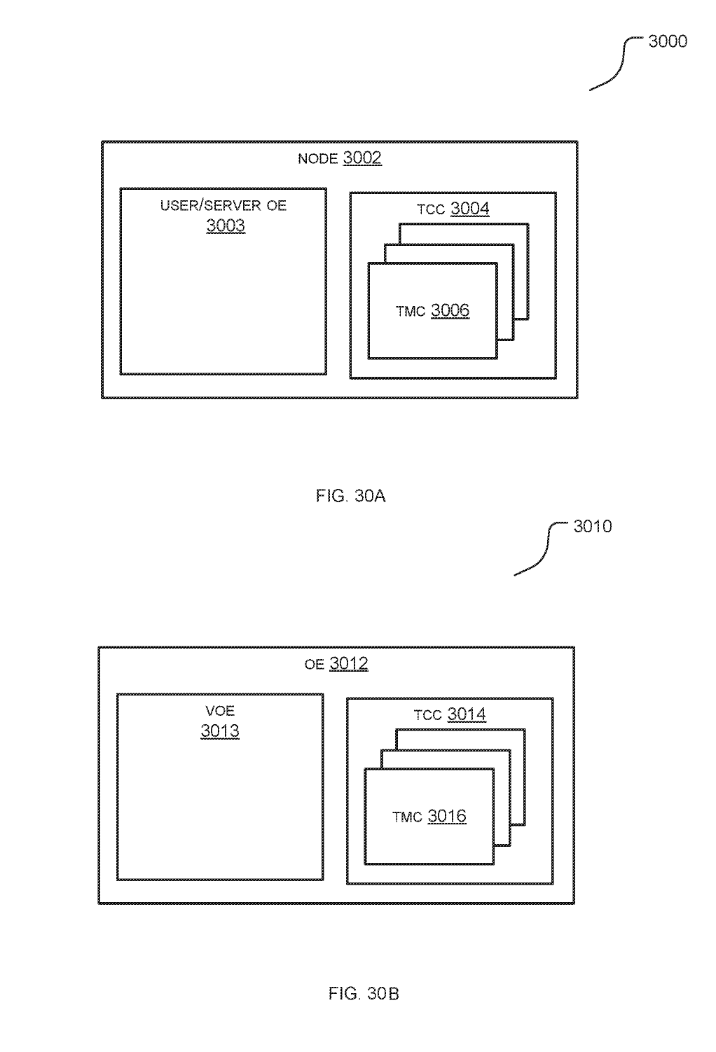

FIG. 30A illustrates an arrangement 3000 similar to arrangement 2900 in FIG. 29A in a node 3002 that hosts another operating environment 3003 in addition to the operating environment provided by the task coordination circuitry 3004. The other operating environment 3003 may be a user operating environment or may be a server operating environment. Node 3002 may host both operating environments simultaneously. Alternatively or additionally, node 3002 may host one of the operating environments during a particular duration. While one operating environment may be operating, the other may be off or in an inactive mode such as sleep mode, a hibernate mode, and the like. When operated at a same time, resources of the node may be allocated to each operating environment. One of the operating environments may control resource allocation, the two operating environments may negotiate for resource access according to configured negotiation polices, or resource allocation may be managed by circuitry not included in either operating environment (e.g. such circuitry may operate in an another operating environment or on hardware of the node 3002 reserved for such purposes. As described with respect to arrangement 2900, task coordination circuitry 3004 may monitor, manage, allocate, or otherwise allow access to one or more instances of task match circuitry 3006. Virtual operating environment 3003 may include some or all of an offer-based computing environment that may assign one or more tasks to task host circuitry 3004 that match an offer from task host circuitry 3004.

FIG. 30B illustrates an arrangement 3010 similar to arrangement 2910 in FIG. 29B in a host operating environment 3012 that may host another virtual operating environment 3013 in addition to the environment provided by the task coordination circuitry 3014. The other virtual operating environment 3013 may be a user operating environment or may be a server operating environment. Operating environment 3012 may host both operating environments simultaneously. Alternatively or additionally, operating environment 3012 may host one of the operating environments during a particular duration. While one operating environment may be operating, the other may be off or in an inactive mode such as sleep mode, a hibernate mode, and the like. When operated at a same time, resources of the node may be allocated to each operating environment. As described with respect to arrangement 2910, task coordination circuitry 3014 may monitor, manage, allocate, or otherwise allow access to one or more instances of task match circuitry 3016. One or both of virtual operating environment 3013 and operating environment 3012 may include some or all of an offer-based computing environment that may assign one or more tasks to task host circuitry 3014 that match an offer from task host circuitry 3014.

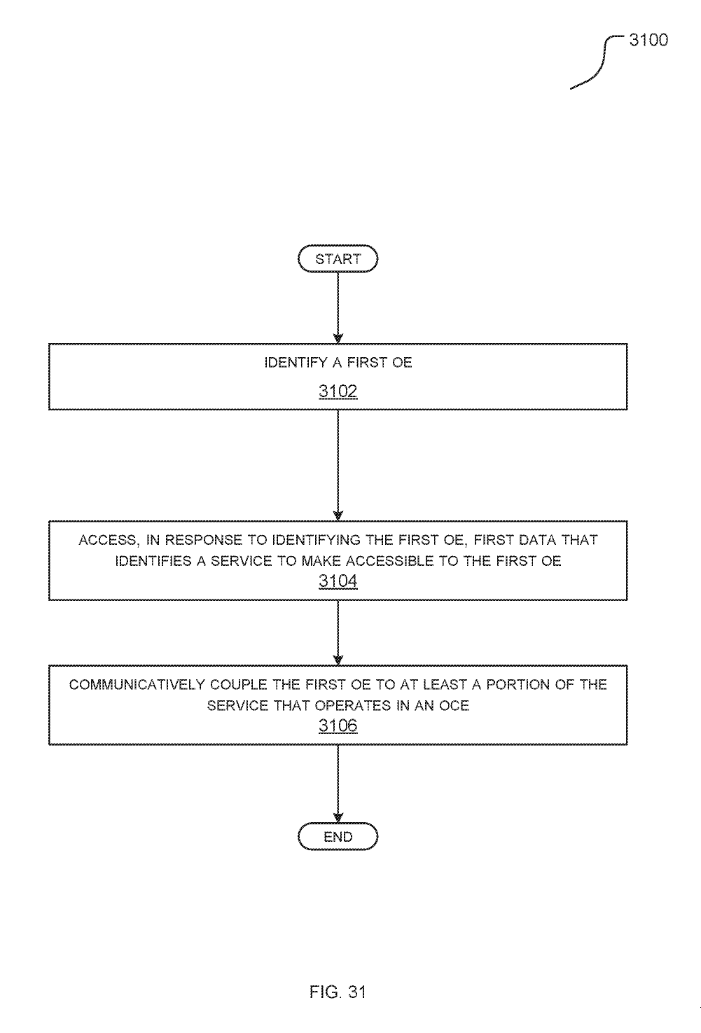

FIG. 31 shows a flow chart 3100 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment or a portion there of including or otherwise hosted by a second node, a service site, a data center, or a cloud computing environment. The system may also include a first operating environment of a first node. In an aspect, the first node is not included in the data center, service site, or cloud computing environment. The first operating environment and the offer-based computing environment may be communicatively coupled via a network. At block 3102, the first operating environment is identified. The first operating environment may be identified by the first operating environment or by the offer-based computing environment. The first operating environment may operate at least partially in the first node and at most partially in another node. The other node may be a node included in or otherwise hosting some or all of the offer-based computing environment. In an embodiment, a portion of the first operating environment may operate in the offer-based computing environment. The portion operating in the offer-based computing environment may be virtualized and may operate in an operating environment provided by the offer-based computing environment. The operating environment provided by the offer-based computing environment include a virtual operation environment, a virtual machine, a container, task host circuitry, a task operating environment, task match circuitry, or task coordination circuitry. At block 3104, first data may be accessed in response to identifying the first operating environment. The first data may identify a service to make accessible to or to otherwise be a part of the first operating environment. At block 3106, at least a portion of the service is operated in the offer-based computing environment. A communicative coupling may be established between the node and some or all of the service operating in the offer-based computing environment.

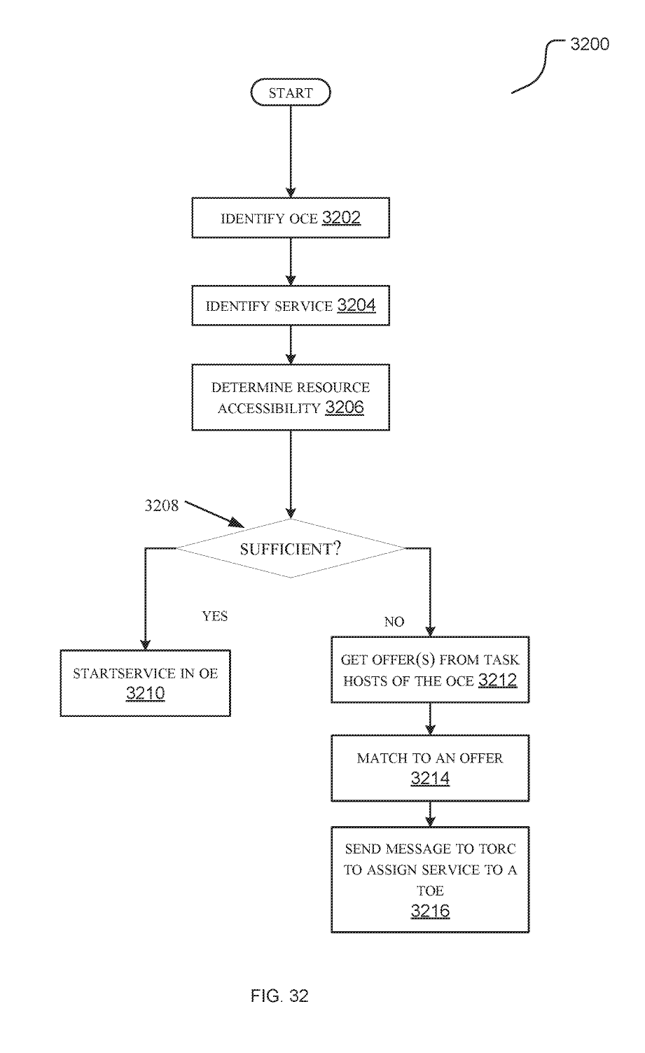

FIG. 32 shows a flow chart 3200 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 3202, an offer-based computing environment may be identified. In an embodiment, an operating environment of a node may identify an offer-based computing environment or a portion thereof. The identifying may be performed by the offer-based computing environment or by a first operating environment. The offer-based computing environment and the first operating environment may be communicatively coupled via a network. The identity of the offer-based computing environment may be configured in the first operating environment, received in response to user interaction between a user and the first operating environment, received in an exchange of data between the first operating environment and the offer-based computing environment, received from another node such as directory service node, or received in response to a search—to name some examples. At block 3204, a service may be identified to provide for the first operation environment. The service may be identified to be included in the first operating environment. The service may be accessed by a portion of the first operating environment or may be provided by the first operating environment as a resource accessible to an application or other circuitry hosted by the first operating environment. At block 3206, a determination may be made regarding the accessibility of a resource accessed or otherwise utilized in providing the service. In an embodiment, an amount of the resource or a performance attribute of the resource, to name just two examples of attributes of the service, may be determined. At decision block 3208, a determination may be made as to whether the resource may be sufficiently accessible based on the determination made in block 3206. If it is determined that the resource is sufficiently accessible, control passes to block 3210 where the service may be started or may otherwise continue to operate in the first node of the first operating environment. Otherwise control passes to block 3212 in which one or more offers are received that are associated with one or more instances of task host circuitry of the offer-based computing environment. At block 3214, a received offer may be matched to or otherwise selected for a task that may operate to provide the service. At block 3216, a message may be sent to the offer-based computing environment to execute the task circuitry in a task operating environment of task host circuitry associated with the matched or selected offer. The task circuitry operates in performing the service. At least part of the service operates in the task operating environment of the task host circuitry via the execution of the task circuitry.

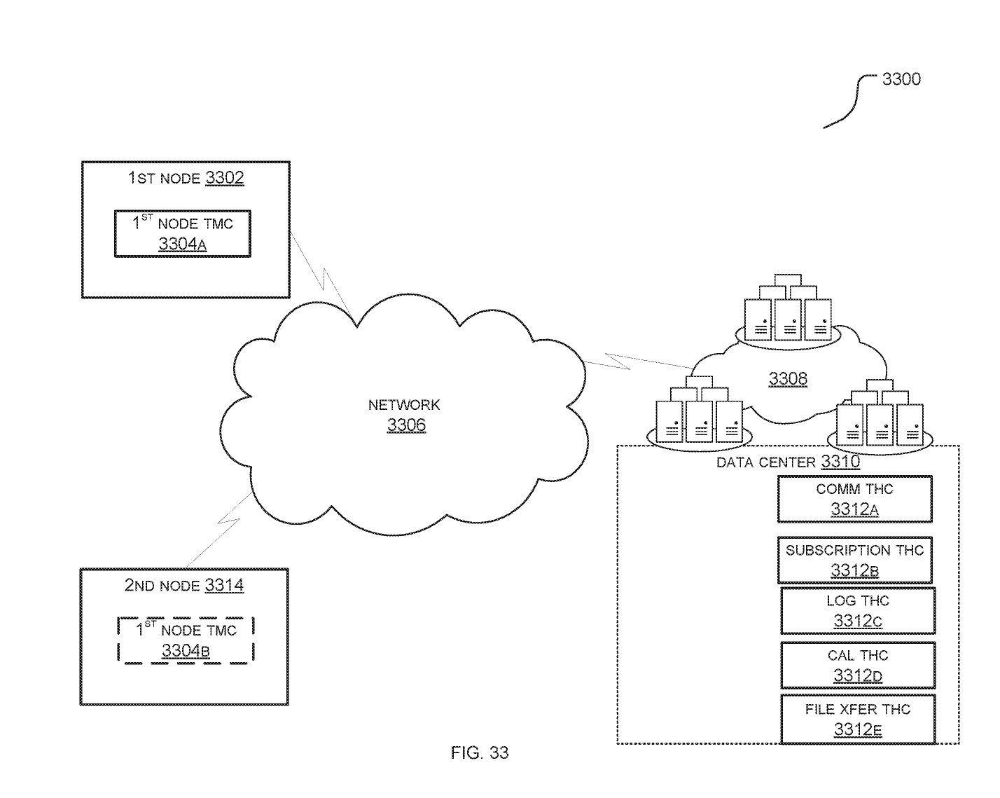

FIG. 33 shows a system 3300 that may operate to perform one or more methods of the subject matter of the present disclosure. FIG. 33 shows that system 3300 includes a first node 3302 that hosts or that may be otherwise included in a first operating environment. First node task match circuitry 3304a may be hosted by the first node 3302 or may otherwise operate in the first operating environment of the first node 3302. First node task match circuitry 3304a may operate in or may be accessible to one or more instances of task coordination circuitry (not shown). In response to determining that access to a resource utilized in providing a service of the first operating environment is insufficient according to a specified criterion, a task included in providing the service may be identified to the first node task match circuitry 3304a along with resource data that may identify the resource utilized in performing the task. An offer may be received via a network 3306 from an offer-based computing environment 3308. The offer-based computing environment may include or may otherwise be hosted by a node other than the first node 3302, a service site, a data center 3310 (as illustrated in FIG. 33), or a cloud computing environment. The offer may be received from task host circuitry 3312 suitable for executing task circuitry that performs the identified task. FIG. 33 illustrates a number of instances of task host circuitry for performing different types of tasks based on resource(s) utilized by respective task circuitry that may operate to perform each task for a type of service. Communication task host circuitry 3312a illustrates circuitry that performs one or more tasks that access a network interface, as a resource, to send or receive data via a network (real or virtual). Subscription task host circuitry 3312b illustrates circuitry that provides access to resource(s) utilized in at least some part of a subscription service. Log task host circuitry 3312c illustrates circuitry that performs one or more tasks that access a log, as a resource, when performed or that otherwise provides at least some part of a logging service. Calendar task host circuitry 3312d illustrates circuitry that performs one or more tasks that access a calendar, as a resource, or that otherwise provides at least some part of a calendar or scheduling service. File transfer task host circuitry 3312a illustrates task host circuitry that performs one or more tasks that access a file transfer protocol, as a resource, or that otherwise provides at least some part of a file transfer service. FIG. 33 also illustrates that system 3300 may include a second node 3314 that hosts or that may be otherwise included in a second operating environment (not shown). First node task match circuitry 3304b may optionally be hosted by the second node 3314 or may otherwise operate in the second operating environment of the second node 3314 rather than the first node 3304a. In an aspect, an instance of task match circuitry 3304 may operate partially in each of the first node 3302 and the second node 3314. In response to determining that access to a resource utilized in providing a service of the first operating environment of the first node 3302 may be insufficient according to a specified criterion, a task included in providing the service of the first operating environment may be identified to the first node task match circuitry 3304b in the second node 3314 along with resource data that may identify the resource utilized in performing the task. An offer may be received via a network 3306 from the offer-based computing environment 3308. The offer may be received from task host circuitry 3312 suitable for operation of task circuitry that performs the identified task in providing a corresponding service for the first operating environment of the first node 3302. In one scenario. task match circuitry may be utilized to initiate or maintain the operation of tasks that provide a service of the first operating environment when the first node is without power, has insufficient resources, is not connected to the network 3306, or is otherwise unable to communicate with the offer-based computing environment.

In an embodiment, circuitry may be provided that may be operable for use with an offer-based computing environment. The circuitry may operate to identify a first operating environment. The circuitry may additionally operate to access first data that may identify a service to make accessible to the identified first operating environment. The circuitry may also operate to bind an instance of the service that operates in the offer-based computing environment to the first operating environment allowing the instance and the operating environment to exchange data via a network (e.g., the Internet, a LAN, etc.).

In an embodiment, circuitry may be provided that may be operable for use with a first operating environment. The circuitry may operate to receive first data that may identify an offer-based computing environment. The circuitry may operate in the first operating environment to exchange second data, via a network, between an instance of the service operating in the identified offer-based computing environment. In an aspect, the instance is not a service of any operating environment other than the first operating environment.

Circuitry may also be generated to operate in the first operating environment where when executed the first operating environment may request the service. The offer-based computing environment may provide the service based on the first operating environment, a type or version of an operating system in the first operating environment, hardware in a node of the first operating environment, a user of the first operating environment, a resource in the first operating environment or in the node, a resource missing or otherwise inadequate for the first operating environment or for the node of the first operating environment, a user of the first operating environment, an organization, a location of the first operating environment, a location of a user of the first operating environment, a location of a node of the first operating environment, and so on. In an aspect, a portion of the service presents a user interface to a user of the first operating environment operates in a user node of the first operating environment and a portion of the service that does not present the user interface to the user of user node operates in the offer-based computing environment. In another aspect, some of all of the service may operate in a second node, a server, a service site, a data center, or a cloud computing environment of the offer-based computing environment when the power or energy accessible to the user node meets a specified condition. Such a condition may be based on a threshold amount of energy available to the user node, a source of the energy (e.g. a battery or an electricity grid), a rate at which energy may be used by the user node or in particular by the service. Some or all of the service may operate in a second node, a server, a service site, a data center, or a cloud computing environment of the offer-based computing environment when the node is in a specified geospatial location. Where the service or a portion of the service operates may be based on a temperature of a node (e.g. The node or entity affected by heat from the node may need more or less heat), processor utilization, a peripheral accessible to the node, a cost of energy or other resource, and a security attribute of the node—to name some examples. In one scenario, a threat level for the node, an operating environment of the node, or other portion of the node may be detected. Some or all of a service, application, computing process, thread, operating environment of the node, a VOE, and the like may operate in a second node, a server, a service site, a data center, or a cloud computing environment of an offer-based computing environment or not based on the type, level, geospatial location, date, time, or other attribute of the detected threat. A service or part of service may operate in a second node, a server, a service site, a data center, or a cloud computing environment of an offer-based computing environment when it is not being utilized or access to the service may be infrequent or otherwise low (absolutely or relatively) according to an identified measure or other type of indicator. A service or part of service may operate in a second node, a server, a service site, a data center, or a cloud computing environment of an offer-based computing environment when it may be shared with another node or another operating environment. For example, some or all of a service, application, or task may be transferred or imitated to operate on a second node, a server, a service site, a data center, or a cloud computing environment of an offer-based computing environment for a multi-player game, a communication between two or more communicants, a shared work space, a co-browsing session, and the like. A service or part of service may operate in a second node, a server, a service site, a data center, or a cloud computing environment of an offer-based computing environment based on a scheduled use of the service, application, or task. The schedule may be user specified, preconfigured, or determined automatically based on past usage or usage of the service by or in another node. A service or part of a service may operate in a second node, a server, a service site, a data center, or a cloud computing environment of an offer-based computing environment based on an operational mode of the first node or the first operating environment. For example, at least a portion of an application, service, or task may be transferred to or otherwise operate in a second node, a server, a service site, a data center, or a cloud computing environment of an offer-based computing environment when the first node, a portion of the first node (e.g. a network adapter), or the first operating environment is in a sleep state, hibernate state, or other low power state. Otherwise the at least a portion may operate in the first node, the portion of the first node, or the first operating environment.

Exemplary services, applications, or tasks that may be performed for an operating environment of node in an offer-based computing environment, in whole or in part, rather than in the operating environment include logging, error reporting, maintenance, monitoring, software updates, firewall, malware protection, authentication and access control, backup, network service, directory service (e.g. a DNS or DHCP client), and the like. Further hibernated processes, sleeping processes, page file/swap space, data caches, virtual address spaces, and the like may all be extended to or transferred for hosting by a second node, a server, a service site, a data center, or an offer-based computing environment.

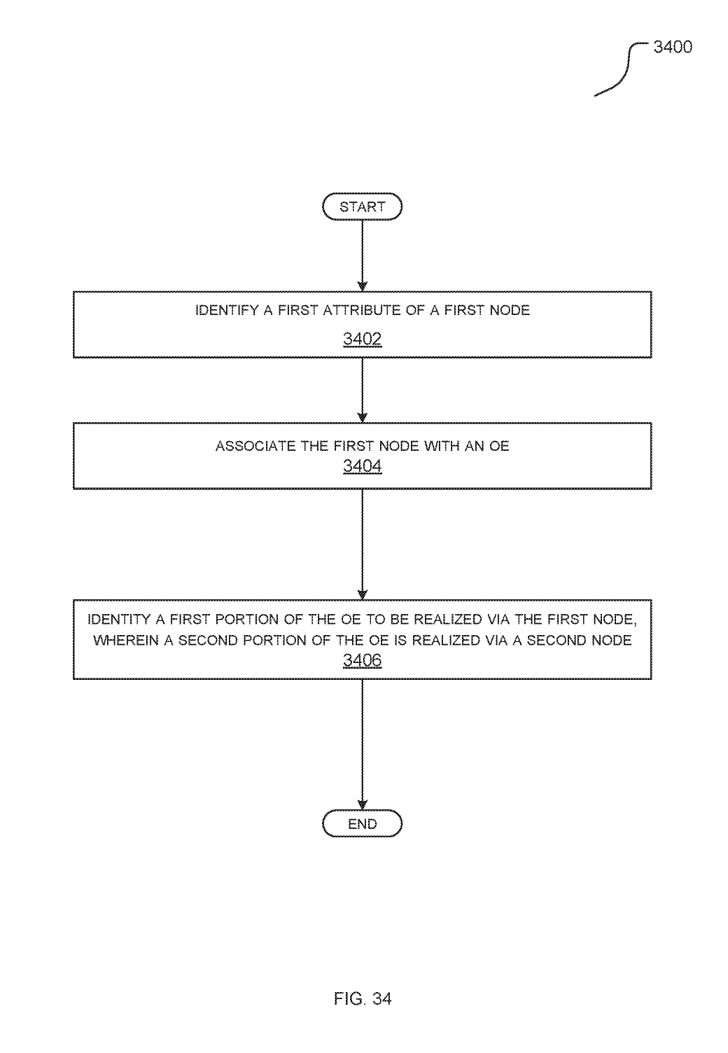

FIG. 34 shows a flow chart 3400 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include a first node and a second node each communicatively coupled to a network. At block 3402, a first attribute of the first node may be identified. At block 3404, an operating environment may be associated with the first node. The operating environment may be associated with the first node based on the first attribute or based on one or more other attributes of the first node or the second node. At block 3406, a first portion of the operating environment may be identified, based on the first attribute, to be included or otherwise provided by the first node. A second portion of the operating environment may be included in or otherwise provided by the second node. The second portion may be determined based on the first portion, an attribute of the first node, or an attribute of the second node. In an embodiment, the second node may be included in a data center of an offer-based computing environment. The second node may be included in a plurality of nodes that include or provide a portion of the operating environment at the same time or at various times. The operating environment may be scalable to include additional nodes as needed or as configured. The second node may be selected from the plurality based on an account of the operating environment, a user, a location of the first node or the second node, a hardware resource of the first node or a hardware resource of the second node, an owner of one or both of the nodes, an administrator or one or both of the nodes, a task to be performed by one of the nodes for the other, a task to be performed by both nodes, and a task that when performed accesses a resource included in one node and a resource included in the other where one or the other resource may be not accessible without one of nodes—to name a few examples. The second portion may include a task matched to a task operating environment based on a resource utilized in performing the task and a resource accessible to the task operating environment.

The method of flow chart 3400 may be extended in various embodiments by performing one or more additional operations. In an embodiment, an operation may be performed to communicatively coupled the first portion of the operating environment and the second portion, so a task may be performed by task circuitry operating partially in the first portion and partially in the second portion. A computing process may be instantiated and executed that includes a first thread that executes in the first portion and a second thread that operates in the second portion. Task match circuitry or task coordination circuitry of the operating environment may determine whether to assign a thread to be executed by a processor in the first portion or a processor in the second portion based on a measure of resource accessible in the first portion or based on measure of a resource accessible in the second portion. A task may be performed in one of the first portion and the second portion based on a security attribute of the task. The attribute may be required, indicated as an optional, identified as an alternative to attribute, or may be identified as a preferred attribute. A process or thread executed by a processor in one of the first portion and the second portion may be suspended and assigned to a process of the other one of the first portion and the second portion to continue operation. An interprocess communication (IPC) mechanism may exchange data between the first portion and the second portion. The IPC mechanism may include a pipe, a semaphore, a lock, a hardware signal, an interrupt, a shared location in a processor memory, a socket, or any IPC accessible to the operating environment. A first address in virtual address space that defines a virtual processor memory may be mapped to a location in a first physical memory device of the first node and a second address in a virtual address space that defines the same virtual processor memory may be mapped to a location in a second physical memory device of the first node. The first portion and the second portion may both access a same physical memory device. The first node may be a user node and the user may be authenticated via the second portion of the operating environment. In an embodiment, the first portion and the second portion may be modified based on a change in a resource accessible in one or both of the first node and the second node. In an embodiment, as accessible energy or another resource changes in the first node, more or less of the operating environment or more or less process may be moved to the second node. Threads of a computing process may be assigned, moved, created, or terminated based on a change in a resource accessible in a portion of the operating environment.

A first portion of an operating environment may include a first portion of an operating system. The second portion of the operating environment may include a second portion of the operating system. A first portion of an operating environment may include a first operating system, such as WINDOWS or a particular version of WINDOWS, and the second portion may include a second operating system, such LINUX or a different version of WINDOWS.

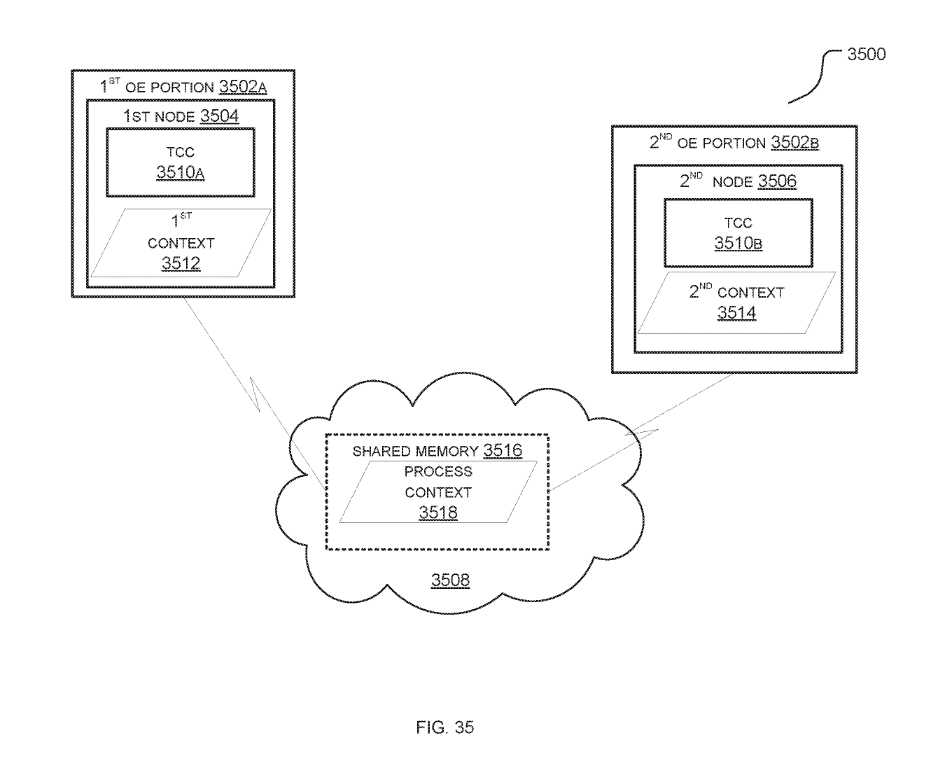

FIG. 35 shows a system 3500 that may operate to perform one or more methods of the subject matter of the present disclosure. FIG. 35 shows that system 3500 includes an operating environment 3502 where a first portion 3502a of the operating environment includes or otherwise may be hosted by a first node 3504. A second portion 3502b of the operating environment includes or otherwise may be hosted by a second node 3506. The first portion 3502a and the second portion 3502b may interoperate via a network, such as a WAN or LAN. In an aspect, the first portion 3502a and the second portion 3502b may interoperate via an offer-based computing environment 3508 which may include a private physical network, a virtual network, a bus, or a switching fabric. In an embodiment, operating environment 3502 may include computing processes which may include one or more threads. A thread scheduler may operate in the operating environment 3502 to schedule thread execution and assign thread execution to a one portion of the operating environment 3502 or the other. In an embodiment, illustrated in FIG. 35, task match circuitry or task coordination circuitry 3510 may be included in one or both portions to schedule threads, as tasks, of the computing processes. Other types of tasks may also be ordered, scheduled, coordinated, or otherwise managed by the task coordination circuitry 3520. Alternatively or additionally, operating environment 3502 may operate based on tasks, allowing any threads to be scheduled by a different scheduler such as thread schedulers in present day operating systems such as Linux, iOS, Android, and Windows. Sub-tasks of a task may be performed sequentially or in parallel. A process may have a process context, a thread may have a thread context, and a task may have a task context whether it is a top level task or a sub-task. FIG. 35 illustrates a first context 3512 maintained in the first portion 3502a of the operating environment and a second context may be maintained by a second portion 3502b of the operating environment. A shared memory 3516 may be included in binding or otherwise enabling data to be exchanged between the first portion 3502b and the second portion 3502b. Data may be exchanged, based on the share memory 3416, via a pipe, a stream, a semaphore, a lock, a signal, and the like. The shared memory may be included in a persistent storage device or may be stored in a volatile memory. The memory may be accessed via one or more processor address spaces. Offers or task data may be exchanged via the shared memory 3516. FIG. 35, illustrates that a process context 3518 may be shared between the first portion 3502a and the second portion 3502b. In an aspect, a first thread of a process having the process context 3518 may operate in the first portion 3502a. The first thread may have a thread context, illustrated by first context 3512. A second thread of the process having the process context 3518 may operate in the second portion 3502b. The second thread may have a thread context, illustrated by second context 3514.

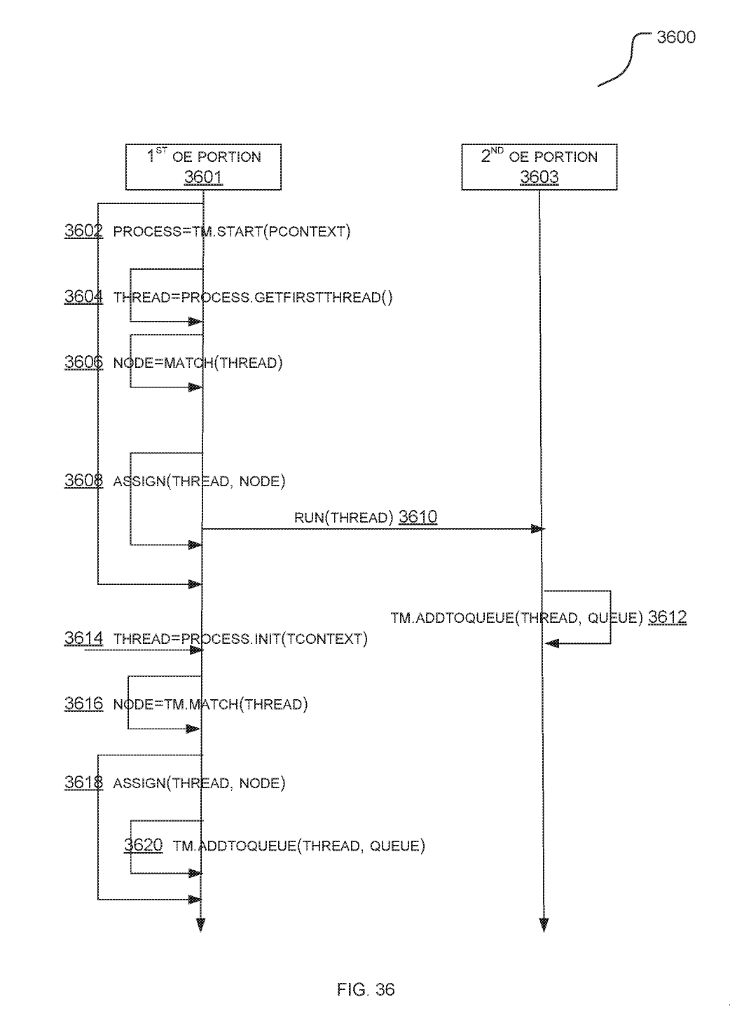

FIG. 36 illustrates a data flow diagram 3600 of data exchanged between or among addressable entities or other parts of a first operating environment portion 3601 and a second operating environment portion 3603. Flow 3602 illustrates a flow of data included in creating a computing process to execute in an operating environment that includes the first operating environment portion 3601 and the second operating environment portion 3603. Flow 3604 is illustrated as included in flow 3602 and in which a first thread of execution may be created as a part of creating the computing process. In flow 3606, the thread or a portion of the thread may be identified as a task that utilizes one or more resources when performed. Data may be exchanged or processed in flow 3606 to match the thread with an offer from task host circuitry in that operates in the second operating environment portion 3603, at least in part. Based on matching the thread to an offer, data may be exchanged in flow 3608 to assign the thread to task host circuitry. In an embodiment, assigning the thread to task host circuitry may include associating the thread with a node, as flow 3608 illustrates. FIG. 3600 illustrates a scenario where the thread/task may be assigned to be performed in the second operating environment portion 3603. Flow 3610, illustrates an exchange of data between the first operating environment portion 3601 and the second operating environment portion 3603 to assign the thread to be performed or at least initiated in the second operating environment portion 3603. Flow 3612, illustrates a flow of data included in placing the thread/task in a queue indicating that it may be ready for execution when a task operating environment of task host circuitry that provides the resource(s) utilized by the thread/task may be available. In an embodiment, an offer may be sent for a task operating environment that may be reserved or otherwise available for a matched task. In an embodiment, an offer may be provided for a task operating environment that may be not currently reserved or otherwise not currently, but will be available. Tasks may be queued or otherwise placed in a state compatible with waiting for the task operating environment. In flow 3614, a second thread may be created for the process in the first operating environment portion 3601. In flow 3616, the second thread or a task included in the second thread may be matched with an offer from task host circuitry that operates in the first operating environment portion 3601 or at least begins execution in the first operating environment portion 3601. Data may be exchanged in flow 3618 to assign the thread to the task host circuitry of the first operating environment portion 3601. Flow 3620 illustrates a flow of data included in placing the thread task in a queue indicating that it may be ready for execution when a task operating environment of the task host circuitry that provides the resource(s) utilized by the thread may be available.

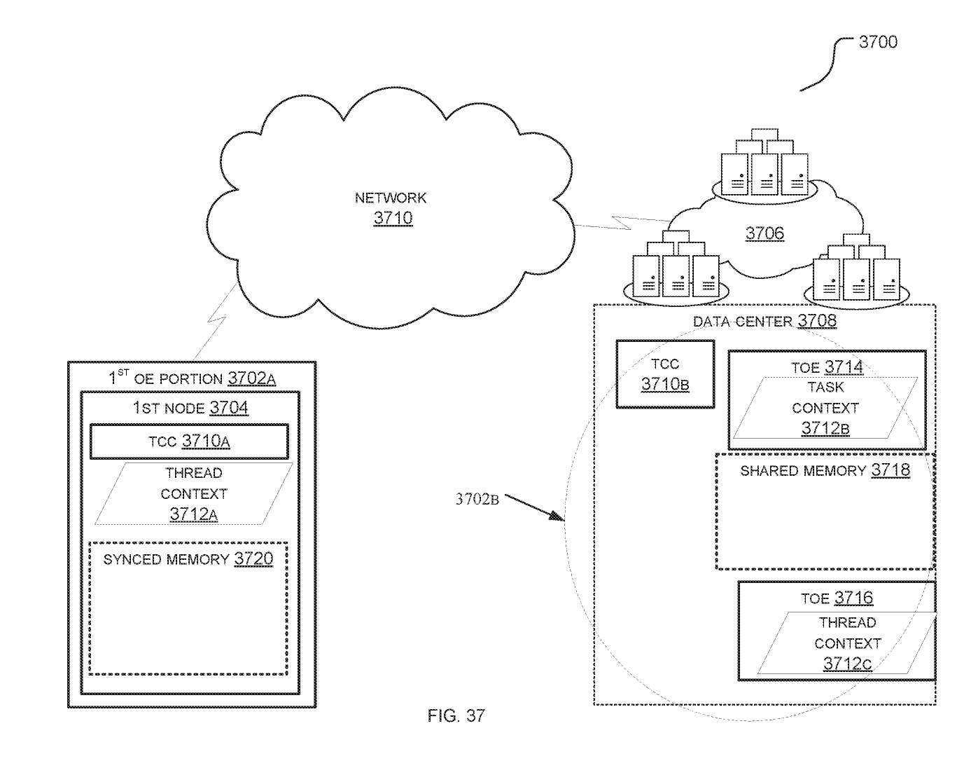

FIG. 37 shows a system 3700 that may operate to perform one or more methods of the subject matter of the present disclosure. FIG. 37 shows that system 3700 includes an operating environment 3702 where a first portion 3702a of the operating environment 3702 includes or otherwise may be hosted by a first node 3704. A second portion 3702b of the operating environment 3702 includes or otherwise may be hosted by an offer-based computing environment 3706. The offer-based computing environment 3706, FIG. 37, includes or otherwise is hosted by a data center 3708. As describe herein, analogs or equivalents of system 3700 may include an offer-based computing environment hosted by a node other than the first node 3704, a service site, or other grouping of nodes. The first portion 3702a and the second portion 3702b interoperate via a network 3710. In an embodiment, operating environment 3702 may include computing processes which may include one or more threads. Task match circuitry or task coordination circuitry 3710 may be included in one or both portions to coordinate tasks. Alternatively or additionally, operating environment 3702 may operate based on threads. Task coordination circuitry 3710 may be included in one or both portions or multiple instances of task coordination circuitry may be included in operating environment 3702. A process may have a process context, a thread may have a thread context, or a task may have a task context. FIG. 37 illustrates a context 3712 for an application. The context 3712 may include a thread context 3712a for a thread that executes in an operating of the application. The context 3712 may, alternatively or additionally, include a task context 3712b for one or more tasks that operate in a task operating environment 3714 as part of the application in the operating environment 3702. A thread context 3712c shows that a thread may operate as a task in a task operating environment 3716 with another thread context 3712c. Operating environment 3702 may include a memory 3718 accessible to the first operating environment portion 3702a and to the second portion 3702b. Shared memory 3718 may be included in exchanging data between or among various threads or tasks of the application. In an embodiment, memory or data may be shared via synchronization, illustrated by synced memory 3720 in the first operating environment portion 3702a which may be synchronized with memory 3718 or a portion thereof.

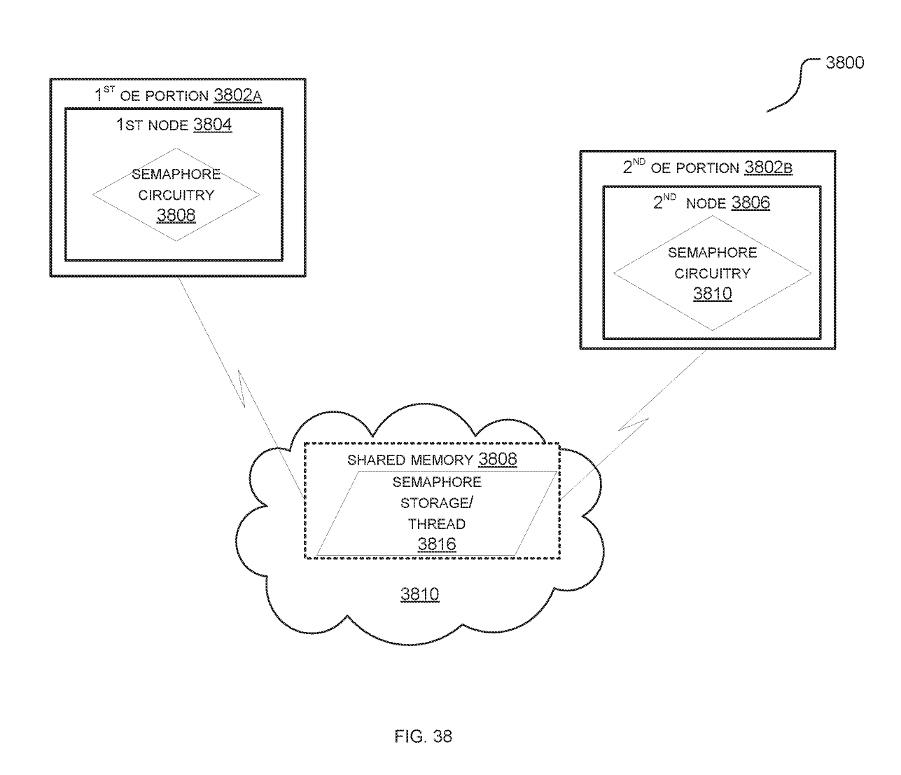

FIG. 38 shows a system 3800 that may operate to perform one or more methods of the subject matter of the present disclosure. FIG. 38 shows that system 3800 includes an operating environment 3802 where a first portion 3802a of the operating environment 3802 includes or otherwise may be hosted by a first node 3804. A second portion 3802b of the operating environment 3802 includes or otherwise may be hosted by a second node 3806. The first portion 3802a and the second portion 3802b interoperate via one or more resources, shown as or including shared memory 3808 in node in a network 3810. The first node 3804 may be a client node, such as laptop, a smartphone, a wearable device, a home appliance, an automotive vehicle, or an IoT device. The second node 3806 may in a service site or an offer-based computing environment. The service site or the offer-based computing environment may each be included in or may otherwise may be at least partially hosted by a data center. In an embodiment, circuitry operating in the first portion 3802a of the operating environment 3802 may interoperate with circuitry operating in the second portion 3802b of the operating environment 3802 via a semaphore. The semaphore may be implemented using the shared memory 3808 or shared circuitry (not shown) via which the semaphore memory may be accessed. Access to the shared circuitry may be serialized (e.g. it may be restricted to running in a single thread and or may be executed serially by a task operating environment or task host circuitry). Alternatively or additionally, access to the semaphore memory may be serialized. Circuitry in one portion of the operating environment may be allowed access to the semaphore while operation of circuitry in the other portion may be paused. Access to the semaphore may be serialized via queuing access attempts for the semaphore using any suitable queuing algorithm such as a first-in first-out queue or a priority based queue.

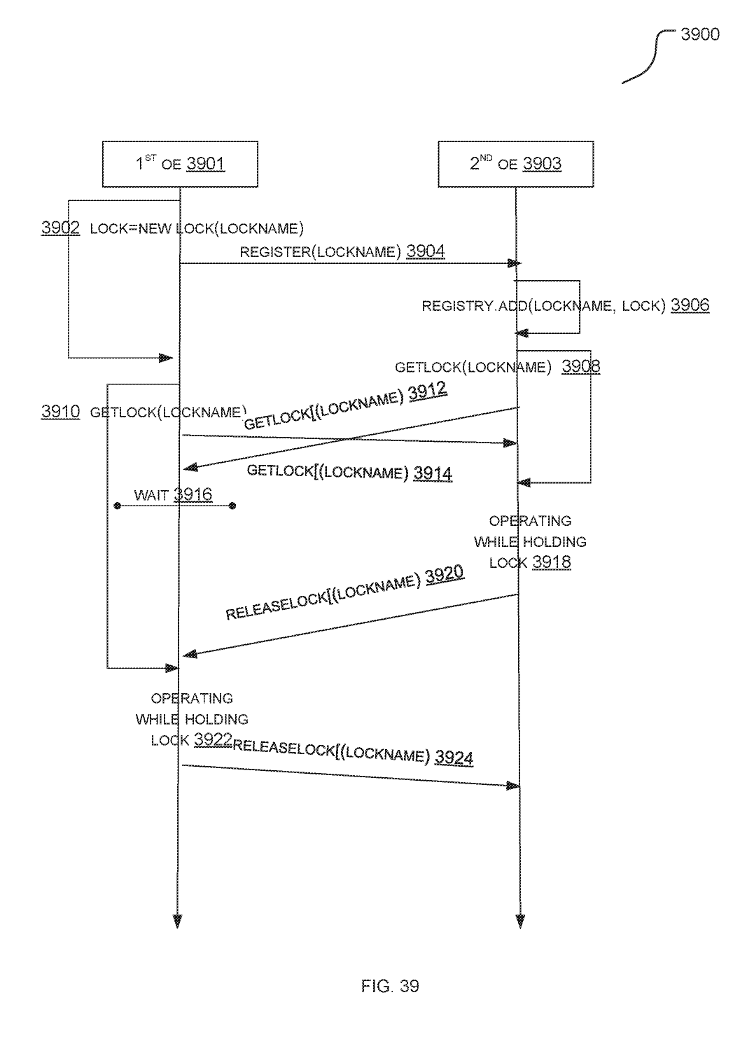

FIG. 39 illustrates a data flow diagram 3900 of data exchanged between or among addressable entities or other parts of a first operating environment 3901 and a second operating environment 3903, which as illustrated may include or may otherwise operate in an offer-based computing environment. In an alternative embodiment, an analogous flow may occur between a first portion of an operating environment that includes or may be otherwise hosted by a first node and a second portion of the same operating environment that includes or may be otherwise hosted by a second node. Flow 3902 illustrates a flow of execution or data within the first operating environment 3901 to create a new serialization mechanism, such as lock or semaphore as FIG. 39 illustrates. Flow 3904 is illustrated as included in flow 3902 in which the new lock may be identified to the operating environment 3903. In another embodiment, a flow analogous to flow 3904 may occur after or in response to flow 3902. In flow 3906, data may be stored to make the new lock accessible to the operating environment 3903. For example, the lock may be added to a database or registry of operating environment 3903. In an embodiment, access to the lock may be restricted to one or more threads, tasks, computing processes, or circuitry of one or more specified hardware parts or systems of each of the first operating environment 3901 and the second operating environment 3903. For example, information for accessing the lock may be added to a thread context or to a task context. Flow 3908, illustrates a flow initiated within the second operating environment 3903 to obtain the lock to enforce an access policy for a resource associated with the lock. Prior to obtaining the lock, a flow 3910 may be initiated within the first operating environment 3901 at a same time, before, or after flow 3908. Both flow 3908 and flow 3910 are initiated before the lock may be granted to either the first operating environment 3901 or the second operating environment 3903. To ensure the access policy, such as a policy that the lock can be held by only one thread, process, or task during any given duration, an exchange of messages between the first operating environment 3901 and the second operating environment 3903 is illustrated that may be transmitted according to a specified synchronization protocol. FIG. 39 illustrates a flow 3912 initiated by the second operating environment 3903 that notifies the first operating environment 3901 of the request for the lock in flow 3908. The flow 3912 may be initiated prior to receiving data by the second operating environment 3903 via a flow 3914 indicating the request for the lock by the first operating environment 3901. In an embodiment, time data, which may identify a time for each lock request, may be identified in each of flow 3912 and flow 3914. The synchronization protocol or a policy may grant the lock to the first requestor according to the respective identified times. A flow 3916 illustrates a thread, task, process, etc. that accesses a resource associated with the lock may be suspended, paused, or otherwise placed in state where it waits for the lock. In an embodiment, each requestor may be assigned a priority and the lock may be assigned based on the respective assigned priorities of the lock requestors. While the lock requestor in the first operating environment 3901 waits, the lock requestor in the second operating environment 3903 may be in an executing state and may access a resource associated with the lock. See flow 3918. In flow 3920, a data exchange occurs between the second operating environment 3903 and the first operating environment 3901 that indicates a release of the lock. The requestor in the first operating environment 3901 may be granted access next or may be left to wait while the lock may be granted to another requestor (not shown), In a response to flow 3920, the requestor in the first operating environment may be given access to the lock and may access the resource associated with the lock while operating (see flow 3922). When the lock requestor in the first operating environment 3901 releases the lock, flow 3924 illustrates a data exchange between the first operating environment 3901 and the second operating environment 3903 that may identify the lock as available.

While FIG. 39 illustrates a lock or semaphore as an IPC mechanism shared between or amount nodes; an interrupt, a queue, a stack, a socket, a pipe, or other IPC mechanism may be shared as those skilled in the art will realize based on the Figures and descriptions of the present disclosure. For example, a first address in virtual address space that defines a virtual processor memory may be mapped to a location in a first physical memory device of the first node and a second address in a virtual address space that defines the same virtual processor memory may be mapped to a location in a second physical memory device of the first node.

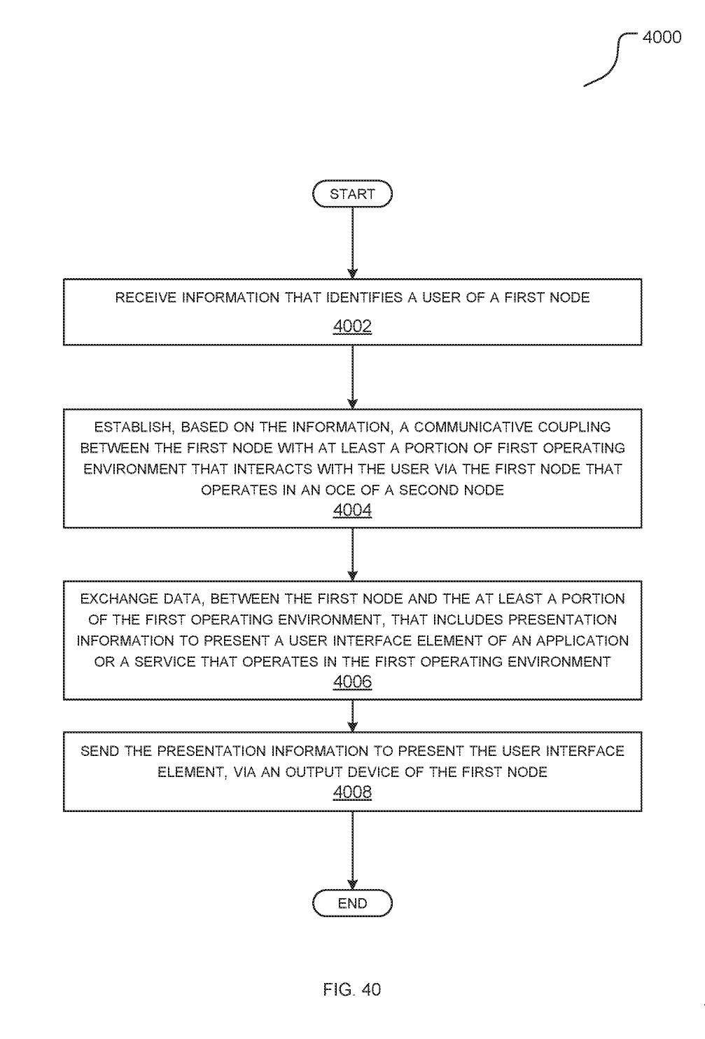

FIG. 40 shows a flow chart 4000 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 4002, information may be received that may identify a user of a first node. Alternatively or additionally, a first operating environment of the first node may be identified, a peripheral device of the first node may be identified, a type of the first node may be identified, a capability of the first node may be identified, and the like. At block 4004, a communicative coupling may be established or otherwise identified based on the received information. The communicative coupling allows a data exchange between the first node and at least a portion of the first operating environment included in or otherwise hosted by a second node. The second node may be included in a service site, a data center, a cloud computing environment, or other grouping of devices. The at least a portion may operate in an offer-based computing environment of the second node. In an embodiment, a first portion of the first operating system may operate in the first node. The at least a portion may be a second portion. At block 4006, data may be exchanged between the first node and the second node via the communicative coupling. In an embodiment, the data may be exchanged between the first portion of the operating environment and the second portion of the operating environment. The data may include presentation information to present a user interface element an application, computing process, thread, task, or other circuitry in or hosted by the first operating environment. At block 4008, the presentation information is sent or otherwise made accessible for presenting the user interface element, via an output device, of the first node.

In a variant of the method of flow chart 4000, the first operating environment may be an operating environment of a peripheral device of the first node.

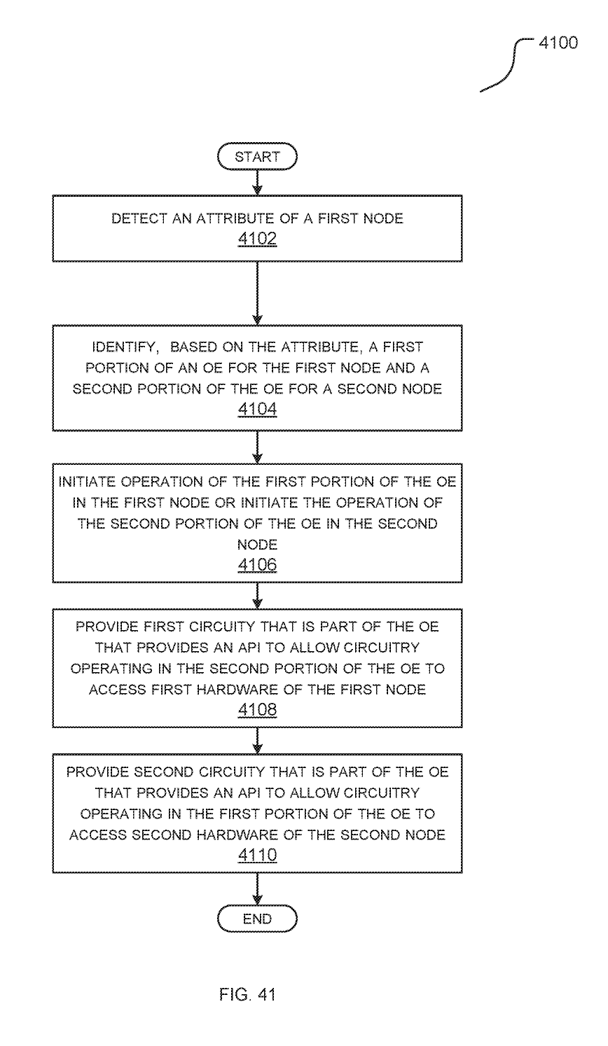

FIG. 41 shows a flow chart 4100 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include a first portion of an operating environment that includes or otherwise may be hosted by a first node and a second portion of the operating environment that includes or otherwise may be hosted by a second node. One or both nodes may each be included in respective service sites, a data centers, cloud computing environments or offer-based computing environments. At block 4102, an attribute of the first node may be detected. (e.g. a peripheral device, a device connected to the second node via the first node, a user of the first node, a capability of the first node, etc.). At block 4104, the first portion of the operating environment may be identified based on the attribute and the second portion of the operating environment may be identified based on the attribute. At block 4106, operation of the first portion of the operating environment may be initiated in the first node or operation of the second portion of the operating environment may be initiated in the second node. At block 4108, first circuitry may be provided in the operating environment that provides access to first hardware of the first node. The first circuitry may be accessible to circuitry operating in the second portion of the operating environment. At block 4110, second circuitry may be provided in the operating environment that provides access to second hardware of the second node. The second circuitry may be accessible to circuitry operating in the first portion of the operating environment.

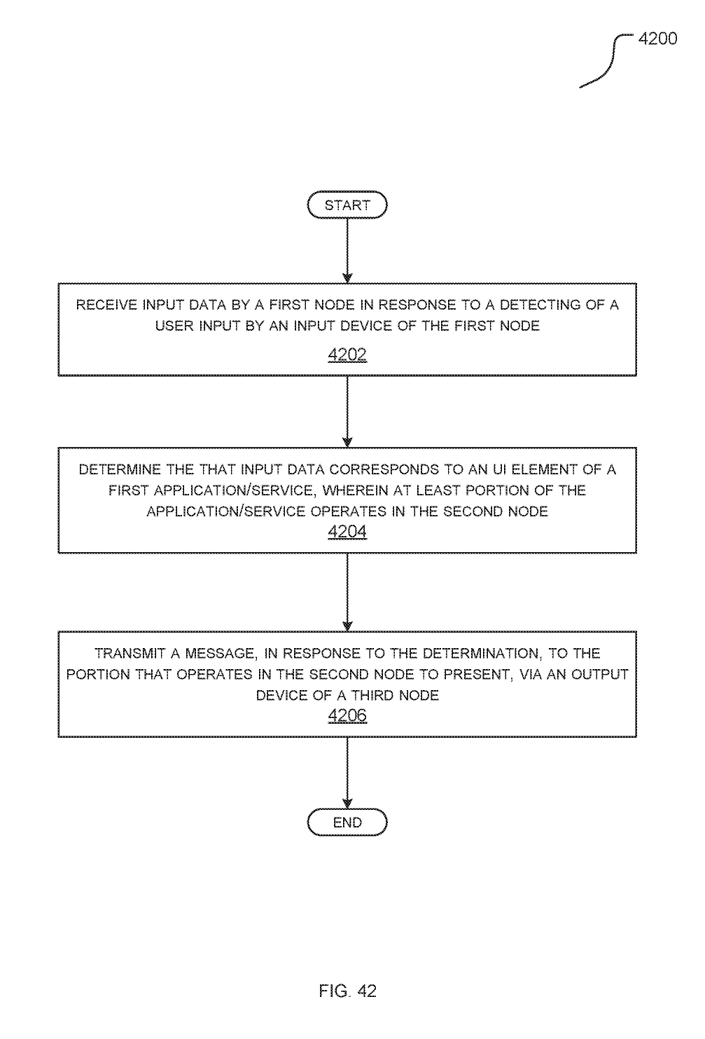

FIG. 42 shows a flow chart 4200 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include a first portion of an operating environment that includes or otherwise is hosted by a first node and a second portion of the operating environment that includes or otherwise is hosted by a second node. One or both nodes may each be included in respective service sites, a data centers, cloud computing environments or offer-based computing environments. At block 4202, input data may be received by the first node, of a first user, in response to a detecting of a user input by an input device of the first node. At block 4204, a determination may be made that the input data corresponds to a user interface element of a first application, service, or other circuitry of or hosted by the operating environment. A portion of the first application, service, or other circuitry of or hosted by the operating environment operates in the second node. At block 4206, a message may be transmitted, in response to the determination, to the portion that operates in the second node to present, via an output device of a third node. The third node may be a node of the user of the first node, in an embodiment. The user may be authenticated to the operating environment via one or both of the first node and the third node. In an embodiment, the user must be authenticated by both the first node and the third node to be allow access to the operating environment or to the second portion of the operating environment.

Referring to block 4206, the message may be transmitted based on a capability or other attribute of the third node. The message may also be transmitted based on a capability or other attribute of the first node. The third node may have a capability, such access to a car, a printer, a home appliance or other device that the first node does not have. The third node may have more of a particular resource or particular type of resource than the first node or less in some embodiments. Capabilities and attributes of the first node or third node that may be processed prior to transmitting the message include capabilities or attributes of a processor, processor memory, a file system, a data base, a persistent data storage device, a network adapter, a network protocol, a network, an output device, an input device, a source of energy, an attribute of accessible energy, or any other capability or attribute selected by a user, developer, designer, administrator, or owner of an embodiment described in the present disclosure or illustrate in the Figures along with analogs and equivalents. In an aspect the message may be sent asynchronously. Alternatively the message may be sent as a response to request. The message may be sent based on a location of the third node or a location of the first node. Sending the message may include providing task data to task match circuitry where sending the message includes performing a task identified by the task data. The task may be performed by task circuitry operating in a task operating environment of task host circuitry matched with the task data based on an offer received by the task match circuitry. That offer may be from or otherwise associated with the task host circuitry. The message may be transmitted via a VPN, SDN, or a network included in an offer-based computing environment that includes the second node or that includes the third node.

In an embodiment, circuitry may be provided that may be operable for use with an offer-based computing environment. The circuitry may operate to receive an offer, via the network from a node, that may identify at least one of an input device and an output device as a resource of the node. The circuitry may operate to identify a task that matches the offer. The circuitry may operate to transmit data, via the network, that assigns the task to the node.

In an embodiment, circuitry may be provided that may be operable for use with an operating environment of a first node. The circuitry may operate to receive data that may identify an offer-based computing environment of a second node. The circuitry may also operate to exchange data, via a network between the first node and the offer-based computing environment. The circuitry may additionally operate to create an offer that may identify at least one of an input device and an output device as a resource of the first node. The circuitry may also operate to transmit the offer via the network to the offer-based computing environment to include the first node or the first operating environment (or respective portions thereof) as a task host circuitry node accessible to the offer-based computing environment.

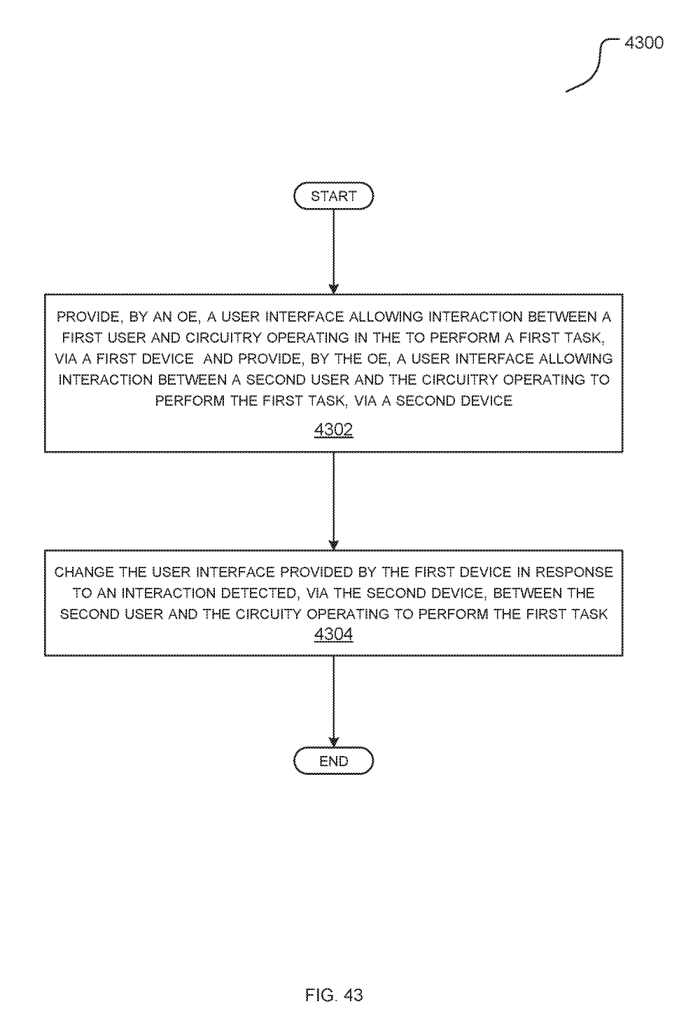

FIG. 43 shows a flow chart 4300 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include a first node and a second node which may be communicatively coupled via a network. At block 4302, an operating environment provides, via the first node, a user interface for a first user identified by or otherwise to the operating environment. The user interface provided via the first node allows interaction between the first user and circuitry operating in the operating environment to perform a first task or a first operation. The operating environment also provides, via a second node, a user interface for a second user identified by or otherwise to the operating environment. The user interface, provided via the second node, allows interaction between the second user and the circuitry operating in the operating environment to perform a first task or the first operation. At block 4304, the user interface provided by the first device may be changed in response to an interaction detected, via the second device, between the second user and the circuitry operating to perform the first task or the first operation. In an embodiment, the user interface provided by the second device may be changed in response to an interaction detected, via the first device, between the first user and the circuitry operating to perform the first task.

The first task may include or may be included in an application, a thread, a computing process, or a virtual operating environment. The circuitry included in performing the task may be hardware or virtual circuitry that operates in the first node, the second node, or a node in a service site, data center, cloud computing environment, or offer-based computing environment. In an embodiment, a first portion of the operating environment may be identified to be hosted by or to include the first node. A second portion of the operating environment may be hosted by or may include the second node.

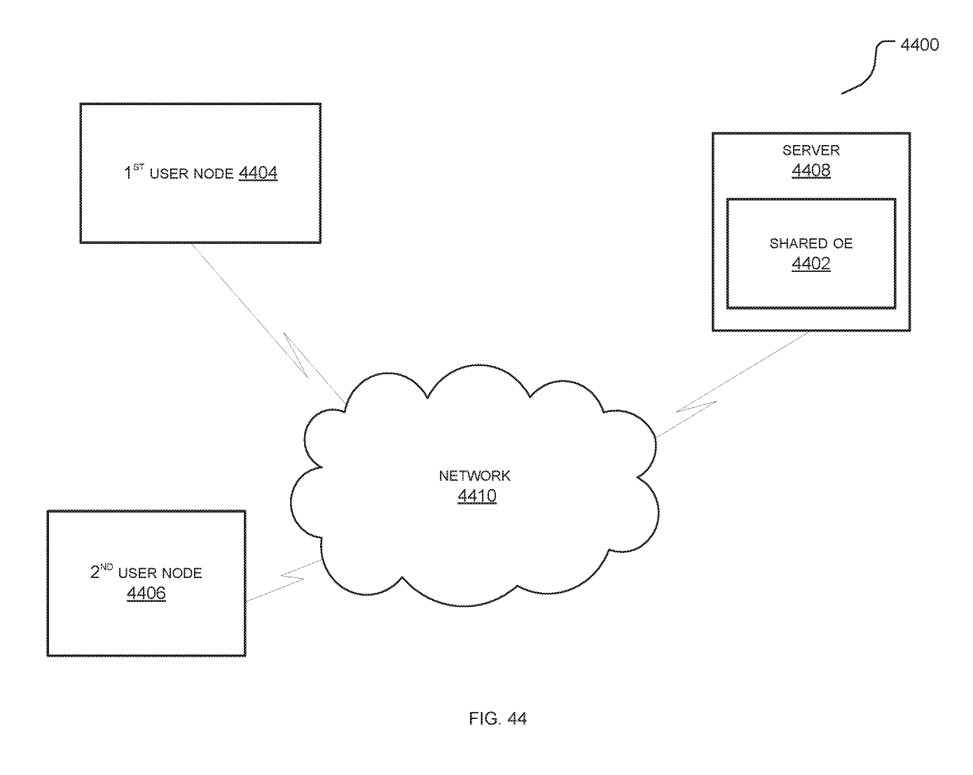

FIG. 44 shows a system 4400 that may operate to perform one or more methods of the subject matter of the present disclosure. FIG. 44 shows that system 4400 includes an operating environment 4402 where a first user interacts with the operating environment 4402 shared with a second user via a first user node 4404 and a second user interacts with the shared operating environment 4402 via a second user node 4406. The shared operating environment 4402 may operate in a server 4408 as illustrated in FIG. 4402. Alternatively or additionally, the shared operating environment 4402 may operate in or may otherwise include a virtual server, a container, a data center, a cloud computing environment, or an offer-based computing environment. System 4400 includes a network 4410 which allows the first user node 4404 and the second user node 4406 to exchange data with the shared operating environment 4402. In an embodiment, the first user node 4402 and the second user node 4404 may exchange data via the network 4410 with or without exchanging the data via server 4408. In an embodiment, a user node may include a so-called “dumb terminal”, analogous to a UNIX terminal or an OS360 terminal. In other embodiments, a user node may include browser circuitry, remote desktop circuitry, or a portion of the operating environment 4402 may operate in one or both of the first user node 4404 and the second user node 4406.

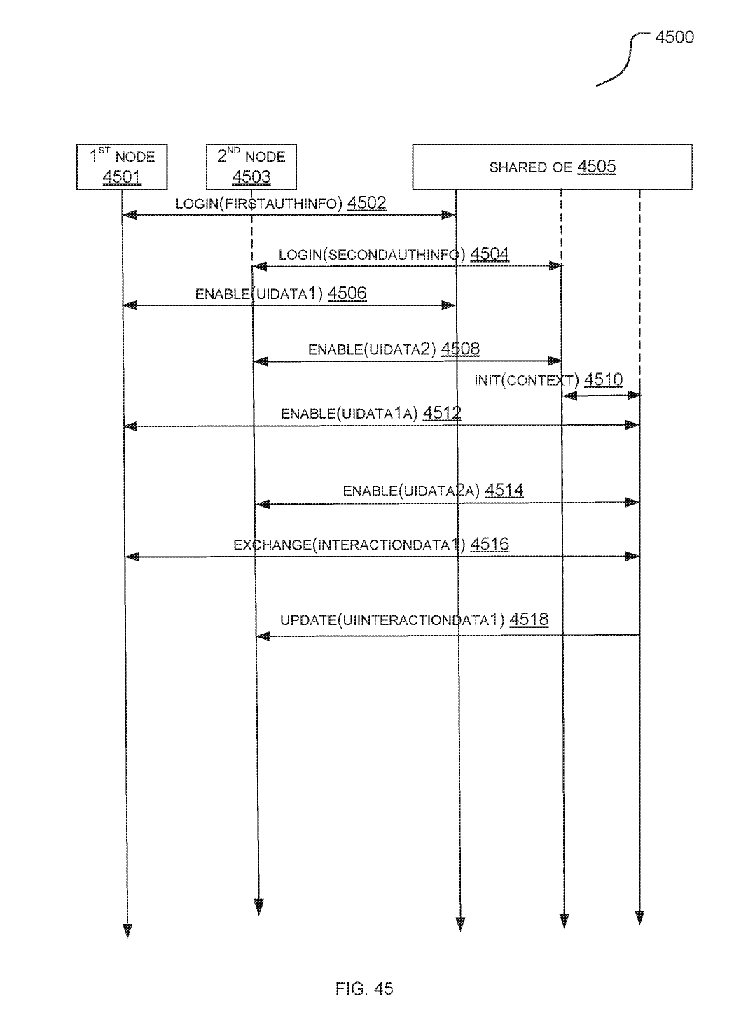

FIG. 45 illustrates a data flow diagram 4500 of data exchanged between or among addressable entities or other parts of a first node 4501, a second node 4503, and a shared operating environment 4505 which, in an embodiment, may operate at least partially in server node, a service site, a data center, a cloud computing environment, or an offer-based computing environment. Flow 4502 illustrates an exchange of data between the first node 4501 and the operating environment 4505 shared with the second node 4503. Data may be included in the exchange to authenticate the first node 4501 or to authenticate a user of the first node 4501 with the shared operating environment 4505 or with a service site or offer-based computing environment hosting the shared operating environment 4505. Alternatively or additionally, data may be included in the exchange to authenticate the shared operating environment 4505, the service site, or the offer-based computing environment with the first node 4501 or with the first user. An analogous flow is illustrated by flow 4504 in which data may be exchanged to authenticate the second node 4503 or a user of the second node 4503 with the shared operating environment 4505 or an entity hosting the shared operating environment. Alternatively or additionally, data may be included in the exchange to authenticate the shared operating environment 4505 or the host of the shared operating environment 4505 with the second node 4503 or with a user of the second node 4503. Flow 4506, illustrates an exchange of data between the first node 4501 and the shared operating environment 4505 to present first output via an output device of the first node 4501. Flow 4508, illustrates an exchange of data between the second node 4503 and the shared operating environment 4505 to present second output via an output device of the second node 4503. Flow 4510, illustrates a flow of data within the shared operating environment 4505 between circuitry operating on behalf of the second node 4503 or on behalf of the user of the second node 4503 with circuitry in the shared operating environment 4505 that interoperates with both the first node 4501 and the second node 4503. Flow 4512, illustrates data exchanged between the shared operating environment 4505 and the first node 4501 to present a first shared user interface via an output device of the first node 4501 that may be responsive to interaction between the user of the first node 4501 and the first shared user interface and may be responsive to interaction between a second shared user interface and the second user of the second node 4503. Flow 4514, illustrates data exchanged between the shared operating environment 4505 and the second node 4503 to present the second shared user interface via an output device of the second node 4503 that may be responsive to interaction between the user of the second node 4503 and the second shared user interface and may be responsive to interaction between the first shared user interface and the first user of the first node 4501. Flow 4516 illustrates an exchange of data between the shared operating environment 4505 and the first node 4501 that occurs in response to an interaction between the user of the first node 4501 and the first shared user interface. Flow 4518, illustrates an exchange of data between the shared operating environment 4505 and the second node 4503, that occurs in response to flow 4516. Data may be exchanged in flow 4518 to update the second shared user interface in response to the interaction between the first user and the first shared user interface. A shared operating environment may constrain access to one or more data resources or one or more executable resources when one or more users of the shared operating environment are not logged in or otherwise interacting with the shared operating environment. The one or more data resources may be accessible or the one or more executable resources may be accessible when certain combinations of users, or users with certain combinations of roles or other attributes are logged in or otherwise interacting with the shared operating environment. In another aspect, one or more data resources or one or more executable resources may not be accessible to a first user when specified second user is logged in or other interacting with the shared operating environment. The second user may or may not have access to the one or more resources or the one or more executable resources ever or when the first user is logged in or otherwise interacting with the operating environment. The second user may access to the one or more data resources or one or more executable resources when a third user is logged in or otherwise interacting with the operating sentence. Those skilled in the art will understand that various combinations of logged in or interacting users may determine whether a resource is accessible to one or more of the logged in or interacting users. Further, identifying a user or users not logged in or interacting with the operating system may further constrain or allow access to the resource to one or more of the logged in or interacting users.

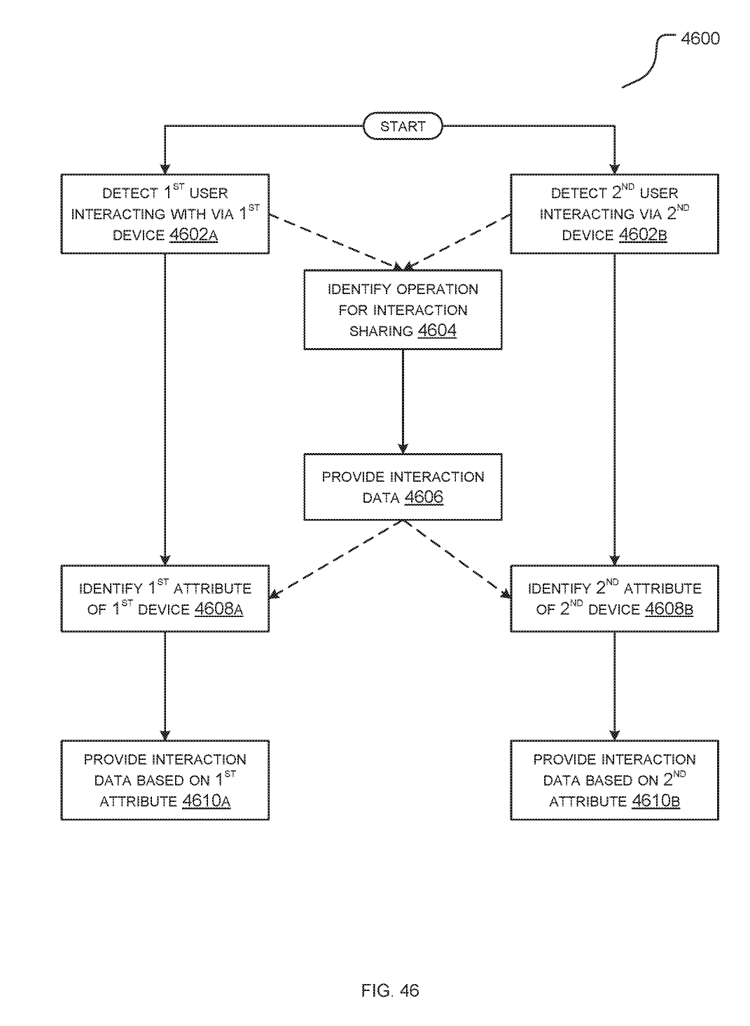

FIG. 46 shows a flow chart 4600 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 4602a, a first user interacting with a first node may be detected. At block 4602b, a second user interacting with a second node may be detected. At block 4604, in response to detecting the first user interacting with the first node and the second user interacting with the second node, a shared application, shared service, or an operation that when performed includes interaction with each of the first user and the second user may be identified. At block 4606, data utilized in executing the shared application or performing the identified operation may be provided or otherwise identified. At block 4608a, an attribute of the first node may be identified. At block 4608b, an attribute of the second node may be identified. At block 4610a, the data may be provided to the first node based on the first attribute. At block 4610a, the data may be provided to the second node based on the second attribute.

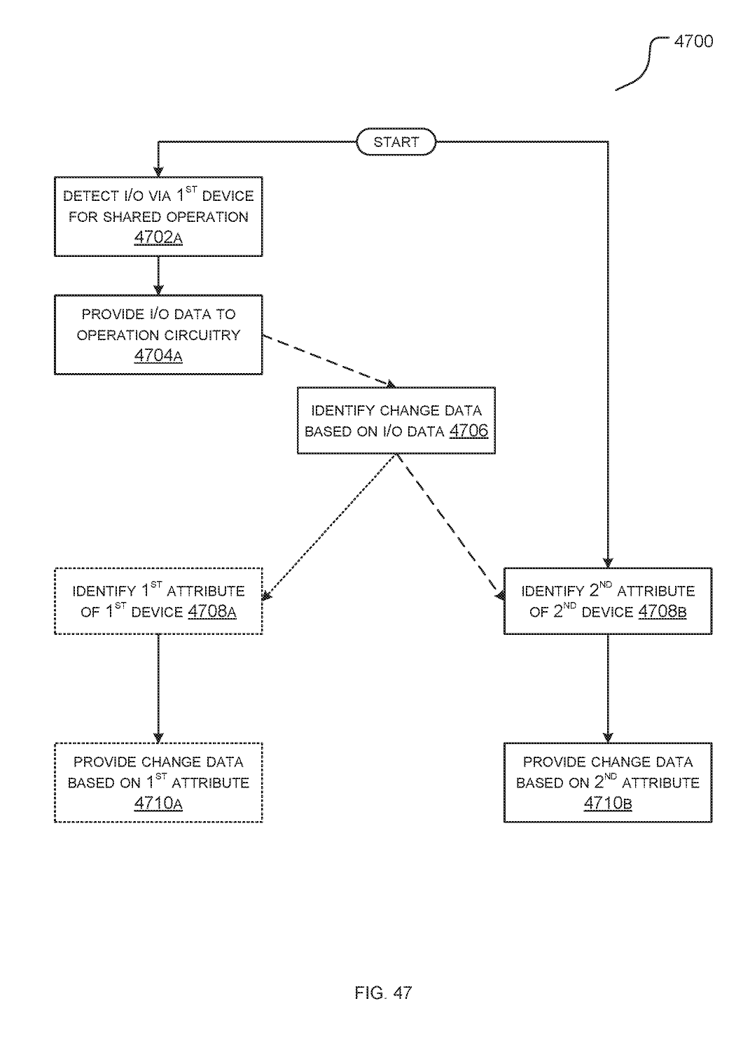

FIG. 47 shows a flow chart 4700 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 4702a, an input or an output included in an interaction with a user of a first device may be detected for an operation shared by the first device and a second device. At block 4704a, interaction data may be provided to operation circuitry included in performing the shared operation or to task circuitry performing a shared task. At block 4706, change data interacting with the first user of the first device and for interacting with a second user of the second device may be identified in response to or otherwise based on the interaction data. At block 4708a, an attribute of the first node may be identified. At block 4708b, an attribute of the second node may be identified. At block 4710a, the data may be provided to the first node based on the first attribute. At block 4710a, the data may be provided to the second node based on the second attribute.

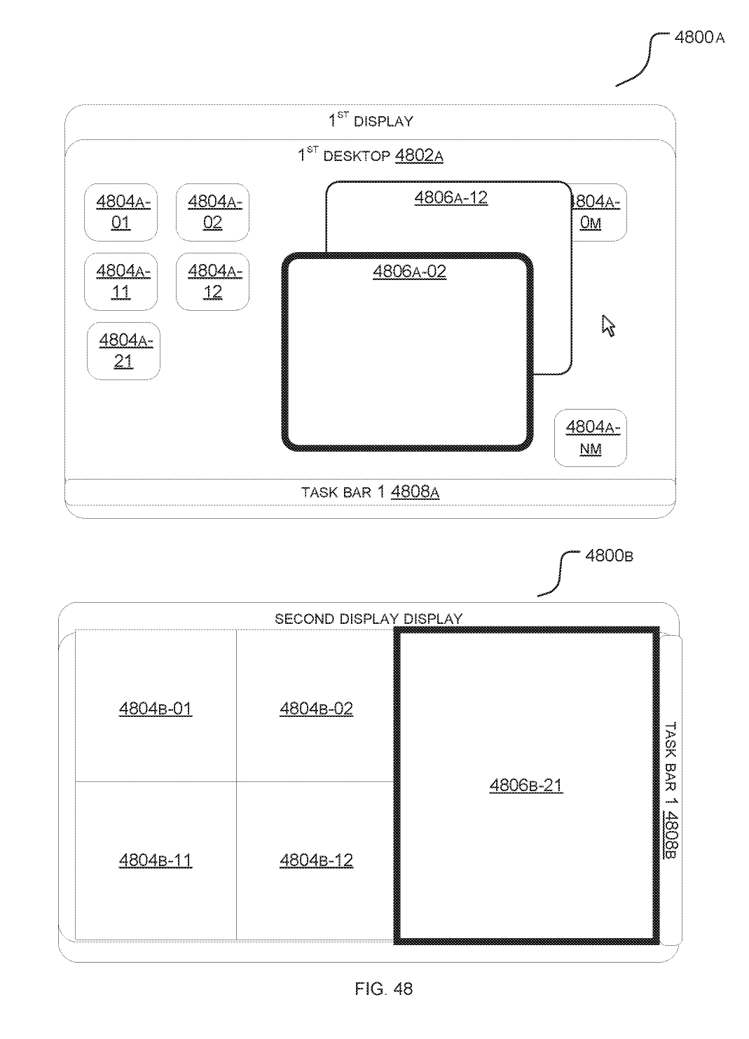

FIG. 48 illustrates a first user interface presented by a first display 4800a, that may be presented to a first user of a shared operating environment in an embodiment and a second display 4800b also presenting the first user interface to a second user of the shared operating environment. The first display device 4800a and the second display device 4800b may each respectively be included in or communicatively coupled to a laptop display, a display device attached to a desktop PC or a server, a television, or a projected display—to name a few examples. The displays 4800 may have different user interface modes or the same modes. In FIG. 48, the first display 4800a presents a first desktop 4802a in a representation of the first user interface. The first desktop 4802a includes user selectable icons 4804a-01 through 4804a-nm for accessing data objects (e.g. files) or executable objects (e.g. apps). The second display 4800b presents a second desktop (hidden in FIG. 48) that includes user selectable tiles 4804b-01 through 4804b-nm some of which are visible in display 4800b and some of which are hidden. Hidden tiles may be accessed, in an embodiment by scrolling the tiles up, down, left, or right via detecting user interaction via an input device, such as a touch screen. In another embodiment, tiles may be layered (e.g. have a z-ordering) like a deck of cards. Inputs may be defined to navigate through the layers, insert a tile in a layer, remove a tile, or reorder in a z-ordering of the tiles. A first active app may be presented in a user interface element 4806a-02 in the first display 4800a. A second active app may be presented in a user interface element 4808a-12 in the first display 4800a. Each may be active in response to an interaction with a user of the first display 4800a and an icon 4804a-02 and 4804a-12 each representing one of the respective apps. One or more of the active apps may be represented in a first task bar 4808a and may have been launched from the first task bar 4808a or a portion thereof (e.g. a start menu). A third active app may be presented in a user interface element 4806b-21 in the second display 4800b. The third app may be active in response to an interaction with a user of the second display 4800b and a tile 4804b-21 (not shown) representing the third app. The third active app may be represented in a second task bar 4808b and may have been launched from the task bar 4808b or a portion thereof (e.g. a start menu).

In an embodiment, the apps and data accessible via the first desktop 4802a and via the second desktop 4802b may be the same. Each desktop 4802 may have its own input focus attribute, z-ordering, set of locations in the respective desktops 4802 that correspond to the set of apps and data, colors, fonts, backgrounds, or other detectable visual attributes. Some or all of the detectable visual attributes may be shared as required by a particular embodiment, configured by an administrator, or agreed upon by a user of the first desktop 4802a and a user of the second desktop 4802b. An app that may be active or data that may be currently accessed in one desktop 4802 may be presented so that its state in the one desktop may be indicated in other desktop 4802. Alternatively or additionally, a state of an app or processing of data via one desktop 4802 may be hidden or not indicated via the other desktop 4802 or other associated output device. Whether such state may be indicated or hidden may be specified in the circuitry of the operating environment or may be configurable by a user. Whether such state may be indicated or hidden may be based on a rule or policy that may be evaluated based on an attribute of a resource of the operating environment, the first node, the second node, a user of one node or the other, a location of one node or the other, or based on any other data accessible to the operating environment, the first node, or the second node. In yet another aspect, some of the data or apps may be private to one user, node, or desktop and not accessible to the other user, node, or desktop.

For a shared app, each desktop may be associated with a same operating instance of the app. Another app in the same embodiment, may have one or more active instances shared via both user interfaces. Again such sharing may be required by an embodiment or may be configurable and may further by conditional.

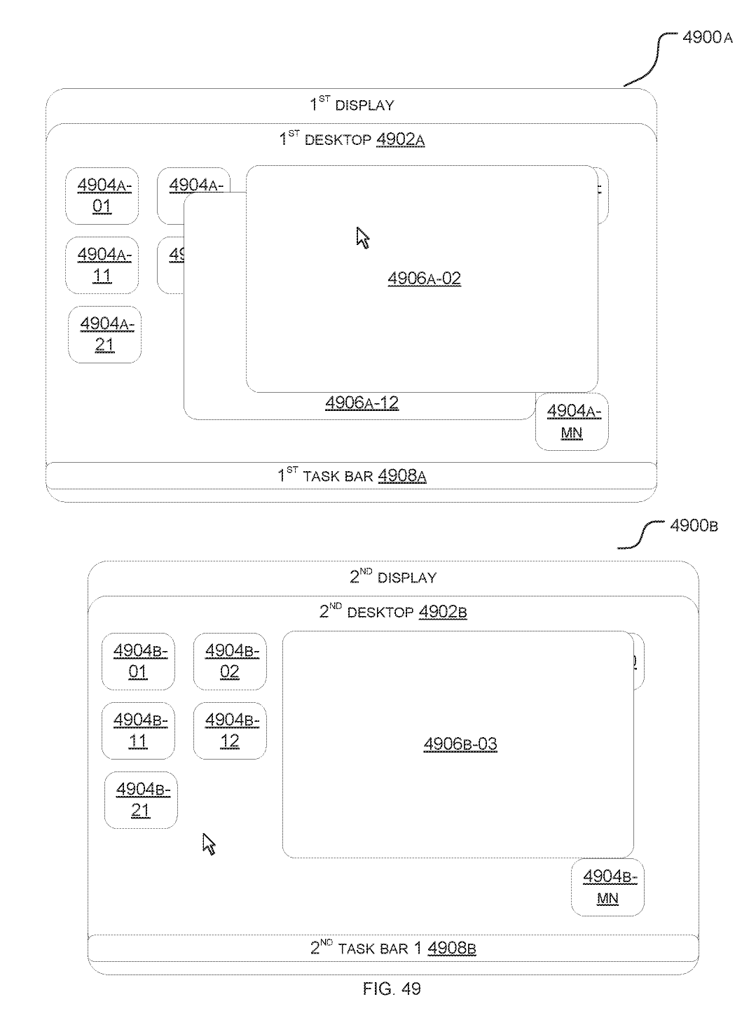

FIG. 49, illustrates a first display 4900a for interacting with a user of a shared operating environment and a second display 4900b for interacting with a user of the shared operating environment. A first virtual desktop 4902a may be presented to a user of the shared operating environment in the first display 4900a and a second virtual desktop 4902b may be presented to a user of the shared operating environment in the second display 4900b. Although, not shown in FIG. 49, the desktops 4902 may, as illustrated in FIG. 48, each be presented in a different user interface model or mode based on a user preference or display type (or any other suitable attribute of a user, display, or data presented via a display). User interface models may differ based on display size or based on device capability. The first virtual desktop 4902a of the shared operating environment, as illustrated, includes user selectable icons 4904a-01 through 4904a-nm for accessing data objects (e.g. files) or executable objects (e.g. apps). The second display 4900b presents a second virtual desktop 4902b of the shared operating environment that includes user selectable icons 4904b-01 through 4904b-nm of which at least some may represent one or more of the same apps and data objects represented by icons 4904a of the first desktop 4902a. Alternatively or additionally, at least some of the icons 4904b may represent different apps and data objects than the of the icons 4904a of the first desktop 4902a. A first active app may be presented in a user interface element 4906a-02 in the first display 4900a. A second active app may be also presented in a user interface element 4906a-12 in the first display 4900a. Each may be active in response to an interaction with the first user and an icon 4904a-02 and 4906a-12 of the first display 4900a where each represents one of the respective apps. One or more of the active apps may be represented in a first task bar 4908a and may have been launched from the first task bar 4908a or a portion thereof (e.g. a start menu). A third active app may be presented in a user interface element 4908b-03 in the second display 4900b. The third app may be active in response to an interaction with a user of the second display 4900b and the icon 4906b-03 of the second desktop 4902b. The third active app may be represented in a second task bar 4908b and may have been launched from the task bar 4904b or a portion thereof (e.g. a start menu).

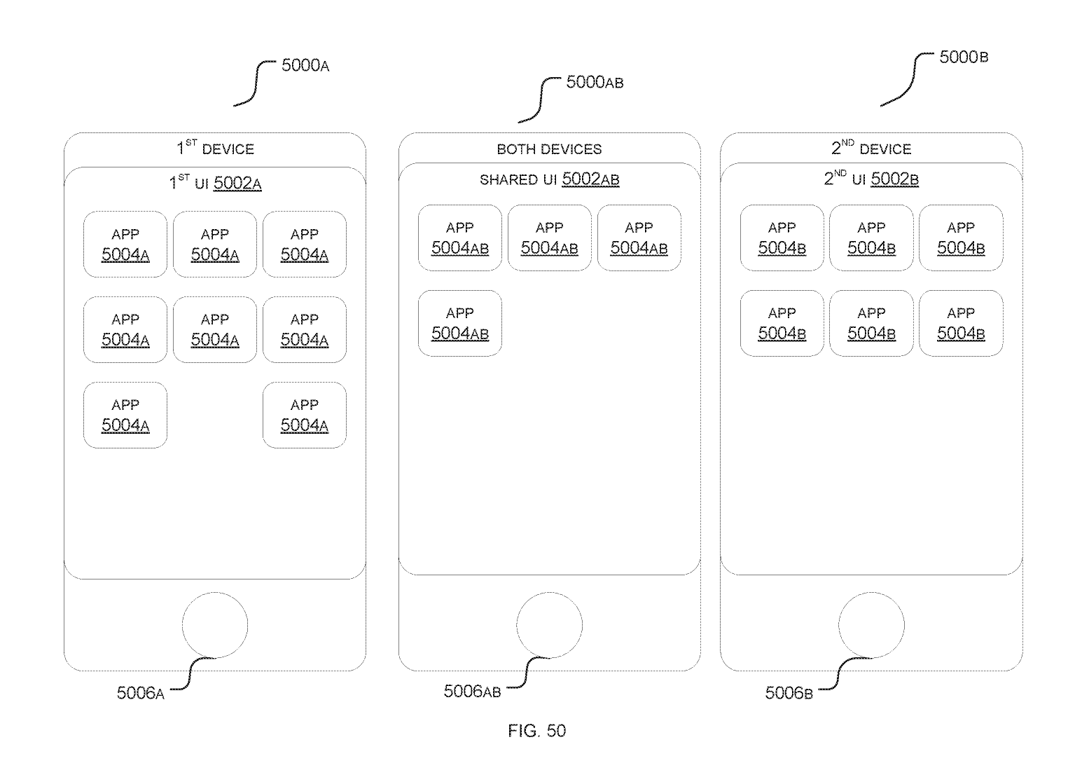

FIG. 50, illustrates a first device 5000a including a display in which a first user interface 5002a may be presented. The first user interface 5002a may be presented based on a first user authenticated or otherwise identified as a user of the first device 5000a. The first user interface 5002a may be presented by a shared operating environment or a shared portion of an operating environment. FIG. 50 also illustrates a second device 5000b including or otherwise having access to a display in which a second user interface 5002b may be presented. The second user interface 5002b may be presented based a second user authenticated or otherwise identified as a user of the second device 5000b. FIG. 50 also illustrates a common representation 5000ab of both devices, both of which may present a shared user interface 5002ab via their respective display devices. The shared user interface 5000ab illustrates output shared by both respectively via the first device 5002a and the second device 5002b. While the user interfaces in FIG. 50 are similar in style and mode, in various embodiments the devices and associated input or output devices may differ. A sharable user interface may be presented according to different models or modes based on a size of display, access to a GPU, or any of various attributes of devices of a shared operating environment. Different devices may present output utilizing different user interface models or metaphors and may interact with respective users via different input devices, output devices, and interaction models which may define particular inputs or outputs differently and or similarly according the particular embodiments. The first device 5000a may be capable of presenting the first user interface 5002a, which may include a desktop output space or other organizing metaphor, for a first user of the first device 5000a. The first user interface 5002a, as shown, includes user interface elements, such as illustrated by user interfaces elements 5004a, for interacting with the first user. The second device 5000b may be capable of presenting the second user interface 5002b for a second user of the second device 5000b. The second user interface 5002b, as shown, includes user interface elements, such as illustrated by user interfaces elements 5004b, for interacting with the second user. The apps, data, or operations represented by the user interface elements presented to the first user via the first user interface 5002a may differ from those presented in the second user interface 5002a. Alternative or additionally, the first user interface 5002a may be presented in a context specific to the first user and the second user interface may be presented in a context specific to the second user. In an embodiment, a first context for the first user may include a first file system for the first user, a first database, a first set of web bookmarks, first user configuration data for one or more of the applications accessible via the first user interface, a first set of permissions, etc. A second context for the second user may include a second file system for the second user, a second database, a second set of web bookmarks, second user configuration data for one or more of the applications accessible via the second user interface, a second set of permissions, etc. Both the first device 5000a and the second device 5000b are capable of presenting a shared desktop 5002ab for both users. The two users may interact with the shared desktop simultaneously or may interact with the shared desktop at different times. In an embodiment, a shared desktop may be accessible to the users only when both users are interacting with their respective devices.

In an embodiment, a first user interface of a shared operating environment may present a user detectable indication via the first user interface that indicates an application or data that may be accessible to a user via a second user interface of the shared operating environment. An indication or indications that are user detectable may be presented via the first user interface that indicates whether an app may be active for or interacting with a user via a second user interface or whether data may be being accessed by a user of the second user interface or an app that may be active for the user of the second user interface. An indication of a past activity or access may be present, such as a time of last access, a count of accesses in a duration, and the like. An indication that may be user detectable may be presented via the first user interface that indicates whether an app or data may be being shared or may be sharable with a user of a second user interface of the shared operating environment. Such an indication may indicate whether each user will access separate instances or copies of an app or data or may access a same instance or copy of an app or data. A user detectable output may be presented indicating a scheduled shared access to an app or data, a schedule or access for one user via one interface of the shared operating environment may be presented via another user interface of the shared operating environment. In an aspect, an app or particular data may be accessible via a user interface of a shared operating environment when a particular user may be interacting with the shared operating environment via a user interface of the shared operating environment, when a specified number of users are interacting with the shared operating environment via respective user interfaces of the shared operating environment, when one or more users interacting with the shared operating environment via a particular role or respective roles via respective user interfaces of the shared operating environment, when one or more users interacting with the shared operating environment via respective user interfaces of the shared operating environment are in a specified location or specified respective locations, or when some other criterion may be met based on an attribute of a user or node of an interface of the shared operating environment. In still another aspect, an app or data shared in a shared operating environment may be shared in a specified order or sequence. That state of the app or data when interaction ends with one user via one user interface of the shared app may be preserved and inherited by a next user of the app or data interacting with the shared operating environment by an another user interface of the shared operating environment.

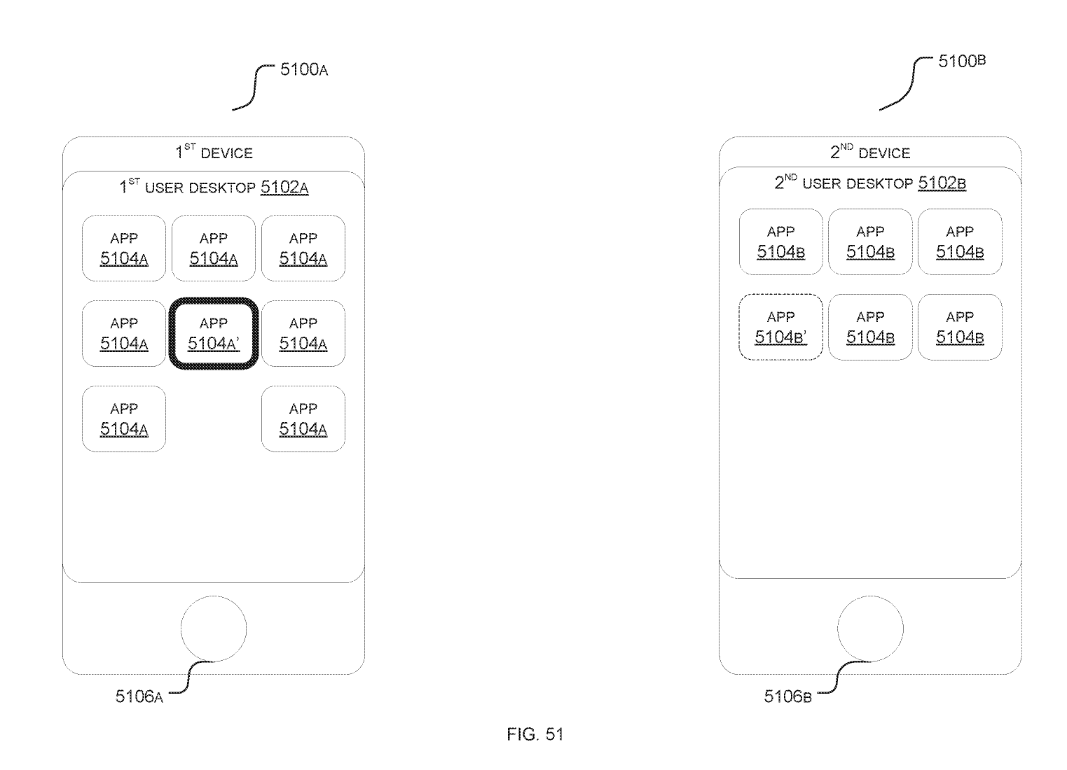

FIG. 51, illustrates a first device 5100a including a display presenting a first user interface illustrated by first user desktop 5102a. The first user desktop 5102a may be presented for a first user of a shared operating environment. In an aspect, the first user interface may be presented for the first user in a display of any number and types of devices with which the first user interacts. The desktop or user interface may be presented via a different user interface model based on an attribute of another device when the user interacts with the other device. FIG. 51 also illustrates a second user interface illustrated by second device 5100b including a display presenting a second user desktop 5102b. The second user desktop 5102b may be presented for a second user of a shared operating environment. In an aspect, the second user desktop 5202b may be presented for the second user in a display of any number and types of devices with which the second user interacts. The second user interface may be presented via a different user interface model based on an attribute of another device when the user interacts with the other device. While the devices in FIG. 51 are similar, in various embodiments the devices and associated input or output devices may differ. Different devices may present output utilizing different user interface models or metaphors and may interact with respective users via different input devices, output devices, and interaction models which may define particular inputs or outputs differently and or similarly according the particular embodiments. The first device 5100a may be capable of presenting the first desktop 5102a for a first user of the first device 5100a. The first desktop 5102a includes user interface elements, such as illustrated by user interfaces elements 5104a, for interacting with the first user. The second device 5100b may be capable of presenting the second desktop 5102b for a second user of the second device 5100b. The second desktop 5102b includes user interface elements, such as illustrated by user interfaces elements 5104b, for interacting with the second user. The apps, data, or operations represented by the user interface elements presented to the first user via the first desktop 5102a may be different than those presented to the second user via the second desktop 5102b. An app that may be sharable between first device and the second device (or the first user and the second user) may be represented in the first user desktop 5102a and in the second desktop 5102b. The sharable app may include a user detectable output specified, configured, or defined to indicate that it may be sharable. The user detectable attribute may be the same in each of the desktops 5102 or may be different. FIG. 51 illustrates a user interface element 5104a′ that may be presented with a border that may be specified to indicate to the first user that it may be sharable with an another device or with a user of another device. The sharable app, shown as user interface element 5104b′ by the second device 5100b may be represented with a different border or other user detectable attribute that is configured to indicate the app is shared. A sharable app may be identified as sharable based on a color, level of transparency, a z-level, a size, a location, or any other user detectable attribute that may distinguish it from non-shared apps for a user.

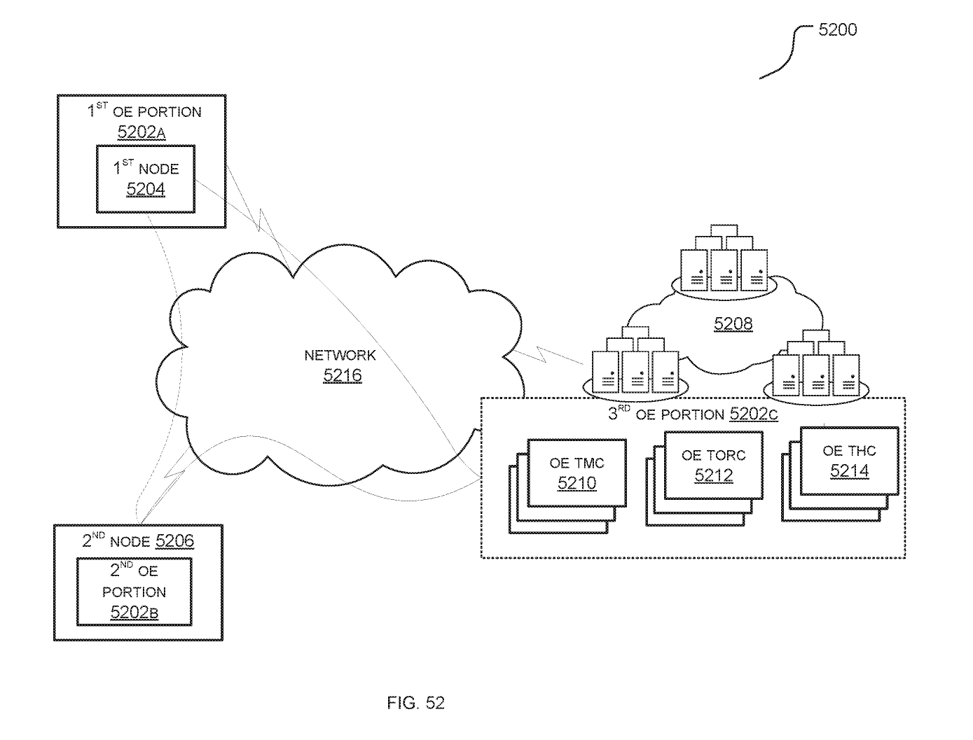

FIG. 52 shows a system 5200 that may operate to perform one or more methods of the subject matter of the present disclosure. FIG. 52 shows that system 5200 includes a shared operating environment 5202 where a first user interacts with the shared operating environment via a first operating environment portion 5202a that includes a first node 5204. System 5200 also illustrates a second node 5206 that hosts a second operating environment portion 5202b of the shared operating environment 5202. A second user interacts with the shared operating environment 5202 via the second operating environment portion 5202b and the second node 5206. The shared operating environment 5202 may include a third operating environment portion 5202c that operates in a server, a service site, data center, a cloud computing environment, or of an offer-based computing environment 5208 as FIG. 52 illustrates. Some of all of the third operating environment portion 5202c may include or may operate in a device in the offer-based computing environment 5208, a virtual server, a container, task match circuitry 5210, task-offer routing circuitry 5212, task host circuitry 5214, a task operating environment (not shown), and various embodiments of task circuitry (not shown) that operate in matched task operating environments in performing tasks of the operating environment. In an embodiment, one or both of the first portion 5202a and the second portion 5202b may include one or more of task match circuitry, task-offer routing circuitry, task host circuitry, task operating environment circuitry, task coordination circuitry, and various embodiments of task circuitry (not shown) that operate in matched task operating environments in performing tasks of the shared operating environment 5202. The first portion 5202a, the second portion 5202b, and the third portion 5202c may interoperate via a network 5216 such as the Internet, a VPN, or a software defined network (SDN).

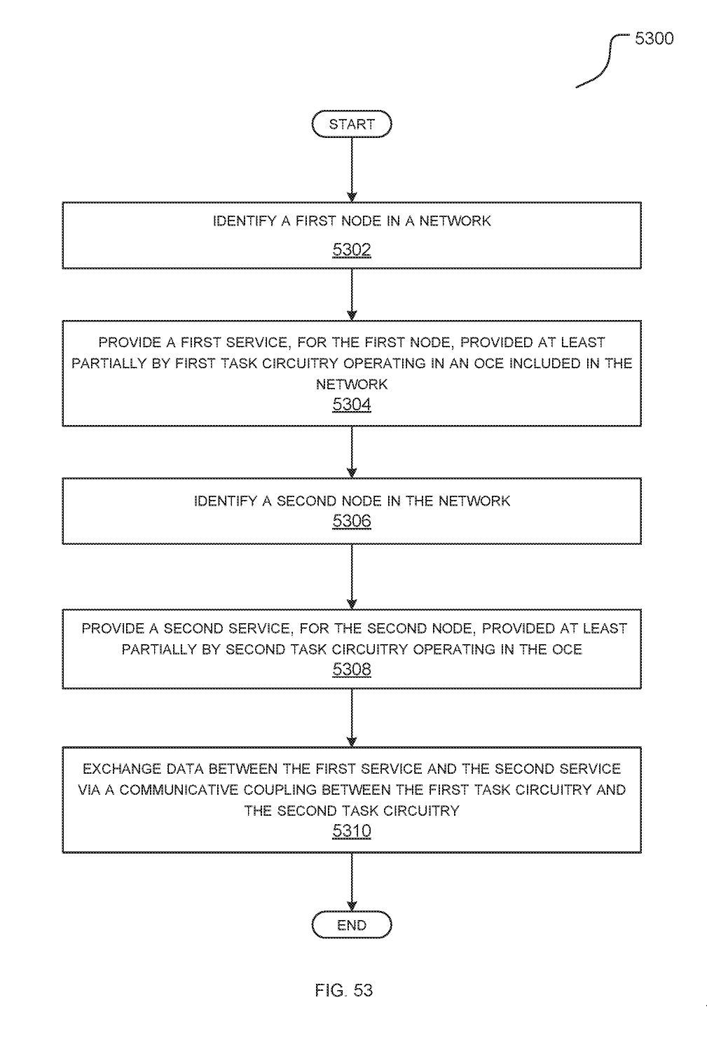

FIG. 53 shows a flow chart 5300 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. In an embodiment, system may include an offer-based computing environment or a portion there of including or otherwise hosted by a second node, a service site, a data center, or a cloud computing environment. The system may also include a first node and a second node. The first node and the second node may exchange data via a network. Each of the first node and the second node may exchange data with the OCE via the network. At block 5302, the first node may be identified. In an aspect, the first node may be identified by the offer-based computing environment via a communicatively coupling between the first node and the offer-based computing environment. In another aspect, the first node may be identified based on a first service of or for the first node provided at least in part by the offer-based computing environment. The first node may be a node of user such as smart phone, a car, an appliance, and the like. In another embodiment the first node may be a node of a service site, data center, cloud computing environment, or other grouping of devices. At block 5304, a first service may be provided for the first node or for an operating environment of the first node. The first service may be provided at least partially by first task circuitry operating in the offer-based computing environment. The first task circuitry may operate in a task operating environment of task host circuitry, based on an assignment from task coordination circuitry or task match circuitry that may operate in the first node or in the OCE. At block 5306, a second node may be identified. As with the first node, the second node may be identified by the offer-based computing environment via a communicatively coupling between the second node and the offer-based computing environment. Alternatively, or additionally, the second node may be identified based on a second service of or for the second node provided at least in part by the offer-based computing environment. The second node, like the first node, may be a node of user such as desktop computer, tablet, an IoT device, a wearable device, and the like. In another embodiment the second node, like the first node, may be a node of a service site, data center, cloud computing environment, or other grouping of devices. At block 5308, a second service may be provided for the second node or for an operating environment of the second node. The second service may be provided at least partially by second task circuitry operating in the offer-based computing environment. The second task circuitry may operate in a task operating environment of task host circuitry, based on an assignment from task coordination circuitry or task match circuitry that may operate in the second node or in the OCE. At block 5310, data may be exchanged between the first service and the second service via a communicatively coupling between the first task circuitry and the second task circuitry. The communicatively coupling may be based on a network in the OCE, a remote procedure call, an SDN, an interprocess communication mechanism, a shared memory, and the like.

In an embodiment, the first service and the second service are each personal communication services, such as email, VoIP, instant message, and so on. An attachment exchanged between the services may be stored in a data store in the OCE for the first node or first operating environment operating as a data sender. The attachment or a reference to the attachment may be exchanged within the OCE and stored in a memory accessible to the second node or an operating environment of the second node. In an embodiment, an exchange between the first service and the second service may take place with one or both of the first node and the second node are not communicatively coupled to the OCE. The first service may be a configuration service that provides configuration data, software updates, and the like to the first node as well as to other nodes in an embodiment. In still another embodiment, the first service provides a directory client service for the first node or the operating environment of the first node. For example, the first service may operate as a DHCP client, a calendar client, a DNS client, an LDAP client, a subscriber to a subscription service, and so on. The second service may provide a directly service that operates at least partially in the OCE. The second service may operate as a DHCP server, a calendar server, a DNS server, an LDAP server, a publishing service providing data to one or more subscriber, and so on

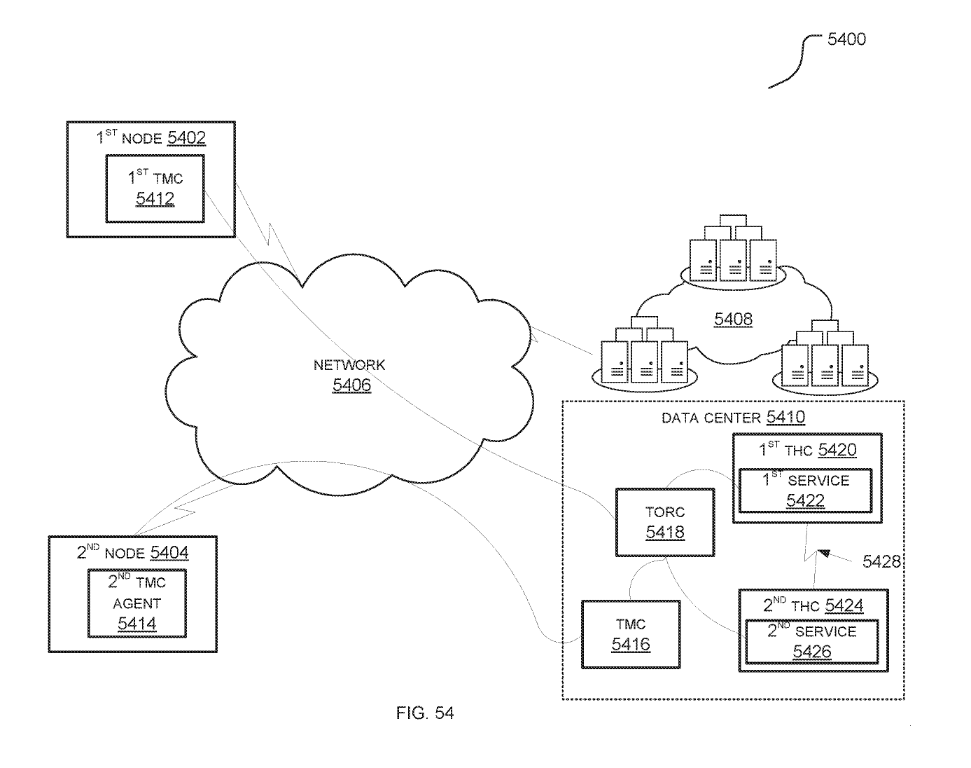

FIG. 54 shows a system 5400 that may operate to perform one or more methods of the subject matter of the present disclosure. FIG. 54 shows that system 5400 includes a first node 5402 and includes a second node 5404. Each node may be communicatively coupled, via a network 5406, to an offer-based computing environment 5408. In various embodiments, the offer-based computing environment 5401 may include or may otherwise be hosted by a third node, a data center 5410 as FIG. 54 illustrates, or a cloud computing environment. FIG. 54 illustrates the first node 5402 includes first task match circuitry 5412 to match tasks to be performed for or on behalf of the first node 5402 with offer(s) from instances of task host circuitry of the offer-based computing environment 5408. The first task match circuitry 5412 may be included in or otherwise accessible to task coordination circuitry (not shown) which may operate in the first node 5402 in whole or in part. FIG. 54 also illustrates second node 5404 includes second task match agent circuitry 5414 to send task data identifying one or more tasks to be performed for or on behalf of the second node 5404 to task match circuitry 5416 operating in data center 5410. Task match circuitry 5416 may operate to match tasks to be performed for or on behalf of the second node 5404 with offer(s) from instances of task host circuitry of the offer-based computing environment 5408 or another offer-based computing environment associated with the second node 5404. Task match circuitry 5416 may interoperate other nodes to match tasks performed for or on behalf of the other nodes with offers, as well. Task match circuitry 5416 may operate or otherwise may be accessible to task coordination circuitry (not shown) operating in offer-based computing environment 5408 in whole or in part. Data center 5410 may include one or more instances of task-offer routing circuitry 5418 that enables one or more embodiments of task match circuitry to communicate with instances of task host circuitry in data center 5410 or otherwise providing a task operating environment for executing task circuitry for the offer-based computing environment 5408. FIG. 54 illustrates first task host circuitry 5420 that provides at least part of a first service 5422 for the first node 5402. Providing the first service may include performing one or more tasks in one or more task operating environments (not shown) of the first task host circuitry 5420 or other instances of task host circuitry of the offer-based computing environment 5408. FIG. 54 illustrates second task host circuitry 5424 that provides at least part of a second service 5424 for the second node 5404. Providing the second service may include performing one or more tasks in one or more task operating environments (not shown) of the second task host circuitry 5424 or other instances of task host circuitry of the offer-based computing environment 5408. In an embodiment, the first service and the second service may be provided via a same task host circuitry by a first task of the first service performed in a first task operating environment and by a second task of the second service performed via a second task operating environment. In an embodiment, the first service and the second service may be provided via same task host circuitry by a first task of the first service and a second task of the second service performed in a same task operating environment. The tasks may be performed in sequence in separate invocations or in separate instantiations of the task operating environment. The tasks may be performed in a same invocation or instantiation of the task operating environment in sequence, in parallel, or performed in an interleaved fashion. In an embodiment, the first task and the second task may be performed by the same task circuitry. The task circuitry may be invoked for the first task with one set of input data and invoked for the second task with a second set of input data. The invocations of the same task circuitry may be performed in a same task operating environment, in different task operating environments of task host circuitry, or may be performed in task operating environments of different instances of task host circuitry. FIG. 54 illustrates that a task of the first service and a task of the second service may interoperate to exchange data (see link 5428). The data may be exchanged locally without instruction from one or both of the nodes or without knowledge of a first user of the first node or a second user of the second node. In an embodiment, the data may be exchanged as a goal or purpose of the first service and the second service. The data may be exchanged in response to or at the direction of one or both of the nodes or with knowledge of a first user of the first node or a second user of the second node. The data exchange may be included in a file transfer, a backup operation, a synchronization operation, a communication operation, a maintenance operation, or for any other suitable reason. An exchange of data may include a communications operation which may include an exchange of message via an email, an instant message, an asynchronous notification, audio data, image data, and the like. A maintenance operation may include a transfer of policy data, security data, a software or firmware update, and the like.

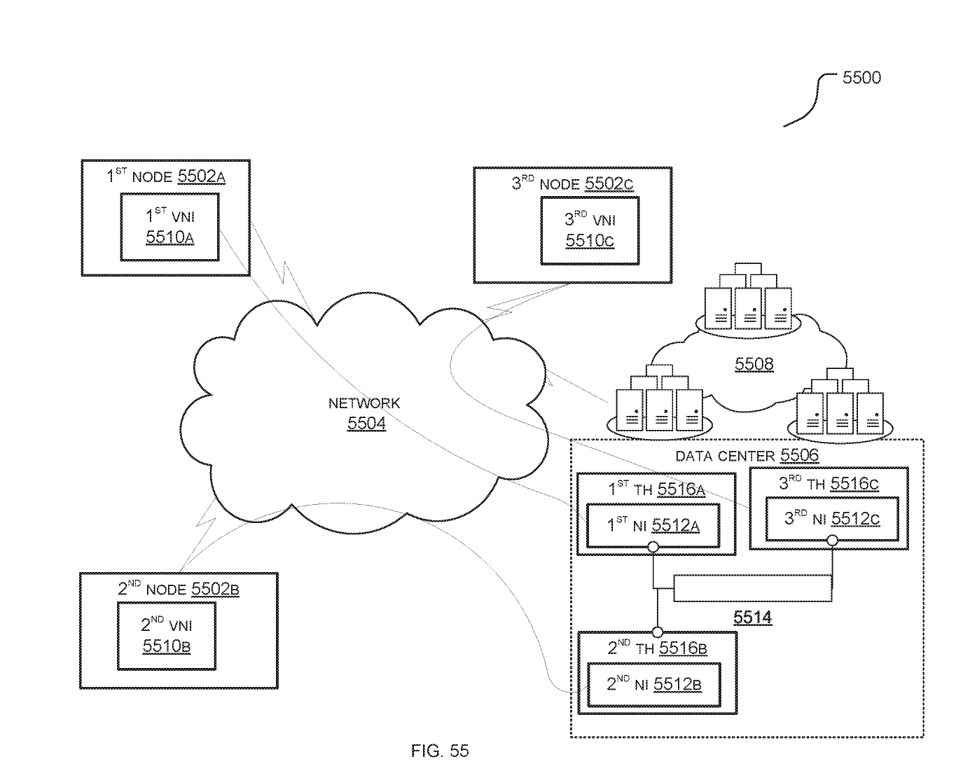

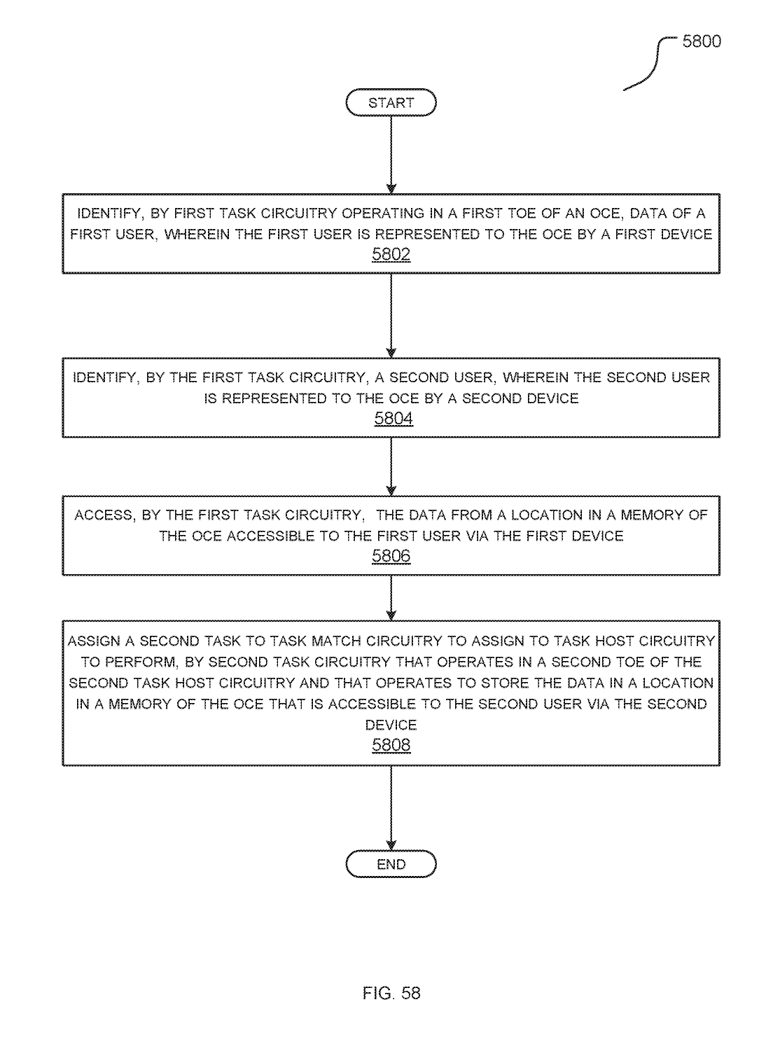

FIG. 55 shows a system 5500 that may operate to perform one or more methods of the subject matter of the present disclosure. FIG. 55 shows that system 5500 includes two or more nodes illustrated in FIG. 55 by a first node 5502a, a second node 5502a, and a third node 5502c. Each node may be communicatively coupled, via a network 5504 to one or more data centers 5506 which may host a cloud computing environment or an offer-based computing environment 5508. In other embodiments, a fourth node or a grouping of nodes not in a data center may host equivalent or analogous circuitry, described below, rather than a data center 5506. FIG. 55 illustrates first node 5502a includes circuitry that emulates a first network hardware interface illustrated by first virtual network interface (VNI) 5510a. Analogously, second VNI circuitry 5510b operates in or based on accessible resources of the second node 5502b, and third VNI circuitry 5510c operates in or based on accessible resources of the third node 5502c. Each VNI 5510 may be at least partially realized via a network interface in its respective host node 5502 which provides access via network 5504 to a respective network interface (NI) in the data center 5506. As shown in FIG. 55, first VNI circuitry 5510a may be communicatively coupled to a first NI 5512a which provides access to a network of the data center 5506. The network is illustrated as a local area network (LAN) 5514. In other embodiments, the network may be a bridged or switched plurality of LANs, an intranet, or an SDN—to identify some examples. FIG. 55 illustrates that, in an embodiment, an NI 5512 may be provided as a resource of task host circuitry 5516 when the data center is included in or otherwise hosts an offer-based computing environment 5508 as FIG. 58 illustrates. In some embodiments, a single instance of task host circuitry or a single task operating environment of task host circuitry may provide access to more than one network interface and task circuitry may be shared by multiple nodes for realizing respective VNIs 5510. FIG. 55 illustrates an embodiment in which each VNI 5510 may be served by task circuitry in a respective task host circuitry 5516 to access a respective network interface 5512. First VNI circuitry 5510a interoperates with task circuitry operating in a first task operating environment (not shown) that operates in or otherwise under control of the first task host circuitry 5516a and provides the first task circuitry access to the network 5514 via the first network interface 5512a. Analogously, second VNI circuitry 5510b interoperates with task circuitry operating in a second task operating environment (not shown) that operates in or otherwise under control of the second task host circuitry 5516b and provides the second task circuitry access to the network 5514 via the second network interface 5512b. Additionally VNIs 5510 may be realized similarly as shown by third VNI circuitry 5510c with interoperates with task circuitry operating in a third task operating environment (not shown) that operates in or otherwise under control of the third task host circuitry 5516c and provides the third task circuitry access to the network 5514 via the third network interface 5512c. Task host task circuitry for each VNI may operates in a respective task operating environment. In an embodiment, an NI in does not have to be accessed via task circuitry operating in a task host.

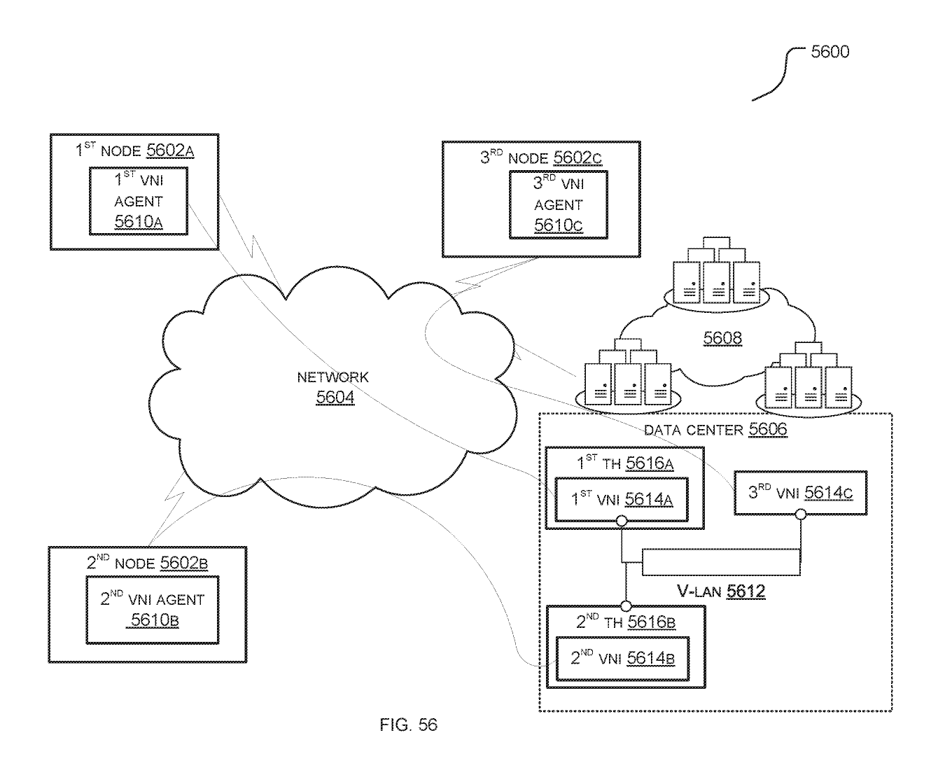

FIG. 56 shows a system 5600 that may operate to perform one or more methods of the subject matter of the present disclosure. FIG. 56 shows that system 5600 includes two or more nodes illustrated in FIG. 56 by a first node 5602a, a second node 5602a, and a third node 5602c. Each node may be communicatively coupled, via a network 5604 to one or more data centers 5606 which may host a cloud computing environment or an offer-based computing environment 5608. In other embodiments, a fourth node or a grouping of nodes not in a data center may host equivalent or analogous circuitry, described below, rather than a data center 5606. FIG. 56 illustrates first node 5602a includes circuitry, first VNI agent circuitry 5610a, that provides access via the first node to a virtual network 5612 of the data center 5606 or of the offer-based computing environment 5608. The network is illustrated as a virtual LAN 5614. In other embodiments, the network may be a virtual bridged or switched plurality of LANs or other types of links, virtual private network (VPN), or a virtual network of an SDN—to identify some examples. First VNI agent circuitry 5610a interoperates via network 5604 with first VNI circuitry 5614 operating in the data center 5606 or otherwise operating in the offer-based computing environment 5608. In an embodiment, first VNI circuitry 5614a that emulates a network interface may operate as task circuitry (not shown) in a task operating environment (not shown) of first task host circuitry 5616a. Second node 5602b may be analogously configured with second VNI agent circuitry 5610b that interoperates via network 5604 with second VNI circuitry 5614b operating in the data center 5606 or otherwise operating in the offer-based computing environment 5608. Second VNI circuitry 5614b that emulates a network interface may operate as task circuitry (not shown) in a task operating environment (not shown) of first task host circuitry 5616b. Additional nodes, such as third node 5602c may also configured in a functionally analogous manner. Third VNI agent circuitry 5610c is illustrated, in third node 5602c, that interoperates via network 5604 with third VNI circuitry 5614b operating in the data center 5606 or otherwise operating in the offer-based computing environment 5608. Third VNI circuitry 5614c, as shown, illustrates that circuitry that emulates a network interface may operate in an environment other than a task host environment of task host circuitry.

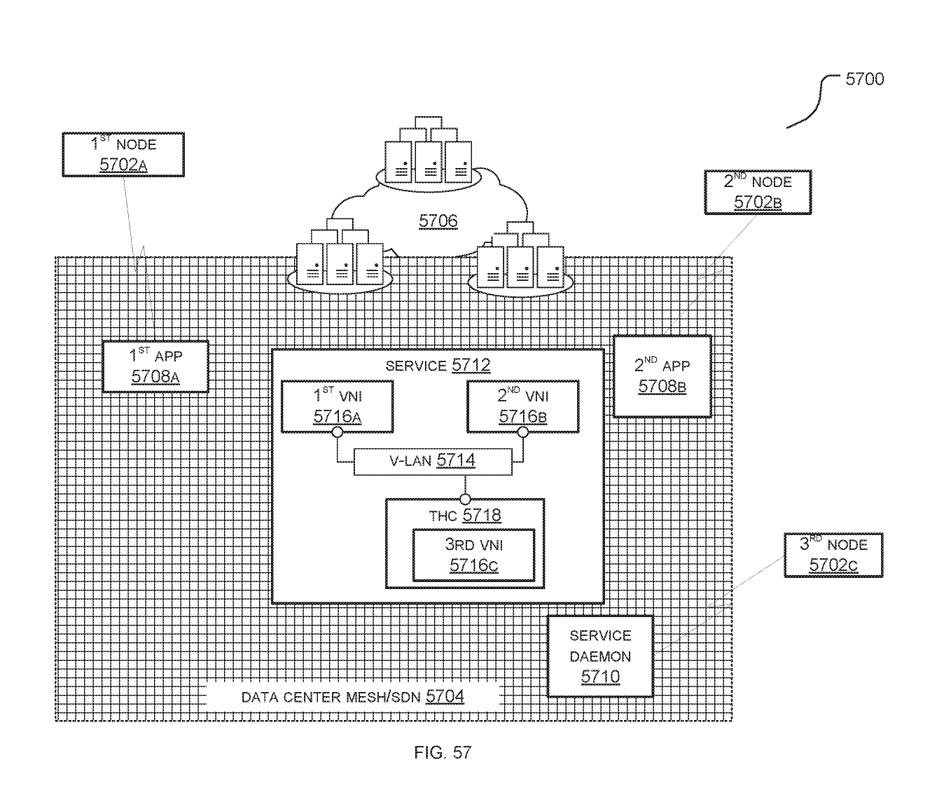

FIG. 57 illustrates yet another system that enables nodes that are remote from one another in a network to communicate via a server node, a data center, a cloud computing environment, or other grouping of devices. The server node, data center, cloud computing environment, or other grouping of devices may be included in or may otherwise host an offer-based computing environment. FIG. 57 shows a system 5700 that may operate to perform one or more methods of the subject matter of the present disclosure. FIG. 57 shows that system 5700 includes two or more nodes illustrated in FIG. 57 by a first node 5702a, a second node 5702a, and a third node 5702c. Each node may be communicatively coupled to a data center 5704. In an embodiment, the data center may at least partially host an offer-based computing environment 5706. FIG. 57 illustrates first node 5702a may be operatively coupled to first app circuitry 5708 operating in data center 5704. The operative coupling may include a communicative coupling via a network, such as the Internet. First app circuitry 5708a may interoperate with first node 5702a to interact with a user of first node 5702a. Second node 5702b may be operatively coupled to second app circuitry 5708b operating in data center 5704. Second app circuitry 5708a may interoperate with second node 5702a to interact with a user of second node 5702a. Third node 5702c may be operatively coupled to circuitry that provides a service to the first app circuitry 5708a or to second app circuitry 5708b. The service may operate, at least partially in the data center 5704 or the offer-based computing environment 5706 as illustrated by service daemon circuitry 5710, which may or may not provide a user interface to a user of the third node 5702c. A service for communicatively coupling the first app circuitry 5702a or the second app circuitry 5702b with the service daemon 5710 may be hosted by the data center 5704 or the offer-based computing environment 5706. At least part of the service may be performed by task circuitry operating in a task operating environment matched with the task based on an offer provided by task host circuitry. FIG. 57 illustrates that a service 5712 may provide a virtual network, exemplified by a virtual LAN (V-LAN) 5714. Service 5712 includes first VNI circuitry 5716a that interoperates with first app circuitry 5708a to transmit or receive data via V-LAN 5714. Also, service 5712 includes second VNI circuitry 5716b that interoperates with second app circuitry 5708b to transmit or receive data via V-LAN 5714. For exchanging data with the service daemon circuitry 5710, service 5712 includes third VNI circuitry 5716c that interoperates with service daemon circuitry 5710 to transmit or receive data via V-LAN 5714. Note that VNI circuitry may be included in task circuitry that operates in a task operating environment of task host circuitry as illustrated by task host circuitry 5718 providing a task operating environment matched with task circuitry that includes or otherwise accesses the third VNI circuitry as a resource of the matched task operating environment.

A network may be an example of a shared resource. Other resources may be share analogously, such as storage, interprocess communication mechanisms, non-executable data, executable code or logic.

Exchanging data within a server node, a data center, a cloud computing environment, or other grouping of devices on behalf of network nodes may be faster, safer, or more reliable (to name a few benefits) than exchanging the data via a network path in an open or public network, such as the Internet. Exchanges between network nodes may be performed, at least in part even when one or more of the network nodes is not operating, not in operational state for sending or receiving data via a network, while coupled to an unsafe network, when under threat from malware, during a maintenance operation, while a user is directing insufficient attention to one of the network nodes, o while a network node or operating environment of a network node has a missing, insufficient, or otherwise inadequate resource that is utilized in sending, receiving, or otherwise processing data exchanged between or among the network nodes. Some or all of the data may at some point be transferred to or received from one or both of the first node and the second node. In some operations, there may be no need for some or all of the data transferred within the server node, data center, cloud computing environment, or other grouping of devices. Data exchange in the server node, data center, cloud computing environment, or other grouping of devices may be exchanged via a private network, a VPN, an SDN, via an IPC mechanism, via shared memory, via a bus, or a switching fabric—to name some examples.

FIG. 58 shows a flow chart 5800 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 5802, first task circuitry may identify data of a first user. The first task circuitry may operate in a first task operating environment of an offer-based computing environment. The user may be represented to the offer-based computing environment by a first node able to communicate with the offer-based computing environment via a network. At block 5804, the first task circuitry may identify a second user. The second user may be represented to the offer-based computing environment by a second node that may communicate with the offer-based computing environment via the network. At block 5806, the first task circuitry accesses the data from a location in a memory of the offer-based computing environment. The data may be accessible to the first user from the location in the memory via the first node. At block 5808, a second task may be identified to task match circuitry to match the second task with task host circuitry. The matched task host circuitry performs the second task by executing second task circuitry in a task operating environment of the offer-based computing environment. The second task circuitry may operate to store the data in a location in a memory of the offer-based computing environment that is accessible to the second user via the second node.

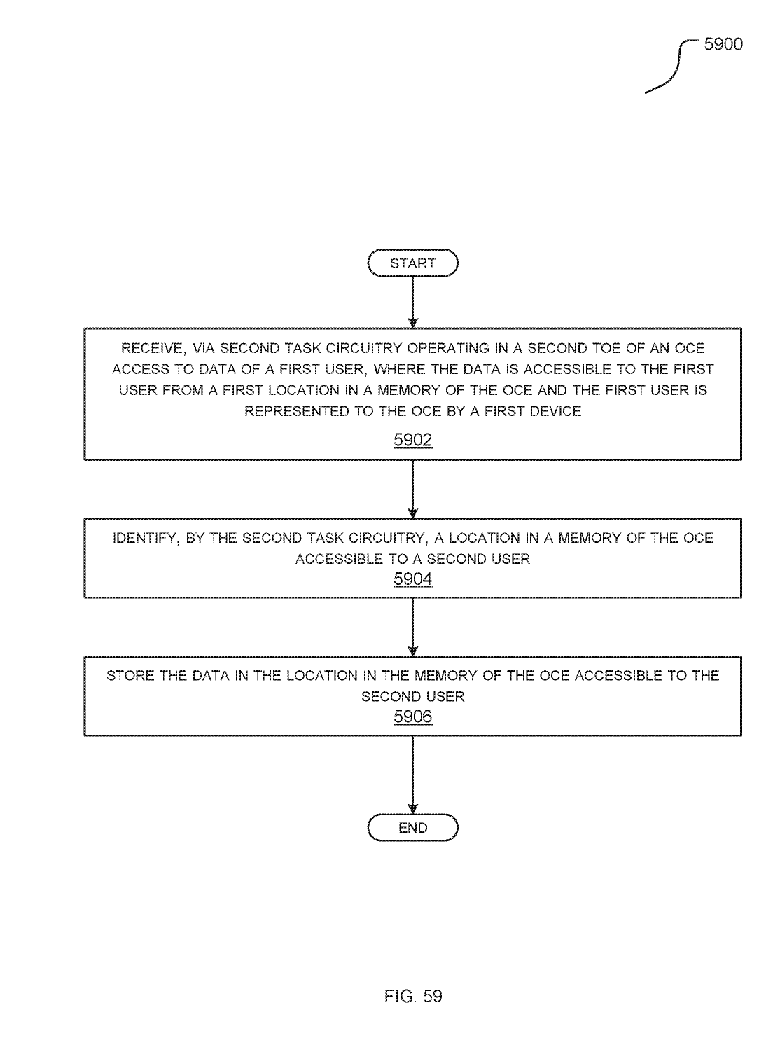

FIG. 59 shows a flow chart 5900 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 5902, access may be received, via second task circuitry operating in a second task operating environment of an offer-based computing environment, to data of a first user. The data may be accessible to the first user from a first location in a memory of the offer-based computing environment. Also the first user may be represented to the offer-based computing environment by a first node. At block 5904, the second task circuitry may identify a location in a memory of the offer-based computing environment that is accessible to a second user. At block 5906, the data may be stored in the location in the memory of the offer-based computing environment that is accessible or the second user.

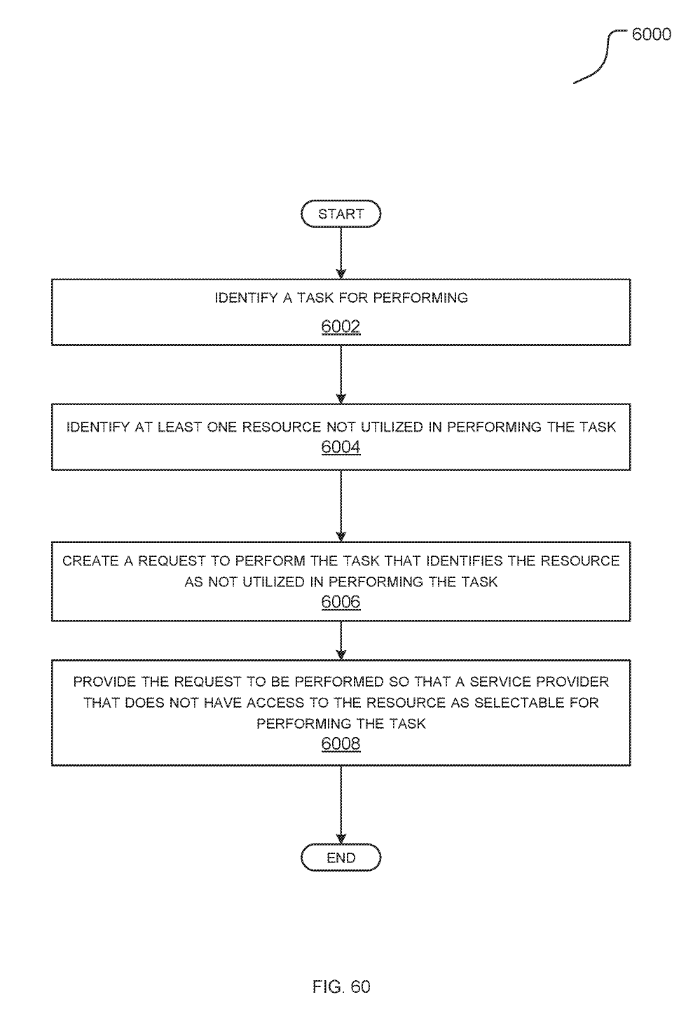

FIG. 60 shows a flow chart 6000 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 6002, a task to be performed may be identified. At block 6004, one or more resources not utilized in performing the task may be determined or otherwise identified. At block 6006, a request may be created or otherwise configured to perform the task. The request may identify the resource as not utilized in performing the task. At block 6008, the request may be provided so that a service provider that does not have access to the resource is or may be selected for performing the task.

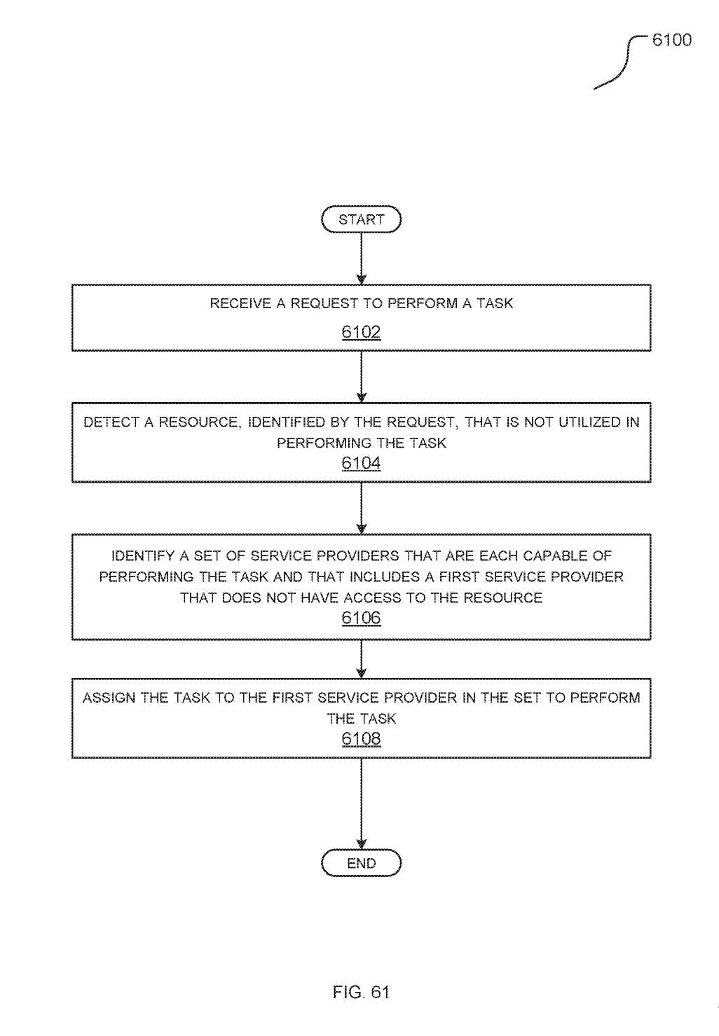

FIG. 61 shows a flow chart 6100 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 6102, a request to perform a task may be received or otherwise identified. At block 6104, a resource may be identified by the request as not utilized in performing the task or a resource may be otherwise determined to not be utilized in performing the task. At block 6106, a set of one or more service providers that are each capable of performing the task are identified. In an embodiment, a service provider may be realized via task host circuitry or a task operating environment. The set includes a service provider that does not have access to the resource. At block 6108, the task may be assigned to the service provider that does not have access to the resource.

A task may be received by task match circuitry or task coordination circuitry based on the resource not needed. An offer may be sent to and received by task match circuitry or task coordination circuitry based on the resource not needed. Further task match circuitry, task coordination circuitry, or task host circuitry may be associated with task-offer routing circuitry based on a resource not needed.

A task host circuitry may create, select, or otherwise configure a task operating environment so that task circuitry operating in the task operating environment does not have access to the resource identified as not utilized in performing the task. Task coordination circuitry and task-offer routing circuitry for a task may negotiate to identify what resource(s) to identify as accessible or not accessible in an offer of the task host circuitry or otherwise processed by the task-offer routing circuitry or task match circuitry.

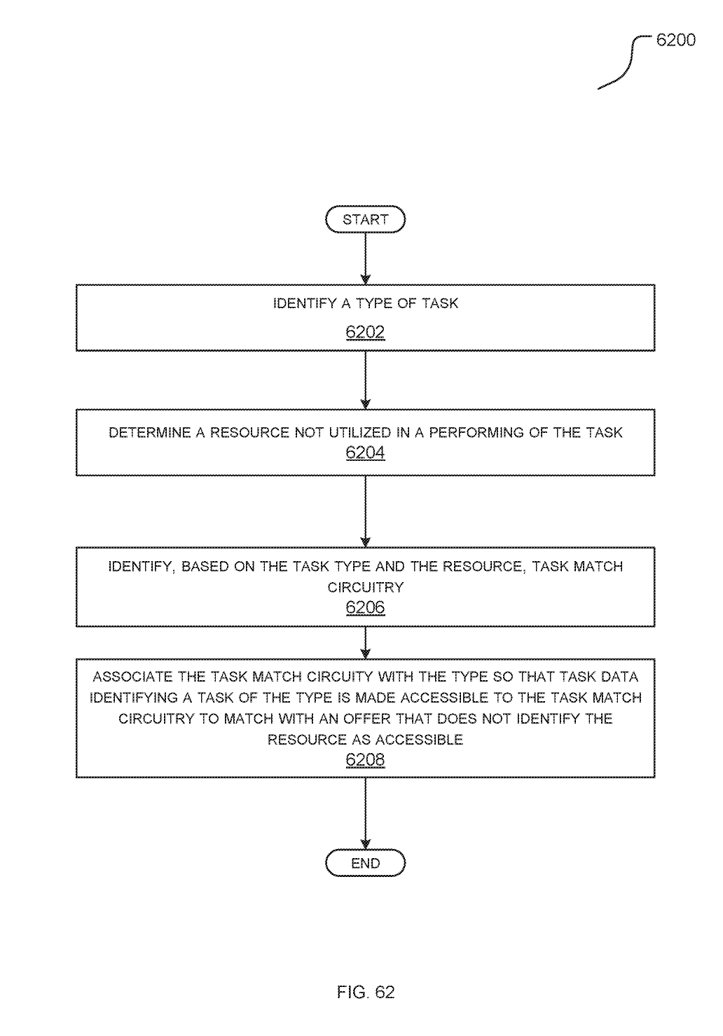

FIG. 62 shows a flow chart 6200 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment provided by a second node, a service site, a data center, or an offer-based computing environment. The system may also include a first node not included in the service site, data center, or offer-based computing environment. The first node and the offer-based computing environment may be communicatively coupled via a network. At block 6202, a type of task may be identified. At block 6204, a first resource may be identified by the request where the resource is not utilized in performing the type of task. Alternatively or additionally, a second resource may be identified that is utilized in performing the type of task. At block 6206, task match circuitry may be identified based on the type of task and the first resource. Alternatively or additionally, task match circuitry may be identified based on the type of task the second resource. At block 6208, the task match circuitry may be associated with the type. The association may be stored in a memory to configure the offer-based computing environment to send, route, provide, or otherwise make accessible task data that may identify a task of the type to the task match circuitry associated with the type. As such, task match circuitry or task coordination circuitry may be associated with task-offer routing circuitry or task host circuitry by a task performed in a task host operating environment as assigned based on an offer from a task host of the task host operating environment. A hierarchy of task match circuitry, task coordination circuitry, task host circuitry, task operating environment, or task-resource allocation circuitry may be configured to assign tasks to task hosts.

In an embodiment, task match circuitry may be identified by identifying task coordination circuitry based on a resource or a type of task. The resource may be identified as utilized in performing the task or not. Further a resource may be identified as required for performing a task or type of task, prohibited, preferred, an alternative, or otherwise as optional in performing a task or type of task.

In an embodiment, associating the task match circuitry with a type may include associating task coordination circuitry with the type. The association, as described, may be stored in a memory to configure an offer-based computing environment to send, route, provide, or otherwise make accessible task data that may identify a task of the type to the task coordination circuitry associated with the type. The task coordination circuitry operates to provide the task data to the task match circuitry.

A task may be received by task match circuitry or task coordination circuitry based on a resource not needed. An offer may be sent to and received by task match circuitry or task coordination circuitry based on the resource not needed. Further task match circuitry, task coordination circuitry, or task host circuitry may be associated with task-offer routing circuitry based on a resource not needed.

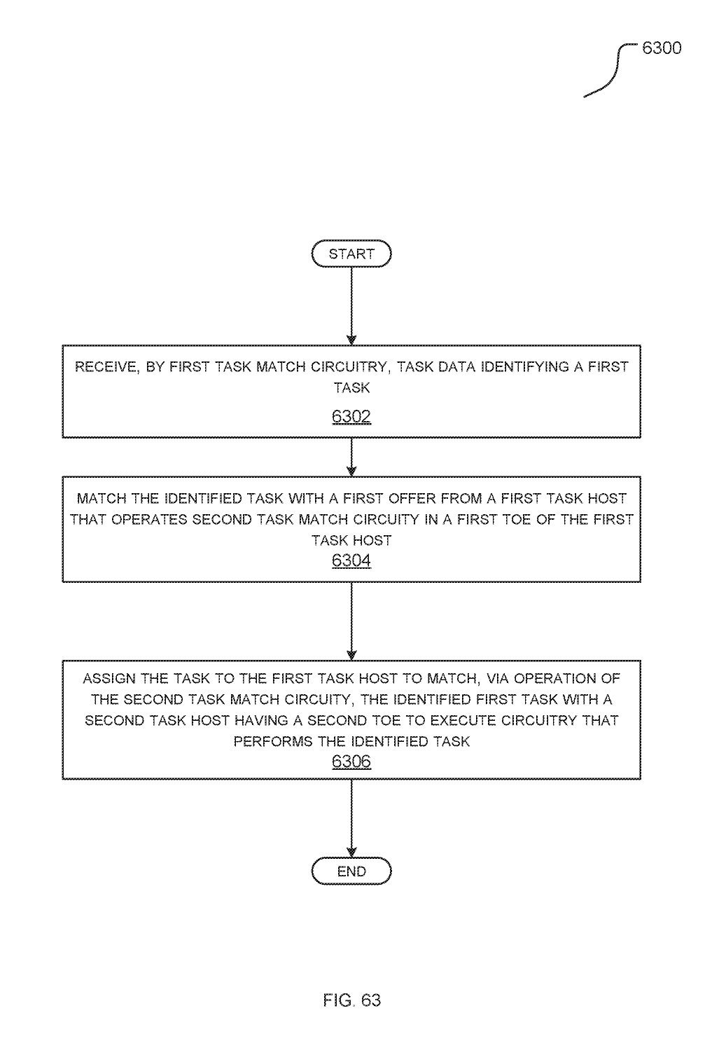

FIG. 63 shows a flow chart 6300 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 6302, first task match circuitry receives task data that may identify a first task. At block 6304, the first task may be matched with a first offer from first task host circuitry that operates second task match circuitry in a first task operating environment of the first task host circuitry. At block 6306, the first task may be identified to the first task host circuitry to match, via operation of the second task match circuitry, the first task with second task host circuitry to perform at least a portion of the first task in a task operating environment of the second task host circuitry.

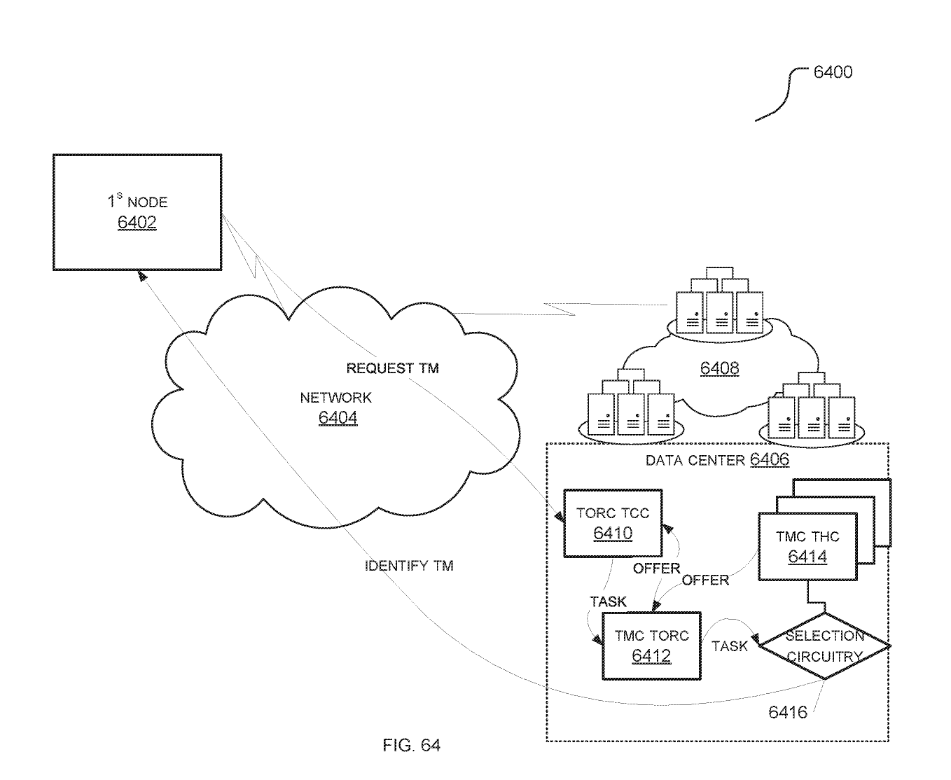

FIG. 64 shows a system 6400 that may operate to perform one or more methods of the subject matter of the present disclosure. FIG. 64 shows that system 6400 includes a first node 6402 that includes a network interface for exchanging data via a network 6404 with one or more other nodes, such as in data center 6406 of an offer-based computing environment 6408. First node 6402 may be shown sending a request to task-offer routing circuitry task coordination circuitry 6410 that coordinates and schedules instances of task match circuitry and/or other task coordination circuitry. Task-offer routing circuitry task coordination circuitry 6410 may include or access task match circuitry that operates to match an offer with a task identified by the first user node 6402. The offer may be not from task host circuitry that performs the task, rather the offer may be from task host circuitry for performing a task that assigns the task to task coordination circuitry and/or to task match circuitry that operates to match the task with an offer from task host circuitry to perform the task. In another embodiment, a node, such a first node 6402, may include circuitry that performs all or part of the role of task-offer routing circuitry task coordination circuitry 6410 in system 6400. Task-offer routing circuitry task coordination circuitry 6410 may receive the request from the first node 6402 based on a configured association between the first node and the task-offer routing circuitry task coordination circuitry 6410. Alternatively or additionally, task-offer routing circuitry task coordination circuitry 6410 may receive the request based on a configured association between the task-offer routing circuitry task coordination circuitry 6410 and a user associated with the task, an attribute of the task, and/or any other suitable attribute associated with the task. Task-offer routing circuitry task coordination circuitry 6410 may interoperate with task match task-offer routing circuitry 6412 (or task coordination circuitry task-offer routing circuitry) to receive an offer from task host circuitry 6414 that operates selection circuitry 6416 that performs the task of selecting task match circuitry or task coordination circuitry based on the node, a user of the node, a task of the node, or any other suitable attribute of the task. The selected task match circuitry (or task coordination circuitry) may be identified to the first node 6402 in an embodiment. The first user node 6402 may send task data, that may identify a task to be perform, to the selected task match circuitry or task coordination circuitry. The task match circuitry or task coordination circuitry may operate in data center 6406 or the offer-based computing environment 6408. In another embodiment, the identified task match circuitry may operate in a data center of the offer-based computing environment 6408 or in a data center or a node of another offer-based computing environment. In yet another embodiment, the task match circuitry or task coordination circuitry may operate in the first node 6402, which may include one or more embodiments of task match circuitry or task coordination circuitry suitable for matching various types of tasks. Still further, the task match circuitry or task coordination circuitry may operate in an another node or a peripheral device attached to a node coupled to network 6404. In yet another embodiment, the task match circuitry may be accessed via a network other than network 6404 and may use a same or a different network protocol(s) or a same or a different data transmission medium or media. A task may operate to associate task match circuitry with task-offer routing circuitry or vice versa. A task may operate to associate task host circuitry with task-offer routing circuitry or vice versa. A task may operate to associate task host circuitry with task coordination circuitry or task match circuitry, so that an offer of the task host may be provided to the task match circuitry. Such associations once configured may be persistent. Alternatively or additionally, such associations may be created dynamically in real-time, near real-time, or as needed.

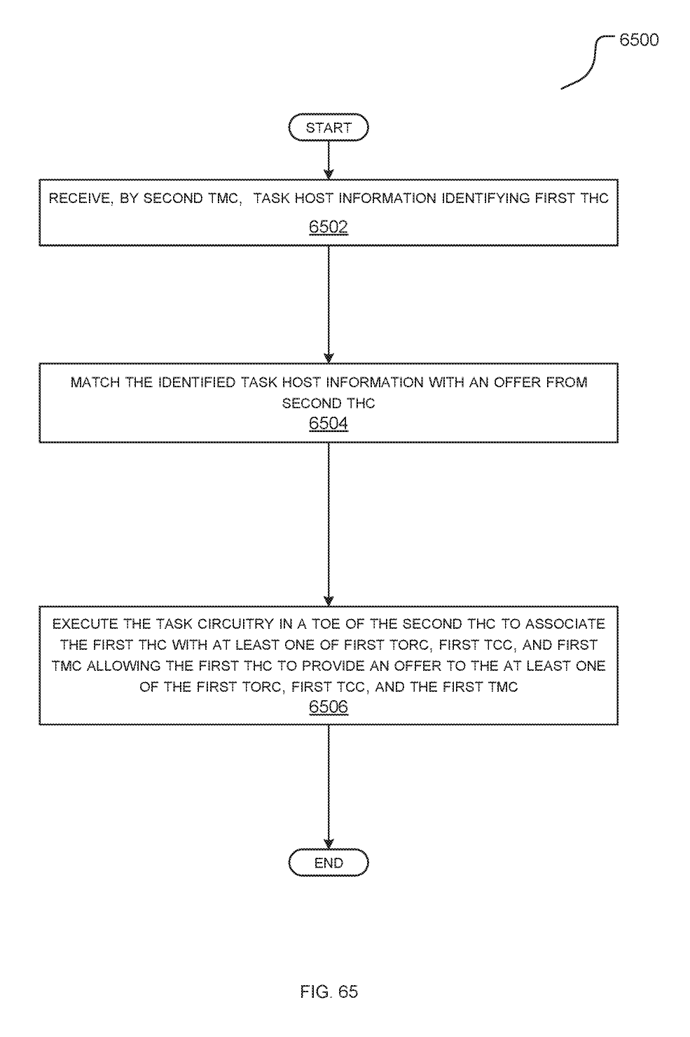

FIG. 65 shows a flow chart 6500 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 6502, second task match circuitry receives task host information that may identify first task host circuitry. At block 6504, the second task match circuitry matches the first task host information with an offer from second task host circuitry. At block 6506, task circuitry may be executed in a task operating environment of the second task host circuitry. The task circuitry associates or binds the first task host circuitry with at least one of first task-offer routing circuitry, first task coordination circuitry, and first task match circuitry. The first host circuitry may be capable, in response to the execution of the task circuitry, of providing an offer to the at least one of the task-offer routing circuitry, the first task coordination circuitry, and the first task match circuitry. The method allows task host circuitry to be efficiently associated with task match circuitry, directly or indirectly. Such associations may be static and long-lived or may be dynamic. Dynamic associations may be changed in real-time, near-real time, or as needed based on the needs of a particular system realizing an embodiment of the method. In an another analogous method, task match circuitry may be associated with at least one of task coordination circuitry, task-offer routing circuitry, and task host circuitry. Further still, yet another variant of the method allows task coordination circuitry to be associated with at least one of task match circuitry, task-offer routing circuitry, and task host circuitry. In still another similar method, task-offer routing circuitry may be associated with at least one of task match circuitry, task coordination circuitry, and task host circuitry. Associating and re-associating circuitry in an offer-based computing environment or in any task based operating environment may be utilized to recover when circuitry fails and may also be useful in scaling a system up or down. The circuitry may also be useful in adding or removing capabilities in a system.

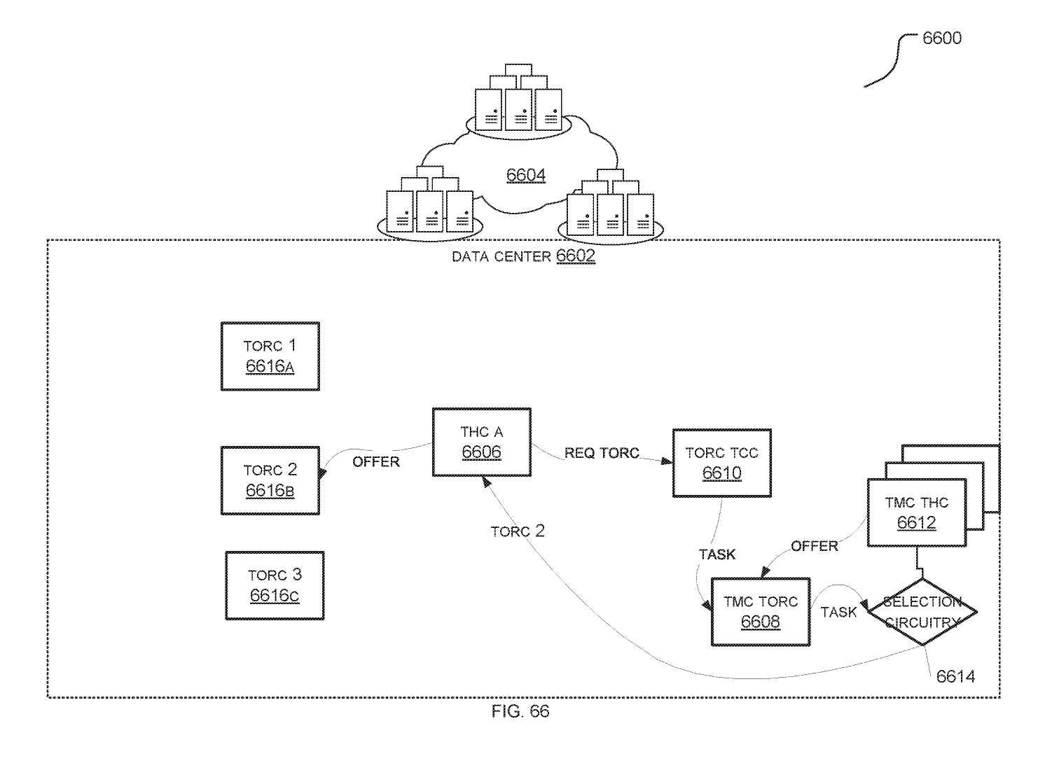

FIG. 66 shows a system 6600 that may operate to perform one or more methods of the subject matter of the present disclosure. A system may include at least one resource. FIG. 66 shows that system 6600 includes a data center 6602 of an offer-based computing environment 6604. Offer-based computing environment 6604 includes task host circuitry A 6606 that may be not associated with task-offer routing circuitry or that may be re-assignable from an existing association with task-offer routing circuitry to a new task-offer routing circuitry. For example, reassignment may occur in response to a priority associated with task-offer routing circuitry, a utilization of the task host circuitry or task-offer routing circuitry, a maintenance condition, a security condition, a performance condition, a time of day, a price, a date, a user, a customer, or any other suitable criterion. Task data may be provided to task match circuitry of task coordination circuitry 6608. The task data may be provided via task-resource allocation task coordination circuitry 6610 as illustrated in FIG. 66. The task data may identify a task that when performed selects an instance of task-offer routing circuitry to associate with task host circuitry A 6606. FIG. 66 illustrates a number of instances of task-offer routing circuitry; task-offer routing circuitry 1 6616A, task-offer routing circuitry 2 6616B, and task-offer routing circuitry 3 6616c; which may be identified when the selection circuitry may be executed. Task match circuitry in or otherwise accessible to task-offer routing circuitry task coordination circuitry 6610 may be invoked to match an offer from one or more offers received from one or more task host circuitry 6612. Task match task host circuitry 6612 identified by the task match circuitry may be assigned, directly or indirectly, to perform the selection task via operation of selection circuitry 6614 in a task operating environment (not shown) of the assigned task match task host circuitry 6612. FIG. 66 illustrates that an instance of task-offer routing circuitry may be selected, (e.g. Task-offer routing circuitry 2 6616b) to associate with task host circuitry A 6606. Data may be exchanged with task host circuitry A (as shown) or with some other circuitry in offer-based computing environment 6604 to create the association. Once the association exists, task host circuitry A 6606 may send an offer to task-offer routing circuitry 2 6616b to be matched with a task. In an embodiment, task host circuitry A may be associated with more than one instance of task-offer routing circuitry.

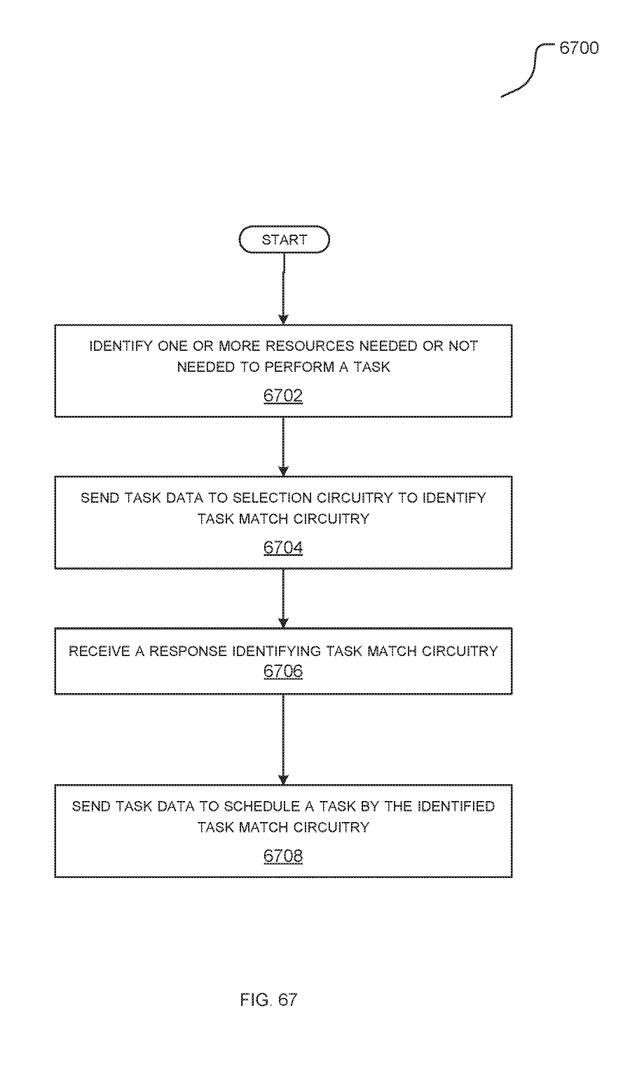

FIG. 67 shows a flow chart 6700 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 6702, one or more resources that are needed or not needed to perform a task are identified. At block 6704, task data may be sent to selection circuitry to identify task match circuitry to match the task with an offer. At block 6706, a response from the selection circuitry may identify the task match circuitry. At block 6708, task data identifying the task may be sent the identified task match circuitry.

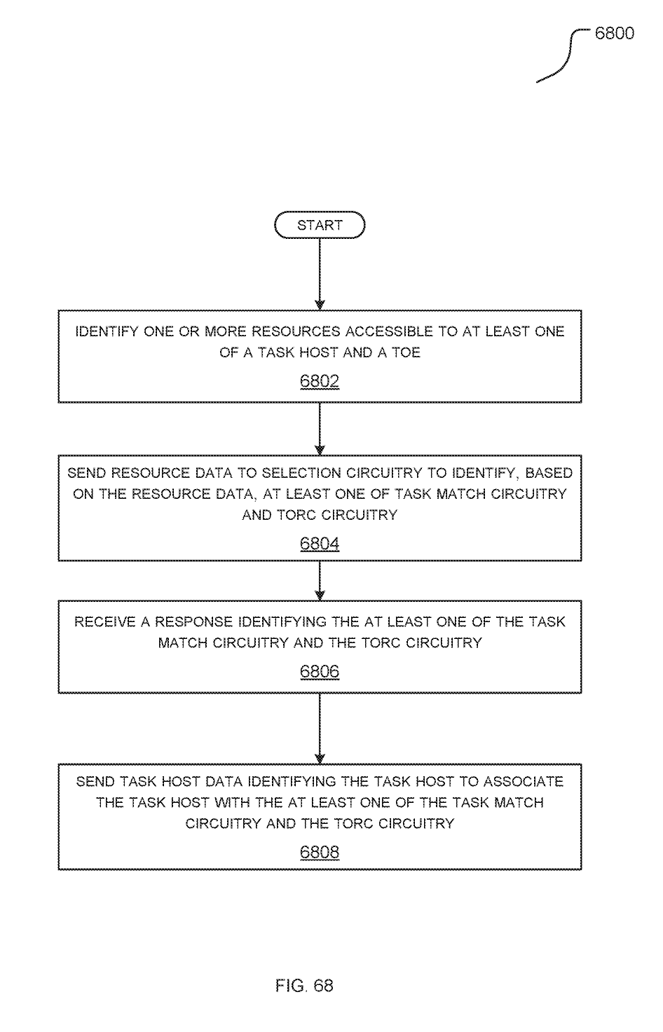

FIG. 68 shows a flow chart 6800 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 6802, one or more resources are identified that are accessible to at least one of task host circuitry and a task operating environment. At block 6804, resource data may be sent to selection circuitry to identify, based on the resource data, at least one of task match circuitry and task coordination circuitry. At block 6806, a response may be received from the selection circuitry identifying the at least one of the task match circuitry and the task coordination circuitry. At block 6808, task host circuitry data may be sent that may identify the task host circuitry. The task host circuitry data may be sent to associate the task host circuitry with the at least one of the task match circuitry and the task coordination circuitry.

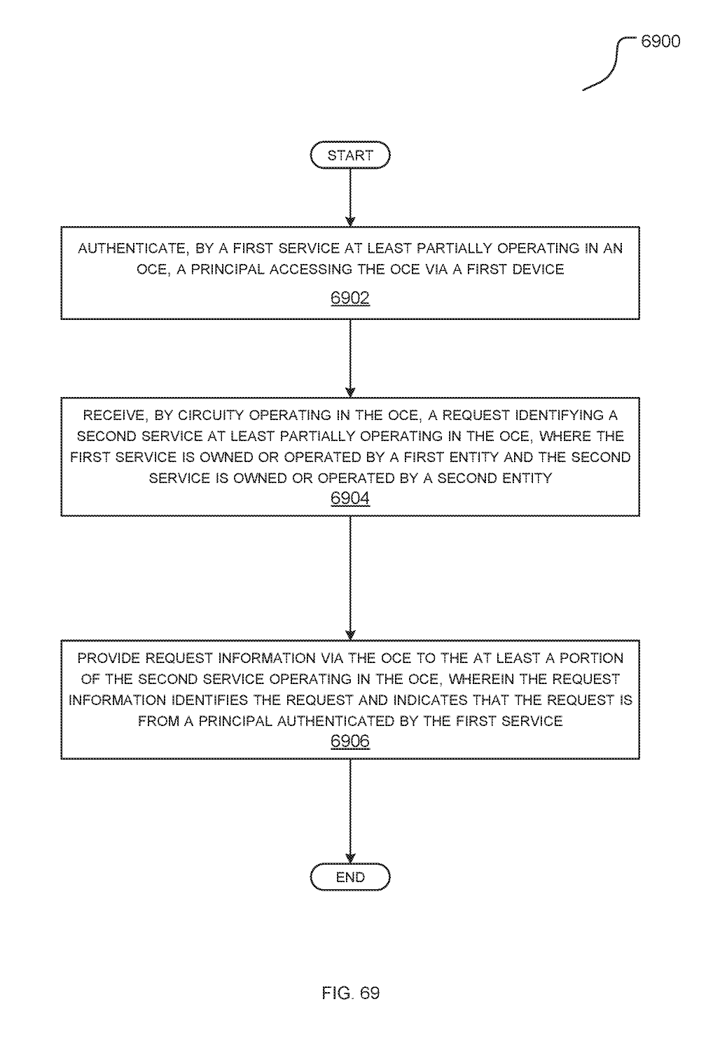

FIG. 69 shows a flow chart 6900 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment or a portion there of including or otherwise hosted by a second node, a service site, a data center, or a cloud computing environment and the system may include a first node that communicates with the offer-based computing environment via a network. At block 6902, a first service, at least partially operating in the offer-based computing environment, authenticates a principal (e.g. a user, a group, a legal entity) that accesses the offer-based computing environment via the first node. At block 6904, circuitry operating in the offer-based computing environment receives a request identifying a second service that at least partially operates in the offer-based computing environment. The first service has a first owner, a first operator, or may be provided by a first service provider that operates part of the first service in one or more nodes not included in or not otherwise hosting the offer-based computing environment. The second service has a second owner, a second operator, or may be provided by a second service provider that operates part of the second service in one or more nodes that are not included in or that do not otherwise host the offer-based computing environment. An owner, operator, or provider of the offer-based computing environment may be the first owner, first operator, or first service provider. Alternatively, the owner, operator, or provider of the offer-based computing environment may be the second owner, second operator, or second service provider. At block 6906, request information may be provided via the offer-based computing environment to the at least a portion of the second service operating in the offer-based computing environment. The request information may identify the request. The request information further indicates to the second service that the request is authenticated by the first service.

Alternatively or additionally, the request information may identify metadata about the principal or metadata that allows the request to processed based on information that may be at least partially false about the principal. For example, an age or location of the principal may be provided that may be not accurate. With respect to the second service, in an embodiment, the service provider site may be an online retailer that provides a web site accessible via the Internet. A web browser or a web protocol enabled app operating in a node may access the web site by transmitting a request (e.g. an HTTP request) including a URL for the website. The browser or app may access the web site without exchanging data via the offer-based computing environment or may access the website without being authenticated by the offer-based computing environment as far as the website may be concerned, as an alternative or in addition to accessing the service via the offer-based computing environment.

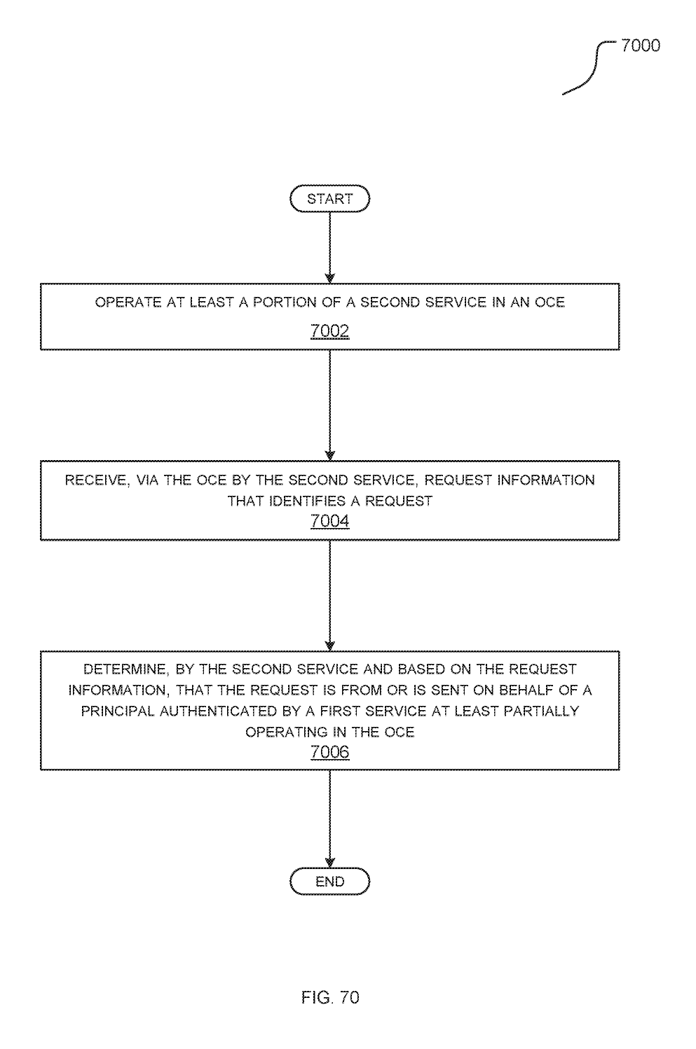

FIG. 70 shows a flow chart 7000 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment or a portion there of including or otherwise hosted by a second node, a service site, a data center, or a cloud computing environment and the system may also include a first node that may exchange data with the offer-based computing environment via a network. At block 7002, at least a portion of a second service may be operated in an offer-based computing environment. At block 7004, request information may be received, via the offer-based computing environment by the at least a portion of the second service operating in the offer-based computing environment. The request information may identify a request. At block 7006, the second service may determine, based on the request, that the request may be from or may be requested on behalf of a principal authenticated by a first service. The first service operates at least partially operating in the offer-based computing environment. The at least a portion of the first service may authenticate the principal. In an aspect, the principal may be represented by the first node that accesses the offer-based computing environment via the network. The principal, in an embodiment, may be user that interacts with a browser or web enabled app via a user interface of the first node. An owner or operator of the first service may be different than an owner or operator of the second service.

An authentication service may be shared by multiple service providers that receive requests via a same data center, a same cloud computing environment, or a same offer-based computing environment as the authentication service. Those skilled in the art will see based on the Figures and description of the present disclosure that services other or in addition to authentication services may be shared via a data center, cloud computing environment, or offer-based computing environment. Some additional services are identified below.

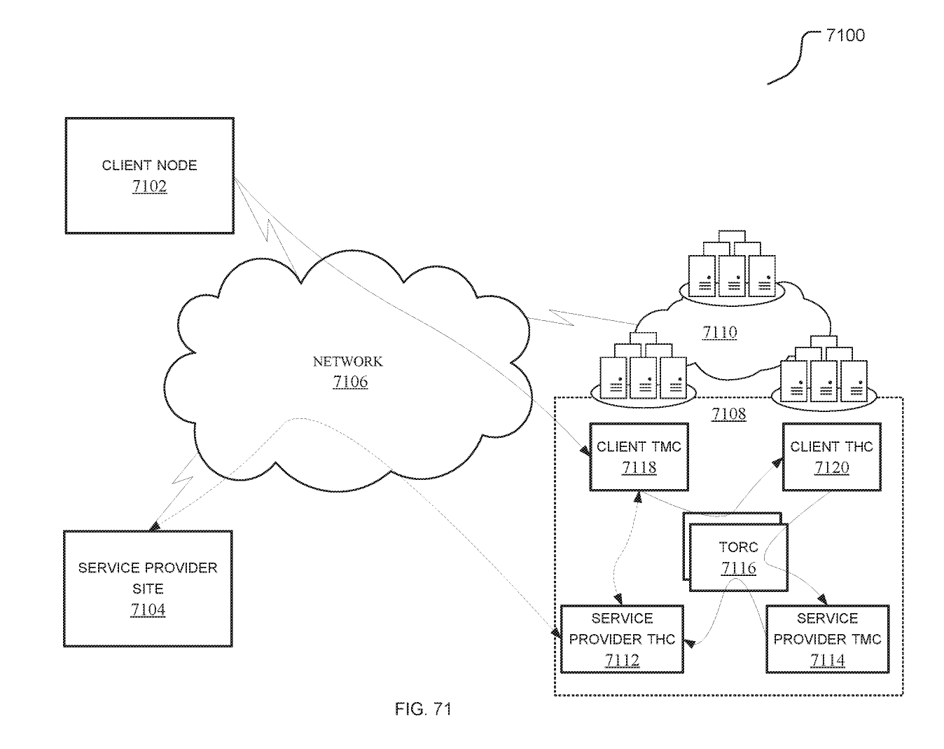

FIG. 71 shows a system 7100 that may operate to perform one or more methods of the subject matter of the present disclosure. FIG. 71 shows that system 7100 includes a client node 7102 that includes hardware that interoperates with a user. FIG. 71 also includes a service provider site 7104 which may operate in or may include one or more servers. The one or more servers may be included in one or more data centers. The one or more data centers may include or may otherwise host an offer-based computing environment which hosts the service provider site circuitry and data. The first node 7102 and the service provider site 7104 each respectively include a network interface for exchanging data via a network 7106 with one or more other nodes, such as in a data center 7108. The data center 7108 may be included in or may otherwise host a cloud computing environment or of an offer-based computing environment 7110. Client circuitry (not shown), such as an app or a browser, operating in an operating environment (not shown) of the client node 7102 may access a service or a resource of the service provider site 7104 via a communicatively coupling between the client node 7102 and the service provider site 7104 via the network 7106. FIG. 71 illustrates that a provider of the service provider site 710 may provide data or circuitry to operate in the data center 7108 or otherwise in the offer-based computing environment 7110. In one embodiment, one or more instances of service provider task host circuitry 7112, service provider task operating environments (not shown), or service provider task circuitry (not shown) may operate in the data center 7108 or otherwise in the offer-based computing environment 7110 to perform tasks included in providing access to a service or other resource offered by the service provider site 7104 or otherwise offered by a provider of the service provider site 7104. The service or other resource may be customized for users of the data center 7108 or of the offer-based computing environment 7110 or may be the same or equivalent to that provided via accessing the service provider site 7104 without the offer-based computing environment 7710 intervening. The service provider site 7104 may interoperate with one or more service provider instances of task host circuitry 7112, task operating environments, or task circuitry to provide access to a service or other resource, to manage or monitor the resources of the service provider in the data center 7108 or in the offer-based computing environment 7110, or to provide any other support service such as shipping, billing, and the like. In another embodiment, the services or other resources of the service provider operating in or otherwise accessible via the data center 7108 or the offer-based computing environment 7110 may operate without any interoperation with the service provider site 7104. Various embodiments, may operate with varying levels of interaction between the service provider site 7104 and the services or other resources of the service provider in the data center 7108 or in the offer-based computing environment 7110. Interoperation may occur in real-time or may occur periodically in response to detection of specified events, conditions, inputs, and the like. Periodic interoperation may occur regularly in time, such as scheduled interoperation or may occur irregularly. Interaction with a user may occur via the client node 7102 exchanging data such as a request for a resource (e.g. identifiable via a URI) with an instance of service provider task match circuitry 7114 either directly (not shown) or indirectly. One or more instances of service provider task match circuitry 7114 may operate in task coordination circuitry (not shown) provided on behalf of or by the service provider. The task coordination circuitry may be a framework or application included in the offer-based computing environment 7110 by the offer-based computing environment provider for the service provider as well as optionally for other customers. An instance of service provider task match circuitry 7114 may operate in the data center 7108 as shown in FIG. 71. In another embodiment, task match circuitry may operate at least partially in the client node 7102, such as in an app of the service provider, or may operate partially in the offer-based computing environment 7110 (data center or an external node/site). One or more instances of service provider task match circuitry 7114 may be included in the offer-based computing environment 7110 to match different types of tasks with offers that identify different sets of resources, to manage changes in capacity, to deal with failure of an instance of the service provider task match circuitry 7114, and so on. An instance of service provider task match circuitry 7112 may receive an offer via task-offer routing circuitry 7116, from one or more service provider hosts 7112. An instance of service provider task match circuitry 7114 may match or select a suitable offer and assign a task to a service provider task host circuitry 7112. The task when performed may be included in providing a service or other resource of the service provider to the client node 7102 or the user of the client node 7102. Responding to a request may include performing one or more tasks each of which may include one or more sub-tasks. One task that may be assigned to a service provider task host circuitry 7112 may include sending data to the client node 7102 to respond to a request from the client node 7102. In an embodiment, tasks usable by a number of service providers may be performed by corresponding task circuitry provided by the offer-based computing environment provider or some other entity. As such, a service provider need only provide service provider specific logic or data. The data may include service provider specific configuration data for logic provided by the offer-based computing environment provider or some other entity. An instance of client task match circuitry 7118 may operate in the data center 7108 as shown in FIG. 71. In another embodiment, client task match circuitry may operate at least partially in the client node 7102, such in a browser in data or logic accessed from service provider circuitry in the offer-based computing environment 7110 or from the service provider site 7114. In an embodiment, client task match circuitry may operate partially in the client node 7102 and partially in the offer-based computing environment 7110 (data center or an external node/site). One or more instances of client task match circuitry 7118 may be included in the offer-based computing environment 7110 to provide one or more services based on the user, the client node, a type of request, a task included in processing a request, a resource accessed in processing a request, to manage changes in capacity, to deal with failure of an instance of the client task match circuitry 7118, and so on. Client task match circuitry 7118 may provide a service or otherwise perform a task for the user or for the service provider. For example, an offer-based computing environment 7110 may include resources to authenticate a user, to determine a location of a client node, to provide a secure communication channel between the client node 7102 and the offer-based computing environment 7110, to decrypt or encrypt data exchanged with service provider logic in the offer-based computing environment 7110 or the service provider site 7104, to convert data from one format or schema to another suitable for processing by service provider logic, to validate data exchanged, to access data of the user maintained by the offer-based computing environment 7110 to transform or to otherwise process the request, and so on. An instance of client task match circuitry 7118 may receive an offer via task-offer routing circuitry 7116, from one or more client instances of task host circuitry 7120. The instance 7118 may match or select a suitable offer and assign a task included in providing a service or other resource of the offer-based computing environment 7110 on behalf of the user or on behalf of the service provider. One task that may be assigned to a client task host circuitry 7120 may include sending data to the client node 7102 to respond to a request from the client node 7102. Another task performed by a client task host circuitry 7120, in an embodiment, may include sending request data based on the request to one or more instances of service provider task match circuitry 7114 to assign one or more tasks included in processing the request as describe above as well as elsewhere in the present disclosure. FIG. 71 illustrates that client task host circuitry 7120 may include task match circuitry that matches a task with an offer from an instance of service provider task match circuitry 7114 which plays the role of task host circuitry that performs the task of matching a task with a service provider task host circuitry 7112. Communication between a client task host circuitry 7120 and an instance of service provider task circuitry 7114 may occur via task-offer routing circuitry 7116 as described in various embodiments in the present disclosure.

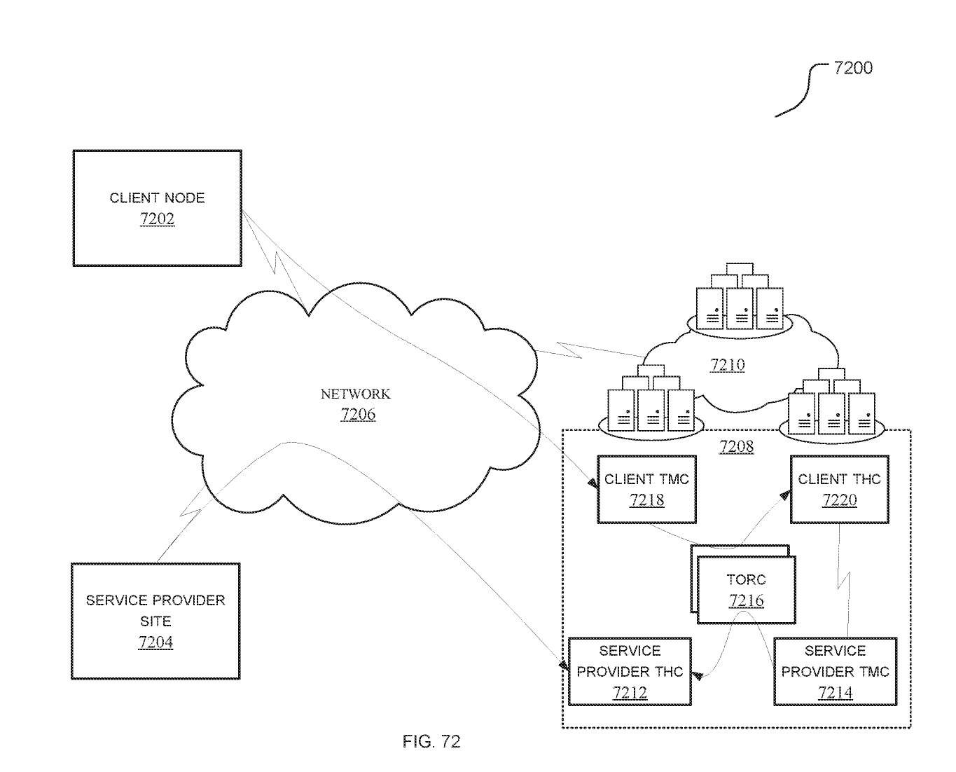

FIG. 72 shows a system 7200 that may operate to perform one or more methods of the subject matter of the present disclosure. FIG. 72 shows that system 7200 includes a client node 7202, a service provider site 7204, a network 7206, a data center 7208, an offer-based computing environment 7210, service provider task host circuitry 7212, service provider task match circuitry 7214, task coordination circuitry 7216, client task match circuitry 7218, and client task host circuitry. The arrangement illustrated in system 7200 may operate in a manner analogous to that described with respect to system 7100 in FIG. 71 or other systems described or illustrated in the present disclosure. FIG. 72 illustrates that in an embodiment, client task host circuitry 7220 may exchange data with service provider task match circuitry 7214 without processing an offer received via task-offer routing circuitry 7216. In an embodiment, an instance of task-offer routing circuitry 7216 may be bound to a client task host circuitry 7220 via hard-wiring, via a reference resolved by a linker, by a path identified by management circuitry of an SDN, via a path identified in a switching fabric such as included in present data network routers or network switches, or via any other suitable communications technologies.

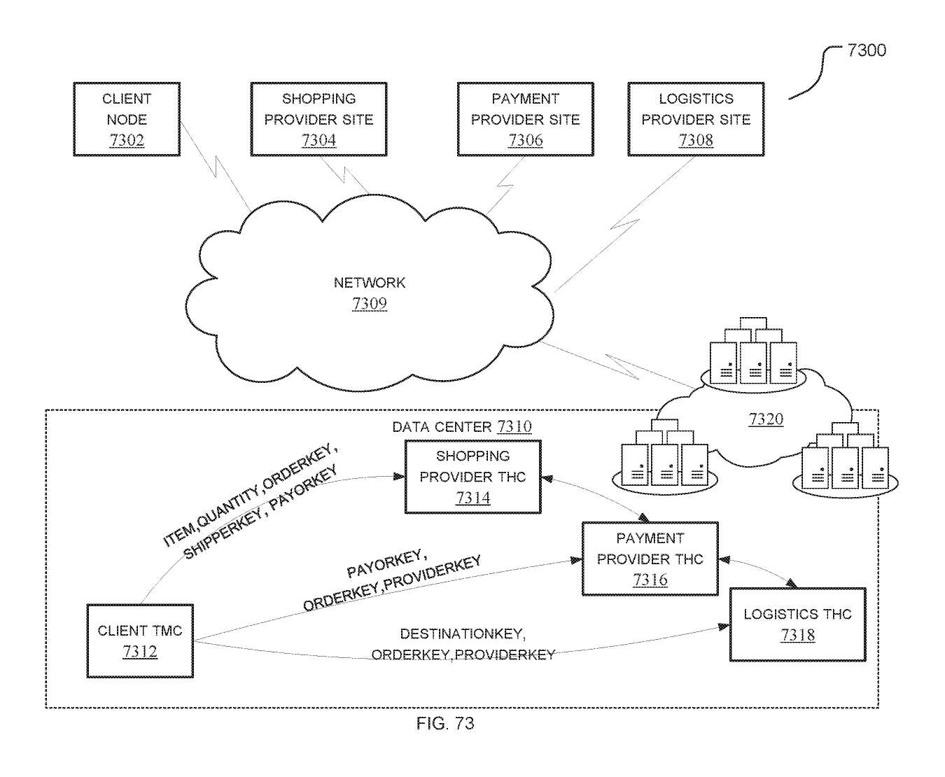

FIG. 73 shows a system 7300 that may operate to perform one or more methods of the subject matter of the present disclosure. FIG. 73 shows that system 7300 includes a client node 7302 and a service provider site, shown as a shopping provider site 7304. The service provider of the site 7304 may provide goods or services for pay. Some or all of the goods or services provided may include delivery to a geospatial location. A payment provider site 7306 in FIG. 73 illustrates a network accessible service that enables customers of the payment provider, such as a user of client node 7302, to pay for goods or services from the shopping provider site 7304. A logistics provider site 7306 in FIG. 73 illustrates a network accessible service that enables customers of the logistics provider to arrange for, pay, and track delivery resulting from a transaction between a customer of the shopping service provider and the shopping provider site 7304. The logistics provider site 7308 provides network access for such arranging, paying, and tracking. As described with respect to FIG. 72, each of the provider sites may provide respective services via a data center 7310. The client node 7302 of the user may exchange data with one or more instances of client task match circuitry 7312 as described in the present disclosure. The service provider may provide logic and data accessible in the data center 7310 to perform tasks included in providing goods or services to a user of the client node 7302 in one or more instances of task host circuitry that are capable of operating task circuitry that performs some or all of the service provider tasks. Service provider instances of task host circuitry 7314 illustrate such instances of task host circuitry in data center 7310. Data provided by to a shopping provider task host circuitry 7314 may include information that may identify an item or service, a quantity, an order identifier or transaction identifier, an identifier of a shipper such as the logistics provider of the logistics provider site 7308, and payment information that may identify a payment amount and a payer service such as the provider of the payment provider site 7306. The payment provider may provide logic or data accessible in the data center 7310 to perform tasks included in providing payment to the shopping service provider for the goods or services from monies accessible to the user of the client node 7302 in one or more instances of task host circuitry that are capable of operating task circuitry that performs some or all of the payment provider tasks. Payment provider instances of task host circuitry 7316 illustrate such instances of task host circuitry in data center 7310. Data provided to the payment provider task host circuitry 7316 may include information that may identify the payer such as the user of the client node 7302, the order identifier or transaction identifier, and an identifier of the payee such as the service provider of the shopping provider site 7304. The logistics provider may provide logic and data accessible in the data center 7310 to perform tasks included in arranging a delivery, paying for the delivery, or tracking delivery of an item to be delivered to an identified geospatial location as a result of the purchase of the goods or services by the user of the client node 7302 from the service provider of the shopping provider site 7304 in one or more instances of task host circuitry that are capable of operating task circuitry that performs some or all of the logistics provider tasks. Logistics provider instances of task host circuitry 7318 illustrate such instances of task host circuitry in data center 7310. Data provided by to the logistics provider task host circuitry 7318 may include information that may identify a destination for delivery, the order identifier to identify one or more packages or items to pick-up, and an identifier of the seller such as the service provider of the service provider site 7304. In addition to or instead of identifying the seller, a pick-up location may be identified where the identified packages or items may be picked up for delivery. The logistics provider may be paid by the payment provider as a service provider for the user or for the seller. The data center 7308 may be included in or otherwise may host an offer-based computing environment 7320, which may be included or otherwise be hosted by one or more data centers or nodes not included in a data center. By interoperating in or via a shared server, data center, cloud computing environment, or offer-based computing environment; service providers may reduce infrastructure costs and support time for hardware, share services that are not core to their businesses or purposes (e.g. encryption, networking, authentication, and so on), share information about their clients or may be denied information about their clients to provide a service enhancing or assuring the privacy of their own privacy as well as their clients' privacy, operating in a more reliable, secure, and efficient environment than provided by the open Internet, and many other benefits that will be apparent to those skilled in the art based on the Figures and specification of the present disclosure. Other such exemplary services that may be shared by service providers and their clients include single sign-on, single credit approval or partial credit approval, verification of identity (email, shipping address, billing address, demographic information, etc.), pre-authorized e-billing or e-payment, transaction insurance, service level agreements (for privacy, performance, security, response time, etc.), revenue sharing, cost sharing, access to a shared set of customers, data analytics, returns processing, and more.

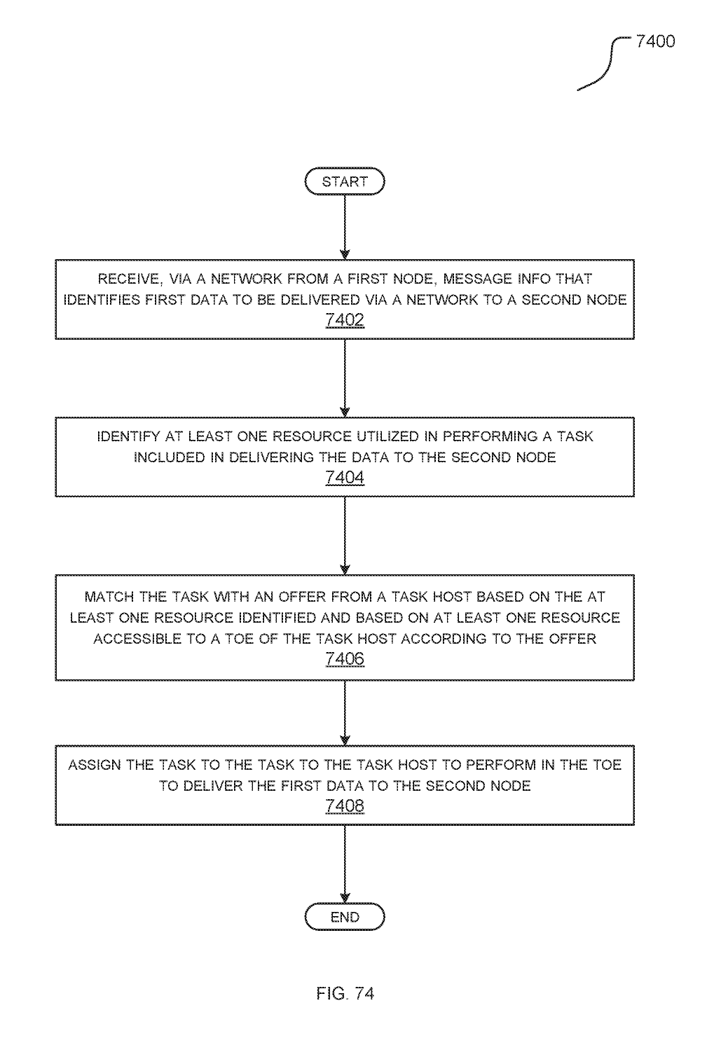

FIG. 74 shows a flow chart 7400 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include an offer-based computing environment or a portion there of including or otherwise hosted by a second node, a service site, a data center, or a cloud computing environment and the system may also include a first node that may exchange data with the second node, service, site, data center, or cloud computing environment via a network. At block 7402, first data may be received via the network. The first data may be received from the first node. The first data may be received from a first operating environment of the first node. The first data may be received from circuitry operating in the first operating environment to transmit data via the network. The data may be communicated without user interaction or in response to interaction with a user. The first data may be included in a communication between a first communicant represented by a first communications agent of the first operating environment. The first data may be identified for delivery to a second node. The first data may be identified for delivery to a second operating environment of the second node. The first data may be identified for delivery for processing by receiving circuitry operating, in the second operating environment, to receive the first data via the network. The first data may be delivered without presenting a user interface to a user of the second operating environment. In another aspect, output may be presented by the second operating environment in response to receiving the first data. The first data may be included in a communication between the first communicant and a second communicant represented by a second communications agent of the second operating environment. At block 7404, one or more resources are identified. The identified one or more resources are utilized in performing an identified task included in delivering the first data to the second node, the second operating environment, the receiving circuitry, the second communications agent, or to the second communicant. At block 7406, the task may be matched with an offer from task host circuitry based on the one or more resources identified by the task data and based on one or more resources accessible via a task operating environment of the task host circuitry according to the offer. At block 7408, the matched task may be assigned to the task host circuitry to perform the task by executing task circuitry in the task operating environment utilizing the one more resources identified by the task data. When performed the task circuitry may operate to deliver the first data to the second node, the receiving circuitry, the second communications agent, or to the second communicant.

In an aspect, first data may be identified to be delivered via a network to a second node or to a second user. A first task to be performed in delivering the first data may be identified. A resource accessed in performing the first task may be identified. First task data that may identify the task and the resource accessed in performing the first task may be provided so that the first task data may be accessible to first task match circuitry that matches the first task with a first offer from task host circuitry capable of performing the first task. In another aspect, the first data may be detected for receiving by the second node, circuitry realizing a receiving endpoint of network protocol, a second communications agent, or other circuitry that represents a second user. A second task to be performed in receiving the first data by the second node, the circuitry realizing a receiving endpoint of network protocol, the second communications agent, or the other circuitry that represents the second user may be identified. A resource accessed in performing the second task may be identified. Second task data, that may identify the second task and the resource accessed in performing the second task, may be provided so that the second task data may be accessible to second task match circuitry that matches the second task with a second offer from task host circuitry capable of performing the second task. The task host circuitry may operate, at least partially in the second node, the circuitry realizing the receiving endpoint of network protocol, the second communications agent, or the other circuitry that represents the second user. The task match circuitry may operate in at least partially in the first node or in an intermediary node (such as in a data center or offer-based computing environment). In an embodiment, the first task circuitry may operate to provide the first data to the second task circuitry via a communicatively coupling between the first task circuitry and the second task circuitry. The communicative coupling may be included in an offer-based computing environment that hosts the first task circuitry and the second task circuitry. The communicatively coupling may include a LAN, a remote procedure call, a network path in a SDN, a VLAN, a VPN, and the like. The first task circuitry and the second task circuitry may each operate, at least partially, in at least one of the first node, the second node, the circuitry realizing the receiving endpoint of network protocol, the second communications agent, or the other circuitry that represents the second user. The first task circuitry may operate at least partially in a third node. The third node may be included in a server site or data center. The third node may be included in an offer-based computing environment.

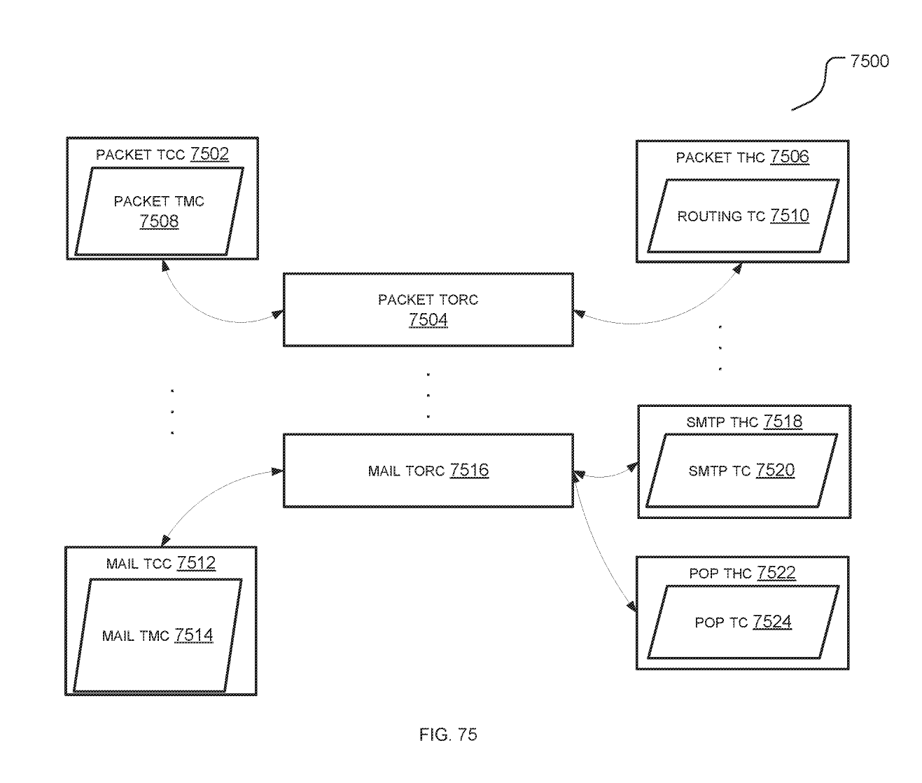

FIG. 75 illustrates an arrangement 7500 that may operate to perform a method of the subject matter of the present disclosure. The arrangement 7500 includes circuitry for packet task coordination circuitry 7502 that interoperates with circuitry of packet task-offer routing circuitry 7504. The packet task-offer routing circuitry 7504 may be associated with at least one instance of packet task host circuitry 7506 that provides a task operating environment (not shown) for hosting task circuitry included in transmitting a packet of a network protocol, such the Internet Protocol (IP), the transmission control protocol (TCP), an Ethernet frame, QUIC, and the like. The packet task coordination circuitry 7502 may receive task data that may identify data to transmit in a packet of a network protocol. The network protocol may be specified or not. Packet task match circuitry 7508 may receive offer(s) from one or more instances of packet task host circuitry 7506 via the packet task-offer routing circuitry 7504. The task match circuitry 7508 may operate to match the task with an offer and may optionally operate along with packet task coordination circuitry 7502 to assign the task to the packet task host circuitry 7506 of the matched offer. The matched packet task host circuitry 7506 may provide task data to routing task circuitry 7510 that may operate to transmit data identified by the task data in one or more packets of the particular network protocol, if specified. When no network protocol may be specified, a network protocol may be identified as a resource in an offer, so that packet task coordination circuitry 7502 may select a network protocol in matching or selecting task host circuitry. In another embodiment, task circuitry operating in a task operating environment of task host circuitry may select a network protocol. A network protocol may be selected based on a previous packet sent or received in a connection, session, or other grouping of packets. A network protocol may be received based on an identifier or a destination, a source, a recipient, a sender, a type of data exchanged, an amount of data, whether the data is encrypted or to be encrypted, whether the data is included or to be included in a stream, whether the data may be included in a communication that includes a user as a recipient or a receiver, a type of communications or network client that may be a source of the data or that may be a recipient of the data, and or any other attribute of the data deemed suitable by a user, administrator, or implementer of an embodiment as taught in the present disclosure or illustrated in the Figures. In another aspect, task data may be provided to packet task coordination circuitry 7502 that may identify a task that when performed includes listening for or receiving data from a particular source, a particular group of sources, or from any transmitting endpoint of a particular network protocol, data having a specified type, data that may be valid according to a specified schema, and the like.

Protocols other than packet based protocols may be supported. A link layer protocol, a network layer protocol, a transport layer, or higher layer network protocols may be supported. Examples of protocols that may be routed, transmitted, or received in an analogous manner in various embodiments include HTTP, QUIC, SIP, XMPP, WRTC, web sockets, and others that are identifiable to those skilled in the art based on teachings of the present disclosure.

FIG. 75 illustrates that a system may be adapted to send and receive data according to an email protocol. FIG. 75 illustrates a mail task coordination circuitry 7512 that includes mail task match circuitry 7514 that matches tasks that operate to send data in an email or that operate to receive data in an email to task host circuitry. Mail task-offer routing circuitry 7516 may include circuitry that relays offer(s) from instances of task host circuitry to one more instances of mail task coordination circuitry 7512. An SMTP task host circuitry 7518 may be shown that may send data via SMTP task circuitry 7520 that may operate to transmit the data via a simple mail transport protocol (SMTP) or a suitable alternative. In another embodiment, SMTP task circuitry 7520 may receive data that may be valid according SMTP and my covert that data for sending via another protocol. Mail may be received via tasks matched to offers from a POP task host circuitry 7522. Tasks included in receiving email may be performed in a POP task host circuitry 7522 via operation of POP task circuitry 7524.

Data may be sent or received via any network protocol by operation of task circuitry generated from source code written to comply with the respective specifications of the various network protocols. In other embodiments, data to be sent or received according to a specified protocol may be sent or received via a different network protocol.

In another embodiment an instance of task coordination circuitry may match tasks with task circuitry that supports more than one protocol. In some embodiments, task match circuitry may select a network protocol from a plurality of offers that may provide access to different network protocols.

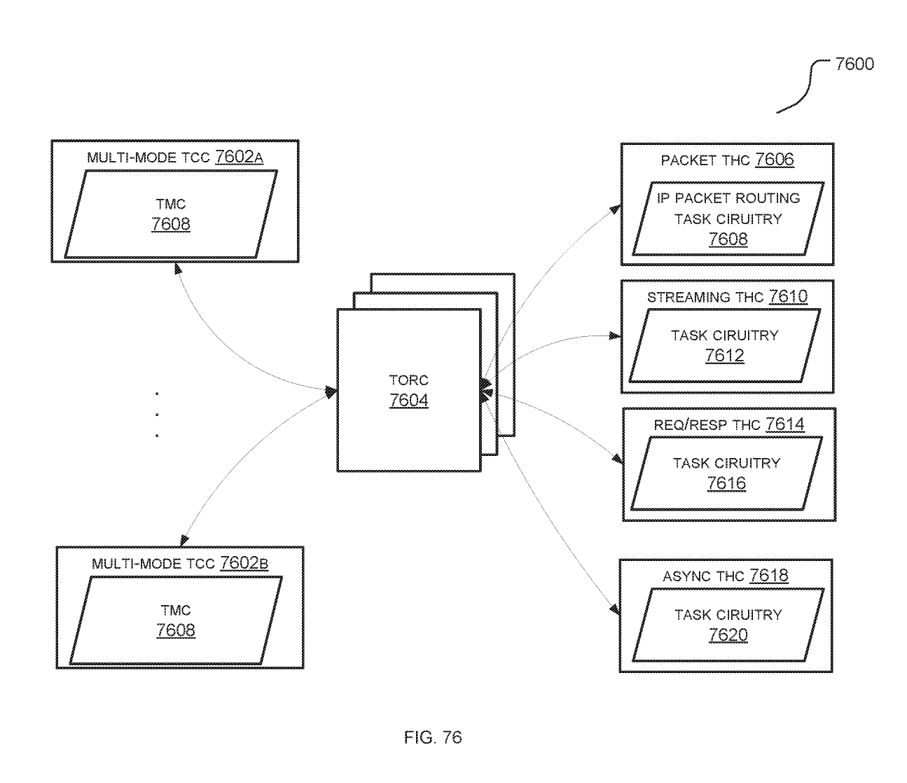

FIG. 76 illustrates an arrangement 7600 that may operate to perform a method of the subject matter of the present disclosure. The arrangement 7600 includes circuitry for multi-protocol (aka multi-mode) task coordination circuitry 7602a. Second multi-protocol task coordination circuitry 7602b is also shown. In an embodiment, multi-protocol task coordination circuitry 7602 may match tasks that access network protocols that are functionally similar. For example, multi-protocol task coordination circuitry 7602 may match tasks that access a request-response protocol, other multi-protocol task coordination circuitry 7602 may match tasks that access a streaming protocol, and so forth. In an embodiment, multi-protocol task coordination circuitry 7602 may match tasks that access network protocols that are used together in a communication such as voice, video, text messaging, or file transfer are utilized by current communications clients (e.g., SKYPE and FACEBOOK MESSENGER). Task hosts may host or otherwise provide task operating environments for task circuitry for multiple protocols in some embodiments. FIG. 76 illustrates a packet task host circuitry 7606 that provides one or more task operating environments in which task circuitry 7608 that accesses one or more packet based network protocols. FIG. 76 illustrates a streaming task host circuitry 7610 that provides one or more task operating environments in which task circuitry 7612 that accesses one or more streaming network protocols. FIG. 76 illustrates a request-response task host circuitry 7614 that provides one or more task operating environments in which task circuitry 7616 that accesses one or more request-response network protocols. FIG. 76 illustrates a async task host circuitry 7618 that provides one or more task operating environments in which task circuitry 7620 that accesses one or more network protocols to send or receive messages asynchronously.

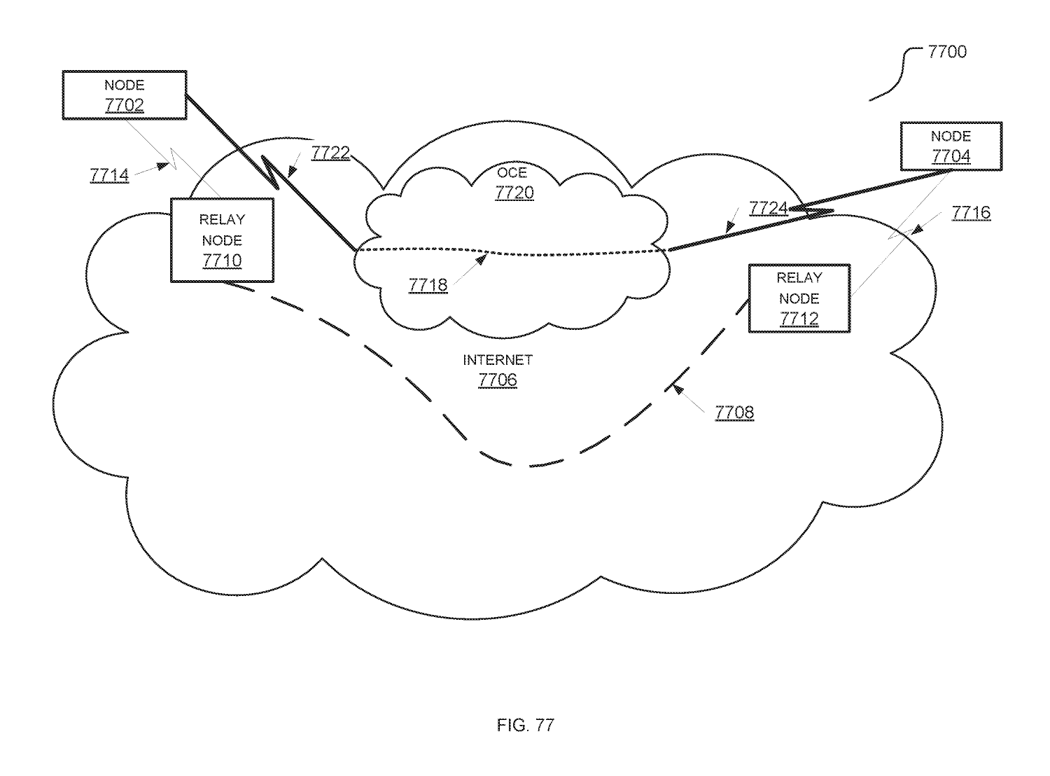

FIG. 77 shows a system 7700 that may operate to perform one or more methods of the subject matter of the present disclosure. FIG. 77 shows that system 7700 includes a node 7702 and a node 7704 that may exchange data via a network 7706, such as the Internet. Node 7702 and node 7704 may exchange data via a network path 7708 having a first end node, shown as relay node 7710, and a second end node 7712. The node 7702 may be communicatively connected to the network path 7708 via link, a hop, or another network path 7714. The node 7704 may be communicatively connected to the network path 7708 via link, a hop, or another network path 7716. Alternatively or additionally, the node 7702 may exchange data with the node 7704 via a network path 7718 provided by a data center (not shown), a cloud computing environment, or an offer-based computing environment 7720. Node 7702 may include a task match agent or at least a portion of task match circuitry to match task data that may identify a task, that is performed in exchanging data between the first node 7702 and the second node 7704, with an offer associated with task host circuitry of the data center, cloud computing environment, or the offer-based computing environment 7720. Data included in the exchange may also be exchanged via the link, hop, or network path 7722, the network path 7718 (which may be or may include a link or a hop), and a link, hop, or path 7724 that communicatively couples the node 7704 and the data center of the offer-based computing environment 7720. Data exchanged via a data center, cloud computing environment, or offer-based computing environment may be transmitted in or through the data center, cloud computing environment, or offer-based computing environment via a protocol that may be different a network protocol of a public or otherwise open network, such as the Internet. The data transmitted may be more secure, may be transmitted more efficiently, or otherwise may be more manageable while in the data center, cloud computing environment, or offer-based computing environment.

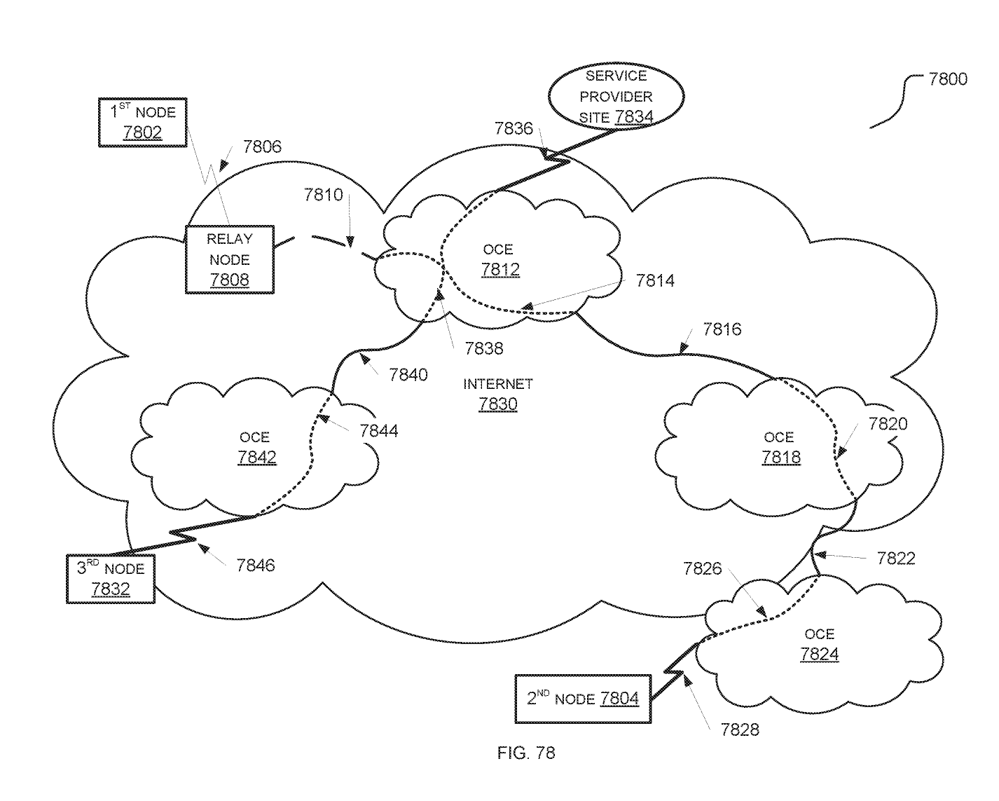

FIG. 78 shows a system 7800 that may operate to perform one or more methods of the subject matter of the present disclosure. FIG. 78 shows that system 7800 includes a first node 7802 that may exchange data with a second node 7804 via network path. The network path includes a first path 7806 that communicatively couples the first node 7802 and a relay node 7808, a second path 7810 that communicatively couples the relay node 7808 and a data center, cloud computing environment, or offer-based computing environment 7812, a third path 7814 that traverses the data center, cloud computing environment, or offer-based computing environment 7812, a fifth path 7816 that communicatively couples the data center, cloud computing environment, or offer-based computing environment 7812 and another data center, cloud computing environment, or offer-based computing environment 7818, a sixth path 7820 that traverses the data center, cloud computing environment, or offer-based computing environment 7818, a seventh path 7822 that communicatively couples the data center, cloud computing environment, or offer-based computing environment 7818 and still another data center, cloud computing environment, or offer-based computing environment 7824, an eighth path 7826 that traverses the data center, cloud computing environment, or offer-based computing environment 7824, and a ninth path 7828 that communicatively couples the data center, cloud computing environment, or offer-based computing environment 7824 and the second node 7804. At least a portion of the network path may traverse an internet 7830 or other network. FIG. 78 also shows that system 7800 includes a third node 7832 that may exchange data with a service provider site 7834 via a network path. The network path includes a tenth path 7836 that communicatively couples the service provider site 7834 and the data center, cloud computing environment, or offer-based computing environment 7812, an eleventh path 7838 that traverses the data center, cloud computing environment, or offer-based computing environment 7812, a twelfth path 7840 that communicatively couples the data center, cloud computing environment, or offer-based computing environment 7812 and another data center, cloud computing environment, or offer-based computing environment 7842, a thirteenth path 7844 that traverses the data center, cloud computing environment, or offer-based computing environment 7842, and a fourteenth path 7846 that communicatively couples the data center, cloud computing environment, or offer-based computing environment 7842 and the node 7832.

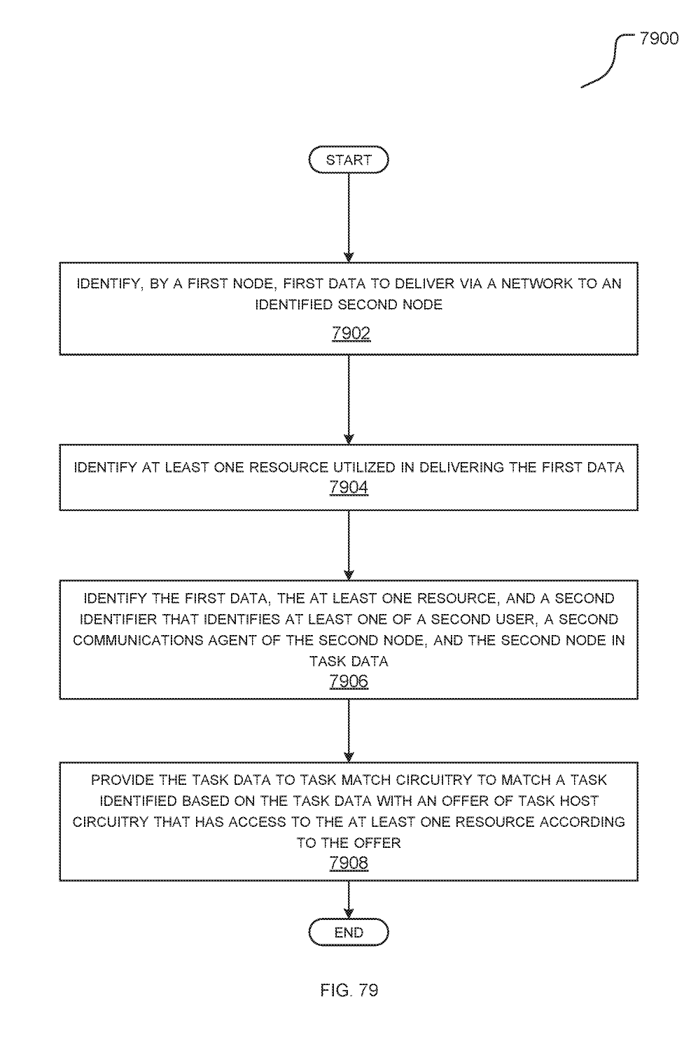

FIG. 79 shows a flow chart 7900 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. The system may include a first node and a second node. At block 7902, the first node may identify first data to deliver via a network to the identified second node. In an embodiment, a first communications agent of the first node may identify the first data and the second node may be identified by identifying a second communications agent of the second node. In an embodiment, the first communications agent or the first node may be identified by identifying a user of the first node or a user of the first communications agent. The second communications agent or the second node may be identified by identifying a user of the second communications agent or of the second node. In an embodiment, the first node may be identified by identifying a first network protocol endpoint of a network protocol utilized to transmit the first data and the second node may be identified by a second network protocol endpoint of a network protocol utilized in receiving the first data. At block 7904, at least one resource may be identified that may be utilized in delivering the first data. At block 7906, an identification may be performed of the first data, the at least one resource, and a second identifier that may identify at least one of the second user, the second communications agent, the second network protocol endpoint, and the second node in task data. At block 7908, the task data may be provided to task match circuitry that matches a data delivery task with an offer of task host circuitry that has access to the at least one resource according to the offer.

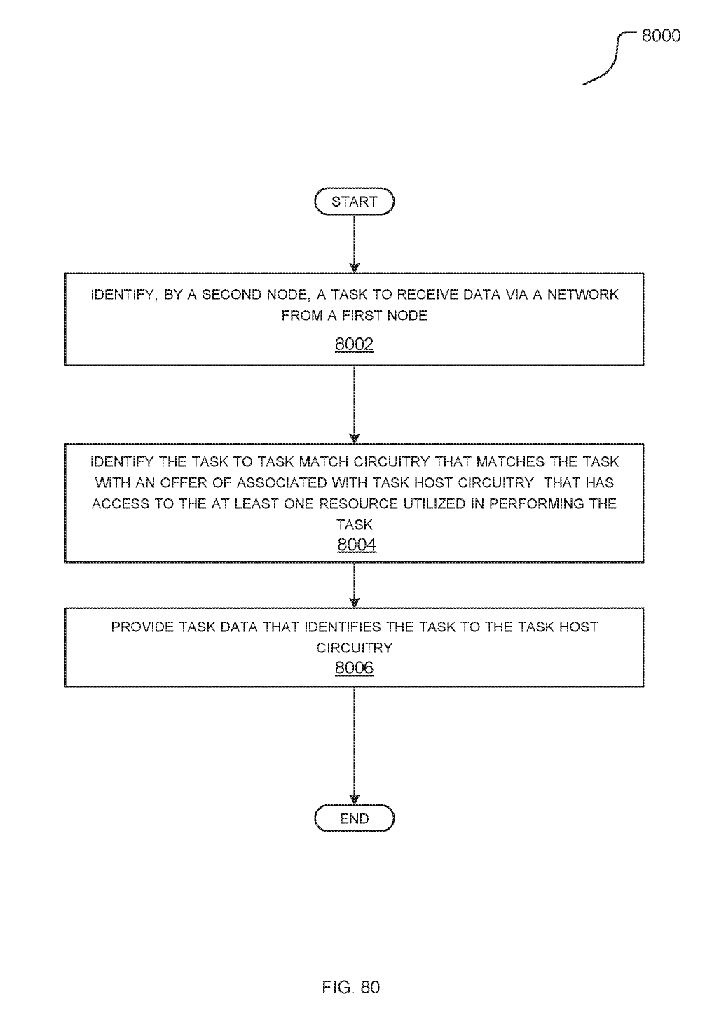

FIG. 80 shows a flow chart 8000 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 8002, a first node may identify a task to receive data via a network from a second node. The second node may be identified prior to receiving the data and/or otherwise along with or as a result of receiving the data. In an embodiment, the first node may be identified by identifying a first communications agent of the first node. In an aspect, identifying the first node may be included identifying a user of the first node or of the first communications agent. The second node may be identified by identifying a second communications agent of the second node. In an aspect, identifying the second node may be included identifying a user of the second node or of the second communications agent. At block 8006, the task data may be provided to task match circuitry that matches a data receiving task with an offer of task host circuitry that has access to the at least one resource according to the offer. A mode of communication may be selected by task coordination circuitry, task match circuitry, or task circuitry executed in a task operating environment of task host circuitry. Data may be sent and received in an offer-based computing environment without traversing or by limiting transmission via the Internet or other public network.

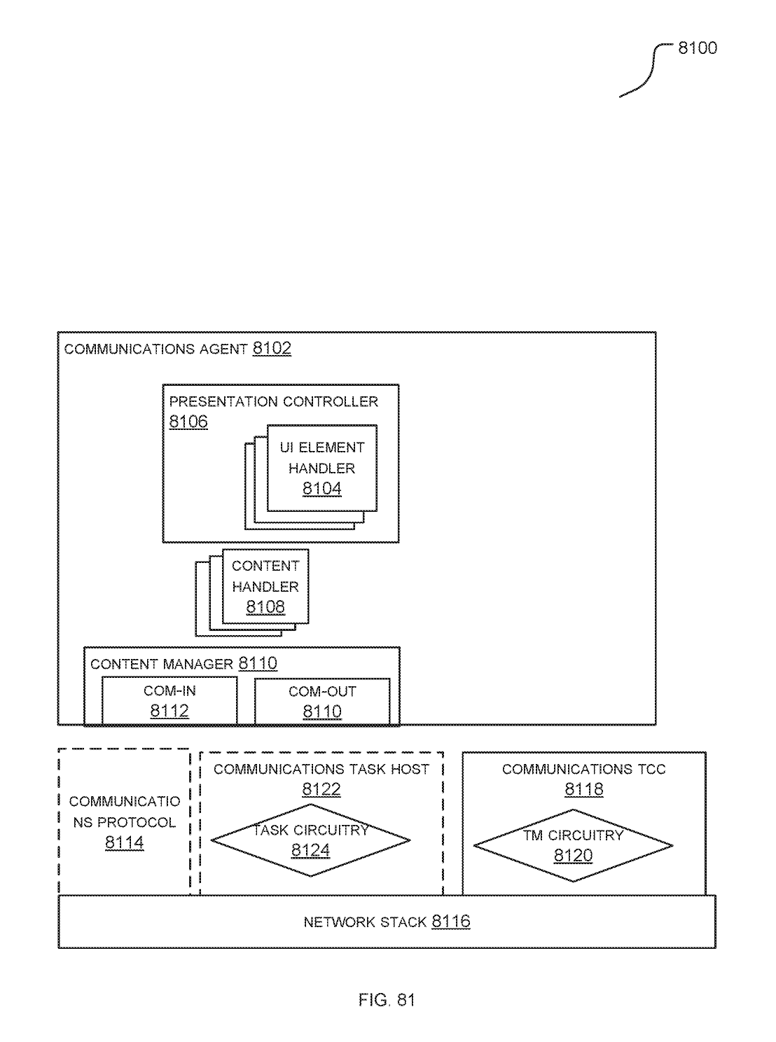

FIG. 81 illustrates an arrangement 8100 that may operate to perform a method of the subject matter of the present disclosure. The arrangement 8100 includes a first communications agent 8102 that represents a first communicant in an exchange of data with a second communicant represented by a second communications agent. The exchange of data may be via a network. The network may be virtual network or a physical network. The communications agent 8102 may interact with a user via circuitry of one or more user interface handler addressable entities 8104 managed by circuitry of a presentation controller 8106. Data to be presented or data to be exchanged with another communications agent may be received, transformed, and exchanged with the one more user interface element handlers 8104 or the presentation controller 8106 via circuitry in one more content handlers 8108 that process data according to its type, schema, source, or format. Circuitry in a content manager 8110 may manage network endpoints for transmitting, illustrated by com-out circuitry 8110, and for receiving data, illustrated by com-in circuitry 8112. Com-in 8112 and com-out 8110 circuitries may interoperate with communications protocol circuitry 8114 that processes data as specified according to a particular communications protocol, such as an instant messaging protocol, an email protocol, a video streaming or audio streaming protocol, and the like. Circuitry compatible with one or more communications protocols may be included to interoperate with the communications agent 8102. Such communications protocols may exchange data via a network according circuitry of a network stack 8116 that operates according to respective schemas or definitions of one or more physical layer, link layer, network layer, transport layer network protocols, or application layer network protocols. Alternatively of additionally, a task included in exchanging data via a network with another communications agent may be provided or identified to task coordination circuitry 8118 that operates to receive one or more offers to be matched by task match circuitry 8120 included in or otherwise accessible to the task coordination circuitry 8118. Tasks included in exchanging data between the first communications agent 8102 and the second communications agent may be assigned to task host circuitry of a matched offer to perform. Traditional user communications protocols may or may not be utilized as resources in such exchanges in various embodiments. As an option, task host circuitry 8122 may be included in the operating environment of the communications agent 8102 in whole or in part that may operate to perform a task assigned by task coordination circuitry operating in the operating environment of the communications agent 8102 or operating elsewhere. The task host circuitry 8122 may execute task circuitry, such as task circuitry 8124, that performs a task included in exchanging data between the first communications agent 8102 and another communication agent. Some or all data exchanged between communications agents may be exchanged within a service site, data center, cloud computing environment, or offer-based computing environment. For example, an attachment may be stored in file storage provided by an offer-based computing environment for the first communicant. The attachment may be copied, moved, or reference the storage location in the offer-based computing environment accessible to a node representing the second communicant.

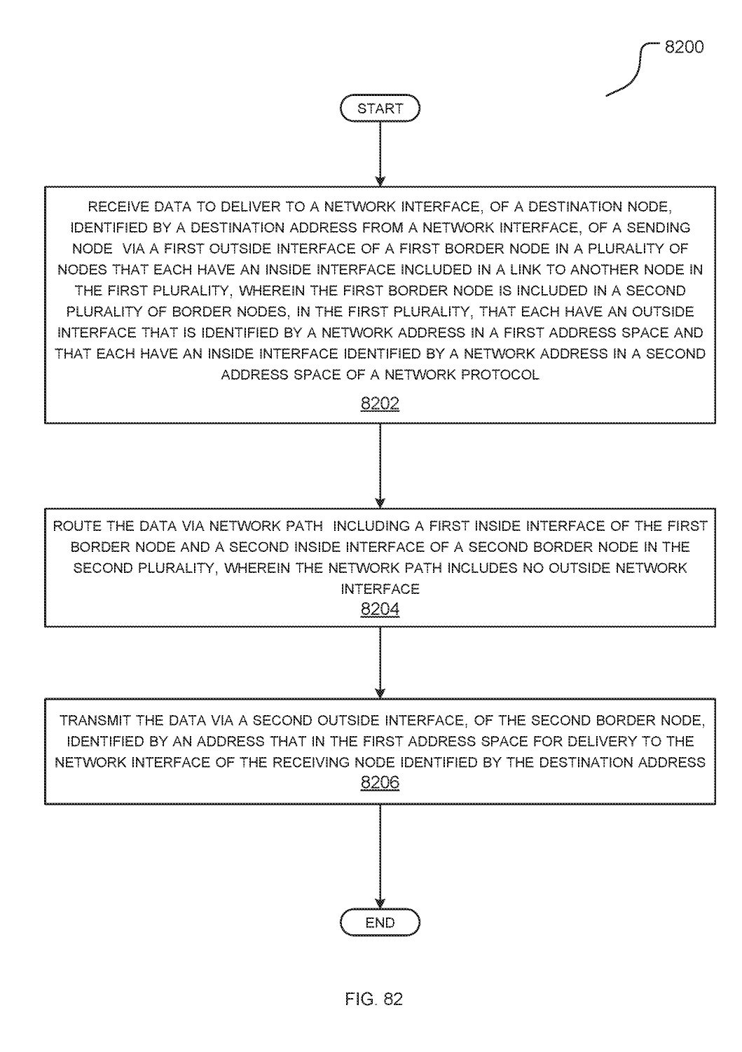

FIG. 82 shows a flow chart 8200 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 8202, data may be received to deliver to a network interface of a destination node. The destination node may be identified by a destination address. The data may be received from a network interface of a sending node. The network interface of the sending node may be identified by a sender address. The data may be received via a first outside interface of a first border node. The term “border node” is described in U.S. patent application Ser. No. 11/962,285, titled “Methods And Systems For Sending Information To A Zone Included In An Internet Network”, filed on Dec. 21, 2007 by the present inventor. The border node may be included in a plurality of nodes that each have an inside interface for exchanging data between the border nodes and any nodes with only inside network interfaces. Each inside network interface may be included in a link or hop to another node in the first plurality. The first border node may be included in a second plurality of border nodes that are included in the first plurality. The second plurality includes some or all of the first plurality. Each border node has, by definition, an outside interface that may be identified by a network address in a first address space of a network protocol and also has an inside interface identified by a network address in a second address space of a network protocol. The network protocol of the second address space may be the same protocol as the network protocol of the first address space or may be a different network protocol. At block 8204, the data may be routed via network path including a first inside interface of the first border node and a second inside interface of a second border node in the second plurality. The network path includes one or more links or hops. The network path includes no outside network interface Note that the data may be not transmitted to the second border node via a tunneling protocol, rather it may be routed via links between the first border node and the second border node. In effect, the first plurality operates as a router or switch within the network of the first address space. At block 8206, the data may be transmitted via a second outside interface, of the second border node, for delivery to the network interface of the receiving node. The second outside interface may be identified by an address in the first address space. In an aspect, one or both of the sender address and the destination address may be in the first address space. One or both of the sender address and the destination address may not be included in the first address space.

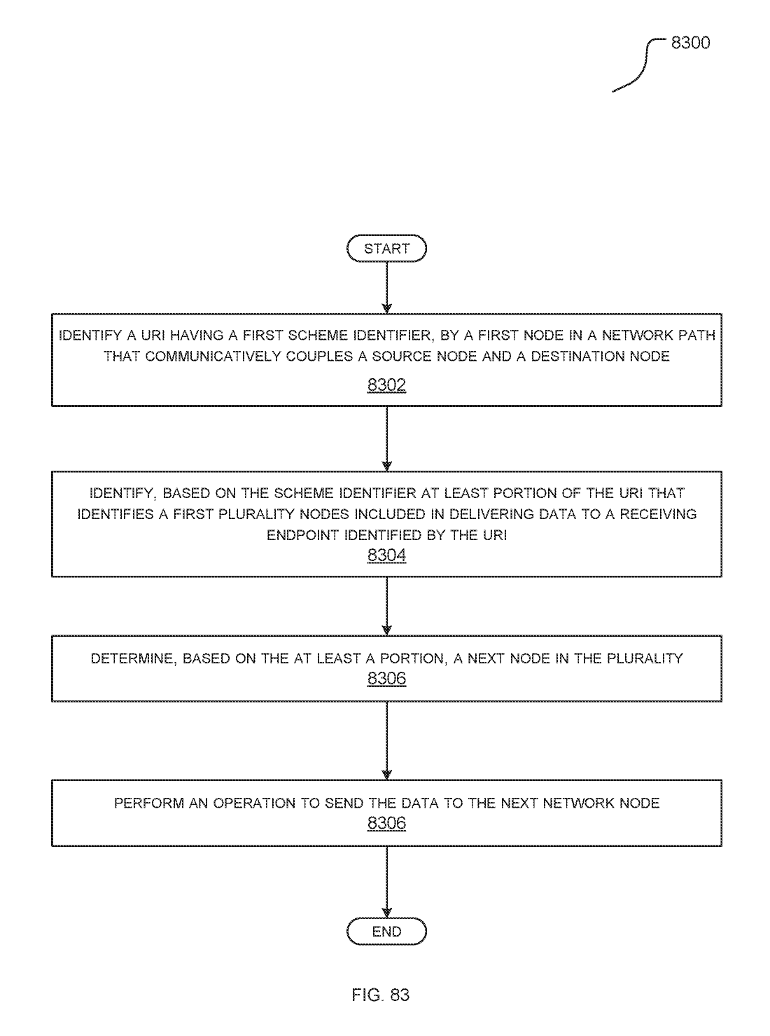

FIG. 83 shows a flow chart 8300 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 8302, a URI may be identified by circuitry operating in a first node. The URI has a first scheme identifier. The first node may be included in a network path including a first plurality of nodes that communicatively couples a source node and a destination node. At block 8304, at least a portion of the URI is identified that identifies each node in the first plurality. At block 8306, a next node in the first plurality is determined based on the at least a portion. The next node may be determined based by or with respect to another node in the first plurality and an ordering of the nodes in the network path. At block 8308, an operation may be performed to send the data to the next network node.

In an embodiment of the method of FIG. 83, for a first node in the network path, the at least a portion of the URI may identify a first-next node. The first node may deliver data to the destination node via the first-next node. For the first-next node, the at least a portion may identify a second next node in the network path. The first-next node may deliver data to the destination node via the second-next node. In an aspect, the first node may resolve the at least a portion or some part of the at least a portion to a network address of the first-next node via a directory lookup or an algorithm that takes an attribute of the first node and the URI and produces a network identifier of the first-next node. The algorithm may be at least partially realized in a policy or rule accessible to the first node. The first-next node may resolve the at least a portion or some part of the at least a portion to a network address of the second-next node via a directory lookup or an algorithm that takes an attribute of the first-next node and the URI and produces a network identifier of the second-next node. The algorithm may be at least partially realized in a policy or rule accessible to the first-next node. The first node and the first-next node may access different directory services or may access a shared directory service that performs contextual lookups. Note that the network address of the first-next node and the network address of the second-next node may be in a same network protocol address space or may be included in different network address spaces of same network protocol or of different network protocols.

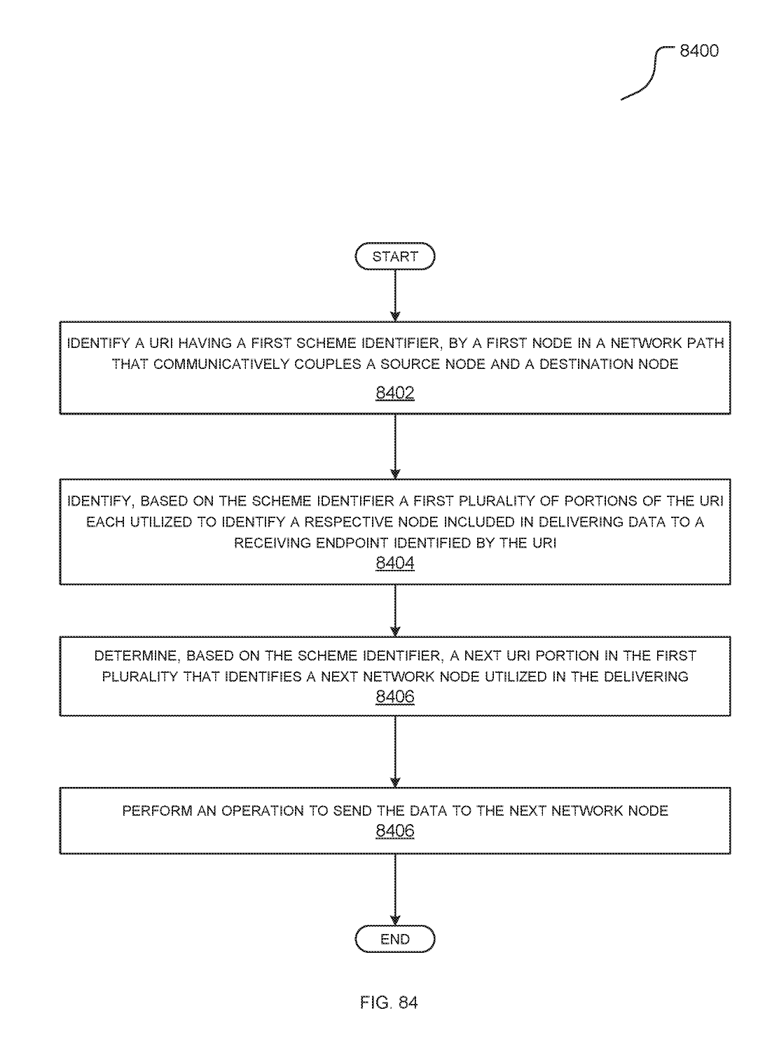

FIG. 84 shows a flow chart 8400 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 8402, a URI may be identified by circuitry operating in a first node. The URI has a first scheme identifier. The first node may be included in a network path that communicatively couples a source node and a destination node. At block 8404, a first plurality of portions of the URI are identified based on the scheme. Each portion respectively corresponds to a node via which data from the source node may be deliverable to the receiving endpoint, identified by the URI, in the destination node. Each URI portion may be utilized to identify its corresponding node. At block 8406, a next URI portion in the first plurality may be determined. The next URI portion may identify a next node utilized in the delivering of the data. At block 8408, an operation may be performed to send the data to the next network node.

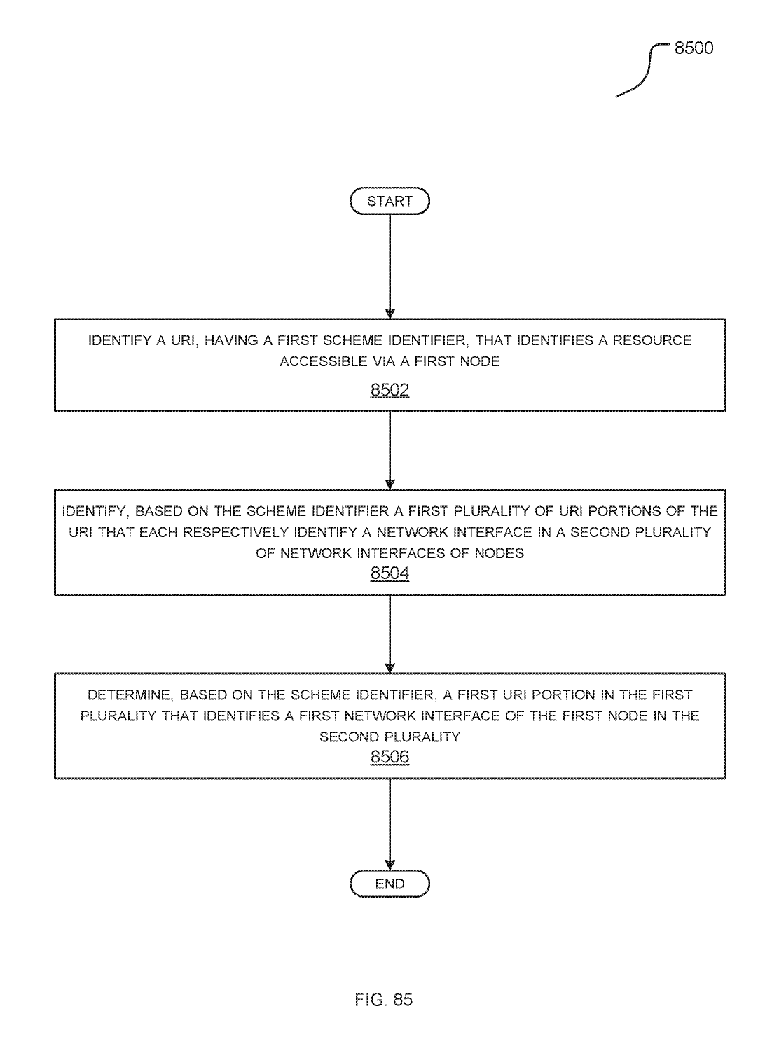

FIG. 85 shows a flow chart 8500 in accordance with an embodiment of a method. As an option, the method may, in various embodiments, be implemented in the context of one or more of the Figures set forth herein. Of course, however, the method may be carried out in any desired environment. Circuitry may be included in an embodiment or the method may include providing circuitry that may be operable for use with a system. At block 8502, a URI may be identified that has a first scheme identifier. The URI may identify a resource accessible via a first node. At block 8504, a first plurality of portions of the URI are identified based on the scheme. Each URI portion respectively may identify at least one network interface in a second plurality of network interfaces of nodes. Alternatively or additionally, the second plurality may include nodes and each portion in the first plurality may identify a node in the second plurality. Alternatively or additionally, the second plurality may include network endpoints that are each endpoints of a network protocol and each portion in the first plurality may identify a network endpoint in the second plurality. At block 8506, a first URI portion in the first plurality may be determined that may identify a first network interface, in the second plurality, of the first node.

The first URI portion may be identified based on a location of the first URI in an ordering of the first plurality, based on a keyword, based on a scheme modifier, or determined based on a rule of a scheme identified by the scheme identifier. In an embodiment, another portion of the plurality of portions may identify a next node for relaying at least a portion of the data sent from the source towards the destination node. In an embodiment, a first network protocol may be used in transmitting the at least a portion of the data from the source node to the next node and a second network protocol may be used in transmitting the at least a portion from the next node towards the destination node. The second network protocol may be used in transmitting the at least a portion towards the destination node instead of or in addition to using the first network protocol for the transmitting towards the destination protocol. In an embodiment, a same network protocol may be used in transmitting the at least a portion from the source node to the next node and in transmitting the at least a portion from the relay portion towards the destination node. At least one of the first network protocol and the second network protocol may be a private protocol. One or both of a network endpoint in the source node, the next node, and the destination node included in the transmitting may be a virtual network endpoint.

The URI may specify a sequence of network addresses identified by respective portions of the URI. The sequence may define a hierarchy of network protocols utilized in transmitting data from the source node to the destination node. The relay node may be a border node of a data center, service site, cloud computing environment, or offer-based computing environment.

A URI scheme as described in the present disclosure as well as analogs and equivalents thereof may be registered with the Internet Assigned Numbers Authority (IANA) or not. If used within a data center, service site, cloud computing environment, or offer-computing environment a need to register such a URI might not exist.

Example 1 below, provides schema for many URL (a type of URI) schemes already in use such as the HTTP scheme, FTP scheme. The URL begins with a schema identifier. The schema identifier is followed by a colon character. Portions in brackets “H” are optional for the particular scheme. Example 1 illustrates that only a “path” portion is required. A host portion, as indicated, may precede the path portion. If provided the host portion must include a “host” identifier, such an IP address or a host name in the Domain Name System (DNS). Within the host portion, a port number may be specified as an option. A user identifier and a password may also be included in the host portion as another option. Example 1 specifies that a query portion or a fragment portion may optionally follow the path portion.

### Example 1: Presently Defined Scheme Schema

scheme:[//[user:password@]host[:port]][/]path[?query][#fragment]

Example 2 below, illustrates a scheme within the scope of the subject matter of the present disclosure. Note that the schema for the scheme is identical to the schema of Example 1. According to the subject matter of the present disclosure, a particular scheme as well as it's schema may be interpreted differently in different computing contexts, as described above by example. As such, existing schemes (e.g. HTTP, MAILTO, etc.) may be interpreted differently in different portions of a network. In particular, existing schemes may be interpreted differently by different nodes in a network path where the network path is identified (directly or indirectly) by a URL of the scheme. For examples, a host name such as “www.mysite.somecloud.com” may identify one or more border nodes of network of cloud computing environment, which may be or may include an offer-based computing environment. “www.mysite.somecloude.com” may identify a particular service, particular task circuitry, particular task coordination circuitry or a particular type of task coordination circuitry, a particular type of node in the cloud computing environment (virtual or physical), and so on. Other portions of the URL may also be interpreted differently in different contexts. For example, the path portion may be defined in one way outside a first portion of a network and may be defined in a second way in the first portion.

### Example 2

scheme:[//[user:password@]host[:port]][/]path[?query][#fragment]

Example 3 below, illustrates a scheme within the scope of the subject matter of the present disclosure. According to the subject matter of the present disclosure, one or more parts of a URI or a particular scheme as well as it's schema may be interpreted differently in different computing contexts. The scheme in example 3 allows a sequence of host identifiers to be specified. The sequence may specify some or all nodes in a network path as illustrated by the httpx URL below the scheme schema.

### Example 3

scheme: [//[user:password@host[:port][//[user:password@]host[:port]]][/]path[?query][#fragment]

httpx://firsthostname///secondhostname///thirdhostname

Example 4 below, illustrates a scheme within the scope of the subject matter of the present disclosure. Again, according to the subject matter of the present disclosure, one or more parts of a URI or a particular scheme as well as it's schema may be interpreted differently in different computing contexts. The scheme in example 4 allows a task identifier to be specified. Access to task circuitry to perform the task may require separate authentication, which the scheme of Example 4 allows. In another scheme, a sequence of nodes or tasks may be specified. An ordering of tasks may correspond to an order in which the identified tasks are to be performed. A schema may permit an attribute that indicates two more tasks that may be performed during a same duration. Other attributes may be specified to allow other types of relationships to be specified. For example, an indicator may be defined to include between task identifies that may be defined to indicate that a result of performing one of the tasks is to be provide as input to the other task. Some task may be implied based on task that are identified in a particular URI.

### Example 4

scheme:[//[user:password@]host[:port][///[user:password@]task]][/]path[?query][#fragment]

Example 5 below, illustrates a scheme within the scope of the subject matter of the present disclosure. Again, according to the subject matter of the present disclosure, one or more parts of a URI or a particular scheme as well as it's schema may be interpreted differently in different computing contexts. The scheme in example 5 allows one or more resources that are accessed or otherwise utilized in performing a task identified in a URI of the schema to be identified.

### Example 5

scheme:[//[user:password@]host[:port][///[user:password@]task[?resource]]][/]path[?query][#fragment]

Example 6 below, illustrates a scheme within the scope of the subject matter of the present disclosure. Again, according to the subject matter of the present disclosure, one or more parts of a URI or a particular scheme as well as it's schema may be interpreted differently in different computing contexts. The scheme in example 6 illustrates that schemes may be combined. Example 6 illustrates a hierarchical combination having a parent schema and a sub-scheme. A parent scheme may be specified to constraint the sub-schemes that may be included or a parent scheme may be defined to allow existing schemes and new schemes to be included as sub-schemes. A sub-scheme may be defined to operate only as a sub-scheme, to operate as sub-scheme only for one or more specified parent schemes, or to operate as parent scheme in some contexts and sub-scheme in others.

While an example is not provided, it should be apparent to those skilled in the art based on the Figures and specification of the present disclosure that a scheme that sequentially combines multiple schemes may be specified (as a flat hierarchy is may be interpreted as a sequence of peer entities).

Each of the methods of FIGS. 83, 84, and 85 may be modified by substituting a network address for a URI. For example, with respect to the method of FIG. 83 a network address may be interpreted differently be each node in a network path. For a first node, the network address or part of the network address may identify a first-next node. For the first-next node, the network address or part of the network address may identify the second-next node in the network path. As with the method of FIG. 83, for the modified method the network address of the first-next node and the network address of the second-next node may be in a same network protocol address space or may be included in different network address spaces of same network protocol or of different network protocols.

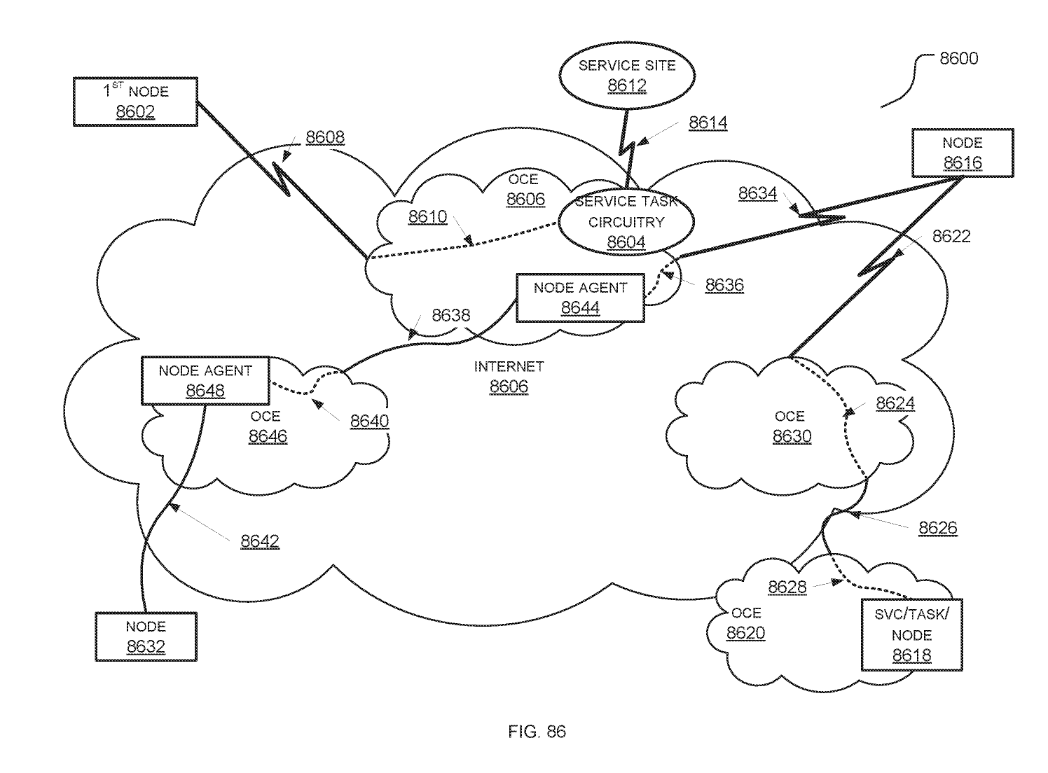

FIG. 86 shows a system 8600 that may operate to perform one or more methods of the subject matter of the present disclosure. FIG. 86 shows that system 8600 includes a network path communicatively coupling a node 8602 and service task circuitry 8604 operating in an offer-based computing environment 8606, data center, or cloud computing environment in various embodiments. The network path includes a first path portion 8608 and a second path portion 8610. A resource of the service provider 8604 may be accessed by the first node 8602 or by a user of the first node 8602 via a URI that may identify a node (not shown) that may be an endnode of the first path portion 8608. and end node of the second path portion 8610 included in communicating with the service task circuitry 8610. The network interface at the end of the second path portion 8610 may be virtual network interface of a virtual operating environment. The virtual operating environment may be a task operating environment of task host circuitry. The second path portion 8610 may have a predetermined mapping or may be dynamically determined. For example, accessing the identified resource may include performing a task. Task match circuitry in the offer-based computing environment 8606 may match the task to an offer of task host circuitry. The second path portion 8610 may be identified based on the task host circuitry matched, selected, or otherwise identified by operation of the task match circuitry. In an aspect, the service task circuitry 8604 may access the resource via interoperation with the service site 8612 via a network path 8614. The service site 8612 or the network path 8614 may be identified directly or indirectly in the URI or URL as illustrated or described in the specification of the present disclosure or by equivalents or analogs of those illustrated or described.

FIG. 86 also shows that system 8600 includes a network path communicatively coupling a node 8616 with a service, task, or node 8618 in an offer-based computing environment 8620, cloud computing environment, or data center in various embodiments. The network path includes a first path portion 8622, a second path portion 8624, a third path portion 8626, and a fourth path portion 8628. The first path portion communicatively couples the node 8616 and an offer-based computing environment 8630. The second path portion communicatively couples a first network interface of the offer-based computing environment 8630 included in the first path portion and a second network interface of the offer-based computing environment 8630 included in the third path portion 8626. The third path portion communicatively couples the offer-based computing environment 8630 and the offer-based computing environment 8620. The fourth path portion communicatively couples a first network interface of the offer-based computing environment 8620 and the service, task and node 8618. Data may be transmitted by the node 8616 to the service, task, or node 8618 in a message that includes a URI as described in the present disclosure. The network interface at the end of the fourth path portion 8628 may be a virtual network interface of a virtual operating environment. The virtual operating environment may be a task operating environment of task host circuitry. The fourth path portion 8628 may be statically defined or may be dynamically determined. For example, accessing the identified resource may include performing a task. Task match circuitry in the offer-based computing environment 8620 may match the task to an offer of task host circuitry. The fourth path portion 8628 may be identified based on the task host circuitry matched, selected, or otherwise identified by operation of the task match circuitry. Alternatively or additionally, the second path portion 8624 may be statically defined or may be dynamically determined. For example, relaying the data may include performing a task. Task match circuitry in the offer-based computing environment 8630 may match the task to an offer of task host circuitry. The second path portion 8628 may be identified based on the task host circuitry matched, selected, or otherwise identified by operation of the task match circuitry. In still another aspect, task match circuitry in the offer-based computing environment 8630 may match a task that may operate to identify some or all of the second path portion 8624 to an offer of task host circuitry. The second path portion 8628 may be identified by task match circuitry associated with the offer. The data may be transmitted via the identified second path portion 8624. Transmitting the data via the second path portion 8624 may, in an embodiment, include performing a task assigned to task host circuitry via operation of task match circuitry as described in various embodiment elsewhere in the present disclosures.

FIG. 86 also shows that system 8600 includes a network path communicatively coupling the node 8616 and a node 8632. The network path includes a first path portion 8634, a second path portion 8636, a third path portion 8638, a fourth path portion 8640, and a fifth path portion 8642. The first path portion 8634 communicatively couples the node 8616 and an offer-based computing environment 8606. The second path portion 8636 communicatively couples a first network interface of the offer-based computing environment 8606 included in the first path portion 8634 and a node agent 8644 that represents the node 8616 or a user of the node 8616 in the offer-based computing environment 8606. The network interface at the end of the second path portion 8636 may be virtual network interface of a virtual operating environment. The virtual operating environment may be a task operating environment of task host circuitry. The third path portion 8638 communicatively couples the node agent 8644 or a portion of the offer-based computing environment 8606 associated with the node agent 8644 (say more TBD) with another offer-based computing environment 8646. The fourth path portion 8640 communicatively couples a first network interface of the offer-based computing environment 8646 included in the fourth path portion 8638 and a node agent 8648 that represents the node 8632 or a user of the node 8632 in the offer-based computing environment 8606. The network interface at the end of the fourth path portion 8640 may be virtual network interface of a virtual operating environment. The virtual operating environment may be a task operating environment of task host circuitry. The fifth path portion communicatively couples the node agent 8648 or a portion of the offer-based computing environment 8646 associated with the node agent 8648 with the node 8632 which node agent 8648 operates on behalf of or otherwise represents.

In a usage scenario of an embodiment, node 8632 and node 8616 may exchange data stored in one or both of the offer-based computing environments (8606 and 8646) via their respective node agents (8632 and 8648). For example, a user of node 8632 may have data stored in offer-based computing environment 8646 (which in other embodiments may be a server node, a service site, a data center, or a cloud computing environment). The user may access the data via a web page in a web browser of node 8632. The user may access a data storage service of offer-based computing environment 8606 via a second web page presented in the same web browser or via another application of node 8632. The user may request that data stored in offer-based computing environment 8646 be copied or moved to offer-based computing environment 8606 in storage shared by the user of node 8616 with the user of note 8632. The data may be transferred between node agent 8648 and node agent 8644 without copying the data through node 8632 or node 8616. In one embodiment, user of node 8632 may use cut copy commands along with a paste command. Alternatively, the user of node 8632 may drag user interface elements represented data stored in offer-based computing environment 8646 from the corresponding web page to a user interface representing the shared stored of the user of node 8616 in offer-based computing environment 8606. end nodes.

### Other Options, Extensions, Alternatives

In various embodiments of methods and systems described and illustrated in the present disclosure, an exchange of data between a first node and a second node may be initiated by the first node or the second node. The second node may be a server node, a node in a service site, a node in a data center, or a node in cloud computing environment or a node in an offer-based computing environment. The exchange may be to identify the first node as including or having access to task match circuitry, task coordination circuitry, task-offer routing circuitry, or task host circuitry accessible or otherwise usable in an offer-based computing environment or a portion thereof that includes the second node, is host by the second node, or which the second node otherwise represent Alternatively or additionally, the exchange of data may be to identify the second node, a service site of the second node, a data center of the second node, a cloud computing environment, or an offer-based computing environment of the second node as a provider of task assignments for task host circuitry operating in or otherwise accessible to the first node or as a provider of access to one or more instances of task host circuitry for performing a task identified by or via the first node. A task identified by or via the first node may be performed by the one or instances of task host circuitry for the first node, for a user of the first node, for an operating environment or an application operating in an operating environment of the first node, or as part of an operating environment or an application partially operating in or otherwise hosted by the first node. Data exchanged between the first node and the second node may be exchanged via any suitable network protocol including a link layer protocol, a network layer protocol, a transport layer protocol, an application layer protocol, a request-response protocol, a streaming protocol, a connection oriented protocol, a connectionless protocol, via an asynchronous message of a network protocol, a subscription protocol, a peer-to-peer protocol, or broadcast protocol—to name some examples.

In an embodiment, an exchange may be based on configuration data accessible to the first node or to the second node that may identify one to the other. For example, a first node may include or access data that may identify task coordination circuitry, task match circuitry, task-offer routing circuitry, task host circuitry, or a task operating environment accessed via the second node. The first node may initiate an exchange of data with the second node based on the identifying data. The data may be received by the first node via interaction with a user, may be accessible based on a location of the first node, based on an operational state of the first node, or based on any other attribute of the first node. Similarly, a node of an offer-based computing environment may access configuration data that may identify a user node or other network connected device as source of task data or a source of offers to be processed by task match circuitry, task coordination circuitry, task-offer routing circuitry, task host circuitry, or a task operating environment of the offer-based computing environment.

An exchange may be initiated in response to a user interaction with the first node, a change in an operating state of the first node, a measure of resource accessible to the first node, a resource not accessible to the first node, a date, a time, a source of energy, or an amount of accessible energy for the first node—to name some examples.

A resource may be identified as required for performing a task, as one of two or more alternative resources, as a preferred alternative, or an optional resource. Whether an offer matches a task identified by task data may be determined by a policy. The policy may require that a resource identified in an offer match exactly a resource identified for performing a particular task or may specify a criterion to be met for a match to exist. The criterion may be based on an attribute of the resource identified in the offer or otherwise known to the task match circuitry. The attribute may be “known” based on a probability or based on a source of information about the attribute that may be defined to be reliable or authoritative. An offer may not match if an amount of other attribute of a resource identified in the offer is determined to be excessive, wasteful, too costly, or otherwise inefficient according task match circuitry, a policy, a rule, a user identified choice. The policy, rule, or user choice may be identified in task data received by the task match circuitry.

In various embodiments of the subject matter of the present disclosure, a task operating environment may be included in a thread, in a computing process, in a virtual operating environment in an operating environment of a node, a container (e.g. a Linux container), or in any other type of operating environment that may be assigned one or more resources accessible to circuitry hosted by the particular operating environment, such as task circuitry. Alternatively or additionally, a task operating environment may include a thread, a computing process, a virtual operating environment, a container (e.g. a Linux container), or in any other type of operating environment in which task circuitry may operate.

In an embodiment, an offer may be valid according to schema of the data center, service site, cloud computing environment, offer-based computing environment, or a client of any of the foregoing. In another embodiment, a schema realized by or otherwise accessible to task host circuitry may be utilized. The offer may be transformed by an offer-based computing environment via a proxy for task host circuitry. Such a proxy may operate in a data center, service site, cloud computing environment, offer-based computing environment, or a node not included in the data center, service site, cloud computing environment, or offer-based computing environment.

Offers transmitted to a node hosting or otherwise having access to task host circuitry may be restricted or constrained by task type, by date, time, duration, by power accessible to the node, by a geospatial location of the node, by an application or another task operating or scheduled to operate in an operating environment of the node, and the like. Similarly, task data transmitted by a node hosting task coordination circuitry or task match circuitry may be analogously constrained or restricted.

A node hosting or having access to task host circuitry may receive task data from a queue or list. The queue may be accessible to more than one instance of task host circuitry which may operate in one or more nodes. In an embodiment, the task data may be received by exactly instance of task host circuitry. The instance may be the first instance to access the task data or may meet some other specified criterion. In another embodiment, multiple instances of task host circuitry may receive the same task data and each may perform the task. The result of each performing of the task may be combined or one result may be selected, such as the first result to be available or received by a task coordination circuitry that placed the task data on the queue. In an aspect, task data for a task may identify a time to initiate, complete, or be performing the task. A time identified in task data may be included in specifying a duration during which some or all of a task may be to be performed. Time may be specified relative to another time or to an event or condition detected at another time. If a task may be not initiated or completed by a specified time or within a specified duration, as configured, the result may be ignored. It may no longer be needed or may otherwise no longer be useful.

In an embodiment, a resource identified as accessed or otherwise utilized in performing a task or a resource identified in an offer may not be included in or otherwise may not be accessible (permanently or temporarily) to an offer-based computing environment included in processing the task data or the offer. Examples of resources that may not be accessible in or via a task operating environment of a node not in a data center or other grouping of devices included in or otherwise hosting an offer-based computing environment or a portion thereof include a user, a client node, a location, a certificate, a cryptography key, a media encoder, a media decoder, an output device, an input device, a light, a heating device, an ambient condition sensor, a speedometer, or a motion detector—to name a few examples. The user as a resource may be user with a particular attribute such a measure of attention, a type of attention, a demographic attribute, in a specified location, an identified skill, a level of education, a language ability, a measure of wealth, an income attribute, a permission, a role, a title, a relationship to another user or other entity, and the like. A node as a resource may include a node with a particular attribute such as a function or capability (e.g. access to home appliance, a steering system of a transportation vehicle, etc.), a usage cost, an access cost, a distance (in time, space, speed) from the data center or other grouping of devices that are included in or that otherwise host the offer-based computing environment of the portion, access to a geospatial location (direct or indirect), an owner, a manufacturer, an attribute of movement, an attribute of heat, an attribute of energy, and so on.

In an embodiment, a user node or a user of the node may have a relationship to the offer-based computing environment. In one embodiment, the node or the user may be authenticated by the offer-based computing environment (e.g. may have an account, may be a member, . . . ). The offer-based computing environment may provide services, such as authentication, for or otherwise based on an organization, a region, a particular type of device, a particular function of a device, a date, or a time—to name a few examples.

In an embodiment, performing the task may include receiving input data in response to interacting with the user via an input device (or an output device), presenting an output to a user of the device, accessing a peripheral operatively coupled to the device, such as a printer or an automobile. An offer may identify a user, an input device, input data, or an output device as a resource(s) accessible for preforming a task. A resource identified in an offer may be qualified or constrained based on an attribute (e.g. a size, a particular resource, etc.) of the resource also identified in the offer.

In embodiments of the systems, methods, and arrangements of the present disclosure; a node not included in a server site, data center, or a cloud computing environment of an offer-based computing environment may receive task data, receive an offer, host task coordination circuitry, host task match circuitry, host task-offer routing circuitry, host task host circuitry, or host a task operating environment. Such a node may be a user node that interacts with a user, a TV, a media player, an appliance, a transportation vehicle, a sensor, an electronic lock, an electronic door, an HVAC system, a wearable device (e.g. a personal accessory or clothing), a node that include or otherwise has access to a device in the Internet of Things (IoT) such as a light or a light fixture, and the like.

In an embodiment, first task data, that may identify a first task or first task circuitry that operates to perform the first task, may identify a second task that may be a subtask of the first task or a peer of the first task that may be a task to be performed along during, before, or after the first task. The first task circuitry may operate to provide second task data to deliver to task coordination circuitry or task match circuitry for processing as described herein.

Task data received by task coordination circuitry, task match circuitry, task-offer routing circuitry, task host circuitry, or a task operating environment for performing a task identified by task data may be processed for performing immediately, at a specified time (absolute or relative), may be blocked, or otherwise may be queued for performing when a suitable task operating environment is available. A task may have an associated duration in which performing of the task is to be initiated, completed, or reach some other specified state of operation. If the task is not initiated, completed, or does not reach the other specified state within the duration; then task data that identifies the task or that identifies another related task, such as logging an error event, may be sent to task match circuitry to match with another offer, may be halted, may be completed with the result discarded, rolled back, or identified to monitoring or management circuitry.

In an embodiment, a first offer-based computing environment that includes or that is otherwise hosted, at least in part, by a first node, a first data center, a first service site, or a first cloud computing environment may locate or otherwise identify or may be located or identified by a second node, a second data center, a second service site, a second cloud computing environment, or a second offer-based computing environment that includes or has access to task match circuitry, task coordination circuitry, task-offer routing circuitry, task host circuitry, or task operating environment that is accessible for use by the first offer-based computing environment. The locating or identifying may be performed based on a directory service, configuration data, data received from a user via an input device, or via a shared resource. A shared resource may include a shared LAN, VLAN, intranet, a subnet, an SDN, a VPN, a geospatial location, or an identifier space; among other things. The locating or the identifying be based on an administrator, a customer relationship, a contract, a legal entity, a government entity, a law, a security requirement or preference, a performance requirement or preference, or a cost requirement or preference—to identify a few alternative or additional factors that may be included in the identifying or locating.

In an accept a first offer may be conditionally offered based on whether a second offer is matched. The two offers may offer or identify a same resource or a portion of the same resource or the first offer may identify a resource that is accessible or not based on attribute of a resource identified in a resource identified in the second offer. When the second offer is matched to a task, the task circuitry matched to the second offer may change the attribute and change access to all or part of the resource identified in the first offer. In a scenario, task circuitry matched with the second offer may delete a resource identified by the first offer. When one of the first offer or the second offer is matched with a task, the other offer may be withdrawn or modified. A resource identified in an offer may change in time. For example, a location of the resource may change. The resource may age, degrade, die, expand, multiply, or transform. The offer may be withdrawn or modified. Offers may identify or may be associated with a time or duration in which the offer remains available or valid. If not matched or a task matched with the offer is not performed according to the specified time or duration, the offer may be withdrawn, a performing of the task may be aborted, ignored, or processed as task performed in error.

In an embodiment an offer may be published in real-time (like presence status). Rather than sending resource info, an offer identifier may be sent to the offer-based computing environment where offers are accessible in real-time. An offer may disappear be removed or modified if accessible resources change.

In an embodiment, a matching offer may be utilized to select an existing task operating environment that provides access to the resource(s) offered. In another embodiment, a task operating environment may be created, based on the matched offer, by task host circuitry.

Circuitry included in performing one or more of the methods of the present disclosure may be may be programmable in some embodiments, may be virtual circuitry generated from source code written in a programming language, or may be hard-wired.

A resource may be identified as not accessible in an offer for task host circuitry because the resource may not exist, may not have a specified attribute such an amount, may exist but may be reserved or in use (e.g. locked via a serialization mechanism), or not accessible due to a constraint based on a late payment, an ownership attribute, a contract, a regulation, a policy, a cost, a location, an environmental impact, or a certification—to name some examples.

In an embodiment, circuitry may be included in, accessible to, or otherwise provided for use with an offer-based computing environment hosted. The circuitry may operate to receive an offer, via a network from a node. The offer may identify a resource of the node that may be not included or that may be not accessible to task host circuitry in another node, a data center, a service site, or a cloud computing environment of the offer-based computing environment or a portion thereof. The circuitry may also determine that no offer from task host circuitry in the offer-based computing environment of the portion identifies the resource. In an aspect, the circuitry may identify a task that matches the offer or may select the offer from a group of offers in which no offer from task host circuitry in the offer-based computing environment or the portion identifies the resource or a resource that matches. Further still, the circuitry may operate in transmitting data, via the network, to assign the task to task host circuitry not included in the offer-based computing environment or the portion.

In another embodiment, circuitry may be included in, accessible to, or otherwise provided for use with an operating environment of a first node not included in an offer-based computing environment or a portion thereof hosted by a second node, a data center, a service site, a cloud computing environment, or other grouping of nodes. The first node may be communicatively coupled to the offer-based computing environment or the portion via a network. The circuitry may operate to receive data that identifies the offer-based computing environment or the portion. The circuitry may additionally operate in exchanging data, via a network between the first node and the second node, the data center, the service site, the cloud computing environment, or the other grouping of nodes. Also, the circuitry may operate to create an offer that may identify a resource of the first node. Further still, the circuitry may operate to transmit the offer, via the network, to the offer-based computing environment or the portion to make the task host circuitry of the first node accessible in the offer-based computing environment for performing one or more tasks.

In an aspect, circuitry may be provided that operates in a first node to receive task data via a network from an offer-based computing environment hosted by a second node, a data center, a service site, a cloud computing environment, or other grouping of nodes. The task data may identify a task that matches an offer from task host circuitry of the first node. The task data may be received when no offer in the second node, the data center, the service site, the cloud computing environment, or the other grouping of nodes identifies the resource or a resource that otherwise matches. The task host circuitry may create or select a task operating environment. The task host circuitry may further initiate task circuitry in the task operating environment to perform the task. Performing the task includes utilizing or otherwise accessing the resource of the first node.

A user may be identified in an offer as a resource available for performing a task. The user may be further identified based on an attribute such an identifier of a particular user, a group that includes the user, an organization that the user represents, a physical attribute of the user, a capability of the user, a demographic attribute of the user, a location of the user, an indication or measure of attention of the user, an indication or measure of a physical condition of the user, and so forth. In an embodiment, circuitry may be provided that may be operable for use with an offer-based computing environment. The circuitry may operate to receive, via a network from a user node, an offer that may identify a user as a resource accessible to the user node. The user node may be not a node included in or that otherwise hosts some or all of the offer-based computing environment. The circuitry may operate to identify a task that matches the offer. The circuitry may also operate to transmit data, via the network, to the first node to assign the task to task host circuitry of the first node.

A criterion for input resources identified by task data or by an offer may be based on a capability or other attribute of the input resource. A capability may include detecting a selection, detect pointing, detecting a location in an output space, detecting light, detecting a speed, detecting a direction of a movement, detecting a direction of a first object with respect to a second object, receiving text, receiving or accessing data (e.g. a file, a record, a directory, a table, a row, a column, etc.) from a persistent data store, or interoperating with a particular type of input device (e.g. a keyboard, a microphone, an image capture device, a touch screen, etc.)—to name some examples. A capability may include presenting an audio output, drawing in an output space, streaming data to a display or a projection device, printing, presenting an output in a particular color, presenting a particular shape, presenting a type of user interface element, or interoperating with an particular type of output device (e.g. a display, a projector, a speaker, a device that physically moves, a printer, or a device that performs a user detectable action such as changing the state of a light, a home appliance, a transportation vehicle, etc.). Exemplary input or output attributes include a decibel range, a resolution of a screen a pixel size, a brightness, a speed or velocity, an acceleration, a location, a security attribute, a cost, etc. An attribute may be identified by a measure. A measure be an absolute measure or may be relative to another measure or entity. A resource identified by task data or by an offer may be identified as required, preferred, or optional to a performing of a task. When a resource is identified, an alternative may also be identified. The optional resource or the alternative may be specified to indicate that at least one may be required, that one may be preferred over the other, or that neither may be required to perform a particular task. An offer that may identify a resource may indicate a probability or other indicator of likelihood that the resource is available. A resource may be guaranteed to be available. An indicator that a resource is available may have an associated constraint. For example, an identified resource may be identified as available based on a specified time constraint, location constraint, or cost constraint. An offer may identify one resource as an alternative to another and may allow task data to select one. In an aspect, task circuitry may interact with a user to allow the user to select a resource utilized in performing a task.

A geospatial location may be identified as resource or as an attribute of resource. A location may be specified that includes a resource to utilize in performing a task. A geospatial location may be a location that a resource has or can obtain information about. Task data or an offer may identify a location by an event associated with the location, a service accessible at or via the location, a route or path that includes the location, an object at or near (e.g. within a specified distance which may be specified absolutely or relatively) the location, an object that has or that will be in or within the location, or an attribute of an object associated with a location such as a type of object, an identifier for an object, a height of an object, a state of an object, and the like. Note that a location may be fixed or may change. A location that changes may change in a continuous or discontinuous manner. For example, a task may utilize one or more sensors (note: a sensor may be or may include a living being or a device) to detect a measure of a rain, humidity, barometric pressure for a location where rain may be falling, or subjective attribute. The location may be constrained by another criterion such as another geospatial region or location. The location may change within the range of a sensor or other resource. A resource may be mobile and may move as the location changes (e.g. as the rain moves) or vice versa.

In an embodiment, task circuitry may operate to maintain or report a status of a user interacting with a device.

In an embodiment, task match circuitry operating in a user node or a user operating environment may operate in or may interoperate with task coordination circuitry operating at least partially in an operating environment of the node or at least partially in an offer-based computing environment or a portion thereof communicatively coupled to the node via a network. The task coordination circuitry may include or may otherwise have access to one or more other instances of task match circuitry for matching different tasks with offers.

In an embodiment, a first portion of an operating environment of a first node or a second portion of the operating environment of a second node may be modified based on a change in a resource accessible in one or both of the first node and the second node. In an embodiment, as accessible energy or another resource changes in the first node, more or less of the operating environment or more or less processing may be moved to the second node. In another aspect, a first portion of an operating environment of a first node or a second portion of the operating environment of a second node operate to synchronize their respective mode so that both may sleep, hibernate, be turned turn off, etc. at a same time or during a same duration. Alternatively or additionally, the portions may operate in different modes. For example, the first portion may be in an active mode while the second portion may be in a hibernation mode. Active tasks, processes, threads, applications, or VOEs may operate in the first portion while inactive task, processes, threads, applications, or VOEs may sleep in the second portion, in another aspect. Accessed data, recently accessed data, or data projected to be accessed within a specified data or order may be stored in a storage device of the first node while data that has not been accessed or not projected to be accessed may be stored in a storage device of the second node. In an embodiment, the first node may be replaced by a third node. Based on a difference between the first node and the third node, the operating environment may be distributed across or between the third node and the second node differently than between the first node and the second node. In another aspect, a different operating environment may operate across the third node and the first node than across the second node. For example, the first node may be a laptop computer. The operating environment of the first node and the second node may include a WINDOWS, LINUX, or MAC operating system. The third node may be an or may be included in a home appliance or an automobile. The operating environment of the third node and the second node may be an operating environment that may be specific for the home appliance or the car. A first portion of a kernel of an operating environment may operate in the first node and a second portion of the kernel may operate in the second node. The first portion of the operating environment may present a user interface to interact with the user. In an embodiment, all of the kernel operates in the second node. The first node may be a user node with input or output devices. A user interaction model for an operating environment may be selected based on one or more input devices or output devices (and their attributes) accessible the first node. Each node may interact with a user via a different user interaction model or user interface model. For task circuitry operating in the first portion the operating environment may include circuitry that provides an API to hardware of the second node. The first portion may include circuitry that provides an API to hardware in the first node. A hardware driver may operate at least partially in the first portion that accesses a hardware adapter of the second node (and vice versa). An operation may be performed during a booting operation in the first node to determine whether a service daemon may be to be executed in the first portion, the second portion, in parallel in both, or a single instance distributed across both. The daemon may be a kernel daemon. The first node may be restricted to communicating with only the second node (or data center) which may provide access to a network. The operating environment may be a virtual operating environment provided by a first operating environment of the first node and a second operating environment of the second node. A processor in at least one of the first node and the second node may not be Turing complete. In an aspect neither node may include a Turing complete processor. In a further aspect, when combined the two nodes may provide a Turing complete instruction execution machine. Such a machine may be a virtual processor. At least some of applications/services of the operating environment of the first node and the second node may be started automatically during booting of the first portion in the first node or during booting of the second portion in the second node. An application or service may be booted or initialized in the first node, in response to identifying a user, or in response to an initial data exchange between the first node and the second node or another node such as a systems management node. An operating system may be selected to be included in the operating environment based on a user of at least one of the nodes, based on the first node, based on an organization that controls the node, based on a geospatial location of the node, based on accessible energy, or based on a source of energy—to name a few examples.

Thread task match circuitry or task coordination circuitry of an offer-based computing environment may determine whether to assign a thread to be executed by a processor in a first portion, of the operating environment, operating in a first node or in a second portion, of the operating environment, operating in a second node. The determination may be based on a measure of a resource accessible in the first portion or based on measure of a resource accessible in the second portion. A process or thread executed by a processor in one of the first portion and the second portion may be suspended and assigned to a process of the other one of the first portion and the second portion to continue operation. An interprocess communication (IPC) mechanism or a network protocol may be utilized in exchanging data between the first portion and the second portion.

The offer-based computing environment may operate in a home and may include or be operatively coupled to a lighting device, a heating device, a cooking device, a cleaning device, a cooling device, a media presentation device, a thermostat, a humidifier, an alarm, a smoke or other gas or particle detector, a wearable device, a laptop, a tablet, a handheld device, and the like.

A resource may be identified according to measure of the resource utilized, a mechanism for accessing the resource, a cost of the resource, and so forth. For example, persistent storage greater than 20 megabytes may not be required to perform a task. An offer that may identify more than 20 megabytes of persistent storage may be said herein to be a resource not utilized in performing the task.

In one scenario, an embodiment of one or more of the methods or portions of the methods be performed in an embodiment that includes in a hierarchy of one or more offer-based computing environments, instances of task match circuitry, task coordination circuitry, task host circuitry, task-offer routing circuitry, or task operating environments. A hierarchical embodiment may operate to create, change, or remove associations of instances of one or more types of foregoing types of circuitry to scale an offer-based computing environment or a portion of an offer-based computing environment up or down, to extend the capabilities of an offer-based computing environment, to update software/circuitry that operates to realize the one or more types of the foregoing types, or to move some or all of an offer-based computing environment from one physical/virtual environment to another—to identify a few beneficial features. Such associations may create an offer-based computing environment that may change in real-time, near real-time, or over any suitable duration as per the desires or needs of implementers, owners, customers, designers, administrators, and the like.

According to the subject matter of the present disclosure, a user may access one or more service providers via a server node, a data center, a service site, a cloud computing environment, or an offer-based computing environment. The service providers may share services of the server node, the data center, the service site, the cloud computing environment, or the offer-based computing environment. A client or user may benefit from consistent privacy, performance, reliability, or security provided via the server node, data center, service site, cloud computing environment, or offer-based computing environment. Service level agreements may be created and enforced by the server node, data center, service site, cloud computing environment, or offer-based computing environment with clients or the service providers or with service providers. A client and service provider may benefit from service such as single sign-on, shared payment services, shared return policies and processes, shared insurance, shared antivirus, shared firewall service, and the ability to perform all of some transactions and parts of other transactions with the server node, data center, service site, cloud computing environment, or offer-based computing environment avoiding the risks of the Internet or other public network.

Further still, according to the Figures and specification of the present disclosure, a group of server nodes, service sites, data centers, cloud computing environments, or offer-based computing environments may enable data exchanges that between a node not in any of the server nodes, service sites, data centers, cloud computing environments, or offer-based computing environments to communicate with another node with no or less use of the Internet or other public network. Mixed protocol URIs are described allowing new network protocols to be utilized in or between the server nodes, service sites, data centers, cloud computing environments, or offer-based computing environments. A hierarchical network may be realized reduces the need for IP addresses (a current problem).

In various embodiments, an offer-based computing environment may be included or otherwise may be hosted by a single node or multiple nodes. Exemplary nodes that may be included in or other may host part or all of an offer-based computing environment include any device identified in the specification or Figures of the present disclosure along with equivalents and analogs. In an embodiment, a smart phone or a laptop may include an offer-based computing environment. Process and thread based computing may be reduced or eliminated in some embodiments. Current operating systems such as WINDOWS, OSX, LINUX, UNIX, IOS, ANDROID, and others may be modified to provide or to operate at least partially based on an offer-based computing architecture, such as illustrated in FIG. 1 as well as other Figures of the present disclosure.

An offer-based computing environment may be created dynamically by a one or more nodes according to the specification and Figures of the present disclosure. As such, users in a same location may share resources via an offer-based computing environment hosted by the nodes of the users in the same location. Offer-based computing environments may be created, resized, or changed functionally based on nodes associated by some attribute other than or in addition to location. A family may share resources via an offer-based computing environment created from nodes of the family members. Capabilities of the offer-based computing environment may change as one or more of the nodes changes location, adds a resources, changes a resource, removes a resource, changes operational state, and so on.

### Operating Environments

In the context of the present disclosure, a network may embody any of a variety of network architectures. A network may take any form including, but not limited to a telecommunications network, a local area network (LAN), a wireless network, a wide area network (WAN) such as the Internet, a peer-to-peer network, a cable network, etc. In the context of the present disclosure a plurality of devices of varying types and capabilities may be coupled to a network. Exemplary devices include client devices, server devices, and network relay or routing devices such as a bridge, a router, a hub, or a switch—to name a few examples. A node in a network may be a user node that interacts with a user. Exemplary user nodes include a desktop computer, a lap-top computer, a tablet computer, a media player device, a gaming device, a printer, scanner, a fax machine, a wearable device, a transportation vehicle (e.g. a car, a boat, a flying machine), a phone, an image capture device, an audio capture device, a home appliance (e.g. a thermostat, a refrigerator, a stove, an oven, a light which may include an LED, a power outlet, a power storage device, a power generating device), circuitry included in a construction material (e.g. a sheet rock panel, a wall or ceiling support, etc.), a fan, a filter, a pump, a cooling device, a heating device, a light emitting device, heating device a cooling device, a heat sensing device, a motion sensing device, a pressure sensing device, a weight sensing device, a touch sensing device, other devices identified in the specification or Figures of the present disclosure and their equivalents, or any other type of device that includes or that interoperates with network interface hardware such as a wired or wireless adapter.

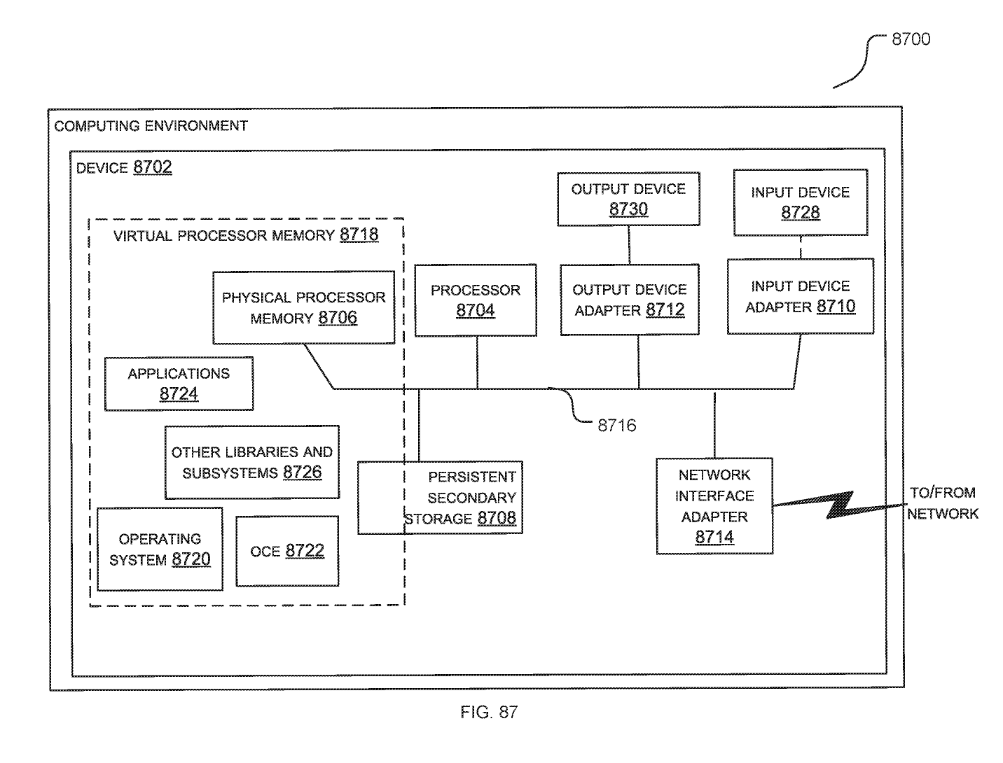

FIG. 87 illustrates an exemplary system, in accordance with an embodiment. As an option, the system may be implemented in the context of in the context of any one or more of the Figures set forth herein. Of course, the system may be implemented in any suitable arrangement of hardware. An arrangement of hardware is included in one or more devices. FIG. 87 illustrates an operating environment as a computing environment 8700 that may be programmed, adapted, modified, or otherwise configured according to the subject matter of the present disclosure. FIG. 87 illustrates a device 8702 or hardware included in computing environment 8700. FIG. 87 illustrates that computing environment 8700 includes a processor 8704, such as one or more microprocessors; a physical processor memory 8706 including storage locations identified by addresses in a physical memory address space of processor 8704; a persistent secondary data store 8708, such as one or more hard drives or flash storage media; an input device adapter 8710, such as a key or keypad hardware, a touch adapter, a keyboard adapter, or a mouse adapter; an output device output device adapter 8712, such as a display or an audio adapter to present information to a user; a network interface, illustrated by a network interface adapter 8714, to communicate via a network such as a LAN or WAN; and a mechanism that operatively couples elements 8704-8714, illustrated as a data transfer medium 8716. Elements 8704-8714 may be operatively coupled by various means. Data transfer medium 8716 may comprise any type network or a bus architecture. A bus architecture may include a memory bus, a peripheral bus, a local bus, a mesh fabric, a switching fabric, or one or more direct connections.

Processor 8704 may access instructions and data via one or more memory address spaces in addition to the physical memory address space. A memory address space includes addresses identifying locations in a processor memory. The addresses in a memory address space are included in defining a processor memory. Processor 8704 may have more than one processor memory. Thus, processor 8704 may have more than one memory address space. Processor 8704 may access a location in a processor memory by processing an address identifying the location. The processed address may be identified by an operand of an instruction or may be identified by a register or other portion of physical processor memory 8706.

An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as physical processor memory 8706 or may refer to virtual processor memory, such as virtual physical processor memory 8706, depending on the context in which the term is used.

FIG. 87 illustrates a virtual processor memory 8718 spanning at least part of physical processor memory 8706 and may span at least part of persistent secondary storage 8708. Virtual memory addresses in a memory address space may be mapped to physical memory addresses identifying locations in physical processor memory 8706. Both physical processor memory 8706 and virtual processor memory 8718 are processor memories, as defined above.

Physical processor memory 8706 may include various types of memory technologies. Exemplary memory technologies include static random access memory (SRAM), Burst SRAM or Synchburst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC SDRAM, Double Data rate SDRAM (DDR SDRAM), Enhanced SDRAM (ESDRAM), Synclink DRAM (SLDRAM), Ferroelectric RAM (FRAM), RAMBUS DRAM (RDRAM) Direct DRAM (DRDRAM), or XDRTM DRAM. Physical processor memory 8706 may include volatile memory as illustrated in the previous sentence or may include non-volatile memory such as non-volatile flash RAM (NVRAM) or ROM.

Persistent secondary storage 8708 may include one or more flash memory storage devices, one or more hard disk drives, one or more magnetic disk drives, or one or more optical disk drives. Persistent secondary storage 8708 may include a removable data storage medium. The drives and their associated computer readable media provide volatile or nonvolatile storage for representations of computer-executable instructions, data structures, software components, and other data. The computer readable instructions may be loaded into a processor memory as instructions executable by a processor.

Computing environment 8700 may include virtual circuitry specified in software components stored in persistent secondary storage 8708, in remote storage accessible via a network, or in a processor memory. FIG. 87 illustrates computing environment 8700 including virtual circuitry in an operating system 8720, in an offer-based computing environment, in one or more applications 8724, and in other software components or data components illustrated by other libraries and subsystems 8726. In an aspect, some or all virtual circuitry specified for realizing the software components may be stored in locations accessible to physical processor memory 8706 in a shared memory address space shared by more than one thread or process of computing environment 8700. The circuitry and data for performing operation(s) in software components accessed via the shared memory address space may be stored in a shared processor memory defined by the shared memory address space. In another aspect, first circuitry for a first software component may be represented in in one or more memory locations accessed by processor 8704 in a first address space and second circuitry for a second software component may be represented in one or more memory locations accessed by processor 8704 in a second address space. The first circuitry may be represented in memory as first machine code in a first processor memory defined by the first address space and the second circuitry may be represented as second machine code in a second processor memory defined by the second address space.

Computing environment 8700 may receive user-provided information via one or more input devices illustrated by an input device 8728. Input device 8728 provides input information to other components in computing environment 8700 via an input device adapter 8710. Computing environment 8700 may include an input device adapter 8710 for a keyboard, a touch screen, a microphone, a joystick, a television receiver, a video camera, a still camera, a scanner, a fax, a phone, a modem, a network interface adapter, a sensor for detecting an ambient condition, a motion detecting device, an energy detecting device, or a pointing device, to name a few exemplary input devices. Input device 8728 included in computing environment 8700 may be included in device 8702 as FIG. 87 illustrates or may be external (not shown) to device 8702. Computing environment 8700 may include one or more internal or external input devices. External input devices may be connected to device 8702 via corresponding data interfaces such as a serial port, a parallel port, or a universal serial bus (USB) port. Input device adapter 8710 may receive input and provide a representation to data transfer medium 8716 to be received by processor 8704, physical processor memory data transfer medium 8716, or other components included in computing environment 8700.

An output device 8730 in FIG. 87 exemplifies one or more output devices that may be included in or that may be external to and operatively coupled to device 8702. For example, output device 8730 is illustrated connected to data transfer medium 8716 via output device adapter 8712. Output device 8730 may be a display device. Exemplary display devices include liquid crystal displays (LCDs), light emitting diode (LED) displays, and projectors. Output device 8730 presents output of computing environment 8700 to one or more users. In some architectures, an input device may also include an output device. Examples include a phone, a joystick, or a touch screen. In addition to various types of display devices, exemplary output devices include printers, speakers, tactile output devices such as motion-producing devices, heat output devices, wind output devices, devices that generate motion detectable by a user or by another device, energy output devices, and other output devices producing sensory information detectable by a user. Sensory information detected by a user is referred in the present disclosure to as “sensory input” with respect to the user.

A device included in or otherwise providing an operating environment may operate in a networked environment interoperating with one or more other devices via one or more network interface components. The device and the operating environment may operate in another operating environment. For example, computing environment 8700 may be included in cloud computing environment, an offer-based computing environment, or may be a virtual operating environment in another computing environment. FIG. 87 illustrates network interface adapter 8714 as a network interface component included in computing environment 8700 to communicatively couple device 8702 to a network. A network interface component includes a network interface hardware (NIH) component and optionally a network interface software (NIS) component. Exemplary network interface components include network interface controllers, network interface cards, network interface adapters, and line cards. A node may include one or more network interface components to interoperate with a wired network or a wireless network. Exemplary wireless networks include a BLUETOOTH network, a wireless 802.11 network, or a wireless telephony network (e.g., CDMA, AMPS, TDMA, CDMA, GSM, GPRS UMTS, or PCS network). Exemplary network interface components for wired networks include Ethernet adapters, Token-ring adapters, FDDI adapters, asynchronous transfer mode (ATM) adapters, and modems of various types. Exemplary wired or wireless networks include various types of LANs, WANs, mesh networks, or personal area networks (PANs). Exemplary networks also include intranets and internets such as the Internet.

Exemplary devices included in or otherwise providing suitable operating environments that may be adapted, programmed, or otherwise modified according to the subject matter include a workstation, a desktop computer, a laptop or notebook computer, a server, a handheld computer, a smartphone, a mobile telephone or other portable telecommunication hardware, a media playing hardware, a gaming system, a tablet computer, a portable electronic device, a handheld electronic device, a multiprocessor device, a distributed system, a consumer electronic device, a router, a switch, a bridge, a network server, any other type or form of computing, telecommunications, network, a media device, a transportation vehicle, a building, an appliance, a human wearable entity, a lighting device, a networking device, a manufacturing device, a test device, a sensor, a musical instrument, a printing device, a vision device, a netbook, a cloud book, a mainframe, a supercomputer, a wearable computer, a minicomputer, an air conditioner, a clock, an answering machine, a blender, a blow dryer, a security system, a calculator, a camera, a can opener, a cd player, a fan, a washer, a dryer, coffee grinder, coffee maker, an oven, a copier, a crock pot, a curling iron, a dishwasher, a doorbell, a lawn edger, an electric blanket, a power tool, a cordless power tool, a musical instrument, a pencil sharpener, an electric razor, an electric toothbrush, an espresso maker, a smoke detector, a carbon monoxide detector, a flashlight, a television, a food processor, a source of electrical energy, a source of non-electrical energy, a freezer, a furnace, a heat pump, a garage door opener, a garbage disposal, a GPS device, an audio recording device, an audio playing device, a humidifier, an iron, a light, lawn equipment, a leaf blower, a microwave oven, a mixer, a printer, a radio, a cook-top, a refrigerator, a scanner, a toaster, a trash compactor, a vacuum cleaner, a vaporizer, a VCR, a video camera, a video game machine, a watch, a water heater, a DVD player, a game console, a robot, a sump pump, a watch, a heart monitor or other body monitors, smart eye-wear, an insulin pump, a pacemaker, or a node in the Internet of Things (IoT). It will be understood by those skilled in the art based on the present disclosure that the foregoing list is not exhaustive. Those skilled in the art will understand that the components illustrated in FIG. 87 are exemplary and may vary by particular operating environment. An operating environment may be or may include a virtual operating environment including software components operating in a host operating environment.

It will be appreciated that an embodiment may also be implemented on platforms and operating environments other than those mentioned. Of course, the various embodiments set forth herein may be implemented utilizing hardware, software, or any desired combination thereof. For that matter, any type of logic may be utilized which is capable of implementing the various functionality set forth herein.

Suitable operating environments for the various methods described in the present disclosure may include or may be provided by a network node. Suitable operating environments include host operating environments and virtual operating environments. Suitable operating environments may include more than one node such as an operating environment of a cloud computing system. Some or all of the code, hardware, or other OERs included in performing any one or more of the methods described in the present disclosure may be adapted to operate in a number of operating environments. In an aspect, circuitry of such code may operate as a stand-alone application or may be included in or otherwise integrated with another application or software system. For example, various methods described in the present disclosure may operate in or may otherwise interoperate with a translator such as a source code editor, a compiler, a linker, a loader, or other programming tool. A compiler, linker, loader, or other programming tool may each operate as standalone applications or may be integrated or included in a hosting application, framework, or software platform.

An operating environment suitable for including circuitry that when executed may operate to perform a method of the present disclosure may be implemented in or otherwise may include one or more client nodes or server nodes. For each method of the present disclosure, one or more of various optional implementations of such circuitry may be included in an operating environment, such as operating environment of a client node or operating environment of a server node. An operating environment may be modified to include such an implementation of circuitry arranged in one or more addressable entities. For each method, circuitry to perform the method may be arranged in various optional arrangements of addressable entities which may implement various flows of data or execution. Suitable operating environments may include more than one node such as an operating environment of a cloud computing system.

For each method, logic to perform the method may be arranged in various optional arrangements of addressable entities. Logic in an implementation of each of methods of the present disclosure may be a translation of or otherwise may be specifiable in source code written in a programming language. Each method of the present disclosure may be embodied in one or more of various suitable arrangements in an operating environment or distributed between or among multiple operating environments. It will be understood that other arrangements of logic for performing each method of the present disclosure may be implemented with the logic distributed among addressable entities that are included in or accessible to one or more computing processes or operating environments.

Those skilled in the art will understand based on the present disclosure that the methods described herein and illustrated in the drawings may be embodied utilizing algorithms that may each be specified in more detail in source code written in any of various programming languages per the desires of one or more programmers. The source code may be translated or otherwise transformed to circuitry, such as machine code, that is executable by a processor. Those skilled in the art will further understand that modern operating environments, programming languages, and software development tools allow a programmer numerous options in writing the source code that specifies in more detail an algorithm that implements a particular method. For example, a programmer may have a choice with respect to specifying an order for carrying out the operations specified in the method. In another example, a programmer may present a user interface element in any number of ways that are known to those skilled in the art. Details of the source code typically will depend on an operating environment which may include a particular operating system and user interface software library. Compilers, loaders, and linkers may rewrite the instructions specified in the source code. As such, with respect to an algorithm that implements a particular method, the number of possible algorithms increases or at least remains as large as the level of specificity increases. Specificity generally increases from software analysis languages to design languages to programming languages to object code languages to machine code languages. Note the term “language” in this paragraph includes visual modeling (e.g. a flow charts, class diagrams, user interface drawings, etc.). It would be impractical to identify all such algorithms specified at the level of analysis languages or at the level of design languages, but such specifications will be apparent to the population as a whole of those skilled in the art. Further at least at some of all such specifications will be apparent or derivable based on the present disclosure to each member of the population. As such, the present disclosure is enabling and all such specifications of the methods/algorithms that may be written by those skilled in the art based on the descriptions herein or based on the drawings in an analysis language, a design language, a high level programming language, or an assembler language are within the scope of the subject matter of the present disclosure. Further, all specifications generated by a tool from any of the user written specifications are also within the scope of subject matter of the present disclosure.

It will also be apparent to those skilled in the art the algorithms taught based on the descriptions herein, the drawings, and the pseudo-code are exemplary and that a particular architecture, design, or implementation for any of the methods described herein may be selected based on various requirements that may vary for an embodiment including or otherwise invoking the circuitry. Requirements may vary based on one or more resources in an operating environment, performance needs/desires of a user or customer, attributes of a display device, attributes of a graphics service if included in an operating environment, one or more user interface elements processed by the circuitry or otherwise affecting the processing of the circuitry, a programming language, an analysis language, a design language, a test tool, a field support requirement, an economic cost of developing and supporting the implemented circuitry, and the desires of one or more developers of the architecture, design, or source code that includes or accesses the implemented circuitry. It will be clear to those skilled in the art that in the present disclosure it would impractical to attempt to identify all possible operating environments, programming languages, development, and test tools much less identify all possible algorithms for implementing the various methods whether the algorithms are expressed in pseudo-code, flow charts, object oriented analysis diagrams, object oriented design diagrams, resource data flow diagrams, entity-relationship diagrams, resource structures, classes, objects, functions, subroutines, and the like.

The methods described herein may be embodied, at least in part, in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of an addressable entity in one or more forms including an electronic, magnetic, optical, and electromagnetic form, such that the instruction execution machine, system, apparatus, or device may read (or fetch) the instructions from the non-transitory or transitory computer readable medium and execute the instructions for carrying out the described methods. By way of example, and not limitation, computer readable media may comprise computer storage media and resource exchange media. Computer storage media includes volatile and nonvolatile, removable and non-removable media implemented in any method or technology for storage of information such as computer readable instructions, resource structures, addressable entities or other resource. Computer storage media includes, but is not limited to, Random Access Memory (RAM), Read Only Memory (ROM), Electrically Erasable Programmable Read Only Memory (EEPROM), flash memory or other memory technology; portable computer diskette; Compact Disk Read Only Memory (CDROM), compact disc-rewritable (CDRW), digital versatile disks (DVD) or other optical disk storage; magnetic cassettes, magnetic tape, magnetic disk storage or other magnetic storage devices; or any other medium which can be used to store the desired information and which can accessed by a device. Resource exchange media typically embodies computer readable instructions, resource structures, addressable entities, or other resources in a modulated resource signal such as a carrier wave or other transport mechanism and includes any information delivery media. The term “modulated resource signal” means a signal that has one or more of its characteristics set or changed in such a manner as to encode information in the signal. By way of example, and not limitation, resource exchange media includes wired media such as a wired network or direct-wired connection, and wireless media such as acoustic, RF, infrared and other wireless media. Combinations of any of the above should also be included within the scope of computer readable media.

### REFERENCES

In various optional embodiments, the features, capabilities, techniques, or technology, etc. disclosed in the following applications may or may not be incorporated into any of the embodiments disclosed herein: U.S. patent application Ser. No. 10/913,071, titled “Method And System For Locating A Service By An Electronic Device”, filed on Aug. 6, 2004; U.S. patent application Ser. No. 11/065,510, titled “Method And System For Enabling Structured Real-Time Conversations Between Multiple Participants”, filed on Feb. 23, 2005; U.S. patent application Ser. No. 11/161,899, titled “Methods, Systems, And Computer Program Products For Conducting A Business Transaction Using A Pub/Sub Protocol”, filed on Aug. 22, 2005; U.S. patent application Ser. No. 11/162,432, titled “Methods, Systems, And Computer Program Products For Providing Service Data To A Service Provider”, filed on Sep. 9, 2005; U.S. patent application Ser. No. 11/192,489, titled “Method And System For Processing A Workflow Using A Publish-Subscribe Protocol”, filed on Jul. 29, 2005; U.S. patent application Ser. No. 11/428,273, titled “Methods, Systems, And Computer Program Products For Providing A Program Execution Environment”, filed on Jun. 30, 2006; U.S. patent application Ser. No. 11/428,280, titled “Methods, Systems, And Computer Program Products For Generating And Using Object Modules”, filed on Jun. 30, 2006; U.S. patent application Ser. No. 11/428,324, titled “Methods, Systems, And Computer Program Products For Using A Structured Data Storage System To Provide Access To Addressable Entities In Virtual Address Space”, filed on Jun. 30, 2006; U.S. patent application Ser. No. 11/428,324, titled “Method And System For Exchanging Messages Using A Presence Service”, filed on Jun. 30, 2006; U.S. patent application Ser. No. 11/428,338, titled “Methods, Systems, And Computer Program Products For Providing Access To Addressable Entities Using A Non-Sequential Virtual Address Space”, filed on Jun. 30, 2006; U.S. patent application Ser. No. 11/555,248, titled “Method And System For Routing A Message Over A Home Network”, filed on Oct. 31, 2006; U.S. patent application Ser. No. 11/610,917, titled “Methods And Systems For Routing A Message Over A Network”, filed on Dec. 14, 2006; U.S. patent application Ser. No. 11/615,438, titled “Methods And Systems For Determining Scheme Handling Procedures For Processing Uris Based On Uri Scheme Modifiers”, filed on Dec. 22, 2006; U.S. patent application Ser. No. 11/644,123, titled “Methods, Systems, And Computer Program Products For A Self-Automating Set Of Services Or Devices”, filed on Dec. 22, 2006; U.S. patent application Ser. No. 11/697,924, titled “Methods And System For Providing Concurrent Access To A Resource In A Communication Session”, filed on Apr. 9, 2007; U.S. patent application Ser. No. 11/742,153, titled “Methods And Systems For Communicating Task data”, filed on Apr. 30, 2007; U.S. patent application Ser. No. 11/766,960, titled “Method And Systems For Providing Transaction Support For Executable Program Components”, filed on Jun. 22, 2007; U.S. patent application Ser. No. 11/766,960, titled “Method And System For Distributing A Software Application To A Specified Recipient”, filed on Aug. 25, 2008; U.S. patent application Ser. No. 11/776,867, titled “Methods, Systems, And Computer Program Products For Providing A Browsing Mode Association Of A Link With Browsed Content”, filed on Jul. 12, 2007; U.S. patent application Ser. No. 11/776,867, titled “Method And Systems For Providing Remote Strage Via A Removable Memory Device”, filed on Jul. 9, 2007; U.S. patent application Ser. No. 11/831,323, titled “Method And System For Managing Access To A Resource Over A Network Using Status Information Of A Principal”, filed on Jul. 31, 2007; U.S. patent application Ser. No. 11/957,809, titled “Methods And Systems For Accessing A Resource Based On Urn Scheme Modifiers”, filed on Dec. 17, 2007; U.S. patent application Ser. No. 11/961,342, titled “Methods And Systems For Providing A Trust Indicator Associated With Geospatial Information From A Network Entity”, filed on Dec. 20, 2007; U.S. patent application Ser. No. 11/962,285, titled “Methods And Systems For Sending Information To A Zone Included In An Internet Network”, filed on Dec. 21, 2007; U.S. patent application Ser. No. 12/055,550, titled “Method And Systems For Invoking An Advice Operation Associated With A Joinpoint”, filed on Mar. 26, 2008; U.S. patent application Ser. No. 12/059,249, titled “Methods, Systems, And Computer Program Products For Providing Prior Values Of A Tuple Element In A Publish/Subscribe System”, filed on Mar. 31, 2008; U.S. patent application Ser. No. 12/062,101, titled “Method And Systems For Routing A Data Packet Based On Geospatial Information”, filed on Apr. 3, 2008; U.S. patent application Ser. No. 12/170,829, titled “Methods And Systems For Resolving A Location Information To A Network Identifier”, filed on Jul. 10, 2008; U.S. patent application Ser. No. 12/170,833, titled “Methods And Systems For Resolving A Query Region To A Network Identifier”, filed on Jul. 10, 2008; U.S. patent application Ser. No. 12/328,048, titled “Methods, Systems, And Computer Program Products For Resolving A Network Identifier Based On A Geospatial Domain Space Harmonized With A Non-Geospatial Domain Space”, filed on Dec. 4, 2008; U.S. patent application Ser. No. 12/328,055, titled “Methods, Systems, And Computer Program Products For Accessing A Resource Based On Metadata Associated With A Location On A Map”, filed on Dec. 4, 2008; U.S. patent application Ser. No. 12/328,059, titled “Methods, Systems, And Computer Program Products For Determining A Network Identifier Of A Node Providing A Type Of Service For A Geospatial Region”, filed on Dec. 4, 2008; U.S. patent application Ser. No. 12/328,059, titled “Method And System For Managing Metadata Associated With A Resource”, filed on Nov. 18, 2008; U.S. patent application Ser. No. 12/328,059, titled “Method And Systems For Incrementally Resolving A Host Name To A Network Address”, filed on Nov. 18, 2008; U.S. patent application Ser. No. 12/328,063, titled “Methods, Systems, And Computer Program Products For Accessing A Resource Having A Network Address Associated With A Location On A Map”, filed on Dec. 4, 2008; U.S. patent application Ser. No. 12/401,706, titled “Method And System For Providing Access To Resources Related To A Locatable Resource”, filed on Mar. 11, 2009; U.S. patent application Ser. No. 12/401,707, titled “Methods And Systems For Resolving A First Node Identifier In A First Identifier Domain Space To A Second Node Identifier In A Second Identifier Domain Space”, filed on Mar. 11, 2009; U.S. patent application Ser. No. 12/413,850, titled “Methods, Systems, And Computer Program Products For Providing Access To Metadata For An Identified Resource”, filed on Mar. 30, 2009; U.S. patent application Ser. No. 12/413,855, titled “Method And System For Providing Access To Metadata Of A Network Accessible Resource”, filed on Mar. 30, 2009; U.S. patent application Ser. No. 12/414,007, titled “Methods, Systems, And Computer Program Products For Resolving A First Source Node Identifier To A Second Source Node Identifier”, filed on Mar. 30, 2009; U.S. patent application Ser. No. 12/414,830, titled “Methods, Systems, And Computer Program Products For Establishing A Shared Browsing Session Between A User Of A Web Browser With A User Of Another Web Browser”, filed on Mar. 31, 2009; U.S. patent application Ser. No. 12/414,835, titled “Methods, Systems, And Computer Program Products For Establishing A Shared Browsing Session Between A User Of A Web Browser With A User Of Another Web Browser”, filed on Mar. 31, 2009; U.S. patent application Ser. No. 12/437,601, titled “Method For Specifying Image Handling For Images On A Portable Device”, filed on May 8, 2009; U.S. patent application Ser. No. 12/485,261, titled “Method, System, And Data Structure For Providing A General Request/Response Messaging Protocol Using A Presence Protocol”, filed on Jun. 16, 2009; U.S. patent application Ser. No. 12/504,937, titled “System And Method For Harmonizing Changes In User Activities, Device Capabilities And Presence Information”, filed on Jul. 17, 2009; U.S. patent application Ser. No. 13/025,944, titled “Methods, Systems, And Computer Program Products For Managing Attention Of A User Of A Portable Electronic Device”, filed on Feb. 11, 2011; U.S. patent application Ser. No. 13/045,556, titled “Methods, Systems, And Computer Program Products For Providing Feedback To A User Of A Portable Electronic Device In Motion”, filed on Mar. 11, 2011; U.S. patent application Ser. No. 13/727,647, titled “Methods, Systems, And Computer Program Products For Identifying A Protocol Address Based On Path Information”, filed on Dec. 27, 2012; U.S. patent application Ser. No. 13/727,649, titled “Methods, Systems, And Computer Program Products For Assigning An Interface Identifier To A Network Interface”, filed on Dec. 27, 2012; U.S. patent application Ser. No. 13/727,651, titled “Methods, Systems, And Computer Program Products For Routing Based On A Nested Protocol Address”, filed on Dec. 27, 2012; U.S. patent application Ser. No. 13/727,652, titled “Methods, Systems, And Computer Program Products For Routing Based On A Scope-Specific Address”, filed on Dec. 27, 2012; U.S. patent application Ser. No. 13/727,653, titled “Methods, Systems, And Computer Program Products For Identifying A Protocol Address In A Scope-Specific Address Space”, filed on Dec. 27, 2012; U.S. patent application Ser. No. 13/727,655, titled “Methods, Systems, And Computer Program Products For Determining A Shared Identifier For A Hop In A Network”, filed on Dec. 27, 2012; U.S. patent application Ser. No. 13/727,657, titled “Methods, Systems, And Computer Program Products For Determining A Protocol Address For A Node”, filed on Dec. 27, 2012; U.S. patent application Ser. No. 13/727,662, titled “Methods, Systems, And Computer Program Products For Routing Based On A Path-Based Protocol Address”, filed on Dec. 27, 2012; and U.S. patent application Ser. No. 14/274,632, titled “Methods, Systems, And Computer Program Products For Associating A Name With A Network Path”, filed on May 9, 2014, which are each incorporated by reference in their entirety for all purposes. If any definitions (e.g. figure reference signs, specialized terms, examples, data, information, definitions, conventions, glossary, etc.) from any material incorporated by reference conflict with this application (e.g. abstract, description, summary, claims, etc.) for any purpose (e.g. prosecution, claim support, claim interpretation, claim construction, etc.), then the definitions in this application shall apply.

I claim:

1. A method, comprising:
provide circuitry operable for use with a system including a node;
receive, via the circuitry, a request to perform a task;
detect, via the circuitry, a resource that is identified by the request and that is not utilized in performing the task;
identify, via the circuitry, a plurality of task host circuitry instances that are each capable of performing the task, wherein a first instance of task host circuitry in the plurality does not have access to the resource; and
assign, via the circuitry, the task to the first instance of task host circuitry to perform the task.
